(19) United States
(12) Patent Application Publication
(10) Pub. No.: US 2005/0265151 A1
(43) Pub. Date: Dec. 1, 2005

(54) Objective optical system, optical pickup apparatus and optical disk drive apparatus

(75) Inventors: Tohru Kimura, Tokyo (JP); Nobuyoshi Mori, Tokyo (JP); Yuichi Atarashi, Tokyo (JP); Kiyono Ikenaka, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA OPTO, INC.

(21) Appl. No.: 11/135,449

(22) Filed: May 24, 2005

(30) Foreign Application Priority Data
May 27, 2004 (JP) JP2004-157798
May 27, 2004 (JP) JP2004-157908
Jul. 9, 2004 (JP) JP2004-203417
Aug. 6, 2004 (JP) JP2004-230967
Sep. 1, 2004 (JP) JP2004-254368
Sep. 14, 2004 (JP) JP2004-267092

(51) Int. Cl. G11B 7/00; G11B 7/135

(52) U.S. Cl. 369/44.37; 369/112.01; 369/112.03

(57) ABSTRACT

An objective optical system for use in an optical pickup apparatus which reproduces and/or records information on an information recording surface of first-third optical disks, the objective optical system includes a first optical element, a first part comprising a material A, a second part comprising a material b, wherein the first part and the second part are laminated on the first optical element in an optical axis of the objective optical system, and the material A and the material B have different Abbe constants for d-line each other and a first phase structure formed on a boundary between the first part and the second part.

This application is based on Japanese Patent Application Nos. 2004-157798 filed on May 27, 2004, 2004-157908 filed on May 27, 2004, 2004-203417 filed on Jul. 9, 2004, 2004-230967 filed on August 6, 2004, 2004-254368 filed on Sep. 1, 2004 and 2004-267092 filed on Sep. 14, 2004 in Japanese Patent Office, the entire content of which is hereby incorporated by reference.

### FIELD OF THE INVENTION

The present invention relates to an objective optical system, an optical pickup apparatus and an optical disc drive apparatus.

### BACKGROUND OF THE INVENTION

What is commonly known in the prior art includes an optical pickup apparatus capable of ensuring compatibility among the high-density optical disc, DVD (based on red laser light source) and CD (based on infrared laser light source) whose recording density has been improved by the use of a blue-violet laser light source, and an optical device used for this optical pickup apparatus (e.g. Patent Documents 1, 2 and 3).

[Patent Document 1] JP-A 2004-079146

[Patent Document 2] JP-A 2002-298422

[Patent Document 3] JP-A 2003-207714

[Patent Document 3] JP-A 2003-232997

In the numerical example 7 of the Patent Document 1, a diffractive structure is provided on the surface of the objective lens wherein this diffractive structure allows the second-order diffracted light flux to be generated in the case of a blue-violet laser beam, and the first-order diffracted light flux to be produced in the case of a red laser beam and infrared laser beam. The spherical aberration caused by the difference in the thickness of the protective layer between a high-density optical disc and DVD is corrected by the operation of this diffractive structure. Further, a divergent light flux is allowed to enter the objective lens at the time of recording/reproducing of information using a CD, thereby correcting the spherical aberration resulting from the difference in the thickness of the protective layer between the high-density optical disc and CD. Such an objective lens is disclosed in the Patent Document 1.

The aforementioned objective lens ensures a high degree of diffraction efficiency in any of the wavelength ranges, but causes the divergence of the red laser beam to be excessively intensified at the time of recording/reproducing of information using a CD. This causes generation of excessive comatic spherical aberration at the time of tracking of the objective lens, with the result that satisfactory recording/reproducing of information using the CD cannot be ensured.

In the numerical example 3 of the Patent Document 2, a diffractive structure is provided on the surface of the objective lens wherein this diffractive structure allows the third-order diffracted light flux to be generated in the case of a blue-violet laser beam, and the second-order diffracted light flux to be produced in the case of a red laser beam and infrared laser beam, whereby the spherical aberration caused by the difference in the thickness of the protective layer among a high-density optical disc, DVD and CD is corrected. Such an objective lens is disclosed in the Patent Document 2.

In this objective lens, the spherical aberration caused by the difference in the thickness of the protective layer between a high-density optical disc and DVD is corrected by the action of this diffractive structure. Further, the spherical aberration caused by the difference in the thickness of the protective layer between a high-density optical disc and CD is also corrected. However, this prior art has the following disadvantages: The speed in recording/reproducing of information using an optical disc cannot be increased because the diffraction efficiency of the third-order diffracted light flux of the blue-violet laser beam and that of the second-order diffracted light flux are as low as 70%; the satisfactbry recording/reproducing performances cannot be ensured because of a low signal-to-noise ratio of the detection signal in the optical detector; and the laser light source is short-lived because of the high voltage applied to the laser light source.

In the objective lens described in the Patent Document 1, the spherical aberration caused by the difference in the thickness of the protective layer between the high-density optical disc HD and CD cannot be corrected by the diffractive structure. In the objective lens described in the Patent Document 2, the diffraction efficiency of the third-order diffraction in the blue-violet wavelength area and that of the second-order diffraction in the infrared wavelength area are reduced. The reason for these phenomena is that the wavelength of the infrared laser light source used for the CD is approximately twice that of the blue-violet laser light source used in the high-density optical disc, and hence the effect of correcting the spherical aberration for the blue-violet laser beam and infrared laser beam of the diffracted light flux emitted from the diffractive structure is in the tradeoff relationship with the diffraction efficiency of the diffracted light flux.

Accordingly, in the objective lens of the numerical example 7 of the Patent Document 1 corresponding to the case where the diffraction efficiency of the diffracted light flux of the blue-violet laser beam and diffraction efficiency of the diffracted light flux of the infrared laser beam are both improved, there is approximate agreement between the diffraction angle of the diffracted light flux of the blue-violet laser beam and that of the diffracted light flux of the infrared laser beam. Accordingly, the spherical aberration caused by the difference in the thickness of the protective layer between the high-density optical disc and CD cannot be corrected by the diffractive structure.

Moreover, it is most preferable to attain the compatibility between three kinds of optical discs as mentioned above using the object optical element which constructed single lenses. However, even if the chromatic aberration can be corrected with the resin lens provided with the diffractive structure on the material surface with an ordinary dispersion, and the lens in which a diffractive structure is formed on a resin layer layered on a glass surface as patent documents 4, it was difficult to correct the aberration generated at the time of tracking operation. It is because there is a reduction in both the diffraction efficiency of the diffracted light flux of the blue-violet laser beam and that of the diffracted light flux of the infrared laser beam in the objective lens of the numerical example 3 of the Patent Document 2. corresponding to the case where there is a difference between the diffraction angle of the diffracted light flux of the blue-violet laser beam and that of the diffracted light flux of the infrared laser beam.

In the art of using the phase correcting device (called the optical path difference providing structure in the present specification) described in the Patent Document 3 in addition to the diffractive structure described in the Patent Documents 1 and 2, the effect of correcting the spherical aberration with respect to blue-violet laser beam and infrared beam by the optical path difference providing structure is in the tradeoff relationship with the transmittance of the optical path difference providing structure, similarly to the case of the diffractive structure.

Generally, the wave front aberration precision required of an optical device is severer for a shorter wavelength and a greater numerical aperture.

For example, in an objective lens for a high-density optical disc having a numerical aperture of 0.85 and a wavelength of 405 nm and an objective lens for a DVD having a numerical aperture of 0.6 and a wavelength of 655 nm, the impact of the same error in profile irregularity upon the spherical aberration is estimated as (655/405)×(0.85/0.6)⁴=6.5 times. Thus, when the high-density optical disc objective lens is manufactured, it is necessary to maintain a profile irregularity 6.5 times severer than that of the DVD objective lens.

As described above, it becomes more difficult to ensure a satisfactory performance of the optical device for a shorter wavelength and a greater numerical aperture. Accordingly, of the design performances for the light fluxes having a plurality of wavelengths, the performance for the light flux having the shortest wavelength should generally take the top priority when designing an objective lens for the optical pickup apparatus compatible with several types of optical discs. The design performance in the sense in which it is used here refers to the comatic aberration that occurs, for example, at the time of entry of the spherical aberration or off-axis light flux.

In an optical device formed with such a phase structure as a diffractive structure or an optical path difference providing structure, the transmittance of the phase structure will be changed generally if the refractive index has deviated from the design value. During the operation of the optical pickup apparatus, the temperature of the optical device formed with the phase structure is changed by the heat radiation from the actuator or change in the ambient temperature. If there is a big change in refractive index resulting from this temperature change, there will be a big change in the transmittance of the phase structure, with the result that stable recording/reproducing performances may not be obtained.

### SUMMARY OF THE INVENTION

In view of the aforementioned problems, it is an object of the present invention to provide an objective optical system, an optical pickup apparatus equipped with the objective optical system and an optical disc drive apparatus provided with the optical pickup apparatus, wherein the spherical aberration caused by the difference in the thickness of the protective layer among a high-density optical disc, DVD and CD, or spherical aberration caused by the difference in the wavelength used among a high-density optical disc, DVD and CD is satisfactorily corrected by the action of a phase structure including a diffractive structure; and a high light utilization efficiency is achieved in any of the blue-violet wavelength range in the vicinity of 400 nm, red wavelength range in the vicinity of 650 nm and infrared wavelength range in the vicinity of 780 nm. The aforementioned objective optical system is further characterized by excellent design performances for the high-density optical disc.

Another object of the present invention is to provide an objective optical system, an optical pickup apparatus equipped with the objective optical system and an optical disc drive apparatus provided with the optical pickup apparatus, wherein the aforementioned objective optical system is capable of emitting two light fluxes at mutually different angles to achieve compatibility between a high-density optical disc and a CD, using a phase structure, and ensuring a high degree of transmittance for a light flux of any wavelength.

A further object of the present invention is to provide an objective optical system, an optical pickup apparatus equipped with the objective optical system and an optical disc drive apparatus provided with the optical pickup apparatus, wherein the spherical aberration caused by the difference in the thickness of the protective layer among a high-density optical disc, DVD and CD, or spherical aberration caused by the difference in the wavelength used among a high-density optical disc, DVD and CD is satisfactorily corrected by the action of a phase structure including a diffractive structure; and a high light utilization efficiency is achieved in any of the blue-violet wavelength range in the vicinity of 400 nm, red wavelength range in the vicinity of 650 nm and infrared wavelength range in the vicinity of 780 nm. The aforementioned objective optical system is further characterized by a minimum change in the transmittance of the phase structure resulting from temperature change.

In order to solve the above-described objects, there is provided the structure described in item 1, that is, an objective optical system for use in an optical pickup apparatus which reproduces and/or records information on an information recording surface of a first optical information medium having a protective substrate with a thickness t1 using a first light flux with a first wavelength λ1 emitted from a first light source, and reproduces and/or records information on an information recording surface of a third optical information medium having a protective substrate with a thickness t3 (t3>t1) using a third light flux with a third wavelength λ3 (λ3>λ1) emitted from a third light source. The objective optical system includes: a first optical element; a first part comprising a material A; a second part comprising a material B; wherein the first part and the second part are laminated on the first optical element in a direction of an optical axis of the objective optical system, and the material A and the material B have different Abbe constants for d-line each other; and a first phase structure formed on a boundary between the first part and the second part.

By providing the objective optical system as described in item 1, the light flux of wavelength λ1 (e.g. blue-violet laser beam having a wavelength of λ1 of about 407 nm) and the light flux of wavelength λ3 (e.g. infrared laser beam having a wavelength λ3 of about 785 nm) whose wavelengths have a ratio with an almost integer value can be emitted at mutually different angles using the first phase structure, with a high degree of diffraction efficiency maintained for both wavelengths. Therefore, it allows a compatibility of a spherical aberration correction caused by the difference between the thicknesses t1 and t3 of the protective substrates, and a sufficient transmittance obtainability for light fluxes with respective wavelengths.

When a first phase structure having a structure is formed on the surface of an objective optical system (composed of material D in this case) such as the prior art system, the following Eq. (1) will hold, where the depth of each step of each pattern in the direction of optical axis is d1; the refractive index at the wavelength λ1 (=407 nm) of the material C of the objective optical system is n_{D407}; the refractive index at the wavelength λ3 (=785 nm) of the material C of the objective optical system is n_{D785}; the refractive index of an air layer is 1; and each step constituting each pattern is designed so that the light flux of wavelength λ1 can pass through, namely, that a phase difference is not vertically assigned to the light flux of wavelength λ1.
d1(n_{D407}−1)=407×N1 (where N1 denotes a natural number) (1)

If a light flux of wavelength λ3 has entered the first phase structure designed in the aforementioned manner, the following Eq. (2) will hold:
d1(n_{D785}−1)≈785×N1/2 (2)

As compared with the ratio of the wavelength of the incoming light flux (407:785≈1:2), the ratio of the difference in the refractive index (n_{D407}−1)/(n_{D785}−1) between the material D with respect to each wavelength and the air layer is sufficiently close to “1”. Accordingly, the left-hand member in Eq. (1) and that if Eq. (2) assume almost the same value, and the value multiplied by 785, a right-hand member of Eq. (2) is half the natural number N1. If the N1 is an even number, the optical path difference given by each step constituting each pattern will be integer times as large as the wavelength, when the light flux of wavelength λ3 has entered. As described above, when the first phase structure is formed on the surface of the objective optical system, the phase of the wave front having passed through the adjacent levels is adjusted in the case of the light flux of wavelength λ3, similarly to the case of the light flux of wavelength λ1. Thus, 100% transmittance is ensured for a light flux of any wavelength. However, since different optical action cannot be applied to the light fluxes of two wavelengths, the spherical aberration caused by the difference between the thicknesses t1 and t3 of the protective substrates cannot be corrected.

In the meantime, when the each of the steps included in each pattern is designed in such a way that N1 takes an odd number, the optical path provided by each of the steps included in each pattern is half integer times as large as the wavelength, when the wavelength λ3 has entered. This allows the action of diffraction to be given to the light flux of the wavelength λ3. Thus, the spherical aberration caused by the difference between the thicknesses t1 and t3 of the protective substrates can be corrected. Since the wave front of the light flux of the wavelength λ3 having passed through the adjacent level surface is greatly phase-shifted, a sufficient transmittance (diffraction efficiency) cannot be obtained with respect to the light flux of the wavelength λ3.

Such being the case, in the first structure, the first optical element constituting the objective optical system has a first part composed of material A and a second part composed of material B laminated in the direction of optical axis. The materials A and B have mutually different Abbe's numbers for d-line, and a first phase structure is formed on the boundary between the first and second parts.

The following Eq. (3) will hold, where the depth of each step constituting each pattern in the direction of optical axis is d1; the refractive index at the wavelength λ1 (=407 nm) of the material A is n_{A407}; the refractive index at the wavelength λ1 (=407 nm) of the material B is n_{B407}; the refractive index at the wavelength λ3 (=785 nm) of the material A is n_{A785}; the refractive index at the wavelength λ3 (=785 nm) of the material B is n_{B785}; and the first phase structure is designed so that the light flux of wavelength λ1 can pass through, namely, so that a phase difference is not vertically assigned to the light flux of wavelength λ1.
d1(n_{A407}−n_{B407})=407×N2 (where N2 denotes a natural number) (3)

Here if a combination between the refractive index of the materials A and B, and the dispersion is adequately selected, the following Eq. (4) holds, when the light flux of wavelength λ3 has entered the first diffractive structure designed in the aforementioned manner:
d1(n_{A785}−n_{B785})≈785×N3 (where N3 denotes a natural number) (4)

When the objective optical system has been structured as described above, the ratio of the difference (n_{A407}−n_{B407})/(n_{A785}−n_{B785}) in the refractive index between the materials A and B, with respect to each wavelength is sufficiently removed from “1” due to different dispersion, as compared with the ratio of the wavelength of the incoming light flux (407:785≈1:2). Accordingly, the left-hand member of the Eq. (3) is different from that of the Eq. (4). This allows action of diffraction to be given to the light flux of wavelength λ3. Thus, the spherical aberration caused by the difference between the thicknesses t1 and t3 of the protective substrates can be corrected. In this case, a high degree of transmittance (diffraction efficiency) of the light flux of wavelength λ3 can be ensured by adequate selection of the number of the levels constituting each pattern according to the ratio of the difference in the refractive index between the materials A and B. The principle of the diffracted light flux generation of the phase structure and a specific example thereof will be described in with reference to [DETAILED DESCRIPTION OF THE INVENTION] to be described later.

In the present specification, the optical disc (it is also described as the optical information recording medium) using the blue-violet laser as the light source for recording and/or reproducing of the information is generally referred as “high density optical disc”, and the high density optical disc includes the optical disc on which information is recorded and/or reproduced by the objective lens with NA 0.85 and whose thickness of the protective layer is 0.1 mm (hereinafter, BD), and the optical disc on which information is recorded and/or reproduced by the objective lens with NA of 0.65 to 0.67 and whose thickness of the protective layer is 0.6 mm (hereinafter, HD DVD). Further, additionally to the optical discs having such protective layers on their recording surfaces, the optical disc having the protective layer of the thickness of about several—several tens nm on the information recording surface, or the optical disc whose thickness of the protective layer is 0, is also included therein. Further, in the present specification, the high density optical disc using the blue-violet laser light source as the light source for recording and/or reproducing of the information.

In this specification, the “objective lens” is defined as a converging lens, arranged so as to face the optical disc in an optical pickup apparatus, for causing the light flux emitted from a light source to be condensed on the information recording surface of an optical disc.

The objective optical system is defined as an optical system including an objective lens (converging element), arranged so as to face optical disc in an optical pickup apparatus, for causing the light flux emitted from a light source to be converged on the information recording surface of an optical disc.

Further, if there is an optical device, integrated with the aforementioned objective lens, for allowing an actuator to perform tracking and focusing, the optical system comprising the optical device and condensing device will be called an objective optical system. In this case, the optical device can be provided with one lens group or two or more lens groups.

In the present specification, the phase structure is a generic term referring to a structure, having steps in the direction of optical axis, for providing an optical path difference (phase difference) to the incoming light flux. The optical path difference provided by these steps can be integer times as large as the wavelength of the incoming light flux or a non-integer times as large as the wavelength of the incoming light flux. Specific examples of such a phase structure include a diffractive structure with the aforementioned step arranged at periodic intervals in the direction of optical axis, and an optical path difference providing structure (also called a phase difference providing structure) with the aforementioned step arranged at aperiodic intervals in the direction of optical axis.

Referring to drawings, the following describes the various phase structures in the present specification.

FIGS. 21(a) through 23(b) are the schematic diagrams representing the phase structure wherein a pattern having a stepped cross section including the optical axis is concentrically arranged, and the step is shifted for each of levels in the predefined number (4 steps in FIGS. 21(a) through 23(b)) by the height corresponding to the number of steps corresponding to the number of levels (4 steps in FIGS. 21(a) through 23(b)) (also called the “multi-level type” in the present specification).

Each of FIGS. 21(a) and 21(b) shows the case where patterns having a stepped cross section face in the same direction. There is also a case where the phase reversing section PR is included, as shown in FIGS. 22(a) and 22(b). Alternatively, there is also a case where a phase reversing section PR, a serration oriented opposite to the that closer to the optical axis than the phase reversing section PR, or a pattern oriented opposite to the pattern closer to the optical axis than the phase reversing section PR, as shown in FIG. 22(a), 22(b), 29(a) or 29(b). FIGS. 21(a) through 23(b) show the case where the phase structure is formed on a flat plane. However, the phase structure can be formed on a spherical plane or aspherical plane. In FIGS. 21(a) through 23(b), “5” can be specified as the number of the levels, without the prevent invention being restricted thereto.

The first phase structure in the present specification corresponding to the case where the structure of FIGS. 21(a) through 23(b) is formed on the boundary between the materials A and B having mutually different Abbe's numbers for d-line.

Further, in the phase structure shown in FIGS. 21(a) through 23(b), the pattern wherein “the step is shifted for each of the levels in the specified number by the height corresponding to the number of steps conforming to the number of levels” refers to the pattern other than the phase reversing section PR, without the phase reversing section PR being included in this pattern.

FIGS. 24(a) through 26(b) show the schematic drawing of the structure wherein the cross section including the optical axis is serrated. In FIGS. 24(a) and 24(b), the serrations are oriented in the same direction. However, there are cases where the phase reversing section PR is included as shown in FIGS. 25(a) and 25(b), or the serration PO oriented opposite to the serration PI closer to the optical axis than the phase reversing section PR is included as shown in FIGS. 26(a) and 26(b). In FIGS. 24(a) through 26(b), the structure with the cross section including the optical axis is serrated is formed on a flat plane. This structure can be formed on a spherical or aspherical plane.

FIG. 27(a) is a schematic drawing showing a stepped structure wherein the cross section including the optical axis is so configured that the optical path gets longer as one goes away from the optical axis. FIG. 27(b) is a schematic drawing showing a stepped structure wherein the cross section including the optical axis is so configured that the optical path gets shorter as one goes away from the optical axis. FIG. 27 shows the case where this stepped structure is formed on a flat plane. This structure can also be formed on a spherical or aspherical surface. The structure shown in FIG. 27(a) corresponds to the case where the structure in FIG. 24(a) is formed on a concave structure, and the absolute value of the action of light divergence by the concave structure and that of the action of light convergence by the phase structure are equal to each other. In the meantime, the structure in FIG. 27(b) corresponds to the case where the structure of FIG. 24(b) is formed on the convex structure, and the absolute value of the action of light convergence by the convex structure and that of the action of light divergence by the phase structure are equal to each other.

FIG. 28(a) is a schematic view showing a stepped structure wherein the cross section including the optical axis is so configured that the optical path gets longer as one goes away from the optical axis, up to a specified height from the optical axis, and that the optical path gets shorter as one goes away from the optical axis, in excess of the specified height from the optical axis. FIG. 28(b) is a schematic drawing showing a stepped structure wherein the cross section including the optical axis is so configured that the optical path gets shorter as one goes away from the optical axis, up to a specified height from the optical axis, and that the optical path gets longer as one goes away from the optical axis, in excess of the specified height from the optical axis. In both cases, the direction of the step is reversed on the phase reversing section PR along the effective diameter. In each of FIGS. 28(a) and 28(b), the stepped structure is formed on a flat plane. However, it can also be formed on a spherical or aspherical plane.

In the present specification, DVD (Digital Versatile Disc) is a generic name of optical discs in a DVD series including DVD-ROM, DVD-Video, DVD-Audio, DVD-RAM, DVD−R, DVD−RW, DVD+R and DVD+RW, while, CD (Compact Disc) is a generic name of optical discs in a CD series including CD-ROM, CD-Audio, CD-Video, CD-R and CD-RW.

### BRIEF DESCRIPTION OF THE DRAWINGS

FIG. 1 is a plan view of the major portion of an optical pickup apparatus;

FIG. 2 is a side view showing an example of the structure of an objective lens unit;

FIG. 3 is a side view showing an example of the structure of an objective lens unit;

FIG. 4 is a side view showing an example of the structure of an objective lens unit;

FIG. 5 is a side view showing an example of the structure of an objective lens unit;

FIG. 6 is a side view showing an example of the structure of an objective lens unit;

FIGS. 7(a) and 7(b) are side views showing the structure of an aberration correcting element;

FIG. 8 is a side view showing an example of the structure of an objective lens unit;

FIG. 9 is a side view showing an example of the structure of an objective lens unit;

FIG. 10 is a chart representing the relationship between the depth of the step of diffractive structure and diffraction efficiency;

FIG. 11 is a diagram representing an optical path for the objective lens unit;

FIG. 12 is a side view representing the structure of the objective lens unit;

FIG. 13 is a side view representing the structure of the objective lens unit;

FIG. 14 is a plan view of the major portion of an optical pickup apparatus;

FIG. 15 is a side view representing the structure of the objective optical system;

FIGS. 16(a) and 16(b) are plan views representing the structure of a first optical element;

FIG. 17 is a plan view of the structure of the first optical element;

FIG. 18 is a plan view of the major portion of the diffractive structure;

FIG. 19 is a chart representing a method of selecting between the materials A and B;

FIG. 20 is a chart representing the diffraction efficiency for each combination of the materials A and B, and depth of each pattern;

FIGS. 21(a) and 21(b) are cross sectional views showing an example of the structure of a phase structure;

FIGS. 22(a) and 22(b) are cross sectional views showing an example of the structure of a phase structure;

FIGS. 23(a) and 23(b) are cross sectional views showing an example of the structure of the phase structure;

FIGS. 24(a) and 24(b) are cross sectional views showing an example of the structure of the phase structure;

FIGS. 25(a) and 25(b) are cross sectional views showing an example of the structure of the phase structure;

FIGS. 26(a) and 26(b) are cross sectional views showing an example of the structure of the phase structure;

FIGS. 27(a) and 27(b) are cross sectional views showing an example of the structure of the phase structure;

FIGS. 28(a) and 28(b) are cross sectional views showing an example of the structure of the phase structure;

FIGS. 29(a) and 29(b) are cross sectional views showing an example of the structure of the phase structure;

FIG. 30 is a side view representing the structure of the objective lens unit;

FIG. 31 is a side view representing the structure of the objective optical system;

FIG. 32 is a side view representing the structure of the objective optical system;

FIGS. 33(a) through 33(c) are side views showing an example of the phase structure;

FIG. 34 is a plan view of the major portion showing the structure of an optical pickup apparatus;

FIG. 35 is a side view representing the structure of the objective optical system;

FIG. 36 is a side view representing the structure of the objective optical system;

FIG. 37 is a side view representing the structure of the objective optical system as an embodiment of the present invention;

FIG. 38 is a side view representing the structure of the objective optical system as an embodiment of the present invention;

FIG. 39 is a side view representing the structure of the objective optical system as an embodiment of the present invention;

FIG. 40 is a side view representing the structure of the objective optical system as an embodiment of the present invention; and

FIG. 41 is a side view representing the structure of the objective optical system as an embodiment of the present invention.

### DETAILED DESCRIPTION OF THE INVENTION

The preferred embodiments of the present invention are explained as follows.

The structure described in item 2 is the objective optical system of item 1, wherein the first phase structure forms a base curve which is a microscopic curve of the first phase structure, the base curve forms an aspherical surface or a spherical surface, the objective optical system satisfies following expressions (11) and (12):
20<|Δνd|<40 (11)
|Δn1|>0.02 (12)
where Δνd is a difference between an Abbe constant of the material A for d-line and an Abbe constant of the material B for d-line, and
Δn1 is a difference between a refractive index of the first part for the first wavelength λ1 and a refractive index of the second part for the first wavelength λ1.

The structure described in item 3 is the objective optical system of item 2, wherein the optical pickup apparatus further reproduces and/or records information on an information recording surface of a second optical information medium having a protective substrate with a thickness t2 (t1≦t2<t3) using a second light flux with a second wavelength λ2 (λ1<λ2<λ3) emitted from a second light source.

The structure described in item 4 is the objective optical system of item 2, wherein the objective optical system further comprising an objective lens arranged on an optical-information-recording-medium side of the first optical element.

The structure described in item 5 is the objective optical system of item 2, wherein the first optical element is an objective lens.

The structure described in item 6 is the objective optical system of item 2, wherein the first phase structure is a diffractive structure.

As described in Item 1, the first and second materials having a difference in Abbe's number for meeting the Eq. (11) are provided, and a phase structure is arranged on the boundary thereof. This structure ensures the heretofore unattainable compatibility between the spherical aberration correcting effect and transmittance for the blue-violet laser beam (first light flux) and infrared laser beam (third light flux). A difference in the refractive index for meeting the Eq. (12) is provided between the first and second members in the first wavelength λ1. This structure reduces the step along the optical axis of each strap, and facilitates the production of a phase structure. Compatibility between the correction of spherical aberration and that of sine conditions is difficult to achieve on the phase structure with the base curve formed on a flat plane. However, an aspherical or spherical structure of the base curve ensures compatibility between the correction of spherical aberration and that of sine conditions, with respect to the first light flux of the first optical element, with the result that the design performance of the first light flux is also improved.

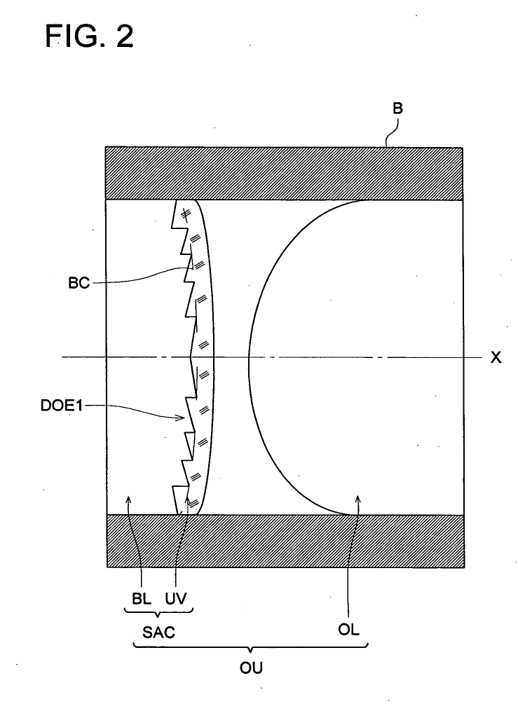

What is called “base curve” in the aforementioned description is defined as an envelope formed by connecting the apexes of serrations of a phase structure, as described by the dotted line in FIG. 2. (to be described later). This envelope represents a macroscopic curve of the phase structure.

The structure described in item 7 is the objective optical system of item 2, wherein the base curve forms an aspherical surface whose deformation amount becomes larger at a position being farther from an optical axis, where the deformation amount of the base curve is a distance along an optical axis from a spherical surface represented by a paraxial curvature radius to the base curve.

As shown in item 7, correction of the spherical aberration for the first light flux of the first optical element and that of sine conditions can be improved, if the base curve is an aspherical surface wherein the deformation of an aspherical plane as the distance along the optical axis from the spherical surface expressed by the paraxial curvature radius is increased as one goes away from the optical axis.

What is called “deformation amount of an aspherical surface” in the aforementioned statement is defined as the value expressed by the following Eq. (18) when the aspherical shape of the base curve is expressed by the “aspherical surface expression formula” to be described later.
Δz=|z|−|[(y²/R)/[1+√{1−(y/R)²}]]| (18)
where “z” denotes an aspherical shape (mm) representing the distance of a flat plane in contact with surface vertex and an aspherical surface in the direction of optical axis, and the value in a brace ({}) indicates a spherical shape representing the distance of the flat plane in contact with the surface vertex and the spherical surface expressed by the paraxial curvature radius, in the direction of optical axis.

Thus, the deformation of the aspherical surface expressed by the aforementioned Eq. (18) “is increased as one goes away from the optical axis” or becomes larger at a position being farther from an optical axis means that Δz is asymptotically increased with the increase of y (distance from the optical axis).

The structure described in item 8 is the objective optical system of item 2, wherein an optical surface of the second part opposite to the boundary is an aspherical surface having an almost same shape to the base curve.

As shown in the description of item 8, the design performance for the first light flux can be further improved if the optical surface of the aforementioned second member, opposite to the boundary is formed into an aspherical surface almost identical with the base curve.

“An aspherical surface almost same shape to the base curve” in the aforementioned statement is defined as meeting the following Eq. (19) in a given “y” (distance form the optical axis) within effective radius, when the aspherical shape z1 (mm) of the base curve on the side of the boundary surface layer and the aspherical shape z2 (mm) of the optical surface of the aforementioned second member on the side opposite to the boundary surface are expressed by “aspherical surface expression formula”:
0≦|z1−z2|≦0.05 (19)

The structure described in item 9 is the objective optical system of item 6, wherein the objective optical system satisfies following expressions:
P_{D}×P_{RT}<0 (13)
0.9<|P_{D}×P_{RT}<1.1 (14)
where P_{D} is a paraxial diffractive power of the first phase structure for the first wavelength λ1, and
P_{RT} is a paraxial refractive power of a total system of the first optical element for the first wavelength λ1.

As in the structure of item 9, if the Eqs. (13) and (14) are met, it is possible to cancel the action of convergence (divergence) resulting from the diffraction of the diffractive structure and action of divergence (convergence) resulting from refraction of the optical surface of the second member on the side opposite to the boundary. The first light flux entering the first optical element as a parallel light flux can be emitted from the first optical element as a parallel light flux. In this case, the second part is laminated in a sufficiently thin form, with respect to the thickness of the first part on the axis, thereby reducing difference between the diameter of the first light flux entering the first optical element and the diameter of the first light flux coming from the first optical element.

The “paraxial diffractive power of the first phase structure for the first wavelength λ1” in this case is defined by the following Eq. (20) when the optical path difference added to the first light flux by the diffractive structure is expressed by the optical path difference function to be described later, where λ_{B} denotes the manufactured wavelength of the diffractive structure, and B2 indicates the second order diffractive surface coefficient.
P_{D}=−2×λ/λ_{B}×M×B₂ (20)

The structure described in item 10 is the objective optical system of item 3, wherein the objective optical system satisfies following expressions:
0.2<|Δn2|/|Δn1|<2.2 (15)
0.4<|Δn3|/|Δn1|<2.4 (16)
0.0<|Δn3|/|Δn2|<2.0, (17)
where Δn2 is a difference between a refractive index of the first part for the second wavelength λ2 and a refractive index of the second part for the second wavelength λ2, and
Δn3 is a difference between a refractive index of the first part for the third wavelength λ3 and a refractive index of the second part for the third wavelength λ3.

The Eqs. (15) through (17) described in item 10 provide conditions for causing the diffracted light flux of the same order of diffraction to be produced for each wavelength, and for ensuring the diffraction efficiency of each wavelength. In this case, if the paraxial diffraction power of the phase structure is made negative, the light characterized by a higher degree of divergence in conformity to longer wavelength enters the objective lens. This arrangement ensures a greater operation distance with respect to the second disc or third disc having a thicker protective layer.

In the first optical element of the objective optical system of the present invention, the diffracted light flux having various orders of diffraction can be emitted for the light flux of each wavelength in the diffractive structure on the boundary surface, by adequate setting of the difference in the refractive index of each of the wavelengths between the first and second members. However, in order to minimize the reduction of the diffraction efficiency resulting from a subtle change in the wavelength, the difference in refractive index in each wavelength between the first and second members is preferably set so as to ensure that the first order diffracted light flux is emitted for the light flux of any wavelength.

Generally, when the light flux of wavelength λ has entered the diffractive structure, the diffracted light flux having various orders of diffraction is emitted. However, adequate setting of the step of the diffractive structure makes it possible to drastically improve the diffraction efficiency of the diffracted light flux having various orders of diffraction. In the present specification, “diffracted light flux of M-th order is emitted in the diffractive structure” means that a step is set in such a way that, of the diffracted beams of light having various orders of diffraction generated in the diffractive structure, the M-th order diffracted beams of light has the maximum diffraction efficiency.

As shown in the structure of the item 10, correct the spherical aberration resulting from the difference between t1 and t3 can be corrected by satisfying the Eqs. (15) through (17). This arrangement achieves compatibility among Blu-ray disc, such a high-density optical disc as HD to DVD, and CD.

The structure described in item 11 is the objective optical system of item 2, wherein the first phase structure corrects a spherical aberration caused by a difference between the thickness t1 and the thickness t3.

To connect the spherical aberration resulting from the difference between t1 and t3 while maintaining a high diffraction efficiency of the first and third light fluxes, it is preferred to use the structure that causes the third light flux to enter the objective optical system as a weak divergent beam. In the objective optical system described in item 11, the step is designed to ensure that the diffracted light flux of the same order is emitted for the light flux of each wavelength. Accordingly, the degree of the divergence of the third light flux entering the objective optical system does not become excessively strong. This arrangement ensures a sufficient small amount of the comatic aberration generated when the objective optical system is engaged in tracking drive. Thus, a satisfactory tracking characteristic is provided.

The structure described in item 12 is the objective optical system of item 3, wherein the first phase structure corrects a spherical aberration caused by a difference between the thickness t1 and the thickness t2 or a spherical aberration caused by a difference between the first wavelength λ1 and the second wavelength λ2.

Furthermore, as a structure described in item 12, in the objective optical system, the first phase structure corrects a spherical aberration caused by a difference between the thickness t1 and thickness t2 or a spherical aberration caused by a difference between the first wavelength λ1 and the second wavelength λ2 and it allows to achieve the compatibility of the objective optical system between the high density optical disc and DVD.

The structure described in item 13 is the objective optical system of item 2, further including a second phase structure arranged on an optical surface of the first part opposite to the boundary.

As shown in the structure of item 13, a phase structure is formed on the optical structure opposite to the boundary surface, out of the optical surfaces of the first part. This arrangement provides excellent condensing characteristics for each of the light fluxes of the objective optical system. This phase structure can be a diffractive structure or an optical path difference providing structure. The aberration corrected by the phase structure can be a chromatic aberration resulting from a minute change in the first wavelength λ1 or a spherical aberration resulting from a change in the refractive index of the objective lens caused by a change in temperature.

The structure described in item 14 is the objective optical system of item 13, wherein the second phase structure does not diffract the first light flux and the third light flux, and diffracts the second light flux selectively, the second phase structure corrects a spherical aberration caused by a difference between the thickness t1 and the thickness t2 or a spherical aberration caused by a difference between the first wavelength λ1 and the second wavelength λ2 and the first phase structure corrects a spherical aberration caused by a difference between the thickness t1 and the thickness t3.

In one phase structure, only the spherical aberration for two light fluxes having mutually different waveforms can be corrected. In an objective optical system commonly used for three light fluxes having mutually different waveforms as in the objective optical system of the present invention, spherical aberration for three light fluxes cannot be corrected by only the action of the phase structure. Thus, if the objective optical system has only one phase structure, the magnification of the remaining one light flux is determined uniquely in order to correct the spherical aberration that cannot be corrected by the action of the phase structure, with the result that freedom in the design of the optical pickup apparatus will be lost.

Against this backdrop, as described in the structure of item 14, the second phase structure is provided with the characteristics for allowing selective diffraction of the second light flux, without allowing the first light flux and third light flux to be diffracted, whereby the spherical aberration resulting from the difference between t1 and t2 or the spherical aberration resulting from the difference between the first and second wavelengths λ1 and λ2 are corrected. Further, by correcting the spherical aberration resulting from the difference between t1 and t3 by the phase structure formed on the boundary, it becomes possible to correct the spherical aberration of the light fluxes having various wavelengths at the same magnification while maintaining high diffraction efficiency for the light fluxes of various wavelengths.

The structure described in item 15 is the objective optical system of item 2, further including a second phase structure arranged on a boundary between an air and one of the first part and the second part whose material has larger Abbe constant for d-line.

According to the structure described in item 15, the second phase structure is arranged on a boundary between an air and one of the first part and the second part whose material has larger Abbe constant for d-line and it makes diffraction efficiencies of the first to third light fluxes raise for the wavelength λ1, λ2 and λ3 respectively.

The structure described in item 16 is the objective optical system of item 2, further including: an objective lens arranged on an optical-information-recording-medium side of the first optical element; and a second phase structure arranged on a surface of the objective lens, wherein an Abbe constant νd for d-line of the objective lens satisfies
40≦νd≦70. (29)

According to the structure described in item 16, the objective optical system further has an objective lens arranged on an optical-information-recording-medium side of the first optical element; and a second phase structure arranged on a surface of the objective lens, wherein an Abbe constant νd for d-line of the objective lens satisfies Eq. (29). It makes diffraction efficiencies of the first to third light fluxes raise for the wavelength λ1, λ2 and λ3 respectively.

The structure described in item 17 is the objective optical system of item 15, wherein the second phase structure is a diffractive structure whose cross sectional shape including an optical axis is a stepped shape and the second phase structure diffracts a light flux corresponding to a wavelength selectively or transmits a light flux corresponding to a wavelength selectively.

The structure described in item 18 is the objective optical system of item 16, wherein the second phase structure is a diffractive structure whose cross sectional shape including an optical axis is a stepped shape and the second phase structure diffracts a light flux corresponding to a wavelength selectively or transmits a light flux corresponding to a wavelength selectively.

According to the structures described in items 17 and 18, the cross section of the second phase structure comprises a plurality of stepped diffractive structures (wavelength selective diffractive structure), and permits selective diffraction or transmission of light in conformity to the wavelength. This arrangement ensures, for example, that a phase difference is not assigned to the first light flux of the first wavelength λ1, and the first light flux is subjected to direct transmission without being diffracted, whereas a phase difference is given to the second light flux of second wavelength λ2 and the third light flux of third wavelength λ3, and the second and third are diffracted. If a phase difference can be given only to the light flux of a predetermined wavelength, only the light of the DVD can be diffracted. This arrangement corrects the spherical aberration of the DVD that will remain in the structure of item 2.

The structure described in item 19 is the objective optical system of item 15, wherein the second phase structure is a blazed diffractive structure.

The structure described in item 20 is the objective optical system of item 16, wherein the second phase structure is a blazed diffractive structure.

In the blazed diffractive structure, the cross section including the optical axis is formed in a serrated structure. Chromatic aberration can be effectively corrected if the second phase structure is designed as a blazed diffractive structure, as described in items 19 and 20. In chromatic aberration, the condensing position of the objective lens remains unchanged despite changes in the wavelength. Mode hopping occurs to the laser used in the optical pickup apparatus. The actuator of the objective lens cannot catch up with its abrupt change in the wavelength, and is left in a defocused state. To solve this problem, the short-wave Blu-ray, HD and DVD require a method for chromatic correction wherein the condensing position of the objective lens does not change despite a change in the wavelength. Chromatic correction can be achieved by the waveform selective diffractive structure but this method is not suited in that a greater number of straps are required than that in the blazed diffractive structure, and chromatic correction cannot be provided at the same time since this method allows passage of DVD and CD light.

The structure described in item 21 is the objective optical system of item 3 satisfies
0.9×t1≦t2≦1.1×t1. (30)

The structure described in item 21 specifies the preferable range of the thickness t2 of the protective layer of the second optical disc (the second information recording medium).

When the thickness t1 is kept in this range, since the spherical aberration produced by difference of wavelength only corrected as the combination of HD DVD and DVD, a diffractive pitch can be enlarged and processability can be raised.

The structure described in item 22 is the objective optical system of item 2, wherein the material B is an ultraviolet curing resin.

The structure described in item 23 is the objective optical system of item 2, wherein the first part is formed by molding.

An optical resin can be laminated on the first part according to the method wherein the optical glass with a phase structure formed on the surface thereof is used as a mold, and an optical resin is formed on the first part (so-called an insert molding method). However, a method more preferable for production is the one wherein an ultraviolet curing resin is laminated on the first part with the phase structure formed on the surface thereof, and ultraviolet ray is applied thereto, as described in item 22.

The first part with a phase structure formed on the surface thereof can be produced according to the method of repeating the photolithographic process and etching processes, thereby forming a phase structure directly on the first part. However, a so-called molding method is more preferred for high-volume production wherein a mold with a phase structure formed thereon is produced, thereby getting a mold with a phase structure formed on the surface thereof, as a replica of this mold, as described in item 23. A mold with a phase structure formed thereon can be produced according to the method of repeating the photolithographic process and etching processes, thereby forming a phase structure or the method of processing a phase structure by a precision lathe.

The structure described in item 24 is the objective optical system of item 2, wherein the material A is a resin.

Although all types of optical glass and optical plastic are applicable to the material of the first part, in order to form microscopic structure as a diffractive structure or phase structure with few errors of shape, the material with small viscosity in a molten state i.e., optical plastics, is suitable. The lens made of resin provides low cost and lightweight compared with the glass lens. Particularly, when the first optical element makes light by making the element of resin, small drive force which performs focusing and tricking control at the case of recording/reproducing of the information is required.

The structure described in item 25 is the objective optical system of item 2, wherein the objective lens is optimized about a spherical aberration correction for a combination of the thickness t1 and the wavelength λ1.

The aspherical shape of the objective lens is preferably determined so as to minimize correction of the spherical aberration for the wavelength λ1 and thickness t1 of the protective layer of the first optical information medium. If the aspherical shape of the objective lens is determined in such a way as to minimize correction of the spherical aberration for the wavelength λ1 and thickness t1 of the first protective layer, it becomes easier to get the condensing performance of the first light flux required to provide a severest wave front accuracy. In this case, “the objective lens is optimized about a spherical aberration correction for a combination of the thickness t1 and the wavelength λ1” means that the aberration of the front wave is 0.05 λ1 RMS or less when the first light flux is condensed through the objective lens and the protective layer of the first optical information medium.

The structure described in item 26 is the objective optical system of item 2, satisfies the following expressions:
α×λ1=λ3
K1−0.1≦α≦K1+0.1
where K1 is a natural number.

The structure described in item 27 is an optical pickup apparatus for reproducing and/or recording information, including: a first light source for emitting a first light flux with a first wavelength λ1; a third light source for emitting a third light flux with a third wavelength λ3 (λ1<λ3); and the objective optical system of item 2, wherein the optical pickup apparatus reproduces and/or records information on an information recording surface of a first optical information medium having a protective substrate with a thickness t1 using the first light flux, and reproduces and/or records information on an information recording surface of a third optical information medium having a protective substrate with a thickness t3 (t3>t1) using the third light flux.

According to the structure described in item 27, an optical pickup apparatus having the same effect to any one of items 2 to 26 can be obtained.

The structure described in item 28 is an optical disc drive apparatus, comprising: the optical pickup apparatus of item 27; and a moving unit for moving the optical pickup apparatus in a radius direction of each of the first to third optical information recording media.

According to the structure described in item 28, an optical disc drive apparatus having the same effect to any one of items 2 to 27 can be obtained.

The structure described in item 29 is the objective optical system of item 1, wherein the first optical element is arranged on an optical path where the first light flux and the third light flux commonly pass through, and the first phase structure diffracts the first light flux and does not diffract the third light flux.

The structure described in item 30 is the objective optical system of item 29, wherein the optical pickup apparatus further reproduces and/or records information on an information recording surface of a second optical information medium having a protective substrate with a thickness t2 (t1≦t2<t3) using a second light flux with a second wavelength λ2 (λ1<λ2<λ3) emitted from a second light source.

The structure described in item 31 is the objective optical system of item 29, wherein the first phase structure diffracts the second light flux.

The structure described in item 32 is the objective optical system of item 29, wherein the objective optical system further comprising an objective lens arranged on an optical-information-recording-medium side of the first optical element.

The structure described in item 33 is the objective optical system of item 29, wherein the first optical element is an objective lens.

When the first optical element makes the structure as described in item 29, the structure ensures good compatibility between the spherical aberration correction effect and sufficient transmittance obtainability for the blue-violet laser light flux (first light flux) and infrared laser light flux (second light flux), wherein it is difficult for the prior art to achieve this compatibility.

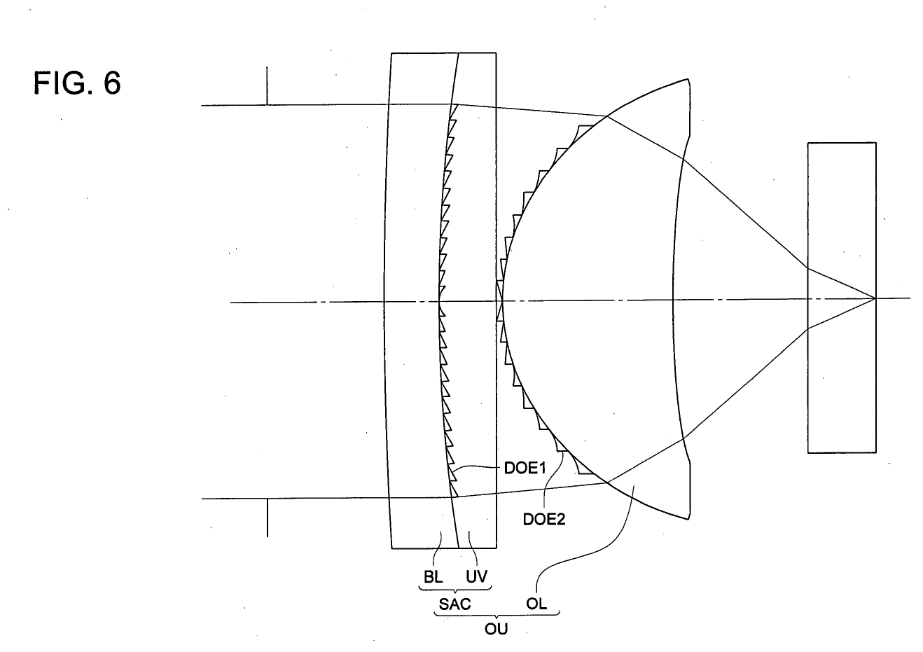

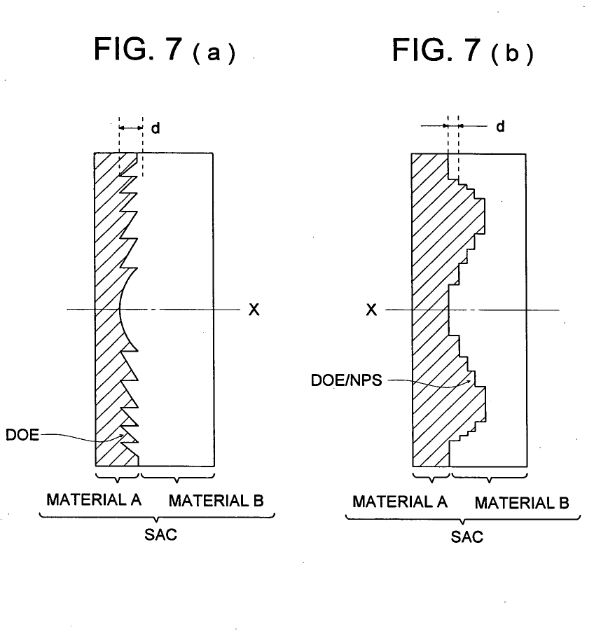

The phase structure includes a serrated cross section type (diffractive structure DOE) shown in FIG. 7(a), a stepped cross section type (diffractive structure DOE and optical path difference providing structure NPS) shown in FIG. 7(b). Although FIG. 7(b) shows an example of the stepped cross section type in which a change direction of steps is reversed within the phase structure, a structure in which the change direction of steps is fixed may also be used.

The structure described in item 34 is the objective optical system of item 29, wherein the objective optical system satisfies following expressions:
|Δn1|<0.01 (21)
20<|Δνd|<40 (22)
where Δνd is a difference between an Abbe constant of the material A for d-line and an Abbe constant of the material B for d-line, and

Δn1 is a difference between a refractive index of the first part for the first wavelength λ1 and a refractive index of the second part for the first wavelength λ1.

As described in the structure of item 34, if a material is selected in such a way as to ensure that the difference Δn1 of the refractive index in the first wavelength λ1 is almost zero, then the first light flux directly passes through without being affected by the phase structure on the boundary surface. Further, if materials A and B are selected in such a way as to ensure that the difference Δνd of the Abbe's number along d-line is kept within the range of Eq. (22), a predetermined optical path difference can be assigned to the second and third light fluxes by the phase structure. This arrangement allows the spherical aberration correcting function to be provided, with the result that the same effect of operation as that of item 29 is ensured.

If Δνd is greater than the lower limit of the Eq. (22), a sufficient refractive index can be obtained in the second wavelength λ2 and third wavelength λ3. This prevents the step d of the phase structure from becoming excessively large, and ensures an easier manufacturing method. In the meantime, if Δνd is greater than the upper limit of the Eq. (22), a drastic reduction will occur in the number of combinations of the materials for meeting the Eq. (21). Accordingly, if the Δνd is smaller than the upper limit of the Eq. (22), there will be an increase in the number of combinations of the materials. This arrangement thus permits selection of the optimum materials.

The structure described in item 1 or 34 provides the structure which does not diffract the first light flux, and diffracts the second light flux and the third light flux selectively. Therefore, it allows a compatibility of a spherical aberration correction caused by the difference between the thicknesses t1 and t3 of the protective substrates, and a sufficient diffraction efficiency (transmittance) obtainability for the blue-violet laser light flux (first light flux) and infrared laser light flux (second light flux), which is a object of the patent documents 1 and 2.

The structure described in item 35 is the objective optical system of item 30, satisfying following expressions:
0<|INT(d×Δn2/λ2)−(d×Δn2/λ2)|<0.3 (23)
0<|INT(d×Δn3/λ3)−(d×Δn3/λ3)|<0.3 (24)
where d is a step depth of the first phase structure,
Δn2 is a difference between a refractive index of the first part for the second wavelength λ2 and a refractive index of the second part for the second wavelength λ2, and
Δn3 is a difference between a refractive index of the first part for the third wavelength λ3 and a refractive index of the second part for the third wavelength λ3.

As described in item 35, two materials are preferably selected so as to meet the Eqs. (23) and (24) because this makes it possible to provide a spherical aberration correcting function with respect to the second and third light fluxes, and to ensure a high diffraction efficiency of the second and third light fluxes. If it is greater than the lower limit of the Eq. (23), a sufficient spherical aberration correcting function for the second light flux is provided. If it is smaller than the upper limit of the Eq. (23), a sufficient diffraction efficiency of the second light flux is ensured. If it is greater than the lower limit of the Eq. (24), a sufficient spherical aberration correcting function for the third light flux is provided. If it is smaller than the upper limit of the Eq. (24), a sufficient diffraction efficiency of the third light flux is ensured.

The structure described in item 36 is the objective optical system of item 35, satisfies
M2=M3, (25)
where M2=INT(d×Δn2/λ2) and (26)
M3=INT(d×Δn3/λ3). (27)

The structure described in item 37 is the objective optical system of item 36, satisfies
M2=M3=1. (28)

When two types of material are selected such that the second light flux and the third light flux have the same diffraction orders as described in item 27, the objective optical system excellent in design property is provided. Particularly, as an item 37, when both the diffraction order of the second light flux and the third light flux is 1, design properties become the best.

The structure described in item 38 is the objective optical system of item 29, further including a second phase structure arranged on a boundary between an air and one of the first part and the second part whose material has larger Abbe constant for d-line.

According to the structure described in item 38, the second phase structure is arranged on a boundary between an air and one of the first part and the second part whose material has larger Abbe constant for d-line and it makes diffraction efficiencies of the first to third light-fluxes raise for the wavelength λ1, λ2 and λ3 respectively.

The structure described in item 39 is the objective optical system of item 32, further including: an objective lens arranged on an optical-information-recording-medium side of the first optical element; and a second phase structure arranged on a surface of the objective lens, wherein an Abbe constant νd for d-line of the objective lens satisfies
40≦νd≦70. (29)

According to the structure described in item 39, the objective lens is arranged on an optical-information-recording-medium side of the first optical element and the second phase structure is arranged on a surface of the objective lens, wherein an Abbe constant νd for d-line of the objective lens satisfies Eq. (29) and it makes diffraction efficiencies of the first to third light fluxes raise for the wavelength λ1, λ2 and λ3 respectively.

The structure described in item 40 is the objective optical system of item 38, wherein the second phase structure is a diffractive structure whose cross sectional shape including an optical axis is a stepped shape and the second phase structure diffracts a light flux corresponding to a wavelength selectively or transmits a light flux corresponding to a wavelength selectively.

The structure described in item 41 is the objective optical system of item 39, wherein the second phase structure is a diffractive structure whose cross sectional shape including an optical axis is a stepped shape and the second phase structure diffracts a light flux corresponding to a wavelength selectively or transmits a light flux corresponding to a wavelength selectively.

According to the structures described in items 40 and 41, the cross section of the second phase structure comprises stepped diffractive structures (wavelength selective diffractive structure), and permits selective diffraction or transmission of light in conformity to the wavelength. This arrangement ensures, for example, that a phase difference is not provided to the first light flux of the first wavelength λ1, and the first light flux is subjected to direct transmission without being diffracted, whereas a phase difference is given to the second light flux of second wavelength λ2 and the third light flux of third wavelength λ3, and the second and third are diffracted. If a phase difference can be given only to the light flux of a predetermined wavelength, only the light of the DVD can be diffracted. This arrangement corrects the spherical aberration of the DVD that will remain in the structure of item 29.

The structure described in item 42 is the objective optical system of item 38, wherein the second phase structure is a blazed diffractive structure.

The structure described in item 43 is the objective optical system of item 39, wherein the second phase structure is a blazed diffractive structure.

In the blazed diffractive structure, the cross section including the optical axis is formed in a serrated structure. Chromatic aberration can be effectively corrected if the second phase structure is designed as a blazed diffractive structure, as described in items 42 and 43. In chromatic aberration, the condensing position of the objective lens remains unchanged despite changes in the wavelength. Mode hopping occurs to the laser used in the optical pickup apparatus. The actuator of the objective lens cannot catch up with its abrupt change in the wavelength, and is left in a defocused state. To solve this problem, the short-wave Blu-ray, HD and DVD require a method for chromatic correction wherein the condensing position of the objective lens does not change despite a change in the wavelength. Chromatic correction can be achieved by the waveform selective diffractive structure but this method is not suited in that a greater number of straps are required than that in the blazed diffractive structure, and chromatic correction cannot be provided at the same time since this method allows passage of DVD and CD light.

The structure described in item 44 is the objective optical system of item 30 satisfying
0.9×t1≦t2≦1.1×t1. (30)

The structure described in item 44 specifies the preferable range of the thickness t2 of the protective layer of the second information recording medium.

When the thickness t1 is kept in this range, since the spherical aberration produced by difference of wavelength only corrected as the combination of HD DVD and DVD, a diffractive pitch can be enlarged and processability can be raised.

The structure described in item 45 is the objective optical system of item 29, wherein one of the material A and the material B is a glass material and another is a resin.

The structure described in item 46 is the objective optical system of item 45, wherein the material A is a glass material and the material B is a resin.

Since there are many types of optical glass, it provides a broader material selection and it is preferable to use one of above two materials is optical plastic as described in item 45. Furthermore, considering the two parts are laminated with the phase structure being microscopic structure placed on the boarder between the two parts, it is preferable that another material is optical plastic from the point of view of production.

The structure described in item 47 is the objective optical system of item 46, wherein the material B is an ultraviolet curing resin.

The structure described in item 48 is the objective optical system of item 46, wherein the first part is formed by molding.

The optical part formed of optical glass with a phase structure formed on the surface thereof can be produced according to the method of repeating the photolithographic process and etching processes, thereby forming a phase structure directly on the optical part. However, a so-called molding method is more preferred for high-volume production wherein a mold with a phase structure formed thereon is produced, thereby getting a mold with a phase structure formed on the surface thereof, as a replica of this mold, as described in item 48. A mold with a phase structure formed thereon can be produced according to the method of repeating the photolithographic process and etching processes, thereby forming a phase structure or the method of processing a phase structure by a precision lathe.

The structure described in item 49 is the objective optical system of item 29, wherein the first phase structure corrects a spherical aberration caused by a difference between the thickness t1 and the thickness t3.

The structure described in item 50 is the objective optical system of item 29, satisfies the following expressions:
α×λ1=λ3
K1−0.1≦α≦K1+0.1
where K1 is a natural number.

The structure described in item 51 is an optical pickup apparatus for reproducing and/or recording information, includes: a first light source for emitting a first light flux with a first wavelength λ1; a third light source for emitting a third light flux with a third wavelength λ3 (λ1<λ3); and the objective optical system of item 32. In the structure, the optical pickup apparatus reproduces and/or records information on an information recording surface of a first optical information medium having a protective substrate with a thickness t1 using the first light flux, and reproduces and/or records information on an information recording surface of a third optical information medium having a protective substrate with a thickness t3 (t3>t1) using the third light flux, and the first optical element is arranged in an optical path between the first light source and the second light source, and the objective lens.

The structure described in item 52 is the optical pickup apparatus for reproducing and/or recording information, including: a first light source for emitting a first light flux with a first wavelength λ1; a third light source for emitting a third light flux with a third wavelength λ3 (λ1<λ3); and the objective optical system of item 32. In the structure the optical pickup apparatus reproduces and/or records information on an information recording surface of a first optical information medium having a protective substrate with a thickness t1 using the first light flux, and reproduces and/or records information on an information recording surface of a third optical information medium having a protective substrate with a thickness t3 (t3>t1) using the third light flux, and the first optical element and the objective lens are formed in one body.

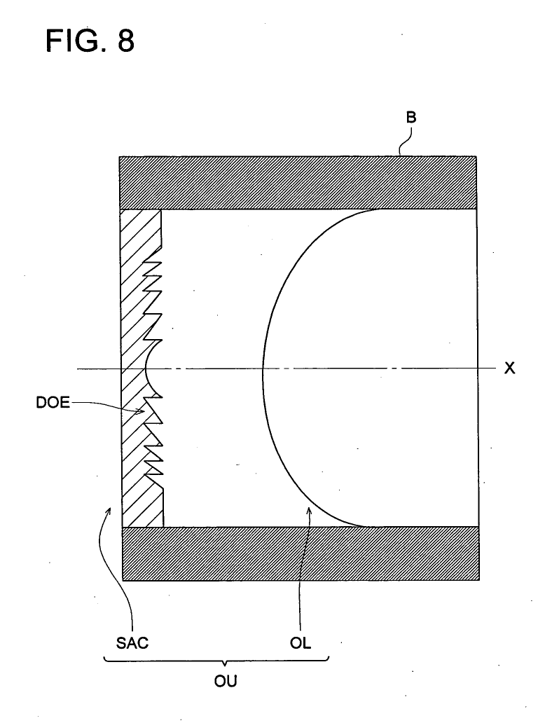

When the first optical element described in any one of the items 32 through 50 is mounted on the optical pickup apparatus, it can be placed on the light source side of the objective lens as described in item 51. (See FIG. 8). This arrangement allows the first optical element to be formed as an approximately flat plate, and provides an advantage of easy production of the first optical element. In this case, the first optical element and objective lens are preferably held so that the mutually relative positional relationship is maintained invariable, because this arrangement ensures that aberration due to eccentricity does not occur at the time of tracking.

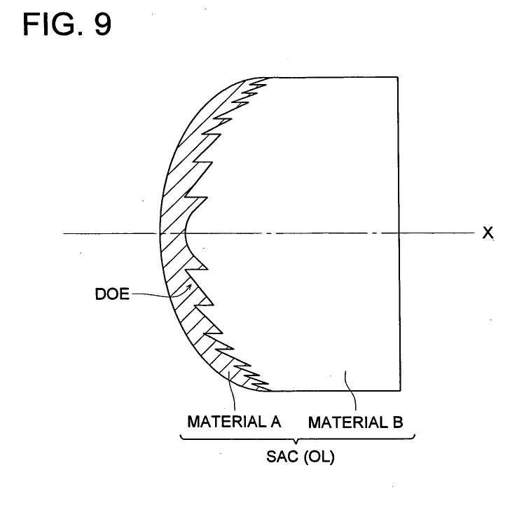

Alternatively, the objective lens can be provided with the function of the first optical element (by integration). (See FIG. 9). This arrangement reduces the number of parts used in the optical pickup apparatus and saves the space.

The structure described in item 53 is the optical pickup apparatus of item 51, wherein the objective lens is optimized about a spherical aberration correction for a combination of the thickness t1 and the wavelength λ1.

The structure described in item 54 is the optical pickup apparatus of item 52, wherein the objective lens is optimized about a spherical aberration correction for a combination of the thickness t1 and the wavelength λ1.

In the structure described in item 51 or 52, it is preferable that the objective lens has an aspherical surface whose shape is defined such that a spherical aberration correcting amount becomes minimum for the first wavelength and the thickness of the protective layer of the first optical information recording medium. Because the light flux with the first wavelength transmits the phase structure of the first optical element without being provided any action by the phase structure as it is in the structure, the converging performance of the first light flux is defined by the objective lens. Accordingly, by defining the aspherical surface of the objective lens so that a spherical aberration correcting amount becomes minimum for the first wavelength and the thickness of the protective layer of the first optical information recording medium, it becomes easy to provide the converging performance of the first light flux as which the severest wavefront accuracy is required. In this case, “the objective lens is optimized about a spherical aberration correction for a combination of the thickness t1 and the wavelength λ1” means that the aberration of the front wave is 0.05 λ1 RMS or less when the first light flux is condensed through the objective lens and the protective layer of the first optical information medium.

The structure described in item 55 is the optical disc drive apparatus, including: the optical pickup apparatus of item 51; and a moving unit for moving the optical pickup apparatus in a radius direction of each of the first to third optical information recording media.

The structure described in item 56 is the optical disc drive apparatus, including: the optical pickup apparatus of item 52; and a moving unit for moving the optical pickup apparatus in a radius direction of each of the first to third optical information recording media.

According to the structure described in item 55 or 56, the optical disc drive having the same effect to one of items 29 to 54 can be obtained.

The structure described in item 57 is the objective optical system of item 1, including two or more optical elements including the first optical element and a second optical element, wherein the first phase structure is a diffractive structure having a plurality of patterns arranged concentrically, and each of the plurality of patterns has a cross section including an optical axis in a stepped shape with a plurality of levels.

When the objective optical system is configured as shown in item 57, the light flux of wavelength λ1 whose wavelength ratio stands in the relationship of approximately integral ratio (e.g. blue-violet laser beam having a wavelength of λ1 of about 407 nm) and the light flux of wavelength λ3 (e.g. infrared laser beam having a wavelength λ3 of about 785 nm) can be emitted at mutually different angles, using the first phase structure. This ensures compatibility between the correction of spherical aberration caused by the difference in thicknesses of protective substrates t1 and t3, and a high degree of transmittance of the light flux of each wavelength.

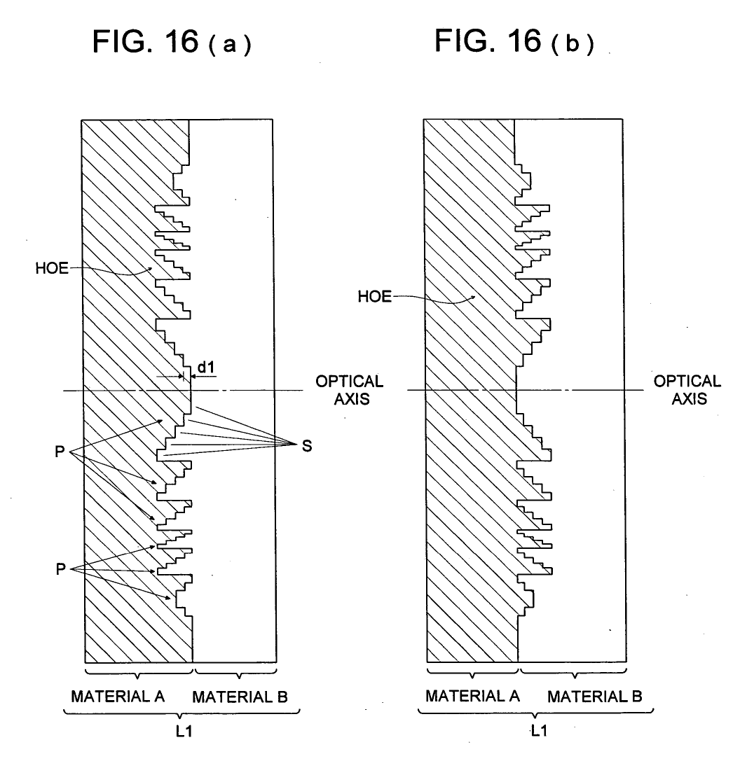

To put it more specifically, the first phase structure HOE (see FIGS. 16(a) and 16(b)) are formed on the boundary surface of the materials A and B by concentric arrangement of the patterns having a stepped cross section including the optical axis. Each pattern is structured in such a way that the step is shifted for each of the levels in the specified number (5 levels in FIGS. 16(a) and 16(b)) by the height corresponding to the number of steps conforming to the number of levels (4 steps in FIGS. 16(a) and 16(b)).

The following effect can achieved by using an objective optical system composed of two or more optical devices and changing the distribution of the refracting power for the light flux of wavelength λ1 of each optical device.

When the refracting power required by the light flux of wavelength λ1 is distributed over a plurality of optical devices, it becomes easy to manufacture the optical device. This arrangement reduces the spherical aberration resulting from temperature variation when the optical device is made of resin, and allows the objective optical system of the numerical aperture (NA) to be composed of the resin lens alone, with the result that both the cost and weight are reduced. Further, when the refracting power required by the light flux of wavelength λ1 is distributed over a plurality of optical devices, the working distance is reduced, as compared to the case where the objective optical system is composed of a single lens. Especially in the case of a low-profile optical pickup apparatus a problem is found in the WD on the side of the third optical information recording medium having a thick protective substrate. If the first phase structure is provided with the diffraction characteristics for converting the light flux of wavelength λ3 into the divergent light flux, a sufficient WD can be ensured on the side of the third optical information recording medium.

Further, when the refracting power for the wavelength λ1 of the first optical element with the first phase structure formed thereon is set to approximately zero (0), it becomes possible to mitigate the reduction of transmittance due to the shading effect of the first phase structure, and to facilitate formation of the first phase structure.

The structure described in item 58 is the objective optical system of item 57, wherein the first phase structure has a structure including a plurality of patterns arranged concentrically, each of the plurality of patterns has a cross section including an optical axis in a stepped shape with a plurality of levels, and a height of each step is shifted for every predefined number of levels by height of steps corresponding to the predefined number of levels.

When the light source whose wavelength is shifted from the design wavelength is used as the first light source, the optical path difference added by each of the steps forming each of the plurality of patterns shifts from the integer times as larger as the wavelength slightly. It makes a local spherical aberration in one of the patterns. Therefore, wavefront with a local spherical aberration discontinues at a position in which a height of each step is shifted for every predefined number of levels by height of steps corresponding to the predefined number of levels, and the wavefront becomes macroscopically flat. As this structure, the tolerance over the individual difference of the emission wavelength of the first light source can be eased by using the first phase structure in which the height of each step is shifted for every predefined number of levels by height of steps corresponding to the predefined number of levels.

The structure described in item 59 is the objective optical system of item 57, wherein the optical pickup apparatus further reproduces and/or records information on an information recording surface of a second optical information medium having a protective substrate with a thickness t2 (t1≦t2<t3) using a second light flux with a second wavelength λ2 (λ1<λ2<λ3) emitted from a second light source.

The structure described in item 60 is the objective optical system of item 57, wherein the objective optical system satisfies
−3.5≦(νdA−νdB)/(100×(ndA−ndB))≦−0.7
where νdA is an Abbe constant of the material A for d-line,
νdB is an Abbe constant of the material B for d-line,
ndA is a refractive index of the material A for d-line,
ndB is a refractive index of the material B for d-line, and ndA≠ndB.

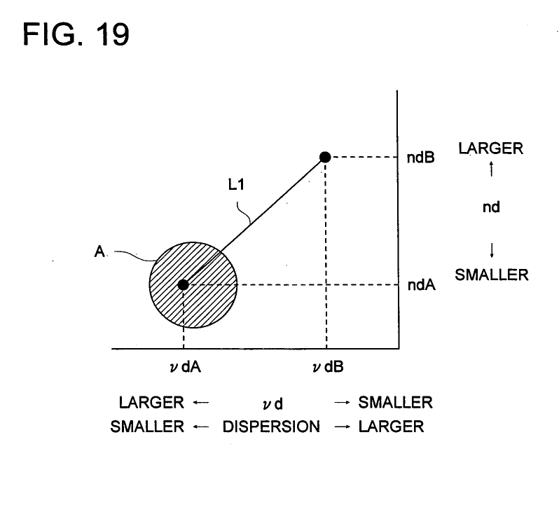

FIG. 19 is a chart with the Abbe's number of the d-line plotted on the horizontal axis, and the refractive index of d-line plotted on the vertical axis. For example, if the material A (Abbe's number for d line: νdA; refractive index: ndA) has been specified as the material of the first part, the number of material B (Abbe's number for d-line: νdB; refractive index: ndB) preferably combined with the material B is not restricted to one. It can be any material that is located within a specified range, such as the one shown in the area A in the chart. This also applies to the selection of material B when the material A has been specified.

The (νdA−νdB)/{100×(ndA−ndB)} in the equation shown in item 60 indicates the inclination of line segment L1 formed by connecting the material A (ndA and νda) and material B (ndB and νdB). The diffraction efficiency of the light flux of wavelength λ3 can be improved by selecting the materials A and B capable of keeping this inclination within the aforementioned range and using it as the materials for the first optical element.

The structure described in item 61 is the objective optical system of item 57, wherein the material A and the material B satisfies
11≦((νdA−νdB)²+10⁴×(ndA−ndB)²)^{1/2}≦47.5
where νdA is an Abbe constant of the material A for d-line,
νdB is an Abbe constant of the material B for d-line,
ndA is a refractive index of the material A for d-line, and ndB is a refractive index of the material B for d-line.

The {(νdA−νdB)²+10⁴×(ndA−ndB)²}^{1/2} in the equation shown in item 61 indicates the length of line segment L1 formed by connecting the material A (ndA and νdA) and material B (ndB and νdB) in FIG. 19. The shape of each pattern in the first phase structure is known as being further characterized in that the transmittance of the passing light flux (diffraction efficiency) is reduced as the ratio of the length (depth) in the direction of the optical axis relative to the length (pitch) in the direction perpendicular to the optical axis (also called the aspect ration) is closer to 1 to 1. To ensure a satisfactory transmittance (diffraction efficiency), it is preferred to reduce the depth relative to the pitch. For this purpose, it is preferably kept within the range of the equation given in item 61.

If the value falls below the lower limit of item 61, the difference in the refractive index between the materials A and B will be too small. Then the pattern will be too deep, and the transmittance (diffraction efficiency) will drop. If the value exceeds the upper limit, the difference in the refractive index between the materials A and B will be excessively increased. This requires the refractive index of one of the materials to be reduced or the refractive index of the other to be drastically increased. The former material is not suited for use in the optical device such as the objective optical system requiring great refracting power, on the one hand. On the other hand, the latter material has a problem in that reduction of costs and weight by the use of more resin cannot be achieved, due to a smaller amount of resin material.

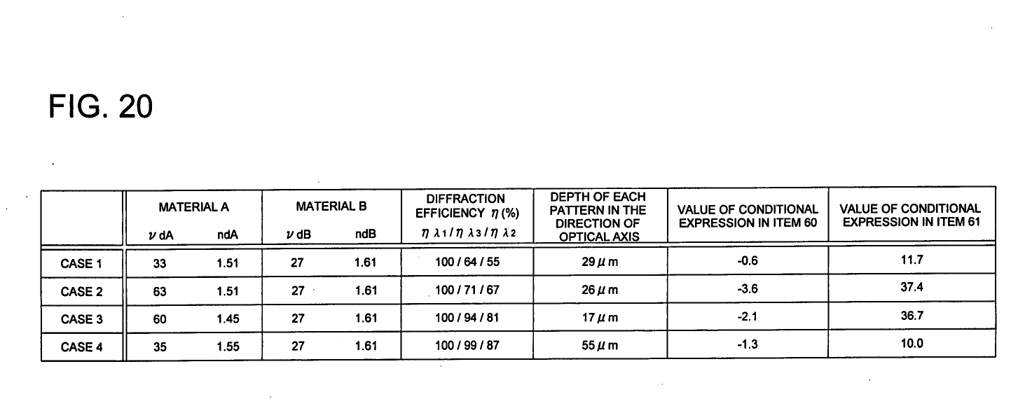

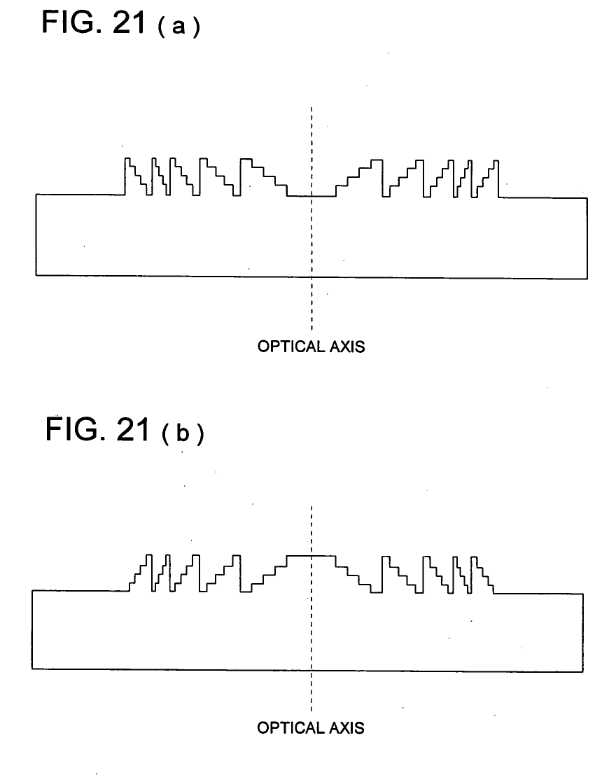

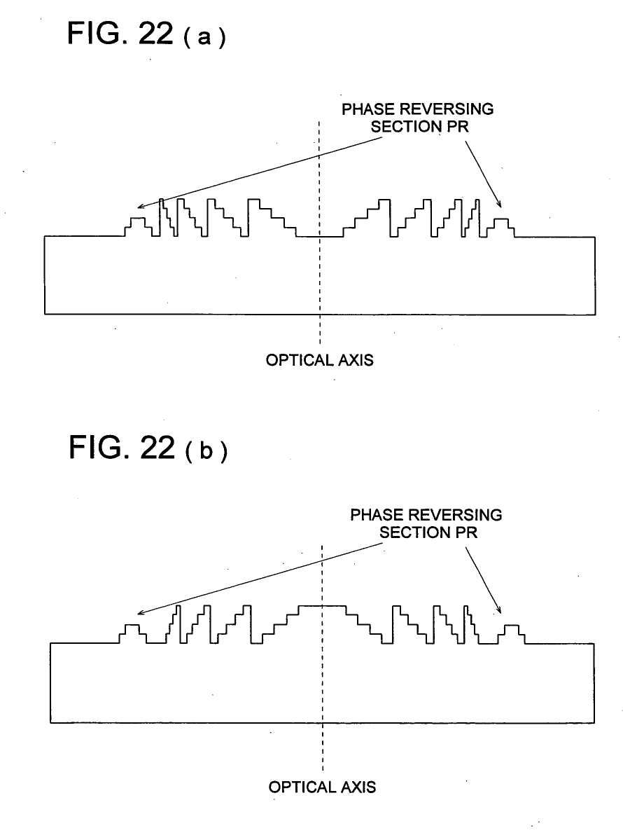

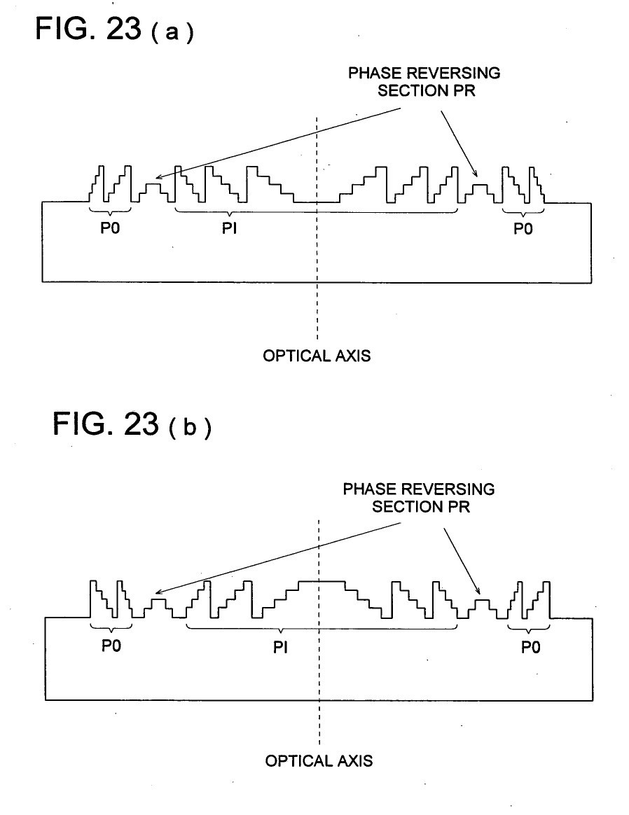

FIG. 20 shows diffractive efficiencies, depth of each of the patterns, values of the expression (νdA−νdB)/(100×(ndA−ndB)) in item 60, and values of the expression {(νda−νdB)²+10⁴×(nda−ndB)²}^{1/2} in item 61, under these cases:
case 1 (νdA, ndA)=(33, 1.51), (νdB, ndB)=(27, 1.61),
case 2 (νdA, ndA)=(63, 1.51), (νdB, ndB)=(27, 1.61),
case 3 (νdA, ndA)=(60, 1.45), (νdB, ndB)=(27, 1.61),
case 4 (νdA, ndA)=(35, 1.55), (νdB, ndB)=(27, 1.61).

In there cases, the diffraction efficiencies are calculated assuming the number of levels of each of the patterns of the first phase structure is 5, the wavelength λ1=407 nm, the wavelength λ3=785 nm. Furthermore, the diffraction efficiencies for the wavelength λ2=655 nm used for recording/reproducing information on the second optical information recording medium (described below) having a protective layer with a thickness t2 (t1≦t2<t3).

FIG. 20 shows that the diffraction efficiencies of the light fluxes with the wavelengths λ2 and λ3 has larger value in the case 3 and case 4 which satisfy the expression of item 60 comparing with the diffraction efficiencies in the case 2 which is lower than the lower limit of the expression in item 60.

The depth of each of the patterns in case 1 which satisfies the expression in item 61 has smaller value comparing with the depth in case 2 and case 3 which is lower than the lower limit of the expression in item 61.

The structure described in item 62 is the objective optical system of item 60, wherein the material B satisfies following expressions:
20≦νdB≦40
1.55<ndB≦1.70.

The structure described in item 63 is the objective optical system of item 61, wherein the material B satisfies following expressions:
20≦νdB≦40
1.55<ndB≦1.70.

The structure described in item 64 is the objective optical system of item 60, wherein the material A satisfies the following expressions:
45≦νdA≦65
1.45<ndA≦1.55.

The structure described in item 65 is the objective optical system of item 61, wherein the material A satisfies following expressions:
45≦νdA≦65
1.45<ndA≦1.55.

The structures described in item 62 to 65 regulate a preferable ranges of νdA, νdB, dnA and ndB. By using materials satisfying the expressions in items 62 to 65 as the material A and material B, the same effect to the structure described in item 60 and 61 are provided.

The structure described in item 66 is the objective optical system of item 57, satisfies following expressions:
α×λ1=λ3
K1−0.1≦α≦K1+0.1
where K1 is a natural number.

The structure described in item 67 is the objective optical system of item 66, satisfying K1=2.

The technique of the present invention is effective when the compatibility is achieved between the plurality of optical information recording media using wavelengths whose ratio is approximately integer as described in item 66. Concretely, it is effective when the compatibility is achieved between the high density optical disc (BD or HD) and CD using wavelengths whose ratio is approximately two as described in item 67.

The structure described in item 68 is the objective optical system of item 66, wherein the first phase structure does not diffract the first light flux and diffracts the third light flux.

In the structure described in item 68, the direction of diffraction of the light flux of the wavelength λ3 can be freely set if the process of diffraction is applied to the light flux of wavelength λ3 alone, out of the light fluxes of wavelengths λ1 and λ3 where the ratio of the wavelengths is an approximately integer. To put it another way, this arrangement controls the direction in which the light flux of wavelength λ3 is diffracted, in such a way as to improve the aberration for the light flux of wavelength λ3, without affecting the aberration for the light flux of wavelength λ1.

Generally, production of the optical device is more difficult as the first wavelength is shorter. Accordingly, the aspherical shape of the first and second optical elements is preferably determined in such a way as to improve the light converging performance for the light flux of wavelength λ1.

The structure described in item 69 is the objective optical system of item 68, satisfies following expressions:
L=d1×(nB1−nA1)/λ1 (35)
M=d1×(nB3−nA3)/λ3 (36)
L/INT(M)≠Integer (37)
φ(M)=INT(D×M)−(D×M) (38)
−0.4<φ(M)<0.4 (39)
where L is 2 or 3, (40)
d1 is a depth along an optical axis of each steps in each of the plurality of patterns of the first phase structure,
nA1 is a refractive index of the material A for the first light flux,
nB1 is a refractive index of the material B for the first light flux,
nA3 is a refractive index of the material A for the third light flux,
nB3 is a refractive index of the material B for the third light flux,
D is the number of levels in each of the plurality of patterns of the first phase structure, and
INT(X) is an integer closest to X.

In the conditional expression in item 69, each of L and M is an optical path difference added to the first and third light fluxes by depth along the optical axis of each steps included in each of the patterns of the first phase structure, respectively. When the suitable combination of the material A and the material B is selected, diffractive action is provided to the third light flux by selecting materials with refractive indexes satisfying Eq. (37). Therefore, spherical aberration caused by a thickness difference between t1 and t3 can be corrected for the third light flux. Further, by regulating the number of levels included in each of the patterns so as to satisfy Eq. (39), the diffraction efficiency of the third light flux can be secured highly enough. In this case, it is preferable that L is 2 or 3. As the value of L becomes large, the depth d1 in the direction of an optical axis of each step becomes deeper, and it becomes difficult to product the stepped shape with sufficient accuracy. Therefore, it is not preferable that L is 4 or more because it enlarges the depth d1 in the direction of the optical axis of each step recklessly. On the other hand, diffraction efficiency of the third light flux is not securable when a value of L is 1.

The structure described in item 70 is the objective optical system of item 58, satisfies following expressions:
0.8×λ1×K2/(nB1−nA1)≦d1≦1.2×λ1×K2/(nB1−nA1)
where d1 is a depth along an optical axis of each steps in each of the plurality of patterns of the first phase structure,
nA1 is a refractive index of the material A for the first light flux,
nB1 is a refractive index of the material B for the first light flux, and
K2 is a natural number.

The structure described in item 71 is the objective optical system of item 70, satisfying K2=2.

When the first phase structure is provided a diffractive property so as to provide a diffractive action only to the third light flux among the first light flux and the third light flux having wavelengths whose ratio is almost integer, it is preferable that the depth d1 along the optical axis of each steps included in each of the patterns in the first phase surface is designed so that an optical path difference for providing the first light flux becomes almost integer times as large as the wavelength λ1 as described in item 72. By this design, it becomes possible to secure the diffraction efficiency of the 3rd light flux highly enough. Particularly, when the depth d1 along the optical axis of each steps is designed so as to provide an optical path difference which is almost twice times as large as the wavelength λ1 to the first light flux as described in item 71, it enlarges a design value of the diffraction efficiency of the third light flux received diffractive action from the first phase structure.

The structure described in item 72 is the objective optical system of item 71, wherein a number of levels in each of the plurality of patterns of the first phase structure is 5, where the number of levels is a number of optical surfaces having ring shapes included in one period of the first phase structure.

In the first phase structure having features and structures described in any one of items 58 to 71, it is preferable that the number of levels included in each of patterns is 5. It makes an optical path difference added to the third light flux by each pattern which is one period of the diffractive ring-shaped zones almost integer times as large as the wavelength λ3. Therefore, a design value of the diffraction efficiency of the third light flux becomes maximum value.

The structure described in item 73 is the objective optical system of item 57, wherein the first phase structure corrects a spherical aberration caused by a difference between the thickness t1 and the thickness t3.

According to the structure described in item 73, the objective optical system which has compatibility to a high density optical disc and CD is realized. Concretely, when the wavelength of incident light flux becomes long, it is preferable to provide the spherical aberration property such that a spherical aberration changes in under direction of the correction, to the first phase structure.

The structure described in item 74 is the objective optical system of item 57, satisfying m1=m2=0, where m1 and m2 are magnifications of the objective optical system for the first light flux and the third light flux respectively.

According to structure described in an item 74, since a position of an object point does not change even when the objective optical system is driven for tracking operation, a good tracking property is acquired to a light flux with any wavelength.

As described above, when a diffractive structure is formed on the surface of the lens as in the prior art, it has been difficult to achieve compatibility between optical information recording mediums (compatibility between a high-density optical disc using the blue-violet laser beam and a CD using the infrared laser beam, for example) where the ratio of the wavelength to be used is approximately integer times, while maintaining a high transmittance (diffraction efficiency) with respect to the light flux of any wavelength. However, as in the present invention, the materials A and B having mutually different Abbe's numbers along d-line are laminated. An optical path difference is designed to be approximately integer times as large as the wavelength λ1, wherein the aforementioned optical path difference assigns the light flux of wavelength λ1 with the depth d1 of each step in the direction of optical axis constituting each pattern of the first phase structure formed on the boundary thereof. Further, the number of the levels constituting each pattern is selected appropriately in conformity to the ratio of the difference in the refracting power between the materials A and B. This arrangement ensures a high degree of transmittance (diffraction efficiency) for the light flux of any wavelength (especially the light flux of longer wavelength).

The structure described in item 75 is the objective optical system of item 59, satisfies following expressions:
β×λ1=λ2
1.5≦β≦1.7.

According to structure described in an item 75, it becomes possible to provide another compatibility to the objective optical system which has compatibility between a high density optical disc and CD.

The structure described in item 76 is the objective optical system of item 59, satisfying the following expressions:
L=d1×(nB1−nA1)/λ1 (35)
N=d1×(nB2−nA2)/λ2 (41)
L/INT(N)=Integer (42)
φ(N)=INT(D×N)−(D×N) (43)
−0.4<φ(N)<0.4 (44)
where L is 2,
d1 is a depth along an optical axis of each steps in each of the plurality of patterns of the first phase structure,
nA1 is a refractive index of the material A for the first light flux,
nB1 is a refractive index of the material B for the first light flux,
nA2 is a refractive index of the material A for the second light flux,
nB2 is a refractive index of the material B for the second light flux,
D is the number of levels included in each of the plurality of patterns of the first phase structure,
INT(X) is an integer closest to X.

It is preferable to select the materials which have refractive indexes which satisfy Eq. (42) in addition to the above-mentioned Eq. (37). Thereby, since the phase difference added by the depth along the optical axis of each step to the second light flux becomes substantially zero, it becomes possible to make the second light flux transmit as it is. In conditional expression described in item 76, L and N are the optical path differences in the wavelength unit added by the depth along the optical axis of each step included each of the pattern in the first phase structure to the first and second light fluxes, respectively. When also giving the compatibility over the second optical information recording medium which uses the second light flux for the objective optical system of the present invention, it is preferable to select materials which have refractive indexes which satisfy Eq. (42) in addition to the above-mentioned Eq. (37). Thereby, since the phase difference added by the depth along the optical axis of each step of the second light flux becomes zero substantially, it becomes possible to make the second light flux transmit as it is. Furthermore, it becomes possible to secure the transmittance of the second light flux highly enough by providing the number of levels included in each of patterns so that Eq. (44) is satisfied. Here, it is preferable that L is 2. Since the structure does not satisfy Eq. (42) and Eq. (44) when L is a value excluding 2, it becomes difficult to make the second light flux transmit as it is with high transmittance.

The structure described in item 77 is the objective optical system of item 59, further including a second phase structure including a plurality of concentric ring shaped zones around an optical axis.

The structure described in item 78 is the objective optical system of item 77, wherein the second phase structure is arranged on an optical surface excluding the boundary between the first part and the second part.

The structure described in item 79 is the objective optical system of item 77, wherein the second phase structure arranged on a boundary between an air and one of the first part and the second part whose material has larger Abbe constant for d-line.

The structure described in item 80 is the objective optical system of item 77, wherein the second phase structure is arranged on an optical surface of the second optical element.

The wavelength λ2 used in the DVD is about 1.6 times the wavelength λ1 used in the high-density optical disc. The phase structure formed on the surface of the same lens as the prior art lens allows mutually different optical actions to be given to the light fluxes of wavelength λ1 and wavelength λ2. In an objective optical system of the present invention, the structures described in items 78 through 80 define the preferable positions for forming the second phase structure in order to provide compatibility between the high-density optical disc and DVD.

The structure described in item 81 is the objective optical system of item 77,
wherein the second phase structure does not diffract the first light flux and the third light flux entering into the second phase structure and diffracts the second light flux.

According to the structure described in item 81, the process of diffraction is applied only to the light flux of wavelength λ2 with respect to the second phase structure, whereby the second phase structure can be designed while the direction where the light flux of wavelength λ2 is diffracted is controlled so as to optimize the aberration with respect to the light flux of wavelength λ2. This can be achieved without affecting the aberration regarding to the light fluxes of the wavelengths λ1 and λ3.

The structure described in item 82 is the objective optical system of item 81, wherein the second phase structure has a structure including a plurality of patterns arranged concentrically, each of the plurality of patterns has a cross section including an optical axis in a stepped shape with a plurality of levels, and a height of each step is shifted for every predefined number of levels by height of steps corresponding to the predefined number of levels.

When the light source whose wavelength is shifted from the design wavelength is used as the first light source or the third light source, the optical path difference added by each of the steps forming each of the plurality of patterns of the second phase structure shifts from integer times as large as the wavelength slightly. It makes a local spherical aberration in one of the patterns. Therefore, wavefront with a local spherical aberration discontinues at a position in which a height of each step is shifted for every predefined number of levels by height of steps corresponding to the predefined number of levels, and the wavefront becomes macroscopically flat. As this structure, the tolerance over the individual difference of the emission wavelength of the first light source can be eased by using the second phase structure in which the height of each step is shifted for every predefined number of levels by height of steps corresponding to the predefined number of levels.

The structure described in item 83 is the objective optical system of item 82, satisfies following expressions:
0.8×λ1×K3/(nC1−1)≦d2≦1.2×λ1×K3/(nC1−1)
where d2 is a depth along an optical axis of each steps in each of the plurality of patterns of the second phase structure,
nC1 is a refractive index of one of the first part and second part including the second phase structure, and
K3 is an even number.

The structure described in item 84 is the objective optical system of item 83, satisfying K3=2.

In the case of providing the diffraction property such that a diffractive action is given only to the second light flux, to the second phase structure as described in an item 84. It is preferable to design the depth d2 along the optical axis of each step of each of the patterns in the second phase structure such that the optical path difference given to the first light flux is almost odd times as large as the wavelength λ1 as described in item 83. This becomes possible to secure the transmittance of the first light flux highly enough. At the same time, since the optical path difference added to the third light flux by the steps designed in this manner becomes almost odd times as large as wavelength λ3, the transmittance of the third light flux can also be secured highly enough. Particularly, it enlarges the design value of the diffraction efficiency of the second light flux which receives a diffractive action by the second phase structure by designing the depth d1 along the optical axis of each step so as to provide the optical path difference which is almost two times as large as the wavelength λ1 to the 1st light flux as described in item 84.

The structure described in item 85 is the objective optical system of item 82, wherein the number of levels included in each of the plurality of patterns of the second phase structure is 5, where the number of levels is a number of optical surfaces having ring shapes included in one period of the second phase structure.

In the second phase structure having the characteristics and structure described in any one of items 82 through 84, the number of levels constituting each pattern is preferably 5. This arrangement ensures that the optical path difference, assigned to the light flux of wavelength λ2 by each pattern (amounting to the one-period portion of the diffraction strap) of the second phase structure, will be approximately integer times as large as the wavelength λ2. Thus, the design value of the diffraction efficiency of the light flux of wavelength λ2 can be maximized.

The structure described in item 86 is the objective optical system of item 77, wherein a cross section of the second phase structure including an optical axis has a serrated shape.

The structure described in item 87 is the objective optical system of item 77, wherein a cross section of the second phase structure including an optical axis has a stepped structure such that an optical path length becomes larger at a position being farther from an optical axis, or a stepped structure such that an optical path length becomes smaller at a position being farther from an optical axis.

The structure described in item 88 is the objective optical system of item 77, wherein a cross section of the second phase structure including an optical axis has one of the following structures: a stepped structure such that an optical path length becomes larger at a position being farther from an optical axis when the position is lower than the predefined height from the optical axis and an optical path length becomes smaller at a position being farther from an optical axis when the position is higher than the predefined height from the optical axis; and
a stepped structure such that an optical path length becomes smaller at a position being farther from an optical axis when the position is lower than the predefined height from the optical axis and an optical path length becomes larger at a position being farther from an optical axis when the position is higher than the predefined height from the optical axis.

In addition to the diffractive structures described in items 81 through 85, the second phase structure that can be used includes the phase structures described in items 86 through 88. These phase structures can be provided with an aberration correcting function not only for the light flux of wavelength λ2 but also for the light flux of wavelength λ1 and light flux of wavelength λ3. If these phase structures are provided with a chromatic aberration correcting function and others in the wavelength area of the wavelength λ1 in addition to a spherical aberration correcting function for achieving compatibility between the high-density optical disc and DVD, for example, then the condensing performance of the objective optical system is further improved.

The structure described in item 89 is the objective optical system of item 77, wherein the second phase structure provides an optical path length of even number times as large as the first wavelength to the first light flux.

As described by the item 89, when the phase structure described in items 86 to 88 is used as the second phase structure, it is preferable to design so that the optical path difference added by the second phase structure to the first light flux is approximately even times as large as the wavelength λ1. This becomes possible to secure the transmittance of the first light flux highly enough. At the same time, since the optical path difference added to the third light flux by the second phase structure designed in this manner becomes almost odd times as large as wavelength λ3, the transmittance of the third light flux can also be secured highly enough.

The structure described in item 90 is the objective optical system of item 77, satisfying 5≦d3≦10, where d3 [μm] is a step depth along an optical axis of each of the plurality of ring shaped zones f the second phase structure.

By designing the step d3 along the optical axis of each of ring-shaped zones included in the second phase structure so as to satisfy the expression of item 90, it is possible to reduce decline in the transmittance by the shading effect of the second phase structure, and to made easy formation of the second phase structure.

The structure described in item 91 is the objective optical system of item 77, satisfying t1=t2, wherein the second phase structure corrects a chromatic spherical aberration caused by a wavelength difference between the first light flux and the second light flux.

The structure described in item 92 is the objective optical system of item 77, satisfying t1<t2, wherein the second phase structure corrects a chromatic spherical aberration caused by a thickness difference between the thickness t1 and the thickness t2.

As described in an item 91, when the protection substrate thickness of a high density optical disc is the same to DVD (for example, HD), the compatibility between the high density optical disc and DVD is achieved by correcting the chromatic spherical aberration caused by a phase difference between the wavelengths λ1 and λ2. Moreover, as described in an item 92, when the thickness of the protective substrate of the high density optical disc is thinner than DVD (for example, BD), the compatibility between the high density optical disc and DVD is achieved by correcting the spherical aberration caused by the difference of t1 and t2, additionally to the chromatic spherical aberration caused by the difference of the wavelengths λ1 and λ2 by the second phase structure.

The structure described in item 93 is the objective optical system of item 59, satisfying m1=m2=m3=0, where m1 to m3 are magnifications of the objective optical system for the first light flux to the third light flux respectively.

According to the structure described in item 93, even if the objective optical system has made a tracking drive, the position of the object point remains unchanged. This structure ensures satisfactory tracking performances for the light flux of any wavelength.

As it described above, it becomes possible to further provide the compatibility over DVD to the objective optical system which has compatibility between the high density optical disc and CD by forming the 2nd phase structure on the surface of the objective optical system of the present invention.

The structure described in item 94 is the objective optical system of item 77, wherein the second phase structure corrects a chromatic aberration for the first light flux.

According to the structure described in item 94, when a chromatic aberration correcting function in the wavelength area for the wavelength λ1 is provided, the condensing performance of the objective optical system can be improved. Even if a waveform change (mode hop) has occurred instantaneously due to a change in the first light source output when reproduction mode is switched over to the recording mode, satisfactory condensing state can be maintained at all times without allowing the condensing spot to be increased.

The structure described in item 95 is the objective optical system of item 77, wherein the second phase structure corrects an increase of a spherical aberration according to a refractive index change of at least one of the first optical element and the second optical element.

As is widely known, the spherical aberration resulting from a change in the refractive index increases in proportion to the fourth power of NA of the objective optical system. When the objective optical system is made of resin characterized by a great change in the refractive index caused by temperature change, means must be provided to avoid such an increase in spherical aberration. In the objective optical system with NA of 0.85, an increase in the spherical aberration resulting from temperature change cannot be ignored sometimes, even if it is made of glass where a change in the refractive index caused by temperature change is smaller than that of the resin. According to the structure described in item 95, such an increase of spherical aberration resulting from temperature change is corrected by the third phase structure. Thus, the present invention provides an objective optical system characterized by a wide range of available temperature.

The structure described in item 96 is the objective optical system of item 57, the boundary includes a central region and a peripheral region surrounding the central region, the central region transmits a light flux portion of the first light flux used for reproducing and/or reproducing information on the first optical information recording medium, and a light flux portion of the third light flux used for reproducing and/or reproducing information on the third optical information recording medium, and the first phase structure is arranged on the central region and is not arranged on the peripheral region.

According to the structure described in item 96, the spherical aberration resulting from the difference in the thickness of protective substrate between the high-density optical disc and CD is corrected only within the numerical aperture (NA3) required for recording/reproducing of information using the CD. Correction is made in the area outside the NA3. Thus, the light flux of wavelength λ2 passing through the area outside the NA3 can be used as a flare component that does not contribute to spot formation. This structure allows the objective optical system of the present invention to have an aperture restricting function corresponding to the light flux of wavelength λ2.

The structure described in item 97 is the objective optical system of item 57,
the boundary includes a central region and a peripheral region surrounding the central region, the central region transmits a light flux portion used for reproducing and/or reproducing information on the first optical information recording medium of the first light flux, and a light flux portion used for reproducing and/or reproducing information on the third optical information recording medium of the third light flux, the peripheral region transmits a light flux portion used for reproducing and/or reproducing information on the first optical information recording medium of the first light flux, and a light flux portion not used for reproducing and/or reproducing information on the third optical information recording medium of the third light flux, the first phase structure is arranged on the central region and the peripheral region.

According to the structure described in item 97, the first phase structure formed inside the numerical aperture (NA3) required for recording/reproducing of information using the CD, and the first phase structure formed in the area outside the NA3 are provided with different amounts of diffraction power with respect to the light flux of wavelength λ3. Because of this structure, the light flux of wavelength λ2 passing through the area outside the NA3 can be used as a flare component that does not contribute to spot formation. At the same time, this structure allows free control of the position where the light flux of wavelength λ2 passing through the area outside the NA3 is condensed. Thus, the objective optical system of the present invention can be provided with an aperture restricting function conforming to the light flux of wavelength λ2.

The structure described in item 98 is the objective optical system of item 96, wherein the objective optical system converges a light flux portion of the third light flux passing through the peripheral region at a more overfocused position than a converged position of the light flux portion passing through the central region.

The structure described in item 99 is the objective optical system of item 97, wherein the objective optical system converges a light flux portion of the third light flux passing through the peripheral region at a more overfocused position than a converged position of the light flux portion passing through the central region.

If the light flux of wavelength λ3 has entered the objective optical system where the spherical aberration correction is optimized with respect to the light flux of wavelength λ1, the spherical aberration remains on the overfocused position. To solve this problem, the spherical aberration is corrected by the first phase structure formed in the area inside the NA3 in such a way as to ensure that the light flux of wavelength λ3 passing through the area outside the numerical aperture (NA3) required for recording/reproducing of information using the CD will be converged on the more overfocused position than the light flux having passed through the area inside the NA3, as in the structure described in items 98 and 99. If this structure is adopted, then the transmittance of the incoming light flux can be improved, wherein the diffraction pitch of the first phase structure formed in the area inside the NA3 does not get excessively fine.

The structure described in item 100 is the objective optical system of item 57, wherein the boundary forms a plane surface without a refractive power for an incident light flux.

According to the structure described in item 100, each level surface constituting each of the patterns of the first phase structure is perpendicular to the optical axis, whereby the processability of the mold for forming the first phase structure is improved.

The structure described in item 101 is the objective optical system of item 57, wherein one of the material A and the material B is an ultraviolet curing resin.

Generally, since the ultraviolet curing resin provides easy control of the Abbe's number for d-line, either the material A or B is made of ultraviolet curing resin, as described in item 101. This structure easily offers an optimum combination of materials, and improves the transmittance (diffraction efficiency) of the light flux entering the first phase structure.

The preferred method of manufacturing the first optical element is to laminate an ultraviolet curing resin on the optical device with the first phase structure formed on the surface thereof, and to apply ultraviolet rays thereafter.

One of the methods of manufacturing the optical element with a phase structure formed on the surface thereof is to form the phase structure directly on the substrate by repeating the processes of photolithography and etching. Another way is a so-called molding method, wherein a mold with the phase structure formed thereon is created, and the optical element with the phase structure formed on the surface thereof is obtained as a replica of this mold. The latter method is preferred from the viewpoint of mass production. A mold with the phase structure formed thereon can be created by the art of repeating the processes of photolithography and etching, thereby forming a phase structure, or by the art of using a precision lathe to produce the phase structure by machining operation.

The structure described in item 102 is the objective optical system of item 57, wherein each of the material A and the material B is resin.

As described in item 102, the weight and manufacturing cost of the first optical element can be reduced by using resin for both materials. Of the materials A and B, the material having a greater Abbe's number along d-line includes cyclic polyolefin based optical resin, represented by ZEONEX® of Nippon Zeon Co., Ltd. and APEL™ of Mitsui Chemicals, Inc., and this optical resin is preferably used. Ultraviolet curing resin and fluorine based polyethylene optical resin represented by OKP4 of Osaka Gas Chemical Co., Ltd. is preferably used as the material with smaller Abbe's number for d-line.

The structure described in item 103 is the objective optical system of item 57, wherein the first optical element has at least one optical surfaces being an aspherical surface.

According to the structure described in item 103, the design properties of the objective optical system can be improved by forming at least one aspheric surface on the first optical element.

The structure described in item 104 is the objective optical system of item 77, wherein the second optical element is arranged at optical-information-recording-medium side of the first optical element.

According to the structure described in item 104, the objective optical system having a reduced curvature of the first optical element can be designed, and it is possible to minimize reduction of the transmittance resulting from the shading effect of the first phase structure. Further, this method maintains a large effective diameter of the first phase structure and improves the transmittance of the incoming light flux, without allowing the diffraction pitch to become too small.

The structure described in item 105 is the objective optical system of item 57, wherein the first phase structure corrects a spherical aberration caused by a difference between the thickness t1 and the thickness t3.

The structure described in item 106 is the objective optical system of item 57, wherein a material of the second optical element has an Abbe constant for d-line is in a range of 50 to 70.

As described in item 105 or 106, the Abbe's number of the second optical element which needs large refractive power to incident light flux for d-line is kept within the range from 50 through 70. This method allows the chromatic aberration performance to be improved for the light flux of wavelength λ1.

The structure described in item 107 is the optical pickup apparatus for reproducing and/or recording information, including: a first light source for emitting a first light flux with a first wavelength λ1; a third light source for emitting a third light flux with a third wavelength λ3 (λ1<λ3); and the objective optical system of item 57,
wherein the optical pickup apparatus reproduces and/or records information using the first light flux on an information recording surface of a first optical information medium having a protective substrate with a thickness t1, and reproduces and/or records information using the third light flux on an information recording surface of a third optical information medium having a protective substrate with a thickness t3 (t3>t1).

The structure described in item 108 is the optical disc drive apparatus, including: the optical pickup apparatus of item 107; and a moving unit for moving the optical pickup apparatus in a radius direction of each of the first to third optical information recording media.

The structure described in item 109 is the objective optical system of item 1, further comprising a first phase structure including a plurality of steps in ringed shape,
wherein the objective optical system satisfies following expressions:
   20<|Δνd|<40 (51)
   0.3<(dn/dT)_{A}/(dn/dT)_{B}<3 (52)
where Δνd is a difference between an Abbe constant of the material A for d-line and an Abbe constant of the material B for d-line,
(dn/dT)_{A} is a change rate of a refractive index of the material A corresponding to a temperature change, and
(dn/dT)_{B}. is a change rate of a refractive index of the material B corresponding to a temperature change.

The structure described in item 110 is the objective optical system of item 109, wherein the objective optical system satisfies
0.5<(dn/dT)_{A}/(dn/dT)_{B}<2. (53)

The structure described in item 111 is the objective optical system of item 109, wherein the optical pickup apparatus further reproduces and/or records information on an information recording surface of a second optical information medium having a protective substrate with a thickness t2 (t1≦t2<t3) using a second light flux with a second wavelength λ2 (λ1<λ2<λ3) emitted from a second light source.

The structure described in item 112 is the objective optical system of item 109, wherein each of the material A and the material B is resin.

The structure described in item 113 is the objective optical system of item 1, further comprising a first phase structure including a plurality of steps in ringed shape,
wherein the objective optical system satisfies
   20<|Δνd|<40, (51)
the material A is a glass material, and
the material B is a material in which a plurality of inorganic particles whose average diameter is 30 nm or less, is dispersed into a base body made of regin,
where Δνd is a difference between an Abbe constant of the material A for d-line and an Abbe constant of the material B for d-line.

The structure described in item 114 is the objective optical system of item 113, wherein a change rate of a refractive index of the base body made of resin corresponding to a temperature change and a change rate of a refractive index of the plurality of inorganic particles has a different sign from each other in the material B.

The structure described in item 115 is the objective optical system of item 113, wherein the material A has a glass transition point of 400° C. or less.

The structure described in item 116 is the objective optical system of item 113, wherein the objective optical system satisfies following expressions:
40<νdA<80 (54)
20<νdB<40 (55)
where νdA is an Abbe constant of the material A for d-line and
νdB is an Abbe constant of the material B for d-line.

The structure described in item 117 is the objective optical system of item 113, satisfying
β−0.1≦α≦β+0.1 (56)
where α is λ3/λ1 and β is a natural number.

The structure described in item 118 is the objective optical system of item 117, satisfying β=2.

The structure described in item 119 is the objective optical system of item 109, wherein each of the plurality of the steps has a depth of 5 μm or more.

The structure described in item 120 is the objective optical system of item 113, wherein each of the plurality of the steps has a depth of 5 μm or more.

The structure described in item 121 is the objective optical system of item 119, wherein each of the plurality of the steps has a depth of 10 μm or more.

The structure described in item 122 is the objective optical system of item 120, wherein each of the plurality of the steps has a depth of 10 μm or more.

The structure described in item 123. The objective optical system of item 109, wherein the first phase structure is a diffractive structure.

The structure described in item 124 is the objective optical system of item 109, further comprising a second phase structure arranged on a surface excluding the boundary between the first part and the second part.

The structure described in item 125 is the objective optical system of item 109, wherein the first optical element is an objective lens.

The structure described in item 126 is the objective optical system of item 109, wherein the objective optical system includes an objective lens arranged on an optical-information-recording-medium side of the first optical element.

The structure described in item 127 is the is the objective optical system of item 111, wherein the objective optical system satisfies t2>t1, and corrects a spherical aberration caused by a difference between the thickness t1 and the thickness t3 and a spherical aberration caused by a difference between the thickness t1 and the thickness t2.

The structure described in item 128 is the objective optical system of item 111, wherein the objective optical system satisfies t2=t1, the first phase structure corrects a spherical aberration caused by a difference between the thickness t1 and the thickness t3 and a spherical aberration caused by a difference between the first wavelength λ1 and the second wavelength λ2.

The structure described in item 129 is the objective optical system of item 126, wherein the objective lens is optimized about a spherical aberration correction for a combination of the thickness t1 and the first wavelength λ1.

The structure described in item 130 is the objective optical system of item 109, wherein the first phase structure corrects a spherical aberration caused by a difference between the thickness t1 and the thickness t3.

The structure described in item 131 is the objective optical system of item 109, satisfies following expressions:
α×λ1=λ3
K1−0.1≦α≦K1+0.1
where K1 is a natural number.

The structure described in item 132 is the optical pickup apparatus for reproducing and/or recording information, including: a first light source for emitting a first light flux with a first wavelength λ1; a third light source for emitting a third light flux with a third wavelength λ3 (λ1<λ3); and the objective optical system of item 109, wherein the optical pickup apparatus reproduces and/or records information using the first light flux on an information recording surface of a first optical information medium having a protective substrate with a thickness t1, and reproduces and/or records information using the third light flux on an information recording surface of a third optical information medium having a protective substrate with a thickness t3 (t3>t1).

The structure described in item 133 is the optical pickup apparatus for reproducing and/or recording information, including: a first light source for emitting a first light flux with a first wavelength λ1; a third light source for emitting a third light flux with a third wavelength λ3 (λ1<λ3); and the objective optical system of item 113,
wherein the optical pickup apparatus reproduces and/or records information using the first light flux on an information recording surface of a first optical information medium having a protective substrate with a thickness t1, and reproduces and/or records information using the third light flux on an information recording surface of a third optical information medium having a protective substrate with a thickness t3 (t3>t1).

The structure described in item 134 is the optical disc drive apparatus, including: the optical pickup apparatus of item 132; and a moving unit for moving the optical pickup apparatus in a radius direction of each of the first to third optical information recording media.

The structure described in item 135 is the optical disc drive apparatus, including: the optical pickup apparatus of item 133; and a moving unit for moving the optical pickup apparatus in a radius direction of each of the first to third optical information recording media.

As in the structure described in item 109, two materials having a difference in Abbe's number to meet the Eq. (51) are laminated, and a phase structure (e.g. a diffractive structure) is formed on the boundary surface. This structure ensures the heretofore unattainable compatibility between the spherical aberration correcting effect and transmittance for the blue-violet laser beam (first light flux) and infrared laser beam (third light flux).

In the phase structure (called “laminated phase structure” in the present specification) sandwiched by two materials, if the difference in the refractive index of two materials has deviated from the design value, the transmittance of the phase structure may fluctuate and a stable recording and reproducing may fail. For example, if one of the two materials is made of glass and the other is made of resin, there is a difference by an order of magnitude in the rate of change of refractive index resulting from temperature variation between glass and resin. In the laminated phase structure of this structure, the difference in the refractive index resulting from the temperature variation greatly fluctuates, with the result that transmittance greatly fluctuates in response to temperature variation, and recording/reproducing operations are adversely affected.

If the material is selected such that the rate of change of refractive index resulting from temperature variation meets the Eq. (52), the difference in the refractive index between two materials can be kept approximately constant, even if there is a temperature variation during the operation of the optical pickup apparatus. The fluctuation in the refractive index resulting from temperature variation can be reduced.

To achieve the aforementioned advantages, it is more preferred to select a material for ensuring that the rate of change of refractive index resulting from temperature variation meets the Eq. (53).

Resin is most suited for use in two materials for meeting the Eq. (52). Further, the resin has a low viscosity in the molten state, and allows such a minute structure as a phase structure to be formed on the surface thereof, with the minimum geometric error. Further, a resin lens is characterized by a low manufacturing cost and light weight as compared with a glass lens. Especially when the diffraction optical device is made of resin to reduce its weight, it is possible to cut down the driving force for focusing and tracking control in the recording/reproducing of information using an optical disc.

The inorganic grains, having an average particle size of 30 nm or less, whose refractive index rises with temperature, are homogeneously mixed in the resin whose refractive index drops with the rise of temperature, whereby dependency of the refractive indexes of the both on temperature can be cancelled. This process provides the optical material (hereinafter referred to as “athermal resin”) characterized by a small change in refractive index resulting from temperature variation, with the moldability of the resin kept unchanged.

As in the structure of item 113, the difference in the refractive index between two materials can be kept approximately constant and the fluctuation of diffraction efficiency resulting from temperature variation can be minimized by lamination of the glass and thermal resin, even when temperature variation has occurred during the operation of the optical pickup apparatus.

Next, temperature-affected changes of refractive index of the optical element relating to the present embodiment will be explained. The temperature-affected change of the refractive index is expressed by temperature coefficient A of the following expression by differentiating refractive index n with temperature t, based on Lorentz-Lorenz equation.

$$A = \frac{( {n}^{2} + 2 ) ( {n}^{2} - 1 )}{6 n} \{ ( - 3 a ) + \frac{1}{[ R ]} \frac{\partial [ R ]}{\partial t} \}$$

α: Coefficient of linear expansion
[R]: Molecular refraction

In the case of general plastic materials, a contribution of the second term is generally small and can be ignored substantially, compared with the first term. For example, in the case of PMMA resin, coefficient of linear expansion α is 7×10⁻⁵, and when it is substituted in the expression above, there is obtained −1.2×10⁻⁴ which agrees an actual measurement substantially. In the present embodiment, in this case, it is possible to make a contribution of the second term to be great substantially by dispersing microparticles, preferably inorganic microparticles, in resins, so that a change by linear expansion of the first term may be canceled.

To be concrete, it is preferable that the change which has been about −1.2×10⁻⁴ in the past is controlled to be less than 10×10⁻⁵ in an absolute value. The change that is preferably less than 8×10⁻⁵, further preferably less than 6×10⁻⁵ or 1.0×10⁻⁶ is preferable for reduction of the spherical aberration resulting of temperature-affected changes of refractive index of the optical element. In the present example, it is possible to solve the dependency of the refractive index change to the temperature change by providing the optical element in which microparticles of niobium oxide (Nb₂O₅) are dispersed in acrylic resins (PMMA).

The volume ratio of the resin material that represents the basic material is about 80% and that of niobium oxide is about 20%, and these are mixed uniformly. Though microparticles have a problem that they tend to cohere, the necessary state of dispersion can be kept by a technology to disperse particles by giving electric charges to the surface of each particle. Incidentally, for controlling a rate of change of the refractive index for temperature, a volume ratio of acrylic resins to niobium oxide in the aforementioned temperature-affected characteristics adjustable material can be raised or lowered properly, and it is also possible to blend and disperse plural types of inorganic particles in a nanometer size.

Though a volume ratio of acrylic resins to niobium oxide is made to be 80:20, namely, to be 4:1, in the example stated above, it is possible to adjust properly within a range from 90:10 to 60:40. If an amount of niobium oxide is less to be out of 90:10, an effect of restraining temperature-affected changes becomes small, while, if an amount of niobium oxide is more to be out of 60:40, on the contrary, moldability of resins becomes problematic, which is not preferable.

Though the above microparticles is inorganic substances, oxides is more preferable. It is preferable that the state of oxidation is saturated, and the oxides are not oxidized any more.

Inorganic particles utilized in this invention have a mean particle diameter of not more than 30 nm and preferably not less than 1 nm. Since dispersion of particles is difficult when it is less than 1 nm, which may result in that desired abilities may not be obtained, while when the mean particle diameter is over 30 nm, the obtained thermoplastic material composition may become turbid to decrease transparency possibly resulting in a light transmittance of less than 70%. Herein, a mean particle diameter refers to a diameter of an equivalent volume sphere.

The shape of inorganic particles utilized in this invention is not specifically limited, but particles having a spherical shape are preferably utilized. Further, distribution of the particle diameter is not also specifically limited, but particles having a relatively narrow distribution rather than having a broad distribution are preferably utilized, with respect to exhibiting the effects of this invention more efficiently.

Inorganic particles utilized in this invention include, for example, inorganic oxide particles. More specifically, preferably listed are, for example, titanium oxide, zinc oxide, aluminum oxide, zirconium oxide, hafnium oxide, niobium oxide, tantalum oxide, magnesium oxide, calcium oxide, strontium oxide, barium oxide, yttrium oxide, lanthanum oxide, cerium oxide, indium oxide, tin oxide, lead oxide; complex oxide compounds thereof such as lithium niobate, potassium niobate and lithium tantalate; and phosphate salts and sulfate salts comprising combinations with these oxides; and specifically preferably utilized are niobium oxide and lithium niobate.

Further, as inorganic particles of this invention, micro-particles of a semiconductor crystal composition can also be preferably utilized. Said semiconductor crystal compositions are not specifically limited, but desirable are those generate no absorption, emission and phosphorescence in a wavelength range employed as an optical element. Specific composition examples include simple substances of the 14th group elements in the periodic table such as carbon, silica, germanium and tin; simple substances of the 15th group elements in the periodic table such as phosphor (black phosphor); simple substances of the 16th group elements in the periodic table such as selenium and tellurium; compounds comprising a plural number of the 14th group elements in the periodic table such as silicon carbide (SiC); compounds of an element of the 14th group in the periodic table and an element of the 16th group in the periodic table such as tin oxide (IV) (SnO₂), tin sulfide (II, IV) (Sn(II)Sn(IV)S₃), tin sulfide (IV) (SnS₂), tin sulfide (II) (SnS), tin selenide (II) (SnSe), tin telluride (II) (SnTe), lead sulfide (II) (PbS), lead selenide (II) (PbSe) and lead telluride (II) (PbTe); compounds of an element of the 13th group in the periodic table and an element of the 15th group in the periodic table (or III-V group compound semiconductors) such as boron nitride (BN), boron phosphide (BP), boron arsenide (BAs), aluminum nitride (AlN), aluminum phosphide (AlP), aluminum arsenide (AlAs), aluminu antimonide (AlSb), gallium nitride (GaN), gallium phosphide (GaP), gallium arsenide (GaAs), gallium antimonide (GaSb), indium nitride (InN), indium phophide (InP), indium arsenide (InAs) and indium antimonide (InSb); compounds of an element of the 13th group in the periodic table and an element of the 16th group in the periodic table such as aluminum sulfide (Al₂S₃), aluminum selenide (Al₂Se₃), gallium sulfide (Ga₂S₃), gallium selenide (Ga₂Se₃), gallium telluride (Ga₂Te₃), indium oxide (In₂O₃), indium sulfide (In₂S₃), indium selenide (InSe) and indium telluride (In₂Te₃); compounds of an element of the 12th group in the periodic table and an element of the 16th group in the periodic table (or II-VI group compound semiconductors) such as zinc oxide (ZnO), zinc sulfide (ZnS), zinc selenide (ZnSe), zinc telluride (ZnTe), cadmium oxide (CdO), cadmium sulfide (CdS), cadmium selenide (CdSe), cadmium telluride (CdTe), mercury sulfide (HgS), mercury selenide (HgSe) and mercury telluride (HgTe); compounds of an element of the 15th group in the periodic table and an element of the 16th group in the periodic table such as arsenic sulfide (III) (As₂S₃), arsenic selenide (III) (As₂Se₃), arsenic telluride (III) (As₂Te₃), antimony sulfide (III) (Sb₂S₃), antimony selenide (III) (Sb₂Se₃), antimony telluride (III) (Sb₂Te₃), bismuth sulfide (III) (Bi₂S₃), bismuth selenide (III) (Bi₂Se₃) and bismuth telluride (III) (Bi₂Te₃); compounds of an element of the 11th group in the periodic table and an element of the 16th group in the periodic table such as copper oxide (I) (Cu₂O) and copper selenide (I) (Cu₂Se); compounds of an element of the 11th group in the periodic table and an element of the 17th group in the periodic table such as copper chloride (I) (CuCl), copper bromide (I) (CuBr), copper iodide (I) (CuI), silver chloride (AgCl) and silver bromide (AgBr); compounds of an element of the 10th group in the periodic table and an element of the 16th group in the periodic table such as nickel oxide (II) (NiO); compounds of an element of the 9th group in the periodic table and an element of the 16th group in the periodic table such as cobalt oxide (II) (CoO) and cobalt sulfide (II) (CoS); compounds of an element of the 8th group in the periodic table and an element of the 16th group in the periodic table such as triiron tetraoxide (Fe₃O₄) and iron sulfide (II) (FeS); compounds of an element of the 7th group in the periodic table and an element of the 16th group in the periodic table such as manganese oxide (II) (MnO); compounds of an element of the 6th group in the periodic table and an element of the 16th group in the periodic table such as molybdenum sulfide (IV) (MoS₂) and tungsten oxide(IV) (WO₂); compounds of an element of the 5th group in the periodic table and an element of the 16th group in the periodic table such as vanadium oxide (II) (VO), vanadium oxide (IV) (VO₂) and tantalum oxide (V) (Ta₂O₅); compounds of an element of the 4th group in the periodic table and an element of the 16th group in the periodic table such as titanium oxide (such as TiO₂, Ti₂O₅, Ti₂O₃ and Ti₅O₉); compounds of an element of the 2th group in the periodic table and an element of the. 16th group in the periodic table such as magnesium sulfide (MgS) and magnesium selenide (MgSe); chalcogen spinels such as cadmium oxide (II) chromium (III) (CdCr₂O₄), cadmium selenide (II) chromium (III) (CdCr₂Se₄), copper sulfide (II) chromium (III) (CuCr₂S₄) and mercury selenide (II) chromium (III) (HgCr₂Se₄); and barium titanate (BaTiO₃). Further, semiconductor clusters structures of which are established such as Cu₁₄₆Se₇₃(triethylphosphine)₂₂, described in Adv. Mater., vol. 4, p.494 (1991) by G. Schmid, et al., are also listed as examples. These micro-particles may be utilized alone or in combination of plural types.

A manufacturing method of inorganic particles of this invention is not specifically limited and any commonly known method can be employed. For example, desired oxide particles can be obtained by utilizing metal halogenides or alkoxy metals as starting materials which are hydrolyzed in a reaction system containing water. At this time, also employed is a method in which such as an organic acid or an organic amine is simultaneously utilized to stabilize the particles. More specifically, for example, in the case of titanium dioxide particles, employed can be a well known method described in Journal of Physical Chemistry vol. 100, pp. 468-471 (1996). According to these methods, for example, titanium dioxide having a mean particle diameter of 5 nm can be easily manufactured by utilizing titanium tetraisopropoxide or titanium tetrachloride as a starting material in the presence of an appropriate additive when being hydrolyzed in an appropriate solvent. Further, inorganic particles of this invention are preferably modified on their surface. A method to modify the particle surface is not specifically limited and any commonly known method can be employed. For example, there is a method in which the particle surface is modified by hydrolysis in the presence of water. In this method, catalysts such as acid and alkali are suitably utilized, and it is generally considered that hydroxyl groups on the particle surface and hydroxyl groups having been generated by hydrolysis of a surface modifying agent form bonds by dehydration. Surface modifying agents preferably utilized in this invention include, for example, tetramethoxysilane, tetraehtoxysilane, tetraisopropoxysilane, tetraphenoxysilane, methyltrimethoxysilane, ethyltrimethoxysilane, propyltrimethoxysilane, methyltriethoxysilane, methyltriphenoxysilane, ethyltriethoxysilane, phenyltrimethoxysilane, 3-methylphenyltrimethoxysilane, dimethyldimethoxysilane, diethyldiethoxysilane, diphenyldimethoxysilane, diphenyldiphenoxysilane, trimethylmethoxysilane, triethylethoxysilane, triphenymethoxysilane and triphenylphenoxysilane. These compounds have different characteristics such as a reaction speed, and utilized may be a compound suitable for the conditions of surface modification. Further, one type may be utilized or plural types may be utilized in combination. Since the properties of obtained inorganic particles may differ depending on the utilized compound, affinity for the thermoplastic resin utilized to prepare a material composition can be promoted by selecting the compound being employed for the surface modification. The degree of surface modification is not specifically limited, and preferably 10-99 weight % and more preferably 30-98 weight % based on micro-particles after surface modification.

Such a minute structure as a phase structure can be formed on the surface of glass, with the minimum geometric error, according to the method of repeating the photolithographic process and etching processes. However, a method of forming a phase structure on the surface of the glass according to the molding process using a mold (so-called glass molding method) is excellent in productivity and is preferably utilized. As in the structure described in item 6, glass having a glass transition point Tg of 400° C. or less is suited for use in the glass molding method. Use of such a glass of low melting point saves the mold temperature at the time of molding, and extends the service life of the mold, with the result that the production cost is reduced. Further, the glass of low melting point generally has a low viscosity in the molten state, and allows the phase structure to be transferred with the minimum geometric error. Such glass of low melting point includes K-PG325 and K-PG375 manufactured by Sumida Optical Glass Co., Ltd.

In the laminated phase structure, the materials having an Abbe's number meeting the Eqs. (54) and (55) are preferred selected as the first and second materials. This selection ensures compatibility between the spherical aberration correcting effect and transmittance for the blue-violet laser beam (first light flux) and infrared laser beam (third light flux).

The laminated phase structure, wherein the Abbe's number (dispersion) meets the Eq. (51) or (54) and (55) effectively controls the phase of the light flux whose wavelength ratio is close to integer times, as described in item 8. This structure is especially effective for the blue-violet wavelength (in the vicinity of 405 nm) as a recording/reproducing wavelength using a high-density optical disc, and the infrared wavelength (in the vicinity of 785 nm) as a recording/reproducing wavelength using a CD.

The step of the phase structure formed on the boundary surface between two materials is deeper as the difference in refractive index is smaller. The fluctuation in the transmittance of the phase structure caused by temperature variation becomes more conspicuous. Resin is most suited for use in the optical material used in the diffraction optical device of the present invention. Since there are less varieties of resin than those of glass, resin cannot provide a sufficient difference in the refractive index and the step tends to be deeper. Even in the laminated phase structure where the step is deeper, the diffraction optical device of the present invention meets the Eq. (52), with the result that the fluctuation in the transmittance caused by temperature variation is reduced.

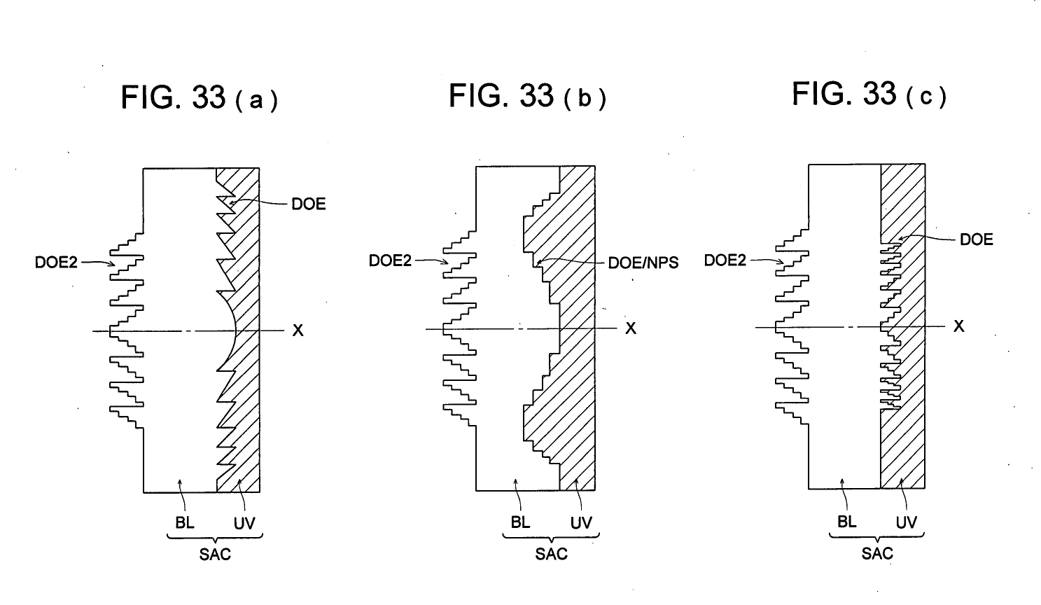

In the present invention, the laminated phase structure can be a diffractive structure or an optical path difference providing structure. However, to ensure optimum design characteristics, the use of the diffractive structure is preferred. The specific structure of the laminated phase structure includes a serrated cross section (diffractive structure DOE) shown in FIG. 33(a), a stepped cross section (diffractive structure DOE or optical path difference providing structure NPS) shown in FIG. 33(b), or a multi-level cross section (diffractive structure DOE) shown in FIG. 33(c).

Further, to get a spherical optical device of excellent performance for three types of light fluxes having different wavelengths, a second phase structure is preferred provided on the optical surface other than the boundary surface, as shown in item 124.

As described in item 125, the first optical element according to the present invention can use the objective lens to condense light on the information recording surface of the first through third optical information recording media.

Alternatively, as described in item 126, if an objective optical system is provided with the first optical surface of the present invention and the objective lens for condensing the light having passed through the first optical element, on the information recording surface of the optical information recording medium, the present invention provides an objective lens that ensures compatibility among at least three types of optical information recording media.

In this case, if the protective layers of these three types of optical information recording media have different thicknesses, the first optical element is provided with a function of correcting the spherical aberration caused by the difference between the t1 and t3, and the spherical aberration caused by the difference in the t1 and t2. This structure provides an objective optical system characterized by compatibility among optical information recording media.

Moreover, when the thickness of the protective layer of the first optical information recording medium and the second optical information recording medium is the same, by providing a function for correcting the spherical aberration caused by the difference of thicknesses t1 and t3 and the spherical aberration caused by difference of the first wavelength λ1 and the second wavelength λ2, the objective optical system which has compatibility to each optical information recording medium can be provided.

In the structure of item 126, it is preferable that the aspherical shape of an objective lens is determined so that the spherical aberration correction becomes minimum value to the first wavelength λ1 and the thickness t1 of the protective layer of the first optical information recording medium. It becomes easy to provide the condensing performance of the 1st light flux as which the severest wavefront accuracy is required by determining the aspheric shape of an objective lens so that the spherical aberration correction becomes minimum value to the first wavelength λ1 and the thickness t1 of the protective layer of the first optical disc.

In this case, “the objective lens is optimized about a spherical aberration correction for a combination of the thickness t1 and the wavelength λ1” means that the aberration of the front wave is 0.05 λ1 RMS or less when the first light flux is condensed through the objective lens and the protective layer of the first optical information medium.

In the structure described in item 126, the first optical element and objective lens are preferably held so that the mutually relative positional relationship is maintained invariable, because this structure reduces the amount of aberration occurring at the time of focusing or tracking, or provides tracking characteristics.

To put it more specifically, in order to hold the first optical element and objective lens so that the mutually relative positional relationship is maintained invariable, it is preferred to use the method of integrating the first optical element and objective lens into one piece through a lens frame, or the method of using the flanges of each of the first optical element and objective lens to fit and fix them in position.

The structure described in item 136 is the objective optical system of item 1, further comprising a second phase structure arranged on a boundary between the first part and air, wherein the objective optical system satisfies following expressions:
20≦νdA<40
40≦νdB≦70
where νdA is an Abbe constant of the material A for d-line and
νdB is an Abbe constant of the material B for d-line.

When the objective optical system is configured as described in item 134, the light flux of wavelength λ1 whose wavelength ratio is 1 to 2 (e.g. blue-violet laser beam having a wavelength of λ1 of about 407 nm) and the light flux of wavelength λ3 (e.g. infrared laser beam having a wavelength λ3 of about 785 nm) can be emitted at mutually different angles using the first phase structure, with a high degree of diffraction efficiency maintained for both wavelengths. For example, this structure ensures compatibility between the correction of spherical aberration and a high degree of transmittance.

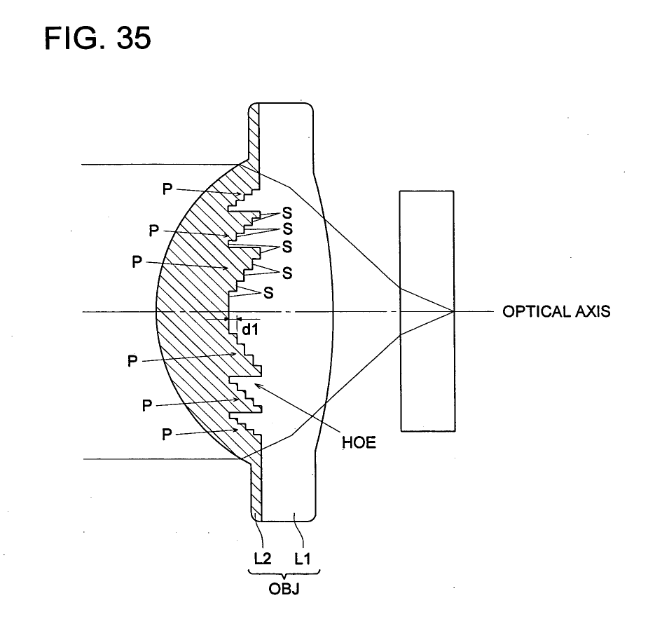

The diffractive structure HOE as an example of the phase structure (FIG. 35) includes the concentric structure of the pattern having a stepped cross section including the optical axis on the boundary surface between the materials A and B. Each pattern includes a plurality of steps (five steps in FIG. 35).

When such an objective lens has been formed, the ratio of the difference in the refractive index between the materials A and B (n_{D407}−1)/(n_{D785}−1) is sufficiently removed from “1” due to different dispersion, as compared with the wavelength ration of the incoming light flux (407:785≈1:2). Accordingly, the left-hand member of Eq. (3) is different from that of Eq. (4). Thus, a desired difference in diffraction angle can be provided for the light of wavelengths λ1 and λ3 by use of ½ of the natural number N2, hence by free selection of a combination of dispersion as the value N3 to be multiplied by 785, a value on the right-hand member of Eq. (4).

The same advantages can be obtained by utilizing a material characterized by anomalous dispersion, instead of a high molecular material.

For example, even when the objective optical system is formed of high molecular materials alone, spherical aberration is caused in response to a change in the oscillation wavelength resulting from the individual difference of the laser as a light source. However, the single lens of the present invention is based on a combination between the low- and high-dispersion materials, and the phase structure is formed on the surface of the high molecular material. This structure reduces the amount of the spherical aberration despite a change in the oscillation wavelength resulting from the individual difference of the laser. Furthermore, for the first and third information recording medium as well as for the DVD as a second information recording medium (to be described later), this objective optical system can be used as a triple-compatible objective optical system.

Even when resin has been selected as well as when glass has been chosen as a low-dispersion material, the objective optical system according to the present invention is formed of a lamination of at least two layers having different Abbe's numbers. Accordingly, this system has a greater number of the boundary surfaces (refraction surfaces) than a single lens composed of one type of optical material. The spherical aberration at the time of temperature variation, for example, can be corrected by providing these boundary surfaces with diffractive structures.

The following describes the laminated lens manufacturing method: When an ultraviolet curing resin is used as the high-dispersion material, it can be easily manufactured by pouring resin directly poured onto a low-dispersion material or by applying light when a lens composed of molded low-dispersion material is pressed onto the resin in the liquid state. When resin is used as the low-dispersion material, a diffractive structure can be provided on the boundary surface between the low- and high-dispersion materials.

The structure described in item 137 is the objective optical system of item 136, wherein at least one of the first phase structure and the second phase structure is a diffractive structure.

The structure described in item 138 is the objective optical system of item 137, wherein the diffractive structure has a structure including a plurality of patterns arranged concentrically, and a shape of a cross section including an optical axis of each of the plurality of patterns has a stepped shape.

The structure described in item 138 provides the so-called wavelength selectivity that diffracts only the light flux of wavelength λ3, not the light flux of wavelength λ1 entering the diffractive structure.

Further, this structure allows the light of wavelength λ1 to pass through and hence mitigates the reduction in the amount of light resulting from the shading effect of diffraction. It is possible to set the direction of light diffraction quite independently for to the wavelengths λ1 and λ3, by applying the process of diffraction only to the light of wavelength λ3.

The structure described in item 139 is the objective optical system of item 137, wherein the diffractive structure has a structure including a plurality of ring-shaped zones arranged concentrically around an optical axis, and a cross section including an optical axis of the diffractive structure is a serrated shape.

The structure described in item 140 is the objective optical system of item 137, wherein the diffractive structure corrects a chromatic aberration for the first light flux.

According to the structure described in item 140, the light of both the wavelengths λ1 and λ3 is diffracted. This makes it possible to apply diffraction effect to both light fluxes and for example, to correct the spherical aberration for compatibility with respect to the light of wavelength λ3 with applying the chromatic aberration correction action with respect to the light of wavelength λ1. It is difficult to be achieved by the aforementioned selective diffractive structure. Further, when the step of the diffractive structure is designed to be oriented always in the same direction with reference to the optical axis, the processability of the diffractive structure can be improved.

The structure described in item 141 is the objective optical system of item 136, wherein the objective optical system consists of the first optical element and a volume ratio of the first part in a total system of the objective optical system is 20% or below.

Many of the high-dispersion materials are birefringent. According to the structure described in item 139, even when such a material is used, the influence of birefringence can be reduced by lowering the volume ratio with respect to the whole.

The structure described in item 142 is the objective optical system of item 136, wherein the objective optical system consists of the first optical element and the first part is arranged at a closest position to the first—third light sources in the objective optical system.

According to the structure described in item 140, when the lens made up of the material, equipped with a phase structure, having an Abbe's number vd of 20≦νd<40, is arranged closest to the aforementioned light source, it becomes possible to design an objective optical system with a reduced curvature on the optical surface of the light source side. It is possible to mitigate the drop in the amount of light resulting from the shading effect with respect to the light of wavelength λ1. This is because of a small angle with respect to the optical axis in the light incoming direction on the optical surface on the side of the light source, rather than on the side of the optical information recording medium.

The structure described in item 143 is the objective optical system of item 136, wherein at least one of the boundary where the first phase structure arranged and the boundary where the second phase structure arranged forms a plane surface without a refractive power for a passing light flux.

According to the structure described in item 141, in the phase structure characterized by a high efficiency with respect to the light of wavelength λ1, all the optical surfaces of each strap are perpendicular to the optical axis (i.e. at the same angle with respect to the optical axis), whereby processability is improved.

The structure described in item 144 is the objective optical system of item 136, satisfying
1.8×t1≦t3≦2.2×t1.

The structure described in item 145. The objective optical system of item 136, wherein the first phase structure is arranged in a region where a light flux portion used for reproducing and/or reproducing information on the third optical information recording medium of the third light flux.

According to the structure described in item 143, no phase structure is formed on an unwanted area, and there is no unwanted reduction in the amount of light. For the light of wavelength λ3, the phase structure has a different shape between the area required for recording and reproducing and on other areas, whereby an aperture restricting function is provided.

The structure described in item 146 is the objective optical system of item 136, wherein the optical pickup apparatus further reproduces and/or records information on an information recording surface of a second optical information medium having a protective substrate with a thickness t2 (0.9×t1≦t2≦t3) using a second light flux with a second wavelength λ2 (λ1<λ2<λ3) emitted from a second light source.

The structure described in item 147 is the objective optical system of item 146, wherein at least one of the first phase structure and the second phase structure corrects a chromatic spherical aberration caused by a wavelength difference between the first light flux and the second light flux.

According to structure described in an item 147, by correcting only the spherical aberration produced by a wavelength difference, the compatibility between the optical information recording media in which only using wavelengths are different from each other, as HD DVD and DVD, can be attained.

The structure described in item 148 is the objective optical system of item 146, satisfies
− 1/12≦m2≦ 1/12
− 1/10≦m3≦ 1/10
where m2 and m3 are magnifications of the objective optical system for the second light flux and the third light flux respectively.

The structure described in item 149 is the objective optical system of item 136, further comprising a diffractive structure arranged in a boundary between the second part and air, and including a plurality of ring-shaped zones arranged concentrically around an optical axis, and a cross section including an optical axis of the diffractive structure is a serrated shape.

According to the structure described in item 149, this diffractive structure applies the process of diffraction also to the light of wavelength λ1 having passed through the phase structure. Further, three beams of light having wavelengths λ1, λ2 and λ3 enter this diffractive structure. If diffraction efficiency is high for the light of wavelengths λ1 and λ2, then diffraction efficiency is also high for the light of wavelength λ3. Accordingly, when the lens is designed, it is sufficient only if consideration is given only to the diffraction efficiency for the light of wavelengths λ1 and λ2.

The structure described in item 150 is the objective optical system of item 136, wherein the first phase structure corrects a spherical aberration caused by a difference between the thickness t1 and the thickness t3.

The structure described in item 151 is the objective optical system of item 136, satisfies the following expressions:
α×λ1=λ3
K1−0.1≦α≦K1+0.1
where K1 is a natural number.

The structure described in item 152 is the optical pickup apparatus for reproducing and/or recording information, comprising: a first light source for emitting a first light flux with a first wavelength λ1; a third light source for emitting a third light flux with a third wavelength λ3 (λ1<λ3); and the objective optical system of item 136,
wherein the optical pickup apparatus reproduces and/or records information on an information recording surface of a first optical information medium having a protective substrate with a thickness t1 using the first light flux, and reproduces and/or records information on an information recording surface of a third optical information medium having a protective substrate with a thickness t3 (t3>t1) using the third light flux.

The structure described in item 153 is the optical disc drive apparatus, comprising: the optical pickup apparatus of item 152; and a moving unit for moving the optical pickup apparatus in a radius direction of each of the first to third optical information recording media.

### EXAMPLES

The following provides a detailed description of the best form of embodying the present invention.

### Embodiment 1

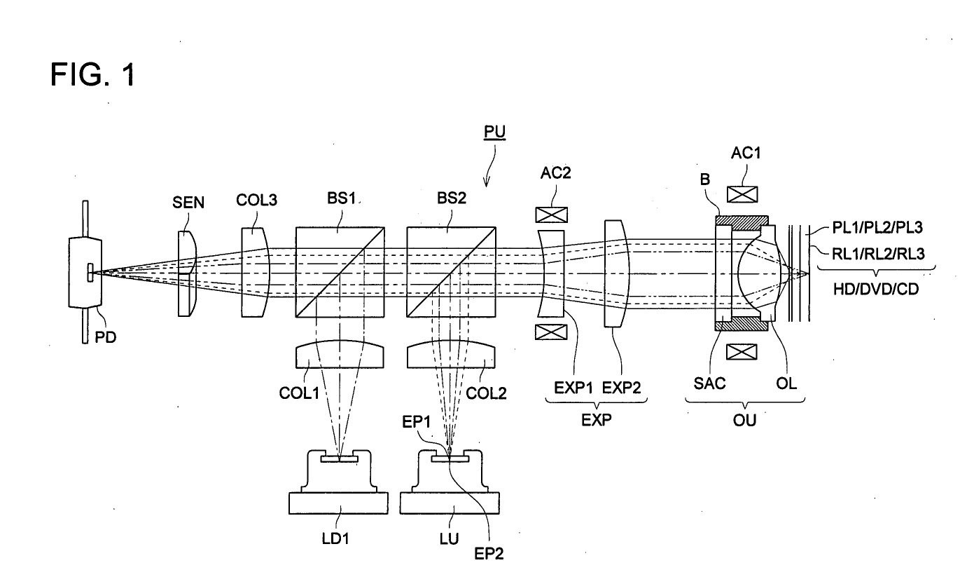

Referring to the drawings, the following describes the first embodiment of the present invention. An optical pickup apparatus PU using an objective lens unit (the objective optical system) OU as an embodiment of the present invention will be described first, with reference to FIG. 1.

FIG. 1 is a schematic view of the structure of the optical pickup apparatus PU capable of appropriate recording/reproducing of information using any of a high-density optical disc HD, DVD and CD. In terms of optical specifications, the high-density optical disc HD has the first wavelength λ1 of 405 nm, the protective layer PL1 having a thickness t1 of 0.1 mm, and the numerical aperture of NA1 of 0.85. The DVD has the second wavelength λ2 of 655 nm, the protective layer PL2 having a thickness t2 of 0.6 mm, and the numerical aperture NA2 of 0.65. The CD has the third wavelength λ3 of 785 nm, the protective layer PL3 having a thickness t3 of 1.2 mm, and the numerical aperture NA3 of 0.50. However, the wavelength, thickness of the protective layer and numerical aperture in the present invention are not restricted thereto.

Herein, the optical pickup apparatus PU has a quarter wavelength plate RE in an optical path between the expander lenses EXP and the objective lens unit OU, but the quarter wavelength plate RE is omitted in the FIG. 1.

The optical pickup apparatus PU comprises:
a blue-violet semiconductor laser LD1, activated when information is recorded and/or reproduced using a high-density optical disc HD, for emitting a blue-violet laser light flux (first light flux) having a wavelength of 405 nm;
a DVD/CD laser light source unit LU having a chip that contains:
   a first emission point EP1, activated when information is recorded and/or reproduced using a DVD, for emitting a red laser light flux (second light flux) having a wavelength of 655 nm; and
   a second emission point EP2, activated when information is recorded and/or reproduced using a CD, for emitting an infrared laser light flux (third light flux) having a wavelength of 785 nm;
a light detector P_{D} to be used commonly for HD, DVD and CD, an objective lens unit OU (objective optical system) further containing:
   an aberration correcting element SAC; and
   an objective lens OL, with both aspherical surfaces, having a function of condensing the laser light flux having passed through this aberration correcting element SAC, onto the information recording surfaces RL1, RL2 and RL3;
a biaxial actuator AC1;
a uniaxial actuator AC2;
an expander lens EXP further containing:
   a first lens EXP having a negative refracting power in paraxial terms; and
   a second lens EXP having a positive refracting power in paraxial terms;
a polarized beam splitter BS1 and a second polarized beam splitter BS2;
a first collimating lens COL1, a second collimating lens COL2 and a third collimating lens COL3; and
a sensor lens SEN for adding astigmatism to the light flux reflected from-the information recording surfaces RL1, RL2 and RL3.

In addition to the above-mentioned blue-violet semiconductor laser LD1, a SHG laser can be used as the light source for the high-density optical disc HD.

For recording/reproducing of information using the HD in an optical pickup apparatus PU, the blue-violet semiconductor laser LD1 is activated to emit light, as the optical path is indicated by a solid line in FIG. 1. The divergent light flux coming from the blue-violet semiconductor laser LD1 is converted into a parallel light flux by the first collimating lens COL1, and is then reflected by the first polarized beam splitter BS1. After passing through the second polarized beam splitter BS2, the light flux goes through the first expander lens EXP1 and second lens EXP2, whereby the diameter of the light flux is increased. Then with its diameter restricted by an aperture STO (not illustrated) and, the light flux is turned into a spot formed on the information recording surface RL1 through the protective layer PL1 of the HD by the objective lens unit OU. The objective lens unit OU allows focusing and tracking to be performed by the biaxial actuator AC1 arranged in its periphery.

The reflected light flux modulated by an information pit on the information recording surface RL1 again passes through the objective lens unit OU, second lens EXP2, first expander lens EXP1, second polarized beam splitter BS2 and first polarized beam splitter BS1. Then the light flux passes through the third collimating lens COL3, when it is turned into a convergent light flux. Astigmatism is applied to this light by the sensor lens SEN, and the light converges on the light receiving surface of the light detector P_{D}. Then the output signal of the light detector P_{D} can be utilized to scan the information recorded on the HD.

For recording/reproducing of information using the DVD in an optical pickup apparatus PU, the emission point EP1 is activated to emit light, as the optical path is indicated by a broken line in FIG. 1. The divergent light flux coming from the emission point EP1 is converted into a parallel light flux by the second collimating lens COL2, and is then reflected by the second polarized beam splitter BS2. The light flux goes through the first expander lens EXPL and second lens EXP2, whereby the diameter of the light flux is increased. Then the light flux is turned into a spot formed on the information recording surface RL2 through the protective layer PL2 of the DVD by the objective lens unit OU. The objective lens unit OU allows focusing and tracking to be performed by the biaxial actuator AC1 arranged in its periphery.

The reflected light flux modulated by the information pit on information recording surface RL2 again passes through the objective lens unit OU, second lens EXP2, first lens EXPL, second polarized beam splitter BS2 and first polarized beam splitter BS1. Then the light flux passes through the third collimating lens COL3, when it is turned into a convergent light flux. Astigmatism is applied to this light by the sensor lens SEN, and the light converges on the light receiving surface of the light detector PD. Then the output signal of the light detector PD can be utilized to scan the information recorded on the DVD.

For recording/reproducing of information using the CD in an optical pickup apparatus PU, the first lens EXP1 has been driven in the optical axial direction by the uniaxial actuator AC2 so that the gap between the first lens EXP1 and second lens EXP2 is smaller than that for recording/reproducing of information using the HD. After that, the emission point EP2 is activated to emit light. As the optical path is indicated by a one-dot chain line in FIG. 1, the divergent light flux coming from the emission point EP2 is converted into a gradual light flux by the second collimating lens COL2, and is then reflected by the second polarized beam splitter BS2. The light flux goes through the first lens EXP1 and second lens EXP2, whereby the diameter of the light flux is increased, and the light flux is converted into divergent light. Then it is turned into a spot formed on the information recording surface RL3 through the protective layer PL3 of the CD by the objective lens unit OU. The objective lens unit OU allows focusing and tracking to be performed by the biaxial actuator AC1 arranged in its periphery.

The reflected light flux modulated by the information pit on information recording surface RL2 again passes through the objective lens unit OU, second lens EXP2, first lens EXP1, second polarized beam splitter BS2 and first polarized beam splitter BS1. Then the light flux passes through the third collimating lens COL3, when it is turned into a convergent light flux. Astigmatism is applied to this light by the sensor lens SEN, and the light converges on the light receiving surface of the light detector PD. Then the output signal of the light detector PD can be utilized to scan the information recorded on the DVD.

As schematically shown in FIG. 2, the objective lens unit (the objective optical system) OU of the present embodiment is structured so that the aberration correcting element (the first optical element) SAC is integrated coaxially with the objective lens OL through the lens frame B, wherein the aspherical shape of the objective lens OL is designed in such a way that spherical aberration is minimized with respect to the first wavelength λ1 and the thickness t1 of the HD protective layer (it is also said as “the protective substrate” in the present specification) PL1. To put it more specifically, the aberration correcting element SAC is fitted into one end of the cylindrical lens frame B and is fixed therein. The objective lens OL is fitted into the other end and is fixed therein. They are integrated into one structure along the optical axis X.

The following describes the structure of the aberration correcting element (the first optical element) SAC and the principle of aberration correction: As shown in FIG. 2, the aberration correcting element SAC is provided with a base lens BL (the first part) as a glass lens and a resin layer (the second part) UV as a ultraviolet curing resin laminated on the surface of the base lens BL. A diffractive structure (the first phase structure) DOE1 having a strap-formed step is formed on the boundary between the base lens BL and resin layer UV.

The diffraction efficiency η(λ) of the diffractive structure DOE1 formed on the boundary between the base lens BL and resin layer UV having different Abbe's numbers (dispersion) is generally expressed by the following equation (61) as a function of:
the wavelength λ1,
the difference Δn(λ) of refractive index between the base lens BL and resin layer UV at this wavelength λ1,
the level differenced of the diffractive structure DOE1, and
the order of diffraction M(λ):
   η(λ)=sin c²[[d·Δn(λ)/λ]−M(λ)] (61)
where sin c (X)=sin (πX)/(πX), and the value of η(λ) is closer to 1 as the value in the square bracket ([ ]) is closer to an integer.

Assume that the difference of the refractive index at the first wavelength λ1 used for the HD is Δn1; the order of diffraction of the diffracted light flux of the first light flux is M1; the difference of the refractive index at the second wavelength λ2 used for the DVD is Δn2; the order of diffraction of the diffracted light flux of the second light flux is M2; the difference of the refractive index at the third wavelength λ3 used for the CD is Δn3; and the order of diffraction of the diffracted light flux of the third light flux is M3. Then the diffraction efficiencies η(λ1), η(λ2), and η(λ3) at each wavelength are expressed by the following equations (62) through (64):
η(λ1)=sin c²[[d·Δn1/λ1]−M1] (62)
η(λ2)=sin c²[[d·Δn2/λ2]−M2] (63)
η(λ3)=sin c²[[d·Δn3/λ3]−M3] (64)

To ensure high diffraction efficiency in each wavelength, it is necessary to select the base lens BL having the difference in refractive index Δni (where “i” denotes 1, 2 or 3) (viz., having the Abbe's number Δνd), resin layer UV, level difference d, and order of diffraction Mi (where “i” denotes 1, 2 or 3) in such a way that the values in the square brackets in Equations (62) through (64) will be close to an integer.

The base curve BC as a macroscopic curvature of the diffractive structure DOE1 is structured in an aspherical structure. As described above, the difference Δνd between the Abbe's number on d-line of the base lens BL and the Abbe's number on d-line of the resin layer UV meets the aforementioned equation (11). The difference Δn1 between the refractive index at the first wavelength λ1 of the base lens BL and the refractive index at the first wavelength λ1 of the resin layer UV satisfies the equation (12). Both the spherical aberration due to the difference in the thickness of the protective layer of the HD and DVD, and the spherical aberration due to the difference in the thickness of the protective layer of the HD and CD are corrected by the surface where the diffractive structure DOE1 of the base lens BL is formed (hereinafter referred to as “first diffractive surface”).

To put it more specifically, the first diffractive surface has a negative paraxial diffraction power (action of diverging light flux). The first, second and third light fluxes passing through this first diffractive surface are all subjected to diffraction (divergence).

Further, the boundary and the optical surface of the resin layer UV on the side opposite to the boundary have positive paraxial diffraction power (action of converging light flux).

The first light flux incident on the aberration correcting element SAC as parallel light flux is subjected to divergence by the first diffraction. At the same time, it is subjected to convergence by the refraction of the optical surface of the resin layer UV on the side opposite to the boundary, whereby the light travels in a straight line without being bent. To put it another way, the aforementioned equations are satisfied.

The second light flux incident on the aberration correcting element SAC as parallel light flux is subjected to divergence by the first diffraction. At the same time, it is subjected to convergence by the refraction. Since the diffraction power increases in proportion to the wavelength, the paraxial diffraction power and paraxial refracting power cancels each other, and the first light flux travels in a straight line, as described above. In the second light flux having a greater wavelength, the paraxial diffraction power is greater than the paraxial refracting power, so the second light flux is turned into the divergent light flux, which is emitted from the aberration correcting element SAC. This structure corrects the spherical aberration resulting from the difference in the thickness of the protective surfaces between the HD and DVD.

Further, the third light flux as a gradual divergent light flux incident on the aberration correcting element SAC is subjected to divergence on the first diffractive surface. For the same reason as that of the second light flux, the third light flux is changed into the divergent light flux, which is emitted from the aberration correcting element SAC. The degree of divergence of the third light flux in this case is greater than that of the second light flux. This is because the paraxial diffraction power for the third light flux is greater than the paraxial diffraction power for the second light flux, and because the third light flux for the aberration correcting element SAC is applied as a gradual divergent light flux. This procedure corrects the spherical aberration resulting from the difference in the thickness of the protective surface between the HD and CD.

As described above, the resin layer UV is laminated on the base lens BL having the difference in Abbe's number meeting the equation (11), and a diffractive structure DOE1 is formed on the boundary. This structure ensures good compatibility of the spherical aberration correction effect with transmittance between the blue-violet laser light flux (first light flux) and infrared laser light flux (second light flux), wherein this compatibility could not been achieved by the prior art. Further, when the base lens BL and resin layer UV has the difference in refractive index meeting the equation (12) in the first wavelength λ1, the level difference of straps along the optical axis can be reduced. This structure ensures easy production of the diffractive structure DOE1. In the diffractive structure having a flat base curve BC, it is difficult to achieve compatibility between the correction of spherical aberration and correction of the sinusoidal conditions. The base curve BC formed in an aspherical or spherical shape achieves the compatibility between the correction of spherical aberration and correction of sinusoidal conditions of the aberration correcting element SAC with respect to the first light flux. This will also improve design performances with respect to the first light flux.

In the aberration correcting element SAC of the present embodiment, the substance for satisfying
|Δνd|=34.3,
|Δn1|=0.0496,
|Δn2|/|Δn1|=1.44,
|Δn3|/|Δn1|=1.50,
|Δn3|/|Δn2|=1.05
is selected as the material for the base lens BL and-resin layer UV, and the step d of the diffractive structure DOE1is set to 9.14 μm. Accordingly, first-order diffracted light flux occurs to the light flux having any wavelength (M1=M2 =M3). The diffraction efficiency of first-order diffracted light flux is 95.3% for the first light flux, 100% for the second light flux and 94.4% for the third light flux. This structure ensures high diffraction efficiency for the light flux having any wavelength.

In the present embodiment, the aberration correcting element SAC and objective lens OL are integrated into one structure through the lens frame B. When the aberration correcting element SAC and objective lens OL are integrated into one structure, it is sufficient only if the positional relationship between the aberration correcting element SAC and objective lens OL is kept constant. In addition to the aforementioned method of using the lens frame B as an intermediary, it is also possible to utilize the method of fitting the flange of the aberration correcting element SAC with that of the objective lens OL.

When the positional relationship between the aberration correcting element SAC and objective lens OL is kept constant as described above, it is possible to minimize aberration produced at the time of focusing and tracking.

Further, the spherical aberration of the spot formed on the information recording surface RL1 of the HD can be corrected by moving the first lens EXP1 of the expander lens EXP in the optical axial direction by the uniaxial actuator AC2. The causes for the occurrence of the spherical aberration to be corrected by adjusting the position of the first lens EXP1 includes variations of the wavelength resulting from the production error of the blue-violet semiconductor laser LD1, changes in refractive index of the objective optical sustem due to temperature change, distribution of refractive index, a focus jump between the image receiving layers in a multilayer disc such as a double-layer or triple-layer disc, and variations of the thickness or distribution of thickness resulting from the production error of the protective layer of the HD. Instead of the first lens EXP1, it is possible to use the structure wherein the second lens EXP2 or the first collimating lens COL1 is driven in the optical axial direction. This method also corrects the spherical aberration of the spot formed on the information recording surface RL1 of the HD.

In the aforementioned description, the spherical aberration of the spot formed on the information recording surface RL2 of the DVD by driving the first lens EXP1 in the optical axial direction. It is also possible to adopt a structure capable of correcting the spherical aberration of the spot formed on the information recording surface RL2 of the DVD, as well as the spherical aberration of the spot formed on the information recording surface RL3 of the CD.

The present embodiment uses the DVD/CD laser light source unit LU having a chip containing both the first emitting section EP1 and-second emitting section EP2. Without being restricted to this structure, it is also possible to employ the one-chip laser light source unit for HD, DVD and CD, wherein the emission point for emitting a laser light flux having a wavelength of 405 nm is also mounted on one and the same chip. Alternatively, it is possible to use the one-can laser light source unit for HD, DVD and CD, wherein three light sources of blue-violet semiconductor laser, red semiconductor laser and infrared semiconductor laser are incorporated in one enclosure.

In the present embodiment, the light source and light detector PD are arranged separately from each other. Without being restricted to such a structure, it is possible to use a laser light source module packing both the light source and light detector.

Further, by mounting the optical pickup apparatus PU shown in the aforementioned embodiment (not illustrated), a rotary drive apparatus for rotatably holding an optical disc and a control apparatus for controlling the drive of these apparatuses, it is possible to provide an optical disc drive apparatus capable of carrying out at least one of the functions of recording of information on an optical disc and reproducing of information from the optical disc.

Further, the present embodiment uses an aperture restricting filter (not illustrated) to restrict the. apertures corresponding to the numerical aperture NA2 and numerical aperture NA3.

### Embodiment 2

Referring to the drawing, the following describes the second embodiment of the present invention. The same structures as those of the aforementioned first embodiment will not be described to avoid duplication.

In the present embodiment, the base lens BL is made of resin, and a resin layer UV as an ultraviolet curing resin is laminated on the surface of this base lens BL.

In the present embodiment, the objective lens unit OU is characterized by addition of a phase structure different from that of the diffractive structure DOE1.

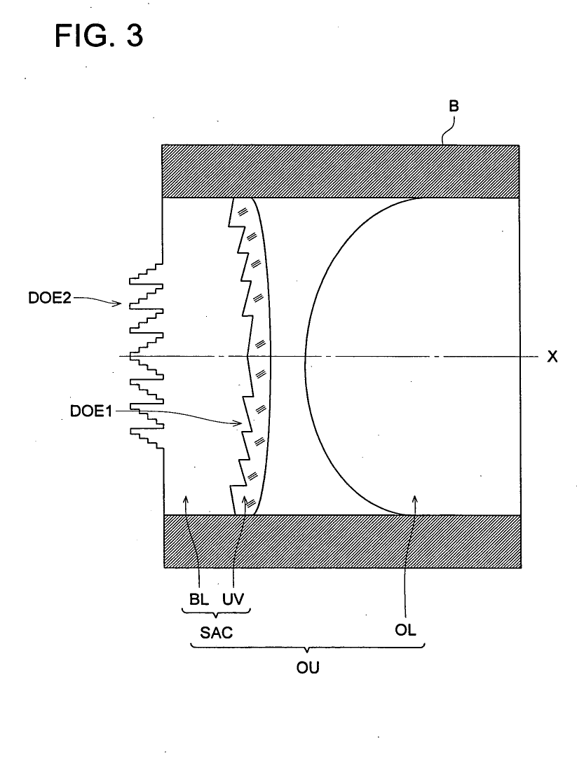

To put it more specifically, the objective lens unit OU in the present embodiment is characterized in that the aberration correcting element SAC is formed coaxially into one structure integrally with the objective lens OL whose aspherical structure is designed in such a way that spherical aberration will be minimized with respect to the first wavelength λ1 and the thickness t1 of the HD protective layer PL1, through the lens frame B, as shown schematically in FIG. 3.

The aberration correcting element (the first optical element) SAC is structured by the base lens (the first part) BL and the resin layer (the second part) UV laminated on the surface of this base lens BL. A diffractive structure (the first phase structure) DOE1 having a ring-shaped step is formed on the boundary surface between the base lens BL and resin layer UV. A diffractive structure (the second phase structure) DOE2 as a phase structure is formed on the optical surface of the base lens BL located on the side opposite to the boundary.

The spherical aberration due to the difference in the thickness of the protective layer of the HD and CD is corrected by the first diffractive surface. The spherical aberration due to the difference in the thickness of the protective layer of the HD and DVD is corrected by the surface where the diffractive structure DOE2 of the base lens BL is formed (hereinafter referred to as “second diffractive surface”).

To put it more specifically, the first diffractive surface has a negative-paraxial diffraction power (action of diverging light flux). The first, second and third light fluxes-passing through this first diffractive surface are all subjected to diffraction (divergence) (first diffraction).

Further, the second diffractive surface has a positive paraxial diffraction power (action of converging light flux). Only the second light flux passing through this second diffractive surface is subjected to diffraction (first diffraction).

The following describes the principle of generating the diffracted light flux in the diffractive structure DOE2. The diffractive structure DOE2 diffracts only the second light flux, not the first or third light flux. In the diffractive structure DOE2, the cross section including the optical axis is structured in such a way that the step-formed patterns are arranged concentrically. For each of the predetermined number of levels (5 surfaces in FIG. 3), the step is shifted by the height amounting to the number of steps (4 steps in FIG. 3), which corresponds to the number of the levels. Here step A in the stair structure is set to a height satisfying the following equation: Δ=2·λ1/(n1_{BL}−1)≈1.2·λ2/(n2_{BL}−1)≈1·λ3/(n3_{BL}−1). Here “n1_{BL}” denotes the refractive index of the base lens BL in the first wavelength λ1, and “n2_{BL}” indicates the refractive index of the base lens BL in the second wavelength λ2, and “n3_{BL}” represents the refractive index of the base lens BL in the wavelength λ3.

The difference in the optical path resulting from the step Δ is twice the first wavelength λ1 and once the third wavelength λ3. Accordingly, the first and third light fluxes pass through directly, without being affected at all.

In the meantime, the difference in the optical path resulting from this step Δ is 1.2 times the second wavelength λ2. Accordingly, the second light fluxes passing through the level surface before and after the step are out of phase with each other by 2π/5. Since one sawtooth is divided into five portions, the phase shift of the second light flux is 5×2π/5=2π for one sawtooth. The first-order diffracted light flux will be produced.

Further, the boundary surface and the optical surface of the resin layer UV on the side opposite to the boundary have a positive paraxial diffraction power (action of converging light flux).

The first light flux incident on the aberration correcting element SAC as a parallel light flux passes through the first diffractive surface and is converged by the refraction of the boundary surface and the optical surface of the resin layer UV on the side opposite to the boundary surface, whereby the light travels in a straight line directly without being bent. To put it another way, the aforementioned equations (13) and (14) are satisfied.

Further, the third light flux incident on the aberration correcting element SAC as a parallel light flux passes through the second diffractive surface and is diverged by the first diffractive surface. Thus, the light flux is turned into a divergent light flux, which is emitted from the aberration correcting element SAC. This procedure corrects the spherical aberration resulting from the difference in the thickness of the protective layer between the HD and CD.

Further, the second light flux incident on the aberration correcting element SAC as a parallel light flux is subjected to diffraction by the second diffractive surface, and is converged. Since it is diverged by the first diffractive surface, the light flux is emitted from the aberration correcting element SAC as a divergent light flux.

The degree of divergence of the second light flux in this case is smaller than that of the third light flux. This is because the second light flux is converged once by the second diffractive surface. This procedure corrects the spherical aberration resulting from the difference in the thickness of the protective surface between the HD and DVD.

As described above, a diffractive structure DOE2 as a phase structure is formed on the optical surface of the base lens BL, on the side opposite to the boundary surface, whereby the condensing performance of the objective lens unit OU for each light flux can be improved. This phase structure may be a diffractive structure, or an optical path difference providing structure. Further, the aberration corrected by the phase structure may be the chromatic aberration resulting from microscopic changes in the first wavelength λ1, or may be a spherical aberration caused by changes in the refractive index of the objective lens OL resulting from temperature changes.

The diffractive structure DOE2 is provided a function of selectively diffracting the second light flux, without allowing the aforementioned first and third light fluxes to be diffracted. This structure corrects the spherical aberration caused by the difference between t1 and t2, or the spherical aberration caused by the difference between the first and second wavelength λ1 and λ2. Moreover, the spherical aberration resulting from the difference between t1 and t3 is corrected by the diffractive structure DOE1 formed on the boundary surface. This procedure can correct the spherical aberration of the light flux of each wavelength at the same rate of magnification, while ensuring high diffraction efficiency for the light flux of each wavelength.

In the aberration correcting element SAC of the present embodiment, the substance for satisfying |Δνd|=26.7, |Δn1|=0.0297, |Δn2|/|Δn1|=1.53, |Δn3|/|Δn1|=1.61, |Δn3|/|Δn2|=1.05 is selected as the material for the base lens BL and resin layer UV, and the step of the diffractive structure DOE1 is set to 15.06 μm. Accordingly, first-order diffracted light flux occurs to the light flux having any wavelength (M1=M2=M3=1). The diffraction efficiency of first-order diffracted light flux is 96.5% for the first light flux, 99.3% for the second light flux and 97.8% for the third light flux. This structure ensures high diffraction efficiency for the light flux having any wavelength.

Further, in the diffractive structure DOE2, only the second light flux is selectively diffracted, as described above. The diffraction efficiency of the light flux of each wavelength is 100% for the first light flux (not diffracted light flux), 87.5% for the second light flux (first-order diffracted light flux) and 100% for the third light flux (not diffracted light flux).

### Embodiment 3

Referring to the drawing, the following describes the third embodiment of the present invention. The same structures as those of the aforementioned second embodiment will not be described to avoid duplication.

In the present embodiment as in the second embodiment, the base lens BL is made of resin, and a resin layer UV as an ultraviolet curing resin is laminated on the surface of this base lens BL.

In the present embodiment as in the second embodiment, the objective lens unit (objective optical system) OU is characterized by addition of a phase structure different from that of the diffractive structure DOE1.

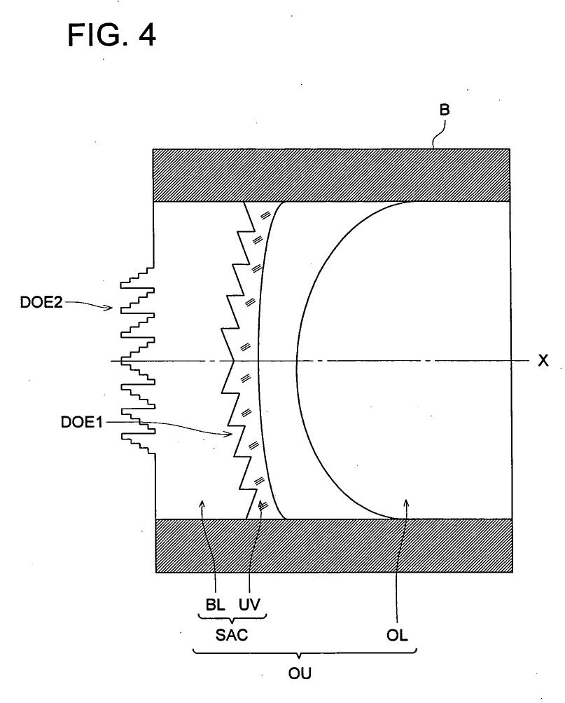

To put it more specifically, the objective lens unit OU in the present embodiment is characterized in that the aberration correcting element SAC is formed coaxially into one structure integrally with the objective lens OL whose aspherical structure is designed in such a way that spherical aberration will be minimized with respect to the first wavelength λ1 and the thickness t1 of the HD protective layer PL1, through the lens frame B, as shown schematically in FIG. 4.

The aberration correcting element SAC is structured by the base lens BL (the first part) and the resin layer (the second part) UV laminated on the surface of this base lens BL. A diffractive structure (the first phase structure) DOE1 having a strap-formed step is formed on the boundary surface between the base lens BL and resin layer UV. A diffractive structure DOE2 (the second phase structure) as a phase structure is formed on the optical surface of the base lens BL located-on the side opposite to the boundary.

The spherical aberration resulting from the difference in the thickness of the protective layer between the HD and CD is corrected by the refraction and divergence of the boundary surface and the optical surface of the resin layer UV on the side opposite to the boundary surface. The spherical aberration resulting from the difference in the thickness of the protective layer between the BD and DVD is corrected by the second diffractive surface.

To put it more specifically, the first diffractive surface has a positive diffraction power (action of converging light flux). Only the first light flux passing through this first diffractive surface is subjected to diffraction (convergence) (first-order diffraction).

Further, the second diffractive surface has a positive diffraction power (action of converging light flux). Only the second light flux passing through this second diffractive surface is subjected to diffraction (first-order diffraction).

The boundary and the optical surface of the resin layer UV on the side opposite to the boundary have a negative refracting power (action of diverging the light flux).

The first light flux incident on the aberration correcting element SAC as a parallel light flux directly passes through the second diffractive surface and is subjected to the convergence by the first diffractive surface. At the same time, it is subjected to divergence by diffraction, whereby the light travels in a straight line without being bent. To put it another way, the equations (13) and (14) are satisfied. The chromatic aberration of the first light flux is corrected by the action of the first diffractive surface.

Further, the third light flux incident on the aberration correcting element SAC as a parallel light flux directly passes through the second and first diffractive surfaces, and is subjected to divergence by the refraction on the boundary and the optical surface of the resin layer UV on the side opposite to the boundary. The third light flux is changed into the divergent light flux, which is emitted from the aberration correcting element SAC. This procedure corrects the spherical aberration resulting from the difference in the thickness of the protective surfaces between the HD and CD.

The second light flux incident on the aberration correcting element SAC as a parallel light flux is subjected to diffraction, hence convergence. Since it is diverged by the refraction on the boundary and the optical surface of the resin layer UV on the side opposite to the boundary, the second light flux is changed into a divergent light flux, which is emitted from the aberration correcting element SAC.

The degree of divergence of the second light flux in this case is smaller than that of the third light flux. This is because the second light flux is converged once by the second diffractive surface. This procedure corrects the spherical aberration resulting from the difference in the thickness of the protective surface between the HD and DVD.

The principle of generating the diffracted light flux in the diffractive structure DOE2 in the present embodiment is the same as that of the diffractive structure DOE2 in the second embodiment. Accordingly, the details will not be described here.

In the aberration correcting element SAC of the present embodiment, the material satisfying the equation |Δνd|=33.7, |Δn1|=0.0458, |Δn2|/|Δn1|=0.271, |Δn3|/|Δn1|=0.167, |Δn3|/|Δn2|=0.617 is selected as the material for the base lens BL and resin layer UV, and the step of the diffractive structure DOE1 is set at d=8.84 μm. Accordingly, the first-order diffracted light flux occurs to the first light flux. The second and third light fluxes directly passes through, without being diffracted. (M1=1, M2=M3=0). The diffraction efficiency of the light flux having each wavelength is 100% for the first light flux (first-order diffraction), 91.2% for the second light flux (not diffracted light flux) and 97.6% for the third light flux (not diffracted light flux). This structure ensures high diffraction efficiency for the light flux having any wavelength.

Further, in the diffractive structure DOE2, only the second light flux is selectively diffracted, as described above. The diffraction efficiency of the light flux of each wavelength is 100% for the first light flux (not diffracted light flux), 87.5% for the second light flux (first-order diffracted light flux) and 100% for the third light flux (not diffracted light flux). This structure ensures high diffraction efficiency for the light flux having any wavelength.

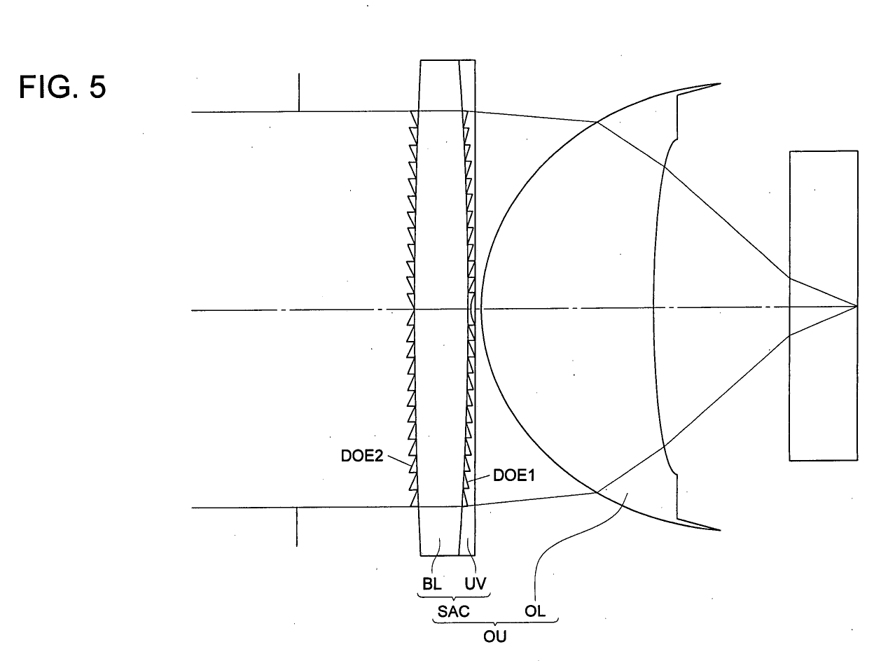

In the present embodiment, a diffractive structure DOE2 as a phase structure is formed on the optical surface of the base lens BL on the side opposite to the boundary, namely, on the boundary between the material having a greater Abbe's number in d-line and air. This arrangement improves the diffraction efficiency of the wavelengths λ1, λ2 and λ3 of the first, second and third light fluxes, respectively. In the present embodiment, the aforementioned description has referred to the case where the diffractive structure DOE2 is a wavelength selection type diffractive structure. A blazed diffractive structure shown in FIG. 5 can also be utilized.

For example, if the diffractive structure DOE2 is a wavelength selection type diffractive structure, a phase difference can be assigned only to the light flux of a predetermined wavelength, and diffraction can be applied only to the light of the DVD, whereby the remaining DVD spherical aberration can be corrected.

In the meantime, if the diffractive structure DOE2 is a blazed type diffractive structure, the chromatic aberration can be corrected with high efficiency.

The present embodiment has been described with reference to the case wherein the diffractive structure DOE1 is formed on the boundary between the base lens BL and resin layer UV. At the same time, the diffractive structure DOE2 is formed on the boundary between the material having a greater Abbe's number in d-line and air. As shown in FIG. 8, a diffractive structure DOE3 may be formed on the surface of the aforementioned objective lens OL, wherein the objective lens OL located on the disc side meets the Abbe's number νd of 40≦νd≦70.

As described above, the Abbe's number νd on d-line in the objective lens OL arranged on the disc side satisfies the aforementioned equation, and a diffractive structure is formed on the surface of the aforementioned objective lens OL. This arrangement improves the diffraction efficiency of the wavelengths λ1, λ2 and λ3 of the first, second and third light fluxes, respectively.

When diffractive structures DOE1, DOE2 and DOE3 are provided, if the thickness t2 of the protective layer PL2 of the DVD is set so as to meet 0.9×t1≦t2≦1.1×t1, it is only necessary to correct the spherical aberration caused by the wavelength alone being different as in the combination of HD_DVD and DVD. This arrangement allows the diffraction. pitch to be increased and processability to be improved.

### Example 1

The following describes a specific numerical example of the objective lens unit OU provided with the aberration correcting element SAC and objective lens OL shown in FIG. 2. The aberration correcting element SAC is made up of a lamination of the resin layer composed of an ultraviolet curing resin and the base lens composed of a glass lens (BACD5 by HOYA). A diffractive structure DOE1 is formed on the boundary between the base lens and resin layer. The objective lens OL is a glass lens (BACD5 by HOYA) whose aspherical structure is designed in such a way that spherical aberration will be minimized with respect to the first wavelength λ1 and the thickness t1 of the HD protective layer PL1. However, a plastic lens may be used.

Tables 1-1 and 1-2 show the lens data in the present example. In the numerical example, the difference of the optical path added to the incoming light flux by the diffractive structure DOE1 is expressed in terms of optical path difference function.

TABLE 1-1
[Paraxial data]

| Surface | | | | | | | | |
|---|---|---|---|---|---|---|---|---|
| number | r (mm) | d (mm) | n₄₀₅ | n₆₅₅ | n₇₈₅ | n_{d} | νd | Remarks |
| OBJ | | d0 | | | | | | Emission point |
| 1 | ∞ | 1.0000 | 1.60526 | 1.58624 | 1.58239 | 1.58913 | 61.3 | Aberration |
| 2 | −16.98300 | 0.1000 | 1.55560 | 1.51454 | 1.50786 | 1.52000 | 27.0 | correcting |
| 3 | −16.98300 | 0.1000 | | | | | | element |
| 4 | 1.50977 | 2.5900 | 1.60526 | 1.58624 | 1.58239 | 1.58913 | 61.3 | Objective lens |
| 5 | −3.98705 | d4 | | | | | | |
| 6 | ∞ | d5 | 1.62230 | 1.57995 | 1.57326 | 1.58546 | 30.0 | Protective layer |
| 7 | ∞ | | | | | | | |

d0_{HD} = ∞, d0_{DVD} = ∞, d0_{CD} = 150.500, d4_{HD} = 0.7141, d4_{DVD} = 0.5656, d4_{CD} = 0.3001,
d5_{HD} = 0.1000, d5_{DVD} = 0.6000, d5_{CD} = 1.2000

[Aspherical surface coefficients]

| | 2nd surface | 3rd surface | 4th surface | 5th surface |
|---|---|---|---|---|
| κ | 0.00000E+00 | 0.00000E+00 | −0.660911 | −70.33824 |
| A4 | 0.29252E−02 | 0.29252E−02 | 0.79413E−02 | 0.99127E−01 |
| A6 | −0.15836E−02 | −0.15836E−02 | 0.86416E−04 | −0.10873E+00 |
| A8 | 0.68895E−03 | 0.68891E−03 | 0.20333E−02 | 0.80514E−01 |
| A10 | −0.82089E−04 | −0.82195E−04 | −0.12698E−02 | −0.40782E−01 |
| A12 | 0.00000E+00 | 0.00000E+00 | 0.28538E−03 | 0.11632E−01 |
| A14 | 0.00000E+00 | 0.00000E+00 | 0.21720E−03 | −0.13968E−02 |
| A16 | 0.00000E+00 | 0.00000E+00 | −0.16847E−03 | 0.00000E+00 |
| A18 | 0.00000E+00 | 0.00000E+00 | 0.45032E−04 | 0.00000E+00 |
| A20 | 0.00000E+00 | 0.00000E+00 | −0.44433E−05 | 0.00000E+00 |

TABLE 1-2

| | 2nd surface |
|---|---|
| M_{HD}/M_{DVD}/M_{CD} | 1/1/1 |
| λ_{B} | 655 nm |
| B2 | 0.28700E−01 |
| B4 | −0.28144E−02 |
| B6 | 0.15138E−02 |
| B8 | −0.66347E−03 |
| B10 | 0.79213E−04 |

In the following second and third examples as well as in the present embodiment, the high-density optical disc HD has a numerical aperture NA1 of 0.85, the DVD a numerical aperture NA2 of 0.65, and the CD a numerical aperture NA3 of 0.50. Further, in Table 1-1 and 1-2, Tables 2-1 and 2-2, and Tables 3-1 and 3-2 shown later, “r” (mm) denotes a curvature radius, and “d” (mm) a lens distance. The n₄₀₅, n₆₅₅ and n₇₈₅ indicate the refractive indexes of the lenses with reference to the first wavelength λ1 (=405 nm), second wavelength λ2 (=655 nm) and third wavelength λ3 (=785 nm), respectively. “νd” indicates the Abbe's number of the lens of the line d, and M_{HD}, M_{DVD} and M_{CD} represent the order of diffraction of the diffracted light flux employed in recording/reproducing using HD, the order of diffraction of the diffracted light flux employed in recording/reproducing using DVD, and the order of diffraction of the diffracted light flux employed in recording/reproducing using CD, respectively. Further, E (e.g. 2.5E-3) is used to express the power multiplier of 10 (e.g. 2.5×10⁻³).

The boundary surface (second surface) between the base lens and resin layer, the optical surface (third surface) of the resin layer on the optical disc side, the optical surface (fourth surface) of the objective lens OL on the light source side, and the optical surface (fifth surface) on the optical disc side are each configured in an aspherical shape. The aspherical shape can be expressed by the equation obtained by substituting the coefficient of the Table into the following aspherical shape equation:

[Aspherical Shape Equation]
z=(y²/R)/[1+√{1−(K+1)(y/R)²}]+A₄y⁴+A₆y⁶+A₈y⁸+A₁₀y¹⁰+A₁₂y¹²+A₁₄y¹⁴+A₁₆y¹⁶+A₁₈y¹⁸+A₂₀y²⁰
where reference symbols denote the following:
z: an aspherical shape (distance in the direction along the optical axis from the plane contacting the surface apex of the aspherical surface)
y: distance from the optical axis
R: curvature radius
K: Cornic coefficient

A₄, A₆, A₈, A₁₀, A₁₂, A₁₄, A₁₆, A₁₈ and A₂₀: aspherical surface coefficients

Further, the diffractive structure DOES is expressed by the optical path difference added to the in coming light flux by the diffractive structure DOE1. Such an optical path difference is expressed by the optical path function φ (mm) obtained by substituting the coefficient of the Table into the equation showing the following optical path difference function:

[Optical Path Difference Function]
φ=M×λ/λ_{B}×(B₂y²+B₄y⁴+B₆y⁶+B₈y⁸+B₁₀y¹⁰)
where the reference symbols denotes the following:
φ: optical path function
λ: wavelength of the light flux incident on the diffractive structure
λ_{B}: manufacture wavelength
M: order of diffraction of the diffracted light flux employed in recording/reproducing using an optical disc
y: distance from optical axis
B₂, B₄, B₆, B₈ and B₁₀: diffractive surface coefficients

### Example 2

The following describes a specific numerical example of the objective lens unit OU provided with the aberration correcting element SAC and objective lens OL shown in FIG. 3. The aberration correcting element SAC is made up of a lamination of the resin layer composed of an ultraviolet curing resin and the base lens composed of resin. A diffractive structure DOE1 is formed on the boundary between the base lens and resin layer and A diffractive structure DOE 2 which is a phase structure is formed on the light-source side of the optical surface of the base lens. The objective lens OL is a glass lens (BACD5 by HOYA) whose aspherical structure is designed in such a way that spherical aberration will be minimized with respect to the first wavelength λ1 and the thickness t1 of the HD protective layer PL1. However, a plastic lens may be used.

Tables 2-1 and 2-2 show the lens data in the present example. In the numerical example, the difference of the optical path added to the incoming light flux by the diffractive structures DOE1 and DOE2 is expressed in terms of optical path difference function.

TABLE 2-1
[Paraxial data]

| Surface | | | | | | | | |
|---|---|---|---|---|---|---|---|---|
| number | r (mm) | d (mm) | n₄₀₅ | n₆₅₅ | n₇₈₅ | n_{d} | νd | Remarks |
| OBJ | | ∞ | | | | | | Emission point |
| 1 | ∞ | 1.0000 | 1.56013 | 1.54073 | 1.53724 | 1.54351 | 56.7 | Aberration |
| 2 | −13.55731 | 0.1000 | 1.53044 | 1.49524 | 1.48938 | 1.50000 | 30.0 | correcting |
| 3 | −13.55731 | 0.1000 | | | | | | element |
| 4 | 1.50977 | 2.5900 | 1.60526 | 1.58624 | 1.58239 | 1.58913 | 61.3 | Objective lens |
| 5 | −3.98705 | d4 | | | | | | |
| 6 | ∞ | d5 | 1.62230 | 1.57995 | 1.57326 | 1.58546 | 30.0 | Protective layer |
| 7 | ∞ | | | | | | | |

d4_{HD} = 0.7152, d4_{DVD} = 0.5039, d4_{CD} = 0.3002, d5_{HD} = 0.1000, d5_{DVD} = 0.6000,
d5_{CD} = 1.2000

[Aspherical surface coefficients]

| | 2nd surface | 3rd surface | 4th surface | 5th surface |
|---|---|---|---|---|
| κ | 0.00000E+00 | 0.00000E+00 | −0.660911 | −70.33824 |
| A4 | 0.12192E−02 | 0.12192E−02 | 0.79413E−02 | 0.99127E−01 |
| A6 | 0.61122E−03 | 0.61122E−03 | 0.86416E−04 | −0.10873E+00 |
| A8 | −0.32711E−03 | −0.32711E−03 | 0.20333E−02 | 0.80514E−01 |
| A10 | 0.77728E−04 | 0.77713E−04 | −0.12698E−02 | −0.40782E−01 |
| A12 | 0.00000E+00 | 0.00000E+00 | 0.28538E−03 | 0.11632E−01 |
| A14 | 0.00000E+00 | 0.00000E+00 | 0.21720E−03 | −0.13968E−02 |
| A16 | 0.00000E+00 | 0.00000E+00 | −0.16847E−03 | 0.00000E+00 |
| A18 | 0.00000E+00 | 0.00000E+00 | 0.45032E−04 | 0.00000E+00 |
| A20 | 0.00000E+00 | 0.00000E+00 | −0.44433E−05 | 0.00000E+00 |

TABLE 2-2
[Diffractive surface coefficients]

| | 1st surface | 2nd surface |
|---|---|---|
| M_{HD}/M_{DVD}/M_{CD} | 0/1/0 | 1/1/1 |
| λ_{B} | 655 nm | 700 nm |
| B2 | −0.80000E−02 | 0.35788E−01 |
| B4 | −0.21490E−03 | −0.12331E−02 |
| B6 | 0.20778E−04 | −0.51982E−03 |
| B8 | −0.85988E−04 | 0.29100E−03 |
| B10 | 0.14077E−04 | −0.72300E−04 |

The boundary surface (second surface) between the base lens and resin layer, the optical surface (third surface) of the resin layer on the optical disc side, the optical surface (fourth surface) of the objective lens OL on the light source side, and the optical surface (fifth surface) on the optical disc side are each configured in an aspherical shape. The aspherical shape can be expressed by the equation obtained by substituting the coefficient of the Table into the above described aspherical shape equation:

Further, the diffractive structures DOE1 and DOE2 are expressed by the optical path difference added to the incoming light flux by the diffractive structures DOE1 and DOE2 respectively. Such an optical path difference is expressed by the optical path function φ(mm) obtained by substituting the coefficient of the Table into the equation showing the above described optical path difference function.

### Example 3

The following describes a specific numerical example of the objective lens unit OU provided with the aberration correcting element SAC and objective lens OL shown in FIG. 3. The aberration correcting element SAC is made up of a lamination of the resin layer composed of an ultraviolet curing resin and the base lens composed of resin. A diffractive structure DOE1 is formed on the boundary between the base lens and resin layer and A diffractive structure DOE 2 which is a phase structure is formed on the light-source side of the optical surface of the base lens. The objective lens OL is a glass lens (BACD5 by HOYA) whose aspherical structure is designed in such a way that spherical aberration will be minimized with respect to the first wavelength λ1 and the thickness t1 of the HD protective layer PL1. However, a plastic lens may be used.

Tables 3-1 and 3-2 show the lens data in the present example. In the numerical example, the difference of the optical path added to the incoming light flux by the diffractive structures DOE1 and DOE2 is expressed in terms of optical path difference function.

TABLE 3-1
[Paraxial data]

| Surface | | | | | | | | |
|---|---|---|---|---|---|---|---|---|
| number | r (mm) | d (mm) | n₄₀₅ | n₆₅₅ | n₇₈₅ | n_{d} | νd | Remarks |
| OBJ | | ∞ | | | | | | Emission point |
| 1 | ∞ | 1.0000 | 1.56013 | 1.54073 | 1.53724 | 1.54351 | 56.7 | Aberration |
| 2 | 13.32086 | 0.1000 | 1.60595 | 1.55316 | 1.54491 | 1.56000 | 23.0 | correcting |
| 3 | 13.32086 | 0.1000 | | | | | | element |
| 4 | 1.50977 | 2.5900 | 1.60526 | 1.58624 | 1.58239 | 1.58913 | 61.3 | Objective lens |
| 5 | −3.98705 | d4 | | | | | | |
| 6 | ∞ | d5 | 1.62230 | 1.57995 | 1.57326 | 1.58546 | 30.0 | Protective layer |
| 7 | ∞ | | | | | | | |

d4_{HD} = 0.7154, d4_{DVD} = 0.5105, d4_{CD} = 0.3000, d5_{HD} = 0.1000, d5_{DVD} = 0.6000,
d5_{CD} = 1.2000

[Aspherical surface coefficients]

| | 2nd surface | 3rd surface | 4th surface | 5th surface |
|---|---|---|---|---|
| κ | −0.23819E+00 | −0.238194 | −0.660911 | −70.33824 |
| A4 | −0.15140E−02 | −0.15140E−02 | 0.79413E−02 | 0.99127E−01 |
| A6 | −0.65733E−03 | −0.65733E−03 | 0.86416E−04 | −0.10873E+00 |
| A8 | 0.50862E−03 | 0.50861E−03 | 0.20333E−02 | 0.80514E−01 |
| A10 | −0.12193E−03 | −0.12194E−03 | −0.12698E−02 | −0.40782E−01 |
| A12 | 0.00000E+00 | 0.00000E+00 | 0.28538E−03 | 0.11632E−01 |
| A14 | 0.00000E+00 | 0.00000E+00 | 0.21720E−03 | −0.13968E−02 |
| A16 | 0.00000E+00 | 0.00000E+00 | −0.16847E−03 | 0.00000E+00 |
| A18 | 0.00000E+00 | 0.00000E+00 | 0.45032E−04 | 0.00000E+00 |
| A20 | 0.00000E+00 | 0.00000E+00 | −0.44433E−05 | 0.00000E+00 |

TABLE 3-2
[Diffractive surface coefficients]

| | 1st surface | 2nd surface |
|---|---|---|
| M_{HD}/M_{DVD}/M_{CD} | 0/1/0 | 1/0/0 |
| λ_{B} | 655 nm | 405 nm |
| B2 | −0.14000E−01 | −0.20904E−01 |
| B4 | 0.10428E−03 | 0.75126E−03 |
| B6 | 0.19938E−03 | 0.43409E−03 |
| B8 | −0.22613E−03 | −0.31005E−03 |
| B10 | 0.44381E−04 | 0.71341E−04 |

### Example 4

In the fourth example, the Table 4 indicates the lens data when a diffractive structure is provided on the boundary between air and the material having the greater Abbe's number on d-line of FIG. 5.

TABLE 4
Example 4: Lens data

| | | | |
|---|---|---|---|
| Focal distance of objective lens | f1 = 2.6 mm | f2 = 2.55 mm | f3 = 2.54 mm |
| system | | | |
| Numerical aperture on image surface | NA1: 0.65 | NA2: 0.65 | NA3: 0.51 |
| side | | | |
| Magnification | m1 = 0 | m2 = 0 | m3 = 0 |

| i-th | | di | ni | di | ni | di | ni |
|---|---|---|---|---|---|---|---|
| surface | Ri | (407 nm) | (407 nm) | (655 nm) | (655 nm) | (785 nm) | (785 nm) |
| 0 | | ∞ | | ∞ | | ∞ | |
| 1 | | 0.0 | | 0.0 | | 0.0 | |
| (Aperture | | (φ 3.38 mm) | | (φ 3.315 mm) | | (φ 2.591 mm) | |
| Diameter) | | | | | | | |
| 2 | 45.953 | 0.50 | 1.5594 | 0.50 | 1.5859 | 0.50 | 1.5369 |
| 3 | −21.671 | 0.05 | 1.6049 | 0.05 | 1.5523 | 0.05 | 1.5449 |
| 4 | ∞ | 0.05 | 1.0000 | 0.05 | 1.0000 | 0.05 | 1.0000 |
| 5 | 1.4920 | 1.50 | 1.6049 | 1.50 | 1.5859 | 1.50 | 1.5824 |
| 6 | 11.285 | 1.22 | 1.0000 | 1.15 | 1.0000 | 0.75 | 1.0000 |
| 7 | ∞ | 0.6 | 1.6187 | 0.6 | 1.5775 | 1.2 | 1.5706 |
| 8 | ∞ | | | | | | |

2nd surface
Optical path function (HD, DVD; second-order DVD: first-
order CD: first-order λ_{B} = 407 nm)

| | |
|---|---|
| B2 | 5.3871E−03 |
| B4 | −1.2289E−03 |
| B6 | −8.9896E−05 |

3rd surface
Optical path function (HD, DVD; first-order DVD: first-
order CD: first-order λ_{B} = 470 nm)

| | |
|---|---|
| B2 | −1.3014E−02 |
| B4 | −1.3130E−03 |
| B6 | −2.3990E−04 |
| B8 | 7.1857E−05 |
| B10 | −7.4697E−06 |

5th surface
Aspherical surface coefficient

| | |
|---|---|
| κ | −8.4008E−01 |
| A4 | 1.6303E−02 |
| A6 | 4.5553E−03 |
| A8 | 1.2775E−03 |
| A10 | −8.0783E−04 |
| A12 | 5.0009E−04 |
| A14 | −3.4475E−05 |

6th surface
Aspherical surface coefficient

| | |
|---|---|
| κ | −4.3018E+02 |
| A4 | 7.9630E−02 |
| A6 | −2.4635E−02 |
| A8 | −1.2481E−02 |
| A10 | 3.3852E−02 |
| A12 | −2.2434E−02 |
| A14 | 4.8507E−03 |

| | nd | νd |
|---|---|---|
| Base lens | 1.5435 | 56.7 |
| Resin | 1.5600 | 23.0 |
| layer | | |
| Objective | 1.5891 | 61.3 |
| lens | | |

*3′ denotes the displacement from the 3′-th surface to 3rd surface.

As shown in Table 4, in the present example, the focal distance f1 is set at 2.60 mm and the magnification m1 is set at 0 when the wavelength λ1 is 407 mm. The focal distance f2 is set at 2.55 mm and the magnification m2 is set at 0 when the wavelength λ2 is 655 nm. The focal distance f3 is set at 2.54 mm and the magnification m3 is set at 0 when the wavelength λ3 is 785 nm.

The refractive index nd in the lined of the base lens BL is set at 1.5435, and the Abbe's number νd in the lined is set at 56.7. The refractive index nd in the lined of the resin layer UV is set at 1.5600, and the Abbe's number νd in the d-line is set at 23.0 The refractive index nd on the d-line of the objective lens OL is set at 1.5891 and the Abbe's number νd in the d-line is set at 61.3.

The optical surface (5th surface) of the objective lens OL on the light source side and the optical surface (6th surface) on the optical disc side are designed in an aspherical shape, and the aspherical surface can be expressed by the equation obtained by substituting the coefficient of the Table 4 into the following aspherical shape equation:

[Aspherical Shape Equation]
z=(y²/R)/[1+√{1−(K+1)(y/R)²}]+A₄y⁴+A₆y⁶+A₈y⁸+A₁₀y¹⁰+A₁₂y¹²+A₁₄y¹⁴

The diffractive structure DOE1 formed on the boundary (third surface) between the base lens BL and resin layer UV, and the diffractive structure DOE2 formed on the boundary (second surface) between the base lens BL and air are each expressed by the difference in the optical path to be added to the incoming light flux by the diffractive structures DOE1 and DOE2. Such an optical path difference is expressed by the optical path function φ (mm) obtained by substituting the coefficient of the Table 4 into the equation showing the following optical path difference function:

[Optical Path Difference Function]

Diffractive structure DOE
φ=λ×M×(B₂y²+B₄y⁴+B₆y⁶+B₈y⁸+B₁₀y¹⁰)

Diffractive structure DOE2
φ=λ×M×(B₂y²+B₄y⁴+B₆y⁶)

“M” denotes the order of diffraction. So in the case of the diffractive structure DOE in the third surface, 1 for HD DVD, 1 for DVD or 1 for CD is substituted. In the case of the diffractive structure DOE2 in the second surface, 2 for HD DVD, 1 for DVD or 1 for CD is substituted.

### Example 5

As Example 5, Table 5 shows the lens data of the structure in which a diffractive structure is further provided with the objective lens (objective optical element) shown in FIG. 6.

TABLE 5
Example 5: Lens data

| | | | |
|---|---|---|---|
| Focal distance of objective lens system | f1 = 2.6 mm | f2 = 2.59 mm | f3 = 2.58 mm |
| Numerical aperture on image surface | NA1: 0.65 | NA2: 0.65 | NA3: 0.51 |
| side | | | |
| Magnification | m1 = 0 | m2 = 0 | m3 = 0 |

| i-th | | di | ni | di | ni | di | ni |
|---|---|---|---|---|---|---|---|
| surface | Ri | (407 nm) | (407 nm) | (655 nm) | (655 nm) | (785 nm) | (785 nm) |
| 0 | | ∞ | | ∞ | | ∞ | |
| 1 | | 0.0 | | 0.0 | | 0.0 | |
| (Aperture | | (φ 3.38 mm) | | (φ 3.367 mm) | | (φ 2.632 mm) | |
| Diameter) | | | | | | | |
| 2 | 30.194 | 0.50 | 1.5594 | 0.50 | 1.5859 | 0.50 | 1.5369 |
| 3 | 12.692 | 0.05 | 1.6049 | 0.05 | 1.5523 | 0.05 | 1.5449 |
| 4 | ∞ | 0.05 | 1.0000 | 0.05 | 1.0000 | 0.05 | 1.0000 |
| 5 | 1.5669 | 1.50 | 1.6049 | 1.50 | 1.5859 | 1.50 | 1.5824 |
| 6 | 13.417 | 1.17 | 1.0000 | 1.13 | 1.0000 | 0.73 | 1.0000 |
| 7 | ∞ | 0.6 | 1.6187 | 0.6 | 1.5775 | 1.2 | 1.5706 |
| 8 | ∞ | | | | | | |

3rd surface
Optical path function (HD, DVD; first-order DVD: first-order
CD: first-order λ_{B} = 470 nm)

| | |
|---|---|
| B2 | −1.3612E−02 |
| B4 | −8.2208E−04 |
| B6 | −4.9252E−04 |
| B8 | 1.4985E−04 |
| B10 | −1.6950E−05 |

5th surface
Aspherical surface coefficient

| | |
|---|---|
| κ | −8.6448E−01 |
| A4 | 1.6067E−02 |
| A6 | 1.1067E−03 |
| A8 | 7.7210E−04 |
| A10 | −7.7877E−04 |
| A12 | 4.7122E−04 |
| A14 | −5.4645E−05 |

Optical path function (HD, DVD; second-order DVD: first-
order CD: first-order λ_{B} = 407 nm)

| | |
|---|---|
| B2 | 2.9618E−03 |
| B4 | −1.0295E−03 |
| B6 | −4.1949E−04 |

6th surface
Aspherical surface coefficient

| | |
|---|---|
| κ | −4.3018E+02 |
| A4 | 5.7205E−02 |
| A6 | −2.7449E−02 |
| A8 | −1.1797E−02 |
| A10 | 3.5291E−02 |
| A12 | −2.1870E−02 |
| A14 | 4.4703E−03 |

| | nd | νd |
|---|---|---|
| Base lens | 1.5435 | 56.7 |
| Resin | 1.5600 | 23.0 |
| layer | | |
| Objective | 1.5891 | 61.3 |
| lens | | |

*3′ denotes the displacement from the 3′-th surface to 3rd surface.

As shown in Table 5, in the present example, the focal distance f1 is set at 2.60 mm and the magnification ml is set at 0 when the wavelength λ1 is 407 mm. The focal distance f2 is set at 2.59 mm and the magnification m2 is set at 0 when the wavelength λ2 is 655 nm. The focal distance f3 is set at 2.58 mm and the magnification m3 is set at 0 when the wavelength λ3 is 785 nm.

The refractive index nd in the lined of the base lens BL is set at 1.5435, and the Abbe's number νd in the lined is set at 56.7. The refractive index nd in the lined of the resin layer UV is set at 1.5600, and the Abbe's number νd in the d-line is set at 23.0 The refractive index nd on the d-line of the objective lens OL is set at 1.5891 and the Abbe's number νd in the d-line is set at 61.3.

The optical surface (5th surface) of the objective lens OL on the light source side and the optical surface (6th surface) on the optical disc side are designed in an aspherical shape, and the aspherical surface can be expressed by the equation obtained by substituting the coefficient of the Table 5 into the following aspherical shape equation:

[Aspherical Shape Equation]
z=(y²/R)/[1+√{1−(K+1)(y/R)^{2}]+}A₄y⁴+A₆y⁶+A₈y⁸+A₁₀y¹⁰+A₁₂y¹²+A₁₄y¹⁴

The diffractive structure DOE1 formed on the boundary (third surface) between the base lens BL and resin layer UV, and the diffractive structure DOE3 formed on the surface of the objective lens OL (fifth surface) are each expressed by the difference in the optical path-to be added to the incoming light flux by the diffractive structures DOE1 and DOE3. Such an optical path difference is expressed by the optical path-function φ (mm) obtained by substituting the coefficient of the Table 4 into the equation showing the following optical path difference function:

[Optical Path Difference Function]

Diffractive structure DOE
φ=λ×M×(B₂y²+B₄y⁴+B₆y⁶+B₈y⁸+B₁₀y¹⁰)

Diffractive structure DOE3
φ=λ×M×(B₂y²+B₄y⁴+B₆y⁶)

“M” denotes the order of diffraction. So in the case of the diffractive structure DOE in the third surface, 1 for HD DVD, 1 for DVD or 1 for CD is substituted. In the case of the diffractive structure DOE3 in the fifth surface, 2 for HD DVD, 1 for DVD or 1 for, CD is substituted.

### Embodiment 4

The following describes the fourth embodiment with reference to drawings. The same structures as those of the aforementioned first embodiment will not be described to avoid duplication.

As shown schematically in FIG. 8, the objective lens unit OU of the present embodiment is structured so that the aberration correcting element SAC is integrated coaxially with the objective lens OL for exclusive use in the HD through the lens frame B, wherein the aspherical shape of the objective lens OL is designed in such a way that spherical aberration is minimized with respect to the first wavelength λ1 and the thickness t1 of the HD protective layer PL1. To put it more specifically, the aberration correcting element SAC is fitted into one end of the cylindrical lens frame B and is fixed therein. The objective lens OL is fitted into the other end and is fixed therein. They are integrated into one structure along the optical axis X.

The following describes the structure of the aberration correcting element SAC and the principle of aberration correction: As shown in FIGS. 7(a) and 7(b), the aberration correcting element (the first optical element) SAC includes a first part made of a material A as an ultraviolet curing resin and a second part made of a material B as optical glass laminated one on top of the other. Here the material A is further characterized in that the refractive index difference Δn1 in the first wavelength λ1 and Abbe's number difference Δνd on the d-line meet the equations (21) and (22). A diffractive structure (the first phase structure) DOE as a phase structure having a strap-formed step is arranged on the boundary between these two materials. This diffractive structure DOE is provided to correct the difference in the spherical aberration resulting from the difference in the thickness of the protective layers of optical discs, and the spherical aberration caused by the difference in the wavelengths used in the optical discs. The diffractive structure DOE may be arranged in such a way that the cross section including the optical axis is serrated as shown in FIG. 7(a) or stepped as shown in FIG. 7(b).
|Δn1|<0.01 (21)
20<|Δνd|<40 (22)

The diffraction efficiency η(λ) of the diffractive structure DOE1 formed on the boundary between the base lens BL and resin layer UV having different Abbe's numbers (dispersion) is generally expressed by the following equation (61) as a function of:
the wavelength λ1,
the difference Δn(λ) of refractive index between the base lens BL and resin layer UV at this wavelength λ1,
the level difference d of the diffractive structure DOE1, and
the order of diffraction M(λ):
   η(λ)=sin c² [[d·Δn(λ)/λ]−M(λ)] (61)
where sin c (X)=sin (πX)/(πX), and the value of η(λ) is closer to 1 as the value in the square bracket ([ ]) is closer to an integer.

Assume that the difference of the refractive index at the first wavelength λ1 used for the HD is Δn1; the order of diffraction of the diffracted light flux of the first light flux is M1; the difference of the refractive index at the second wavelength λ2 used for the DVD is Δn2; the order of diffraction of the diffracted light flux of the second light flux is M2; the difference of the refractive index at the third wavelength λ3 used for the CD is Δn3; and the order of diffraction of the diffracted light flux of the third light flux is M3. Then the diffraction efficiencies η(λ1), η(λ2), and η(λ3) at each wavelength are expressed by the following equations (62) through (64):
η(λ1)=sin c²[[d·Δn1/λ1]−M1] (62)
η(λ2)=sin c²[[d·Δn2/λ2]−M2] (63)
η(λ3)=sin c²[[d·Δn3/λ3]−M3] (64)

To ensure high diffraction efficiency in each wavelength, it is necessary to select the base lens BL having the difference in refractive index Δni (where “i” denotes 1, 2 or 3) (viz., having the Abbe's number Δνd), resin layer UV, level difference d, and order of diffraction Mi (where “i” denotes 1, 2 or 3) in such a way that the values in the square brackets in Equations (62) through (64) will be close to an integer.

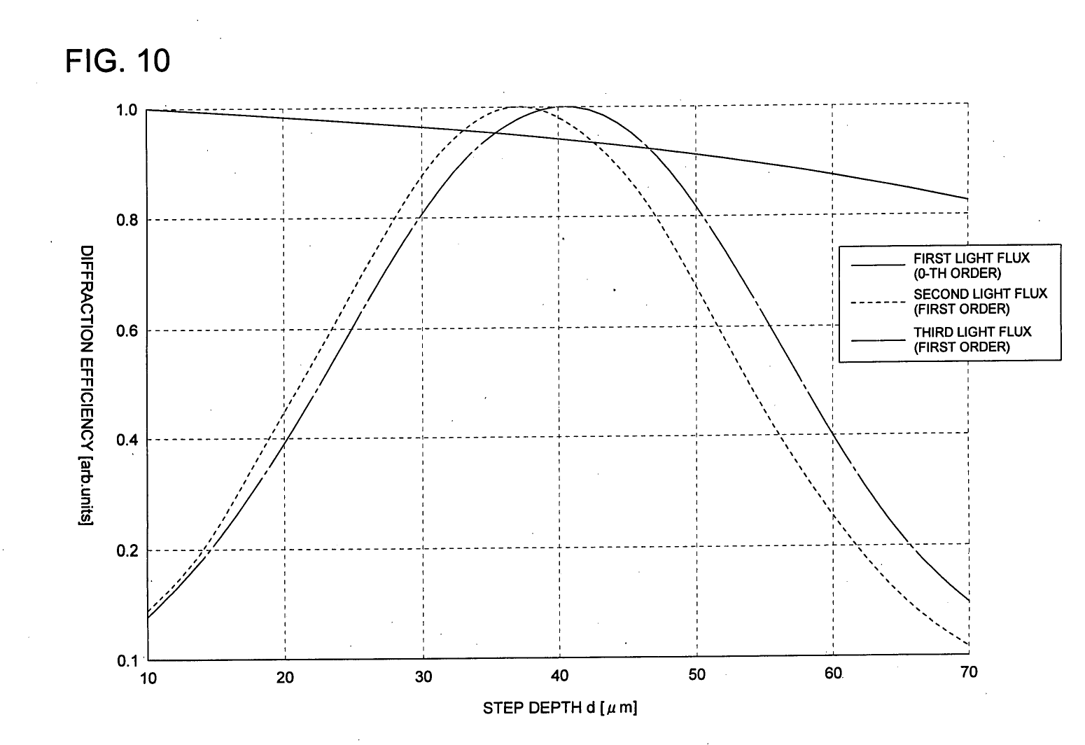

In the aberration correcting element SAC of the present embodiment, the materials A and B selected meet the equations (21) and (28). Accordingly, the first light flux directly passes through, without being affected by the diffractive structure DOE (i.e. M1=0 in equation (62)). Further, since the materials A and B selected meet the equations (23) and (28). Accordingly, first-order diffracted light flux is produced when the second and third light fluxes have entered the diffractive structure DOE (i.e. M2=M3=1 in equations (63) and (64)). Table 6 shows the physical properties of the specific materials A and B. FIG. 10 shows the relationship between the step d and the diffraction efficiency of the diffracted light flux of each light flux. As can be seen from FIG. 10, if the step d of the diffractive structure DOE is set at about 35 μm, then the diffraction efficiency as high as 95% can be ensured for a light flux having any wavelength.

TABLE 6

Material

| | Material A: | Material B: |
|---|---|---|
| | Ultraviolet | Optical glass |
| | curing resin | (BACD5 by HOYA) |
| Refractive index in | 1.60667 | 1.60526 |
| the first wavelength | | |
| λ1 (= 405 nm) | | |
| Refractive index in | 1.56874 | 1.58624 |
| the second wavelength | | |
| λ2 (= 655 nm) | | |
| Refractive index in | 1.56273 | 1.58239 |
| the third wavelength | | |
| λ3 (= 785 nm) | | |
| Abbe's number on line νd | 29.1 | 61.3 |

As described above, two materials meeting the aforementioned equations (21) and (22) are laminated and a diffractive structure is formed on the boundary thereof. This arrangement allows the diffractive structure DOE to have a function of selectively diffracting only the second and third light fluxes, without the first light flux being diffracted. Thus, this arrangement ensures compatibility between the spherical aberration correction effect and improved diffraction efficiency of the diffracted light flux of the blue-violet laser light flux (first light flux) and infrared laser light flux (third light flux). This compatibility has been difficult to achieve in the prior art.

Here the diffraction power paraxial with respect to the structure is negative. The second and third light fluxes entering the diffractive structure DOE are converted into divergent light fluxes, which enter the objective lens OL. This procedure prolongs the back focus of the objective lens unit OU with respect to the second and third light fluxes, and therefore provides a sufficient operation distance with respect to the DVD and CD having a thick protective layer. The diffraction power P_{D} paraxial with respect to the diffractive structure DOE is defined by P_{D}=−2·M·B₂ using the second-order diffractive surface coefficient B₂ of the optical path difference function φ to be described later and the order of diffraction M of the diffracted light flux employed in the recording/reproducing of information using an optical disc.

In the aberration correcting element SAC, the diffractive structure DOE is formed only in the area corresponding inside the numerical aperture NA2 and the spherical aberration resulting from the difference in the thickness of t1 and t2 is not corrected in the area outside the numerical aperture NA2. Accordingly, the second light flux having passed through the area outside the numerical aperture NA2 is turned into a flare component that spreads to a position sufficiently removed from the spot formed on the information recording surface RL2, by the diffractive structure DOE.

Further, in the aberration correcting element SAC, the area corresponding inside the numerical aperture NA2 where the diffractive structure DOE is formed is divided into two areas; a central area corresponding inside the numerical aperture NA3 and a strap-formed peripheral area corresponding to the range from numerical aperture NA3 to numerical aperture NA2, enclosing the central area. Here the diffractive structure formed in the central area is characterized in that the width of the diffraction strap is determined to ensure that both the second and third light fluxes are condensed on the information recording surface of each optical disc. In the meantime, the diffractive structure formed in the peripheral area is so designed that the width of the diffraction strap is determined to ensure that only the second light flux is condensed on the information recording surface RL2 of the DVD, and the third light flux is turned into a flare component that spreads to a position sufficiently removed from the spot formed on the information recording surface RL3 of the CD.

As described above, the aberration correcting element SAC used in the optical pickup apparatus PU of the present embodiment has an aperture restricting function corresponding to the numerical aperture NA2 of the DVD and an aperture restricting function corresponding to the numerical aperture NA3 of the CD, in addition to the spherical aberration correcting function. This structure allows the structure of the optical pickup apparatus and to be simplified, and the number of parts to be reduced.

In the present embodiment, the aberration correcting element SAC and objective lens OL are integrated into one structure through the lens frame B. When the aberration correcting element SAC and objective lens OL are integrated into one structure, it is sufficient only if the positional relationship between the aberration correcting element SAC and objective lens OL is kept constant. In addition to the aforementioned method of using the lens frame B as an intermediary, it is also possible to utilize the method of fitting the flange of the aberration correcting element SAC with that of the objective lens OL.

When the positional relationship between the aberration correcting element SAC and objective lens OL is kept constant as described above, it is possible to minimize aberration produced at the time of focusing and tracking. Thus, this arrangement provides excellent focusing or tracking characteristics.

Further, in the present embodiment, the aberration correcting element SAC and objective lens OL are arranged as separate devices. As schematically shown in FIG. 1, the objective lens unit OU can be replaced by the so-called hybrid objective lens wherein the objective lens OL is provided with the function as an aberration correcting element SAC.

In the objective lens unit OU shown in FIG. 8, the condensing performance of the objective lens unit OU can be improved by addition of a phase structure different from the diffractive structure DOE. Such a phase structure may be formed on the optical surface of either the aberration correcting element SAC or objective lens OL. For production purposes, the phase structure is preferably formed on the optical surface of the aberration correcting element SAC on the light source side or the optical surface of the optical disc of the aberration correcting element SAC. The function to be assigned to the phase structure includes correction of the increase (so-called chromatic aberration) of the condensing spot of the objective lens unit OU resulting from the change in the wavelength and correction of the increase (so-called temperature aberration) of the condensing spot of the objective lens unit OU resulting from temperature changes.

The spherical aberration of the spot formed on the information recording surface RL1 of the HD can be corrected by driving the first lens EXP1 of the expander lens EXP by the uniaxial actuator AC2 in the direction of optical axis. The causes for the occurrence of the spherical aberration to be corrected by adjusting the position of the first lens EXP1 includes variations of the wavelength resulting from the production error of the blue-violet semiconductor laser LD1, changes in refractive index of the objective lens OL due to temperature change, distribution of refractive index, a focus jump among the image receiving layers in a multilayer disc such as a double-layer or triple-layer disc, and variations of the thickness or distribution of thickness resulting from the production error of the protective layer of the HD. Instead of the first lens EXP1, it is possible to use the structure wherein the second lens EXP2 or the first collimating lens COL1 is driven in the direction of optical axis. This method also corrects the spherical aberration of the spot formed on the information recording surface RL1 of the HD.

In the aforementioned description, the spherical aberration of the spot formed on the information recording surface RL1 of the HD by driving the first lens EXP1 in the direction of optical axis. It is also possible to adopt a structure capable of correcting the spherical aberration of the spot formed on the information recording surface RL2 of the DVD, as well as the spherical aberration of the spot formed on the information recording surface RL3 of the CD.

The present embodiment uses the DVD/CD laser light source unit LU having a chip containing both the first emitting section EP1 and second emitting section EP2. Without being restricted to this structure, it is also possible to employ the one-chip laser light source unit for HD, DVD and CD, wherein the emission point for emitting a laser light flux having a wavelength of 405 nm is also mounted on one and the same chip. Alternatively, it is possible to use the one-can laser light source unit for HD, DVD and CD, wherein three light sources of blue-violet semiconductor laser, red semiconductor laser and infrared semiconductor laser are incorporated in one enclosure.

In the present embodiment, the light source and light detector P_{D} are arranged separately from each other. Without being restricted to such a structure, it is possible to use the laser light source module packing the light source and light detector.

Further, by mounting the optical pickup apparatus PU shown-in-the aforementioned embodiment (not illustrated), a rotary drive apparatus for rotatably holding an optical disc and a control apparatus for controlling the drive of these apparatuses, it is possible to provide an optical disc drive apparatus capable of carrying out at least one of the functions of recording of information on an optical disc and reproducing of information from the optical disc.

The aforementioned description of the present embodiment refers to the case where the diffractive structure DOE is formed only on the boundary between the materials A and B. It is also possible to make such arrangements that a diffractive structure (a phase structure) is formed on the boundary between air and either the material A or B having the greater Abbe's number on the line d, as shown in FIG. 7. Thus, since the diffractive structure is formed on the boundary between air and the material having a greater Abbe's number on the line d, this arrangement improves the diffraction efficiency for the wavelengths λ1, λ2 and λ3 of the first, second and third light fluxes, respectively.

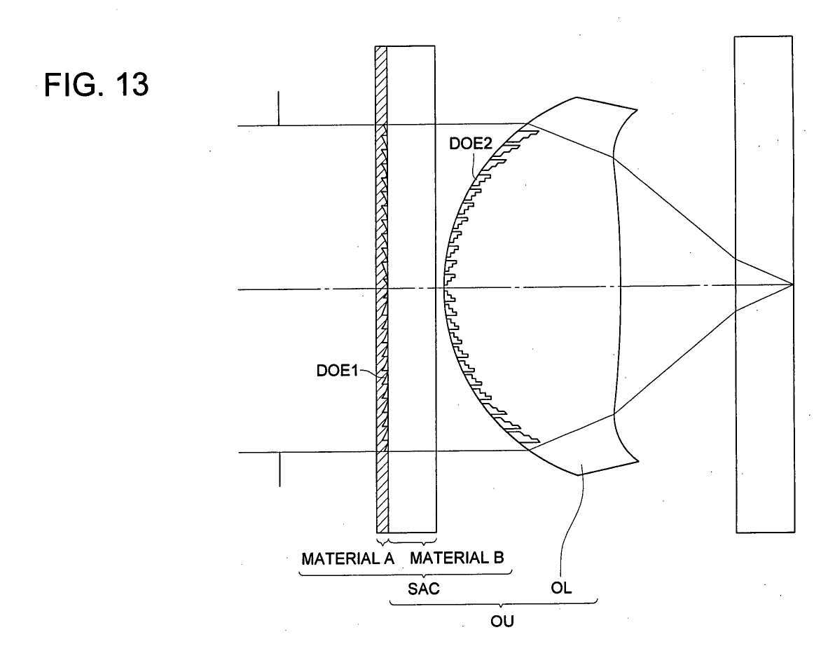

As shown in FIG. 13, the objective lens (objective optical system) placed on the disc side may be designed in such a way that the Abbe's number νd of the d-line meets the 40≦νd≦70 and a diffractive structure is formed on the surface of the aforementioned objective lens.

Since the Abbe's number νd in the objective lens OL located on the disc side meets the aforementioned equation and a diffractive structure is formed on the surface of the objective lens, this arrangement improves the diffraction efficiency for the wavelengths λ1, λ2 and λ3 of the first, second and third light fluxes, respectively.

These diffractive structures may be wavelength selection type diffractive structures or blazed type diffractive structures. If the diffractive structure is a wavelength selection type diffractive structure, a phase difference can be assigned only to the light flux of a predetermined wavelength, and diffraction can be applied only to the light of the DVD, whereby the remaining DVD spherical aberration can be corrected.

In the meantime, if the diffractive structure is a blazed type diffractive structure, the chromatic aberration can be corrected with high efficiency.

If a diffractive structure is arranged on other that the boundary between the materials A and B, the thickness t2 of the protective layer PL2 of the DVD is set so as to meet the 0.9×t1≦t2≦1.1×t1. Then it is only necessary to correct the spherical aberration caused by the wavelength alone being different as in the combination of HD DVD and DVD. This arrangement allows the diffraction pitch to be increased and processability to be improved.

### Example 6

The following describes a specific numerical example of an objective lens unit OU provided with the aberration correcting element SAC and objective lens OL shown in FIG. 8. The aberration correcting element SAC is made up of a lamination of the material A as an ultraviolet curing resin and the material B as a glass lens (BACD5 by HOYA). A diffractive structure DOE is formed on the boundary between the materials A and B. The objective lens OL is a glass lens (BACD5 by HOYA) specifically designed for HD. However, a plastic lens may be used.

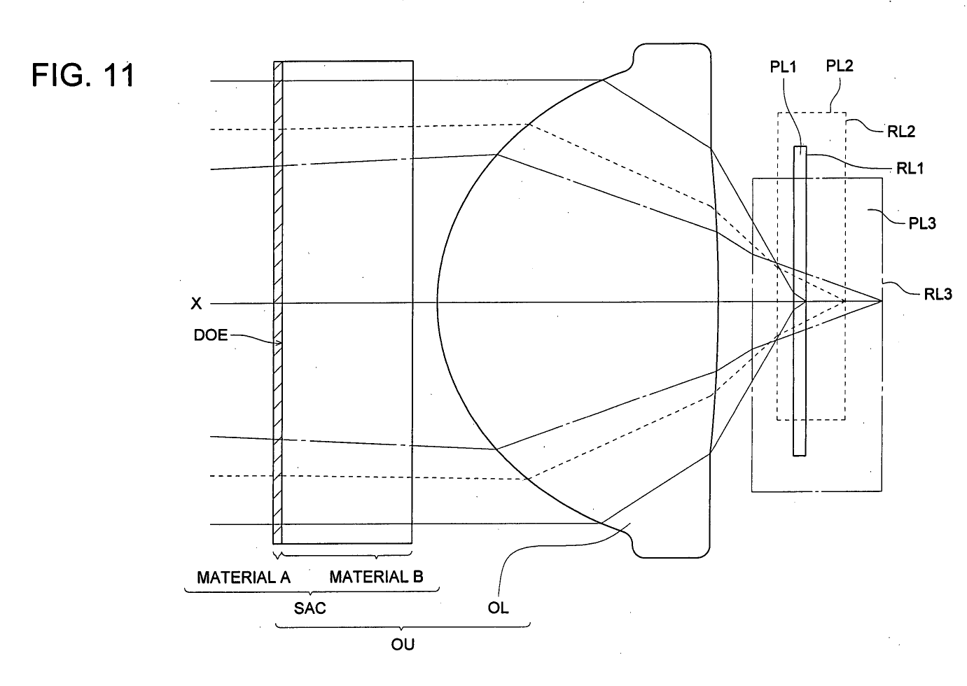

Table 7 shows the lens data of the sixth embodiment, and Table 8 shows the specifications. The optical path is given in FIG. 11. In the present numerical example, the optical path to be added to the incoming light flux by the diffractive structure DOE is expressed by the optical path function. The diffractive structure DOE is not illustrated in FIG. 11 showing the optical path.

TABLE 7
[Paraxial data]

| Surface | | | | | | | | |
|---|---|---|---|---|---|---|---|---|
| number | r (mm) | d (mm) | n₄₀₅ | n₆₅₅ | n₇₈₅ | n_{d} | νd | Remarks |
| OBJ | | ∞ | | | | | | Emission point |
| 1 | ∞ | 0.1000 | 1.60667 | 1.56874 | 1.56273 | 1.57365 | 29.1 | Aberration |
| 2 | ∞ | 1.2000 | 1.60526 | 1.58624 | 1.58239 | 1.58913 | 61.3 | correcting |
| 3 | ∞ | 0.2000 | | | | | | element |
| 4 | 1.50977 | 2.5900 | 1.60526 | 1.58624 | 1.58239 | 1.58913 | 61.3 | Objective lens |
| 5 | −3.98705 | d4 | | | | | | |
| 6 | ∞ | d5 | 1.62230 | 1.57995 | 1.57326 | 1.58546 | 30.0 | Protective layer |
| 7 | ∞ | | | | | | | |

d4_{HD} = 0.7151, d4_{DVD} = 0.5594, d4_{CD} = 0.3239, d5_{HD} = 0.1000, d5_{DVD} = 0.6000,
d5_{CD} = 1.2000

| [Aspherical surface coefficients] | | | [Diffractive surface coefficients] | |
|---|---|---|---|---|
| | 4th surface | 5th surface | | 2nd surface |
| κ | −0.660911 | −70.33824 | M_{HD}/M_{DVD}/M_{CD} | 0/1/1 |
| A4 | 0.79413E−02 | 0.99127E−01 | B2 | 0.16673E+02 |
| A6 | 0.86416E−04 | −0.10873E+00 | B4 | −0.14870E+01 |
| A8 | 0.20333E−02 | 0.80514E−01 | B6 | 0.49761E+00 |
| A10 | −0.12698E−02 | −0.40782E−01 | B8 | −0.19214E+00 |
| A12 | 0.28538E−03 | 0.11632E−01 | B10 | 0.73613E−02 |
| A14 | 0.21720E−03 | −0.13968E−02 | | |
| A16 | −0.16847E−03 | 0.00000E+00 | | |
| A18 | 0.45032E−04 | 0.00000E+00 | | |
| A20 | −0.44433E−05 | 0.00000E+00 | | |

TABLE 8

| | HD | DVD | CD |
|---|---|---|---|
| Wavelength (nm) | 405 | 655 | 785 |
| Numerical aperture | 0.85 | 0.65 | 0.50 |
| Effective diameter of | 3.74 | 2.94 | 2.32 |
| first surface (S1) (mm) | | | |
| Magnification | 0 | 0 | −1/22.28 |

In Table 8, “r” (mm) denotes a curvature radius, and “d” (mm) a lens distance. The n₄₀₅, n₆₅₅ and n₇₈₅ indicate the refractive indexes of the lenses with reference to the first wavelength λ1 (=405 nm), second wavelength λ2 (=655 nm) and third wavelength λ3 (=785 nm), respectively. “νd” indicates the Abbe's number of the lens of the line d, and M_{HD}, M_{DVD} and M_{CD} represent the order of diffraction of the diffracted light flux employed in recording/reproducing using HD, the order of diffraction of the diffracted light flux employed in recording/reproducing using DVD, and the order of diffraction of the diffracted light flux employed in recording/reproducing using CD, respectively. Further, E (e.g. 2.5E-3) is used to express the power multiplier of 10 (e.g. 2.5×10⁻³).

In Table 8, when the HD is used, the numerical aperture NA1 of the objective lens unit OU is 0.85, the effective diameter of the first surface (Si) is 3.74 mm, and the magnification is 0. When the DVD is used, the numerical aperture NA2 of the objective lens unit OU is 0.65, the effective diameter of the first surface (S1) is 2.94 mm, and the magnification is 0. When the CD is used, the numerical aperture NA3 of the objective lens unit OU is 0.50, the effective diameter of the first surface (S1) is 2.32 mm, and the optical system is set to −1/22.28. In the present embodiment, 0.1 and 1 are selected as M_{HD} and M_{DVD}, and M_{CD}, respectively. The magnification in the CD mode can be set to a small value when correction is made of the spherical aberration caused by the difference in the protective layer between the HD and CD. Even when the objective lens unit OU has shifted 0.5 mm in the direction perpendicular to the optical axis, the wave front aberration is a good as about 0.05 λ3 RMS. In the optical pickup apparatus, the tracking amount of the objective lens unit OU is about ±0.5 mm. Accordingly, the objective lens unit OU of the present embodiment can be said to have an excellent tracking characteristic for the CD.

The optical surface (fourth surface) of the objective lens OL on the light source side and the optical surface (fifth surface) on the disc side are aspherical in shape. This aspherical surface is expressed by the equation obtained by substituting the coefficient of the Tables 7 and 8 into the following aspherical shape formula.

[Aspherical Shape Equation]
z=(y²/R)/[1+√{1−(K+1)(y/R)²}]+A₄y⁴+A₆y⁶+A₈y⁸+A₁₀y¹⁰+A₁₂y¹²+A₁₄y¹⁴+A₁₆y¹⁶+A₁₈y¹⁶+A₂₀y²⁰
where reference symbols denote the following:
z: aspherical shape (distance in the direction along the optical axis from the surface apex of the aspherical surface)
y: distance from the optical axis
R: curvature radius
K: Cornic coefficient
A₄, A₆, A₈, A₁₀, A₁₂, A₁₄, A₁₆, A₁₈ and A₂₀: aspherical surface coefficients

Further, the diffractive structure DOE formed on the boundary between the materials A and B is expressed by the optical path difference to be added to the incoming light flux by the diffractive structure DOE. Such an optical path difference is expressed by the optical path function φ (mm) obtained by substituting the coefficient of Tables 7 and 8 into the equation showing the following optical path difference function:

[Optical Path Difference Function]
φ=λ×M×(B₂y²+B₄y⁴+B₆y⁶+B₈y⁸+B₁₀y¹⁰)
where the reference symbols denotes the following:
φ: optical path function
λ: wavelength of the light flux incident on the diffractive structure
M: order of diffraction of the diffracted light flux employed in recording/reproducing using an optical disc
y: distance from optical axis

B₂, B₄, B₆, B₈ and B₁₀: diffractive surface coefficients

### Example 7

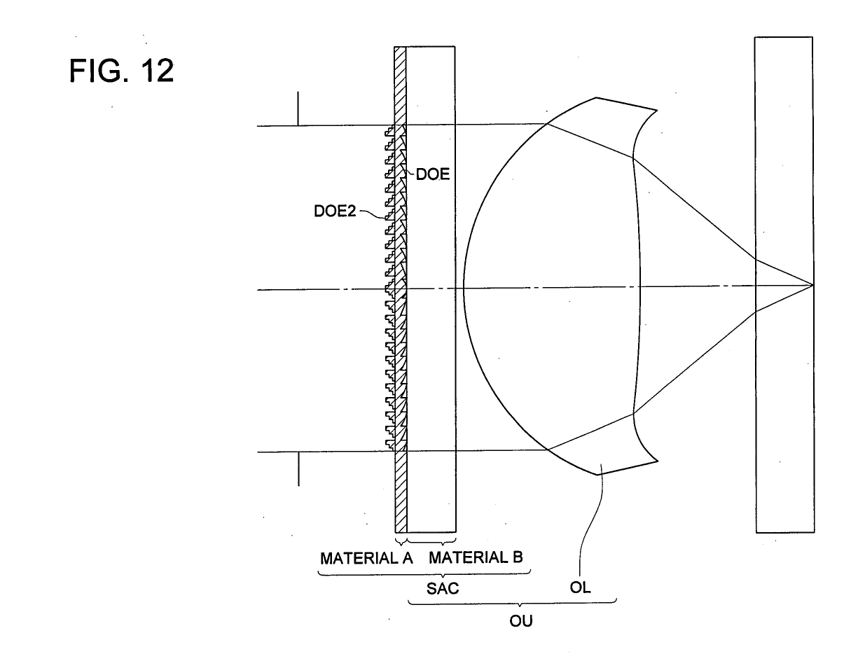

Table 9 shows the lens data when a diffractive structure is arranged also on the boundary between air and the material having a greater Abbe's number on the d-line of FIG. 12, by way of the seventh embodiment.

TABLE 9
Example 7: Lens data

| | | | |
|---|---|---|---|
| Composite focal distance of an | f1 = 2.6 mm | f2 = 2.65 mm | f3 = 2.70 mm |
| aberration corrected lens and an | | | |
| objective lens | | | |
| Numerical aperture on image surface | NA1: 0.65 | NA2: 0.65 | NA3: 0.51 |
| side | | | |
| Magnification | m1 = 0 | m2 = 0 | m3 = 0 |

| i-th | | di | ni | di | ni | di | ni |
|---|---|---|---|---|---|---|---|
| surface | Ri | (407 nm) | (407 nm) | (655 nm) | (655 nm) | (785 nm) | (785 nm) |
| 0 | | ∞ | | ∞ | | ∞ | |
| 1 | | 0.0 | | 0.0 | | 0.0 | |
| (aperture | | (φ 3.38 mm) | | (φ 3.445 mm) | | (φ 2.754 mm) | |
| diameter) | | | | | | | |
| 2 | ∞ | 0.10 | 1.6049 | 0.10 | 1.5859 | 0.10 | 1.5824 |
| 3 | ∞ | 0.50 | 1.6090 | 0.50 | 1.5680 | 0.50 | 1.5611 |
| 4 | ∞ | 0.05 | 1.0 | 0.05 | 1.0 | 0.05 | 1.0 |
| 5 | 1.7350 | 1.80 | 1.6049 | 1.80 | 1.5859 | 1.80 | 1.5824 |
| 6 | −10.243 | 1.21 | 1.0 | 1.24 | 1.0 | 0.90 | 1.0 |
| 7 | ∞ | 0.6 | 1.6187 | 0.6 | 1.5775 | 1.2 | 1.5706 |
| 8 | ∞ | | | | | | |

2nd surface
Optical path function (HD, DVD; 0-th-order DVD: first-order
CD: 0-th-order (blazed wavelength: 655 nm)

| | |
|---|---|
| B2 | 8.6696E−03 |
| B4 | −1.9776E−03 |
| B6 | −1.4467E−04 |

3rd surface
Optical path function (HD, DVD; 0-th-order DVD: first-order
CD: first-order (blazed wavelength: 700 nm)

| | |
|---|---|
| B2 | 0.0000E+00 |
| B4 | −5.1542E−04 |
| B6 | −1.2376E−04 |
| B8 | 1.4922E−05 |
| B10 | −3.2778E−06 |

5th surface
Aspherical surface coefficient

| | |
|---|---|
| κ | −9.9022E−01 |
| A4 | 1.3546E−02 |
| A6 | 7.3264E−04 |
| A8 | 2.1784E−03 |
| A10 | −1.6562E−03 |
| A12 | 5.5552E−04 |
| A14 | −5.4190E−05 |

6th surface
Aspherical surface coefficient

| | |
|---|---|
| κ | 5.0000E+00 |
| A4 | 2.8038E−02 |
| A6 | 1.1168E−02 |
| A8 | −3.5820E−02 |
| A10 | 3.2493E−02 |
| A12 | −1.2586E−02 |
| A14 | 1.8053E−03 |

| | nd | νd |
|---|---|---|
| Material A | 1.5891 | 61.3 |
| Material B | 1.5737 | 29.1 |
| Lens | 1.5891 | 61.3 |
| Material | | |

*3′ denotes the displacement from the 3′-th surface to 3rd surface.

As shown in Table 9, in the present example, the focal distance f1 is set at 2.60 mm and the magnification m1 is set at 0 when the wavelength λ1 is 407 mm. The focal distance f2 is set at 2.65 mm and the magnification m2 is set at 0 when the wavelength λ2 is 655 nm. The focal distance f3 is set at 2.70 mm and the magnification m3 is set at 0 when the wavelength λ3 is 785 nm.

The refractive index nd in the d-line of the material A is set at 1.5891, and the Abbe's number νd in the d-line is set at 61.3. The refractive index nd in the lined of the material B is set at. 1.5737, and the Abbe's number νd in the d-line is set at 29.1. The refractive index nd on the d-line of the objective lens OL is set at 1.5891 and the Abbe's number νd in the d-line is set at 61.3.

The optical surface (5th surface) of on-the light source side and the optical surface. (6th surface) on the optical disc side the objective lens OL are designed in an aspherical shape, and the aspherical surface can be expressed by the equation obtained by substituting the coefficient of the Table 9 into the following aspherical shape equation:

[Aspherical Shape Equation]
z=(y²/R)/[1+√{1−(K+1)(y/R)²}]+A₄y⁴+A₆y⁶+A₈y⁸+A₁₀y¹⁰+A₁₂y¹²+A₁₄y¹⁴

The diffractive structure DOE formed on the boundary (third surface) between the material A and material B; and the diffractive structure DOE2 formed on the boundary (second surface) between the material A and the air are each expressed by the difference in the optical path to be added to the incoming light flux by the diffractive structures DOE and DOE2. Such an optical path difference is expressed by the optical path function φ (mm) obtained by substituting the coefficient of the Table 9 into the equation showing the following optical path difference function:

[Optical Path Difference Function]

Diffractive structure DOE
φ=λ×M×(B₂y²+B₄y⁴+B₆y⁶+B₈y⁸+B₁₀y¹⁰)

Diffractive structure DOE2
φ=λ×M×(B₂y²+B₄y⁴+B₆y⁶)

“M” denotes the order of diffraction. So in the case of the diffractive structure DOE in the third surface, 0 for HD DVD, 1 for DVD or 0 for CD is substituted. In the case of the diffractive structure DOE2 in the fifth surface, 0 for HD DVD, 1 for DVD or 0 for CD is substituted.

### Example 8

Table 10 shows the lens data when a diffractive structure is arranged also on the surface of the objective lens shown in FIG. 13, by way of the eighth embodiment.

TABLE 10
Example 8: Lens data

| | | | |
|---|---|---|---|
| Composite focal distance of an | f1 = 2.6 mm | f2 = 2.65 mm | f3 = 2.70 mm |
| aberration corrected lens and an | | | |
| objective lens | | | |
| Numerical aperture on image surface | NA1: 0.65 | NA2: 0.65 | NA3: 0.51 |
| side | | | |
| Magnification | m1 = 0 | m2 = 0 | m3 = 0 |

| i-th | | di | ni | di | ni | di | ni |
|---|---|---|---|---|---|---|---|
| surface | Ri | (407 nm) | (407 nm) | (655 nm) | (655 nm) | (785 nm) | (785 nm) |
| 0 | | ∞ | | ∞ | | ∞ | |
| 1 | | 0.0 | | 0.0 | | 0.0 | |
| (aperture | | (φ 3.38 mm) | | (φ 3.445 mm) | | (φ 2.754 mm) | |
| diameter) | | | | | | | |
| 2 | ∞ | 0.10 | 1.6049 | 0.10 | 1.5859 | 0.10 | 1.5824 |
| 3 | ∞ | 0.50 | 1.6090 | 0.50 | 1.5680 | 0.50 | 1.5611 |
| 4 | ∞ | 0.05 | 1.0 | 0.05 | 1.0 | 0.05 | 1.0 |
| 5 | 1.7309 | 1.80 | 1.6049 | 1.80 | 1.5859 | 1.80 | 1.5824 |
| 6 | −10.467 | 1.21 | 1.0 | 1.24 | 1.0 | 0.90 | 1.0 |
| 7 | ∞ | 0.6 | 1.6187 | 0.6 | 1.5775 | 1.2 | 1.5706 |
| 8 | ∞ | | | | | | |

3rd surface
Optical path function (HD, DVD; 0-th-order DVD: first-order
CD: first-order λ_{B} = 700 nm)

| | |
|---|---|
| B2 | 0.0000E+00 |
| B4 | −5.4740E−04 |
| B6 | −1.0497E−04 |
| B8 | 6.8832E−06 |
| B10 | −1.1413E−06 |

5th surface
Aspherical surface coefficient

| | |
|---|---|
| κ | −9.8720E−01 |
| A4 | 1.3621E−02 |
| A6 | 7.0941E−04 |
| A8 | 2.2009E−03 |
| A10 | −1.6581E−03 |
| A12 | 5.5244E−04 |
| A14 | −5.4517E−05 |

Optical path function (HD, DVD; 0-th-order DVD: first-order
CD: 0-th-order λ_{B} = 655 nm)

| | |
|---|---|
| B2 | −2.3116E−03 |
| B4 | 3.5622E−04 |
| B6 | 5.8574E−05 |

6th surface
Aspherical surface coefficient

| | |
|---|---|
| κ | 5.0000E+00 |
| A4 | 2.7943E−02 |
| A6 | 1.1100E−02 |
| A8 | −3.5881E−02 |
| A10 | 3.2444E−02 |
| A12 | −1.2611E−02 |
| A14 | 1.8231E−03 |

| | nd | νd |
|---|---|---|
| Material A | 1.5891 | 61.3 |
| Material B | 1.5737 | 29.1 |
| Lens | 1.5891 | 61.3 |
| Material | | |

*3′ denotes the displacement from the 3′-th surface to 3rd surface.

As shown in Table 10, in the present example, the focal distance f1 is set at 2.60 mm and the magnification m1 is set at 0 when the wavelength λ1 is 407 mm. The focal distance f2 is set at 2.65 mm and the magnification m2 is set at 0 when the wavelength λ2 is 655 nm. The focal distance f3 is set at 2.70 mm and the magnification m3 is set at 0 when the wavelength λ3 is 785 nm.

The refractive index nd in the d-line of the material A is set at 1.5891, and the Abbe's number νd in the d-line is set at 61.3. The refractive index nd in the lined of the material B is set at 1.5737, and the Abbe's number νd in the d-line is set at 29.1. The refractive index nd on the d-line of the objective lens OL is set at 1.5891 and the Abbe's number νd in the d-line is set at 61.3.

The optical surface (5th surface) of on the light source side and the optical surface (6th surface) on the optical disc side the objective lens OL are designed in an aspherical shape, and the aspherical surface can be expressed by the equation obtained by substituting the coefficient of the Table 10 into the following aspherical shape equation:

[Aspherical Shape Equation]
z=(y²/R)/[1+√{1−(K+1)(y/R)²}]+A₄y⁴+A₆y⁶+A₈y⁸+A₁₀y¹⁰+A₁₂y¹²+A₁₄y¹⁴

The diffractive structure DOE formed on the boundary (third surface) between the material A and material B, and the diffractive structure DOE3 formed on the surface of the objective lens OL (fifth surface) are each expressed by the difference in the optical path to be added to the incoming light flux by the diffractive structures DOE and DOE2. Such an optical path difference is expressed by the optical path function φ (mm) obtained by substituting the coefficient of the Table 10 into the equation showing the following optical path difference function:

[Optical Path Difference Function]

Diffractive structure DOE
φ=λ×M×(B₂y²+B₄y⁴+B₆y⁶+B₈y⁸+B₁₀y¹⁰)

Diffractive structure DOE3
φ=λ×M×(B₂y²+B₄y⁴+B₆y⁶)

“M” denotes the order of diffraction. So in the case of the diffractive structure DOE in the third surface, 0 for HD DVD, 1 for DVD or 1 for CD is substituted. In the case of the diffractive structure DOE2 in the fifth surface, 0 for HD DVD, 1 for DVD or 0 for CD is substituted.

### Embodiment 5

Referring to the drawing, the following describes the fifth embodiment:

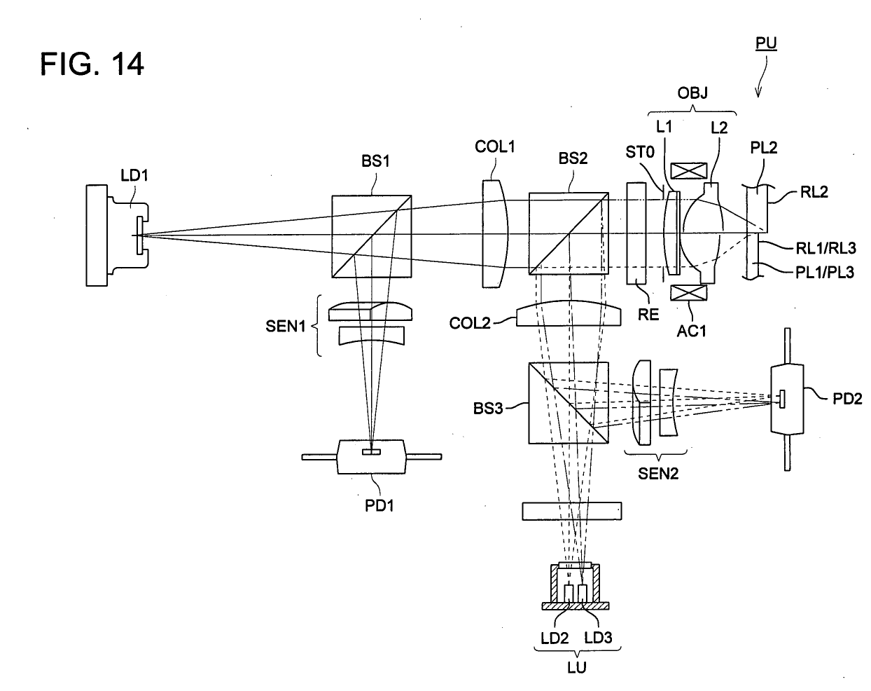

FIG. 14 is a drawing schematically representing the structure of an optical pickup apparatus PU capable of adequate recording/reproducing of information using any of the HD (first optical information recording medium) and DVD (second optical information recording medium). In terms of optical specifications, the HD is characterized by the first wavelength λ1 of 407 nm, the protective layer PL1 having a thickness t1 of 0.6 mm, and the numerical aperture of NA1 of 0.65. The DVD is characterized by the second wavelength λ2 of 655 nm, the protective layer PL2 having a thickness t2 of 0.6 mm, and the numerical aperture NA2 of 0.65. The CD is characterized by the third wavelength λ3 of 785 nm, the protective layer PL3 having a thickness t3 of 1.2 mm, and the numerical aperture NA3 of 0.51.

The magnifications of the objective optical system device (m1 through m3) for recording/reproducing of information using the first through third optical information recording medium can be represented by m1=m2=m3=0. To put it another way, the objective optical system OBJ in the present embodiment is structured in such a way that all the first through third light fluxes are emitted as parallel light. It should be noted, however, that the combination of wavelength, the thickness of the protective layer, numerical aperture and optical system magnification are not restricted thereto. A Blu-Ray Disc (BD) of about 0.1 mm in the thickness t1 of the protective layer PL1 can also be used as the first optical information recording medium.

The optical pickup apparatus PU comprises:
a light source unit LU further comprising of an integrated structure of:
   a blue-violet semiconductor laser LD1 (first light source), activated when information is recorded and/or reproduced using a high-density optical disc HD, for emitting a laser light flux (first light flux) having a wavelength of 407 nm;
   a light detector PD1 for the first light flux;
   a red-violet semiconductor laser LD2 (second light source), activated when information is recorded and/or reproduced using a DVD, for emitting a laser light flux (second light flux) having a wavelength of 655 nm; and
an infrared semiconductor laser LD3 (third light source), activated when information is recorded and/or reproduced using a CD, for emitting a laser light flux (third light flux) having a wavelength of 785 nm;
a light detector PD2 to be used commonly for second and third light fluxes;
a first collimating lens COL1 for allowing passage of only the first light flux;
a second collimating lens COL2 for allowing passage of the second and third light fluxes;
an objective optical system OBJ further containing:
   a first optical element L1 wherein a first phase structure is formed on the boundary between materials A and B; and
   a second optical element L2, with both aspherical surfaces, having a function of condensing the laser light flux having passed through the first optical element L1, onto the information recording surfaces RL1, RL2 and RL3;
a beam splitter BS1, a second beam splitter BS2 and a third beam splitter BS3;
an aperture STO; and
sensor lens SEN1 and SEN2.

For recording/reproducing of information using the HD in an optical pickup apparatus PU, the blue-violet semiconductor laser LD1 is activated to emit light, as the optical path is indicated by a solid line in FIG. 14. The divergent light flux emitted from the blue-violet semiconductor laser LD1 passes through the first beam splitter BS1 and reaches the first collimating lens COL1.

It is converted into a parallel light flux when it passed through the first collimating lens COL1. Passing through the second beam splitter BS2 and a quarter-wave plate RE, it reaches the objective optical system OBJ and is turned into a spot formed on the information recording surface RL1, by the objective optical system OBJ through the protective layer PL1. The objective optical system OBJ allows focusing and tracking to be performed by the biaxial actuator AC1 arranged in its periphery.

The reflected light flux modulated by an information pit on the information recording surface RL1 again passes through the objective optical system OBJ, quarter-wave plate RE, second beam splitter BS2 and first collimating lens COL1. Then it is diverged by the first beam splitter BS1. Astigmatism is applied to this light by the sensor lens SEN1, and the light converges on the light receiving surface of the light detector PD1. Then the output signal of the light detector P_{D} can be utilized to scan the information recorded on the high-density optical disc HD.

For recording/reproducing of information using a DVD, the red semiconductor laser LD2 is activated to emit light, as the optical path is indicated by a two-dot chain line in FIG. 14. The divergent light flux from the red semiconductor laser LD2 passes through the third beam splitter BS3 and reaches the second collimating lens COL2.

It is converted into a parallel light flux when it passed through the second collimating lens COL2. After being reflected by the second beam splitter BS2, the light passed through the quarter-wave plate RE and reaches the objective optical system OBJ. The light is turned into a spot formed on the information recording surface RL2, by the objective optical system OBJ through the second protective layer PL2. The objective optical system OBJ allows focusing and tracking to be performed by the biaxial actuator AC1 arranged in its periphery.

The reflected light flux modulated by an information pit on the information recording surface RL2 again passes through the objective optical system OBJ and is reflected by the second beam splitter BS2. Then the light is diverged by the third beam splitter BS3 and is converged on the light receiving surface of the light detector P_{D}2. Then the output signal of the light detector P_{D}2 can be utilized to scan the information recorded on the DVD.

For recording/reproducing of information using a CD, the infrared ray semiconductor laser LD2 is activated to emit light, as the optical path is indicated by a dotted line in FIG. 14. The divergent light flux from the infrared semiconductor laser LD2 passes through the third beam splitter BS3 and reaches the second collimating lens COL2.

The light is converted into a gradual light flux when it passes through the second collimating lens COL2. After being reflected by the second beam splitter BS2, the light passed through the quarter-wave plate RE and reaches the objective optical system OBJ. The light is turned into a spot formed on the information recording surface. RL2, by the objective optical system OBJ through the second protective layer PL2. The objective optical system OBJ allows focusing and tracking to be performed by the biaxial actuator AC1 arranged in its periphery.

The reflected light flux modulated by an information pit on the information recording surface RL2 again passes through the objective optical system OBJ and quarter-wave plate RE. After being reflected by the second beam splitter BS2, the light passes through the collimating lens COL2 and is diverged by the third beam splitter BS3. Then the light is converged on the light receiving surface of the light detector PD2. Then the output signal of the light detector PD2 can be utilized to scan the information recorded on the CD.

The following describes the structure of the objective optical system OBJ.

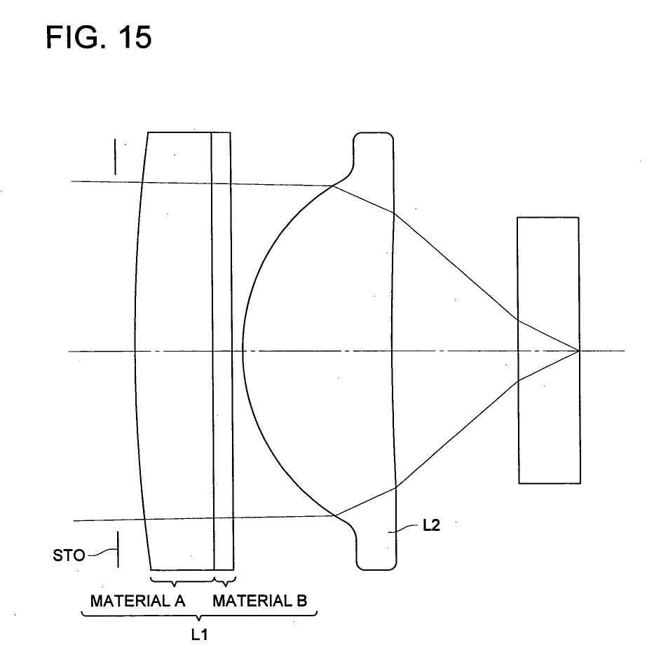

As schematically shown in FIG. 15, the objective optical system is a plastic lens provided with the first and second optical elements L1 and L2 coaxially integrated with each other through the lens frame (not illustrated).

In the present embodiment, the first and second optical elements L1 and L2 are integrated with each other through the lens frame (not illustrated). When the first and second optical elements L1 and L2 are integrated, it is sufficient only if the positional relationship between the first and second optical elements L1 and L2 is kept constant. In addition to the aforementioned method of using the lens frame as an intermediary, it is also possible to utilize the method of fitting the flanges of the first and second optical elementes L1 and L2 with each other.

As shown in FIGS. 16(a) and (b), the first optical element L1 is formed of a lamination between the materials A and B having different Abbe's numbers on the line d.

Assume that the Abbe's number and refractive index of the material A on the d-line are νdA and ndA, and the Abbe's number and refractive index of the material B on the d-line are νdB and ndB. Setting is made in such a way that the following equation is satisfied:
−3.5≦(νdA−νdB)/[100×(ndA−ndB)]≦−0.7

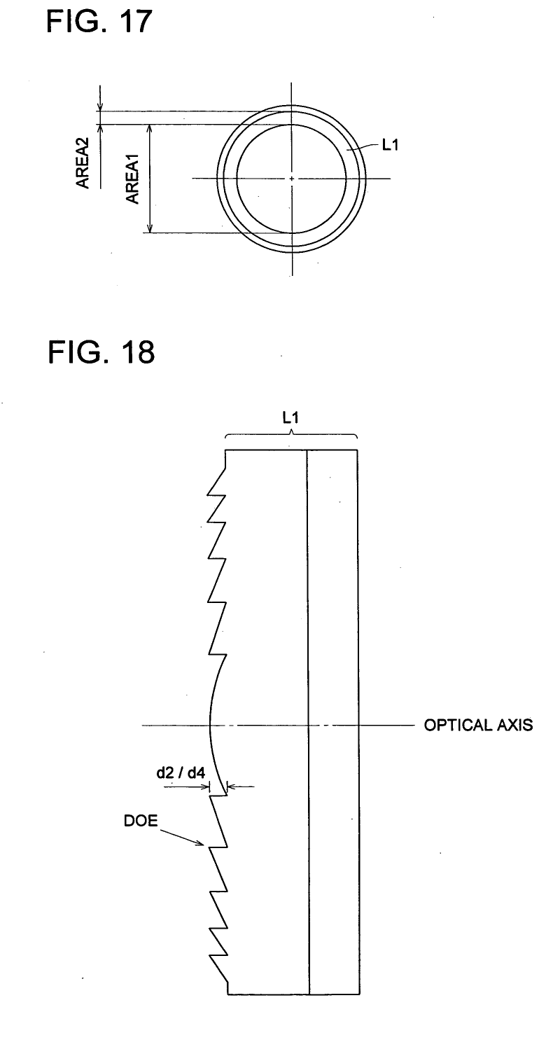

As shown in FIG. 17, the boundary between the material A as a cyclic polyolefin based optical resin and the material B as an ultraviolet curing resin is divided into two areas; a first area AREA1 including the optical axis corresponding to the area inside the NA2 and a second area AREA2 including the optical axis corresponding to the area up to the NA1 and NA2.

A first phase structure HOE as a diffractive structure is formed in the first area AREA1 of the present embodiment, as shown in FIG. 16(a), wherein the first phase structure HOE is structured by concentric arrangement of the step-formed patterns P having a stepped cross section including the optical axis, and, in each pattern, the step is shifted by the height amounting to the number of steps (4 steps in FIGS. 16(a) and (b)) for each of the predetermined number of levels ((5 steps in FIGS. 16(a) and (b)). However, the structure shown in FIG. 16(b) can also be used.

In the diffractive structure HOE formed in the first area AREA1, the depth d1 of the step S formed inside each pattern P in-the direction of optical axis is set so as to satisfy the following equation:
0.8×λ1×K2/(nB1−nA1)≦d1≦1.2×λ1×K2/(nB1−nA1)
where reference symbols denote the following:
nA1: refractive index of the material A with respect to light flux having a wavelength λ1
nB1: refractive index of the material A with respect to light flux having a wavelength λ1

When the depth d1 in the direction of optical axis is set in this manner, the light flux of wavelength λ1 passed by, virtually without being assigned with a phase difference in the first phase structure HOE. In the light flux of wavelength λ3, the ratio of the difference in the refractive index between the materials A and B is increased sufficiently due to different forms of divergence, as described above. Accordingly, the light is virtually assigned with phase difference in the first phase structure HOE and is subjected to diffraction.

To put it more specifically, the depth 1 of the first phase structure in the direction of optical axis is set to d1, d=0.407×2/(1.640199−1.46236)=4.58 μm. Accordingly, when the light flux having a wavelength λ1=0.407 μm has entered this diffractive structure, a phase difference of 2π×2 is produced by the adjacent levels, and virtual phase difference does not occur. To put it another way, the light flux having a wavelength λ1 passes through with high efficiency (100%).

When the light flux having a wavelength λ3=0.785 μm has entered this diffractive structure, a phase difference of 2π×d1×(1.585994−1.444785)/0.785=2π×0.823 is produced by the adjacent levels. If the number of the levels inside each pattern is 5, the phase difference occurring at both ends of each pattern will be 2π×0.823×5=2π×4.11, which is close to an integer. Accordingly, the light flux having a wavelength λ3 is diffracted with high efficiency (84%).

Further, when the light flux having a wavelength λ2=0.655 μm has entered the diffractive structure, a phase difference of 2π×d1×(1.593694−1.447749)/0.655=2π×1.02 is produced by the adjacent levels. Since there is no virtual phase difference, the light flux having a wavelength λ2 passes through with high efficiency (97%).

A diffractive structure DOE (second and third phase structures in FIG. 18) provided with a plurality of straps having a serrated cross section including the optical axis is formed on the optical surface of the first and second optical elements L1 and L2.

For example, the second phase structure is provided with the function of correcting the spherical aberration caused by the difference between the wavelengths λ1 and λ3. This arrangement allows the HD and DVD to be compatible with each other with respect to the objective optical system OBJ. (The spherical aberration caused by the difference between the wavelengths λ1 and λ3 can also be corrected by allowing at least three of the optical surfaces of the objective optical system OBJ to be formed aspherical, instead of forming the second phase structure). Further, by providing a chromatic aberration correcting function in the area of wavelength λ1 through the third phase structure, excellent state of condensation can be maintained at all times, without the condensing spot getting increased in size, even when a mode hop has occurred. Further, if the third phase structure is used to correct an increase in the spherical aberration resulting from temperature changes, the usable temperature range of the objective optical system OBJ can be expanded.

As described above, in the optical pickup apparatus PU shown in the present embodiment, the objective optical system OBJ is provided with the first and second optical elements L1 and L2. Of these lenses, the first optical element L1 is provided with a lamination of the materials A and B having different Abbe's numbers on the line d. Further, the first phase structure HOE is formed on the boundary between the materials A and B.

Because of this arrangement, the light flux of wavelength λ1 (e.g. blue-violet laser beam having a wavelength λ1=407 nm) having a wavelength ratio equal to almost an integer ratio, and the light flux of wavelength λ3 (e.g. infrared laser beam having a wavelength λ3=785 nm) can be emitted at different angles from each other, using the first diffractive structure HOE. This arrangement corrects the spherical aberration caused by the difference in thicknesses t1 and t3 of the protective layer. At the same time, the number of the levels constituting each pattern is selected adequately in conformity to the ratio of the difference in the refractive indexes of the materials A and B, whereby a sufficiently high diffraction efficiency of the wavelength λ3 can be ensured.

The present embodiment uses the light source unit LU provided with a red semiconductor laser LD2 and infrared semiconductor laser LD3 integrated with each other. However, without being restricted thereto, the present invention allows use of a laser light source unit for HD, DVD and CD with the blue-violet semiconductor laser LD1 (first light source) also incorporated in one casing.

### Embodiment 6

The following describes the sixth embodiment of the present invention with reference to drawings. The same structures as those of the aforementioned first embodiment will not be described to avoid duplication.

The following describes the objective optical system OU.

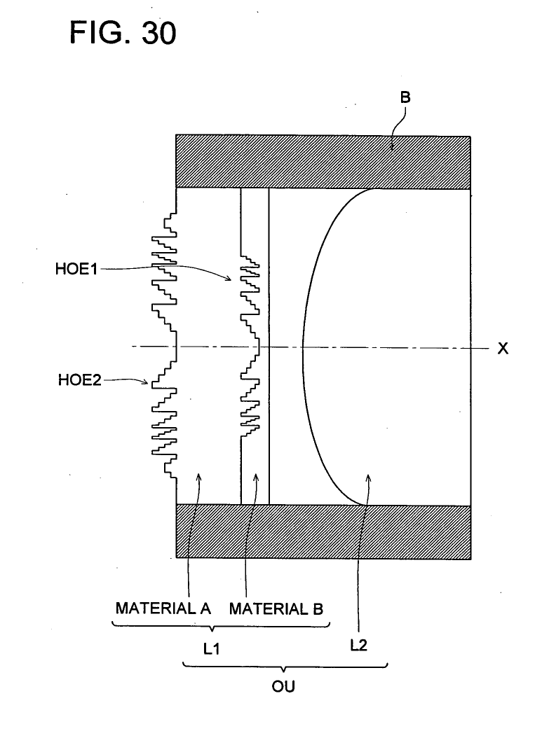

As shown schematically in FIG. 30, the objective optical system is a BD, DVD and CD-compatible lens unit provided with the first and second optical element L1 and L2 coaxially integrated through the lens frame B.

As shown in FIG. 30, the first optical element L1 is made of a lamination of the materials A and B having different Abbe's numbers on the line d. Both materials A and B are made of resin. The second optical element L2 is a glass lens having a NA of 0.85, wherein the aspherical shape is optimized to ensure that the spherical aberration will be minimized with respect to the first wavelength λ1 and protective substrate having a thickness of 0.1 mm.

Assume that the Abbe's number and refractive index of the material A on the d-line are νdA and ndA, and the Abbe's number and refractive index of the material B on the d-line are νdB and ndB. Setting is made in such a way that the following equation is satisfied:
−3.5≦(νdA−νdB)/[100×(ndA−ndB)]≦−0.7
Further, νdB<νdA and ndB>ndA are satisfied. To put it more specifically, νdA=56.4, νdB=27, ndA=1.509140, ndB=1.630000.

The boundary between the materials A and B is divided into two areas; a first area AREA1 (central area) including the optical axis corresponding to the area inside the NA2 and a second area AREA2 (peripheral area) including the optical axis corresponding to the area from NA2 to NA1 and NA2 (not illustrated). A first phase structure HOE1 is formed in the first area AREA1, as shown in FIG. 30, wherein the first phase structure HOE is structured by concentric arrangement of the step-formed patterns having a stepped cross section including the optical axis, and the step is shifted by the height amounting to the number of steps (4 steps in FIG. 30) for each of the predetermined number of levels (5 steps in FIG. 30). However, the structure shown in FIG. 16(b).

In the first phase structure HOE1, the depth d1 of the step S formed inside each pattern P in the direction of optical axis is set so as to satisfy the following equation:
0.8×λ1×K2/(nB1−nA1)≦d1≦1.2×λ1×K2/(nB1−nA1)
where reference symbols denote the following:
nA1: refractive index of the material A with respect to light flux having a wavelength λ1
nB1: refractive index of the material A with respect to light flux having a wavelength λ1
K2: natural number

To put it more specifically, nA1=1.524649, nB1=1.673134, λ1=0.405 μm, K2=2, d1=5.457 μm. To put it another way, the step d1 has a height to satisfy d1=2·λ1·(nB1−nA1)=0.974·λ2·(nB2−nA2). Accordingly, when the light having a wavelength λ1 of 0.405 μm has entered the first phase structure HOE1, an optical path difference equivalent to two wavelengths λ1 occurs between the adjacent levels. When the light having a wavelength λ2=0.655 μm has entered the first phase structure HOE1, an optical path difference equivalent to one wavelengths λ2 occurs between the adjacent levels.

Here nA2 denotes the refractive index of the material A (nA2=1.506513) in the present embodiment) with respect to the light flux of wavelength λ2. nB₂ denotes the refractive index of material B (nB₂=1.623379) with respect to the light flux of wavelength λ2. Accordingly, the light fluxes of wavelength λ1 and λ2 pass through with high efficiency, without virtual phase difference, since there is agreement in the wave front between the adjacent levels (0-th order diffracted light flux). It should be noted, however, that the efficiency of the light flux of wavelength λ1 is 100% and that of the wavelength λ2 is 94.6%.

In the meantime, when the light of wavelength λ3=0.785 μm has entered the first phase structure HOE1, an optical path difference of |d1·(nB3−nA3)−λ3|=|0.611−0.785″=0.174 μm occurs between the adjacent levels. Here nA3 denotes the refractive index of material A with respect to the light flux of wavelength λ3 (nA2=1.506513) in the present embodiment), and nB3 denotes the refractive index of material B with respect to the light flux of wavelength λ3 (nB3=1.623379) in the present embodiment).

The number of levels in one period of the first phase structure HOE1 is 5, thus 0.174×5=0.870 μm. The absolute value is close to wavelength λ2. An optical path difference equivalent to just one wavelength occurs on both ends of each pattern. Accordingly, when the light of wavelength λ3 has entered the first phase structure HOE1, light diffracts in the first-order direction (in the direction where the light flux of the wavelength λ2 having entered as parallel light is converted into divergent light) with high efficiency (84.5%).

As described above, the first phase structure HOE1 independently controls the aberration with respect to the light flux of wavelength λ3 by selective diffraction of the light flux of wavelength λ3 alone. This permits satisfactory correction of the spherical aberration caused by the difference in the thickness of the protective substrate. Transmittance of the blue-violet wavelength having an approximately twice the wavelength ratio and infrared wavelength, and compatibility between BD and CD are ensured, especially by lamination of the materials A and B having different forms of dispersion.

Further, the light incoming surface of the material A is divided into two areas; a third area AREA3 (central area) including the optical axis corresponding to the area inside the NA3 and a fourth area AREA4 (peripheral area) corresponding to the area from NA3 to NA1 (not illustrated). The third area AREA3 is provided with a second phase structure HOE2 formed by concentric arrangement of the step-formed patterns P having a stepped cross section including the optical axis as shown in FIG. 30 wherein the step is shifted by the height amounting to the number of steps (4 steps in FIG. 30) for each of the predetermined number of levels (5 steps in FIG. 30).

In the second phase structure HOE2, the depth d2 of the step S formed inside each pattern P in the direction of optical axis is so set as to meet the equation of 0.8×λ1×K3/(nC1−1)≦d2≦1.2×λ1×K3/(nC1−1).

In this case, nC1 denotes the refractive index of the material A with respect to the light flux having wavelength λ1, λ3 indicates a natural number.

To put it more specifically, nC1=1.524694, λ1=0.405 μm, K3=2, d2=1.544 μm. To put it another way, this step d2 has a height to meet d2=2·λ1·(nC1−1)=0.990·λ3·(nC2−1). Accordingly, when light of wavelength λ1=0.405 μm is applied to the second phase structure HOE2, optical path difference equivalent to two wavelengths λ is produced on the adjacent levels. When the light of wavelength λ3=0.785 μm is applied to the second phase structure HOE2, optical path difference equivalent to about one wavelengths λ3 is produced on the adjacent levels

Here nC2 denotes the refractive index of material A with respect to the light flux of wavelength λ3 (nC2=1.503235) in the present embodiment). Thus, the light fluxes of wavelengths λ1 and λ3 pass through with high efficiency, without virtual phase difference, since there is agreement in the wave front between the adjacent levels (0-th order diffracted light flux). It should be noted, however, that the efficiency of the light flux of wavelength λ1 is 100% and that of the wavelength λ3 is 99.2%.

In the meantime, when the light of wavelength λ2=0.655 μm is applied to the second phase structure HOE2, the optical path difference equivalent to |d2·(nC2−1)−λ2|=|0.782−0.655|=0.127 μm is produced on the adjacent levels, where cC2 denotes the refractive index of material A with respect to the light flux of wavelength λ3 (nC2=1.506513) in the present embodiment).

Since the number of levels in one period of the second phase structure HOE2 is 5, 0.127×5=0.635 μm. The absolute value is close to the wavelength λ3. An optical path difference equivalent to just one wavelength occurs on both ends of each pattern. Accordingly, when the light of wavelength λ2 has entered the second phase structure HOE2, light diffracts in the first-order direction (in the direction where the light flux of the wavelength λ2 having entered as parallel light is converted into divergent light) with high efficiency (87.3%).

As described above, the second phase structure HOE2 independently controls the aberration with respect to the light flux of wavelength λ2 by selective diffraction of the light flux of wavelength λ2 alone. This permits satisfactory correction of the spherical aberration caused by the difference in the thickness of the protective substrate. Transmittance of the blue-violet wavelength having an approximately 1.6 times the wavelength ratio and infrared wavelength, and compatibility between BD and DVD are ensured, especially by formation of the second phase structure on the material A meeting the Abbe's number of 45≦νdA≦65 on the line d.

As described above, the first phase structure HOE1 is formed on the first area AREA1(central area) including the optical axis corresponding to the area inside the NA2. So the spherical aberration caused by the difference in the thickness between the BD and CD is not corrected, with respect to the light flux of wavelength λ3 passing through the second area AREA2 (peripheral area) corresponding to the area from NA3 to NA1. Accordingly; on the CD information recording surface, the light flux of wavelength λ3 passing through the second area AREA2 (peripheral area) having a large spherical aberration is concentrated on spot beyond the condensed spot formed by the light flux of wavelength λ3 passing through the first area AREA1 (central area). This is equivalent to automatic aperture restriction conforming to the NA2. The objective optical system of the present embodiment does not require aperture restriction conforming to the NA2. This ensures a simplified structure of the optical pickup apparatus.

Further, the second phase structure HOE2 is formed on the third area AREA3 (central area) including the optical axis corresponding to the area inside the NA3. For the same reason as mentioned above, the objective optical system of the present embodiment does not require aperture restriction conforming to the NA3.

The optical pickup apparatus PU of the present embodiment is structured in such a way that the first lens EXP1 of the expander lens EXP can be driven in the direction of optical axis by the uniaxial actuator AC2. This arrangement allows the light flux of each wavelength to be emitted as parallel light from the expander lens EXP, by changing the focal distance of the expander lens EXP in conformity to the wavelength of the incoming light flux. This arrangement also corrects the spherical aberration of the spot formed on the information recording surface RL1 of the BD. The causes for the occurrence of the spherical aberration to be corrected by adjusting the position of the first lens EXP1 includes variations of the wavelength resulting from the production error of the blue-violet semiconductor laser LD1, a focus jump among information recording layers in a multilayer disc such as a two-layer or four-layer disc, and variations of the thickness or distribution of thickness resulting from the production error of the protective substrate of the BD. The optical pickup apparatus PU of the present embodiment preferably comprises a spherical aberration detecting means for detecting the spherical aberration of the spot formed on the information recording surface RL1 of the BD; and a control means for operating the uniaxial actuator AC2 according to the spherical aberration error signal produced by the spherical aberration detecting means.

The present embodiment uses the light source unit LU for DVD and CD, wherein both the first emitting section EP1 and second emitting section EP2 are formed on one chip. However, without being restricted thereto, the present invention allows use of a laser light source unit for BD, DVD and CD, wherein an emitting section for emitting a laser beam having a wavelength of 405 nm is also incorporated on one and the same chip. Alternatively, it is also possible to use a laser light source unit for BD, DVD and CD, wherein three light sources of blue-violet semiconductor laser, red semiconductor laser and infrared semiconductor laser are incorporated in one enclosure.

In the present embodiment, the light source and light detector P_{D} are arranged separately from each other. Without being restricted to such a structure, it is possible to use a laser light source module packing both the light source and light detector.

In the present embodiment, the first and second optical elements L1 and L2 are integrated into one unit through the lens frame B. When the first and second optical elements L1 and L2 are integrated into one unit, it is sufficient only if the positional relationship between the first and second optical elements L1 and L2 is kept constant. In addition to the aforementioned method of using the lens frame an intermediary, it is also possible to utilize the method of fitting the flanges of the first and second optical elements L1 and L2 with each other.

In the present embodiment, the first phase structure HOE1 (or second phase structure HOE2) is formed only in the first area AREA1 (or the third area AREA3). The first phase structure HOE1 (or second phase structure HOE2) can also be formed in the second area AREA2 (or fourth area AREA4). This arrangement permits free control of the spherical aberration of the light flux of wavelength λ3 (or λ2) passing through the second area AREA2 (or fourth area AREA4), and hence ensures excellent characteristics in detecting the focus position of the objective optical system by the light detector P_{D}.

Moreover, a third phase structure can be formed on at least one of the optical surface of the material B on the optical information recording medium side, the optical surface of the second optical element L2 on the light source side, and optical surface of the second optical element L2 on the optical information recording medium side. This arrangement allows characteristics of the objective optical system to be improved. When the third phase structure is used to correct the chromatic spherical aberration in the wavelength area within wavelength λ1±10 nm, it is possible to relax the tolerance in terms of the individual difference in the oscillation waveforms of the violet semiconductor laser light source. Further, when the third phase structure is used to correct the focus displacement of the objective optical system in the wavelength area within the range of wavelength λ2±2 nm, it is possible to reduce the deterioration of the condensation performance by mode hopping at the time of switching from reproducing mode to recording mode, or from recording mode to reproducing mode. If the third phase structure is used to correct the increase in the spherical aberration caused by changes in refractive index, it is possible to improve the recording/reproducing characteristics at the time of temperature change, and permits the second optical element to be made of resin. Accordingly, this arrangement reduces the weight of the objective optical system, and hence the manufacturing cost.

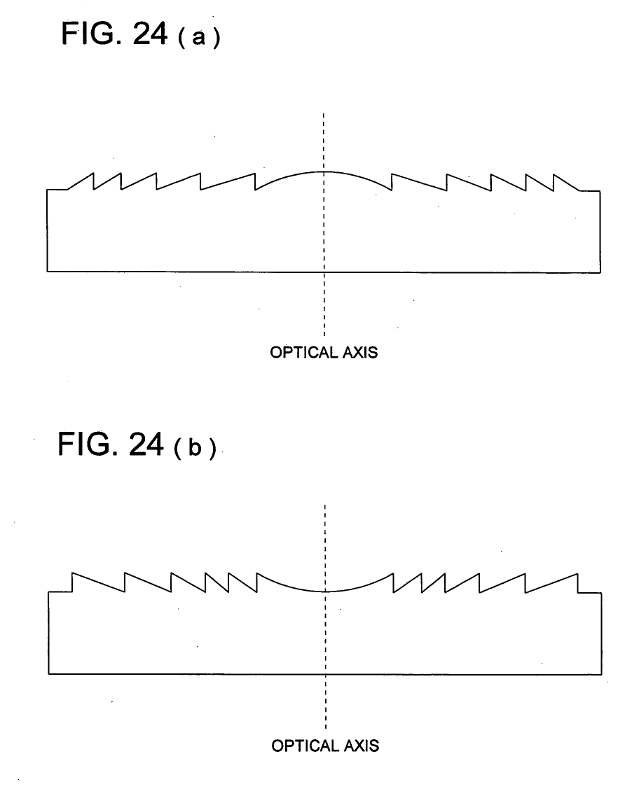

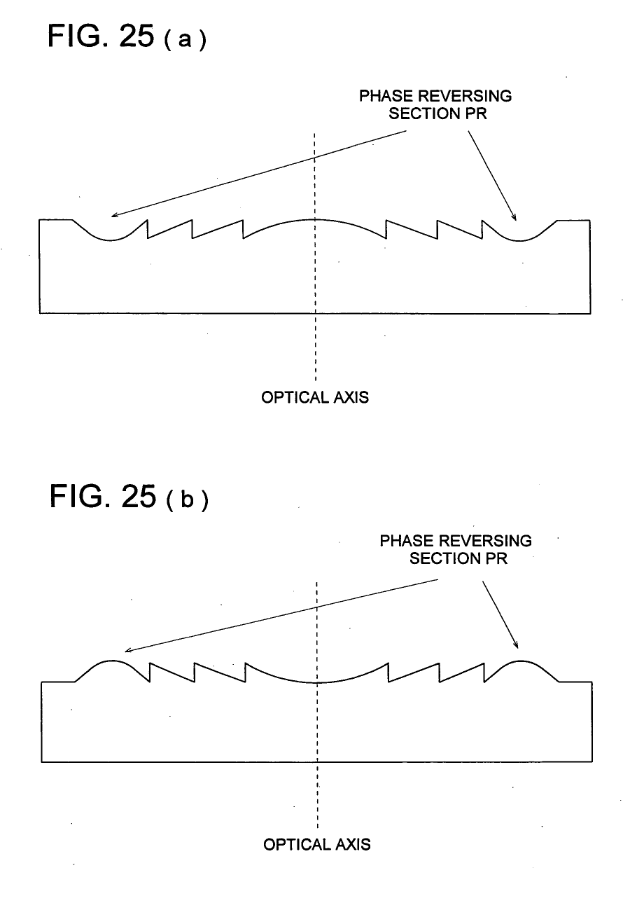

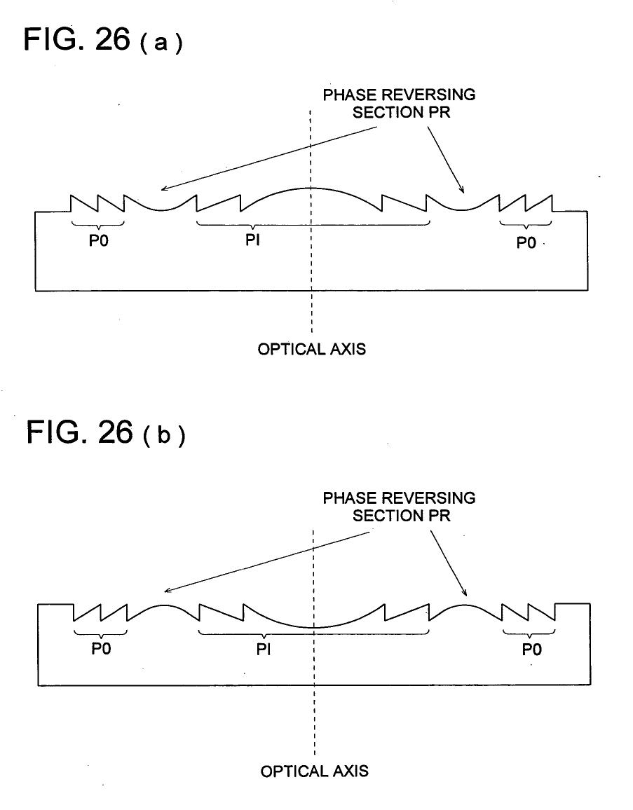

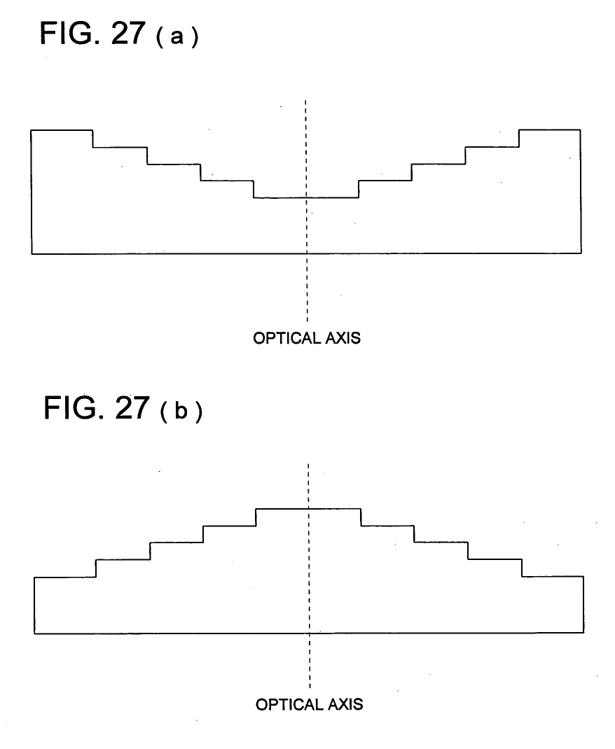

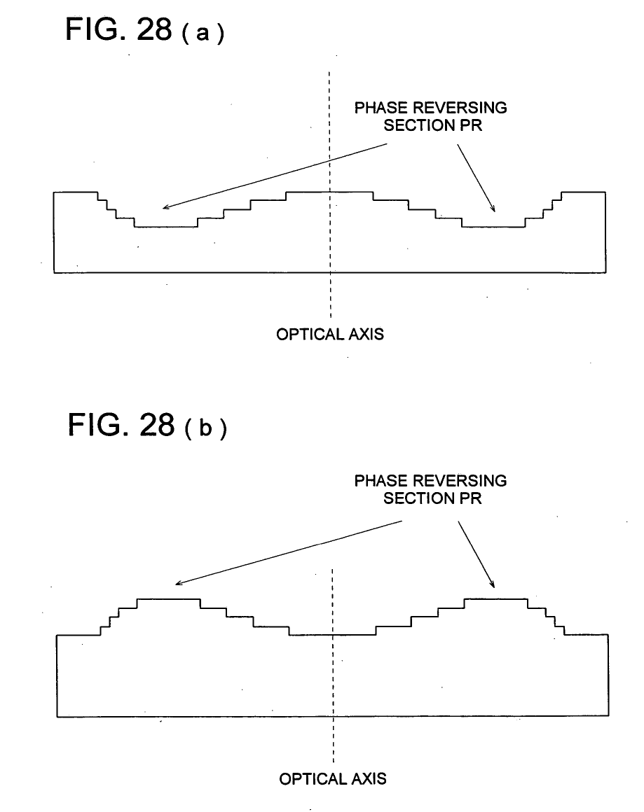

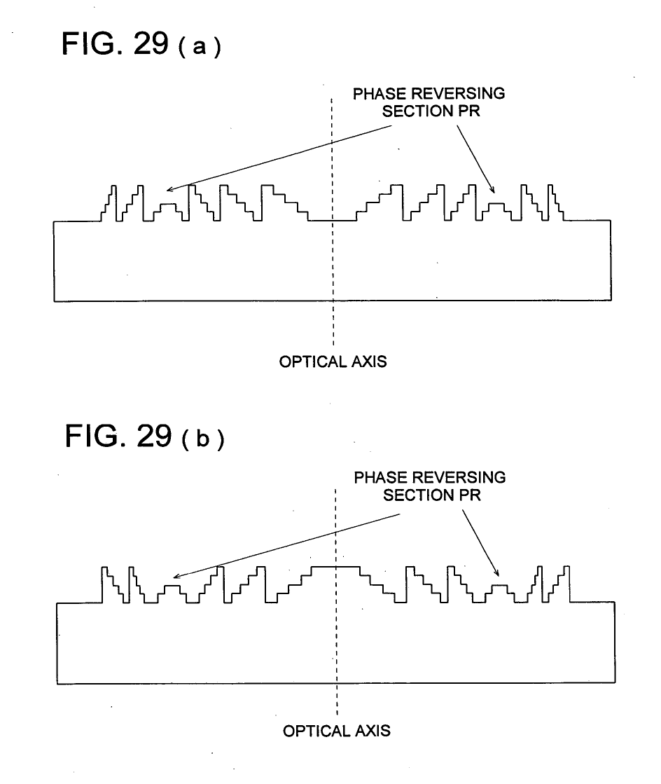

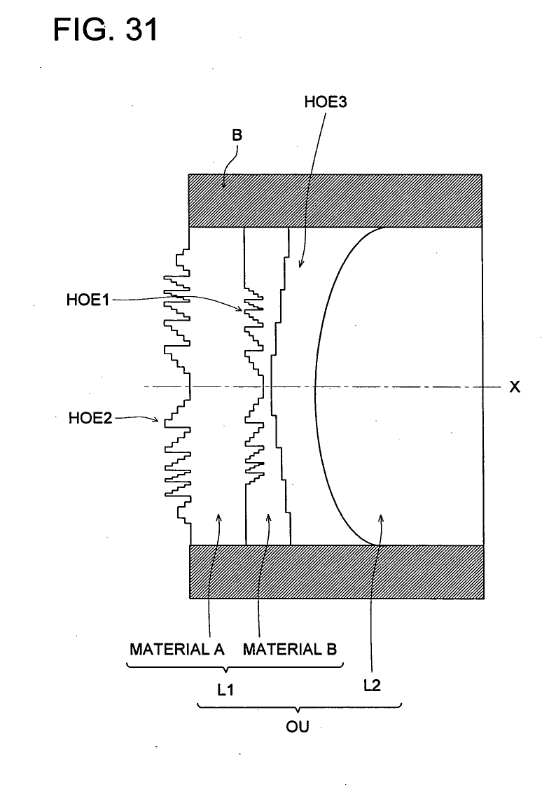

FIG. 31 schematically shows the objective optical system when a third diffractive structure DOE3 is formed on the optical surface of the material B on the optical information recording medium side. In FIG. 31, the third diffractive structure DOE3 is formed in such a stepped structure that the optical path gets longer as the cross section including the optical axis moves away from the optical axis (FIG. 27(a)). This arrangement corrects the chromatic spherical aberration in the range of the wavelength λ1±10 nm, and the focal displacement of the objective optical system in the range of the wavelength λ1±2 nm. The cross section including the optical axis of the third phase structure varies according to the type of the aberration as an object of correction. It corresponds to any one of the structures schematically shown in FIGS. 24(a) through 28(b).

In the invention mentioned above, the following shows the preferred ranges for the wavelengths λ1, λ2 and λ3 and thicknesses of protective substrate t1, t2 and t3:
350 nm≦λ1≦450 nm
600 nm≦λ2≦700 nm
750 nm≦λ3≦850 nm
0.0 mm≦t1≦0.7 mm
0.4 mm≦t2≦0.7 mm
0.9 mm≦t3≦1.3 mm

The following shows the more preferred ranges:
390 nm≦λ1≦415 nm
635 nm≦λ2≦670 nm
770 nm≦λ3≦810 nm
0.0 mm≦t1≦0.7 mm
0.5 mm≦t2≦0.7 mm
1.1 mm≦t3≦1.3 mm

### Example 9

The following describes the example of the objective optical system shown in the aforementioned embodiment:

Table 11 gives the lens data for the ninth embodiment.

In Table 11 and table 12 to be shown later, “Ri” denotes a paraxial curvature radius (unit: mm). “di” (407 nm), “di” (655 nm) and “di” (785 nm) denote the spaces between surfaces (unit: nm) when HD, DVD and CD are used, respectively. “ni” (407 nm), “ni” (655 nm) and “ni” (785 nm) indicate the refractive indexes in the wavelengths λ1, λ2 and λ3, respectively. The order of diffraction a/b/c represents that the diffracted light flux of the wavelength λ1 occurring in the diffractive structure has the order “a” of diffraction, that of the wavelength λ2 has the order “b” of diffraction, and that of the wavelength λ3 has the order “c” of diffraction. The diffraction efficiency (scalar calculation) A/B/C indicates that the diffraction efficiency of the diffracted light flux of the wavelength λ1 occurring in the diffractive structure according to scalar calculation is A %, that of the wavelength λ2 is B %, and that of the wavelength λ3 is C %.

TABLE 11
Example 11: Lens data

| | | | |
|---|---|---|---|
| Focal distance of objective lens | f1 = 2.6 mm | f2 = 2.68 mm | f3 = 2.66 mm |
| Numerical aperture on the image | NA1: 0.65 | NA2: 0.65 | NA3: 0.51 |
| surface side | | | |
| Magnification | m1 = 0 | m2 = 0 | m3 = 0 |

| i-th | | di | ni | di | ni | di | ni |
|---|---|---|---|---|---|---|---|
| surface | Ri | (407 nm) | (407 nm) | (655 nm) | (655 nm) | (785 nm) | (785 nm) |
| 0 | | ∞ | | ∞ | | ∞ | |
| 1 | | 0.0 | | 0.0 | | 0.0 | |
| (aperture | | (φ 3.484 mm) | | (φ 3.484 mm) | | (φ 3.484 mm) | |
| diameter) | | | | | | | |
| 2 | ∞ | 0.10 | 1.46236 | 0.10 | 1.447749 | 0.10 | 1.444785 |
| 3 | ∞ | 0.80 | 1.640199 | 0.80 | 1.593694 | 0.80 | 1.585994 |
| 3′ | ∞ | 0.00 | 1.640199 | 0.00 | 1.593694 | 0.00 | 1.585994 |
| 4 | | 0.05 | 1.0 | 0.05 | 1.0 | 0.05 | 1.0 |
| 5 | 1.39550 | 1.50 | 1.46236 | 1.50 | 1.447749 | 1.50 | 1.444785 |
| 6 | −7.66609 | 1.28 | 1.0 | 1.33 | 1.0 | 0.92 | 1.0 |
| 7 | ∞ | 0.6 | 1.61869 | 0.6 | 1.57752 | 1.2 | 1.57063 |
| 8 | ∞ | | | | | | |

2nd surface
Optical path function (blazed wavelength: 407 nm)
Order of diffraction 8/5/4
Diffraction efficiency (scalar calculation)
100/89/100

| | |
|---|---|
| C2 | −1.1812E−03 |
| C4 | −3.7265E−04 |
| C6 | 8.3558E−05 |
| C8 | −2.4856E−05 |
| C10 | 2.7875E−06 |

3rd surface
Optical path function (blazed wavelength: 785 nm)
(0 mm ≦ h < 1.355 mm) Order of diffraction 0/0/1
Diffraction efficiency (scalar calculation)
100/97/84

| | |
|---|---|
| C2 | −3.2911E−03 |
| C4 | −7.3603E−04 |
| C6 | −8.9165E−05 |

3′-th surface
(1.355 mm ≦ h)
5th surface
Aspherical surface coefficient

| | |
|---|---|
| κ | −9.2315E−01 |
| A4 | 1.7061E−02 |
| A6 | 2.7605E−03 |
| A8 | 2.7881E−03 |
| A10 | −1.2808E−03 |
| A12 | 3.8889E−04 |
| A14 | 2.3646E−05 |

6th surface
Aspherical surface coefficient

| | |
|---|---|
| κ | −9.2308E+01 |
| A4 | 1.5820E−02 |
| A6 | 4.5572E−03 |
| A8 | −7.8219E−03 |
| A10 | 4.1497E−03 |
| A12 | −1.0960E−03 |
| A14 | 1.1606E−04 |

| | nd | νd |
|---|---|---|
| Material A | 1.45 | 60 |
| Material B | 1.6 | 27 |
| Second | 1.45 | 60 |
| optical | | |
| element | | |

*3′ denotes the displacement from the 3′-th surface to 3rd surface.

As shown in FIG. 11, in the HD, D-VD and CD-compatible objective optical system, the focal distance f1 for wavelength λ1 of 407 nm is set at 2.6 mm, and the magnification m1 at 0; the focal distance f2 for wavelength λ3 of 785 nm is set at 2.66 mm, and the magnification m3 at 0; and the focal distance f3 for wavelength λ2 of 655 nm is set at 2.68 mm, and the magnification m2 at 0. The refractive index nd on d-line of the material A constituting the first optical element is set at 1.45, and the Abbe's number νd on the d-line at 60; the refractive index nd on the d-line of the material B is set at 1.6, and the Abbe's number νd on d-line at 27; and the refractive index nd on the d-line of the material B constituting the second optical element is set at 1.45, and the Abbe's number νd on the d-line at 60.

The boundary surface between the material A of the first optical element and material B is divided into two portions; a 3rd surface where the height h around the optical axis is 0 mm<0 mm≦h≦1.355 mm, and a 3′-th surface where 1.355 mm<h.

Further, the incoming surface (second surface), the 3rd surface and 3′-th surface of the first optical element are plane surfaces having no refracting power with respect to the light flux passing through. The incoming surface (5th surface) and outgoing surface (6th surface) of the second optical element are formed in an axisymmetric, aspherical surface around the optical axis L, defined by the equation obtained by substituting the coefficient of Table 11 into the following equation (Numreal 1).

$$Aspherical shape \\ X ( h ) = \frac{( {h}^{2} / R )}{1 + \sqrt{1 - ( 1 + κ ) {( h / R )}^{2}}} + {\sum }_{i = 2}^{10} {A}_{2 i} {h}^{2 i} \qquad [ Numeral . 1 ]$$

In the aforementioned equation, “x” denotes the axis in the direction of optical axis (traveling direction of the light is assumed as positive), “κ” the cone coefficient and “A₂ᵢ” the aspherical surface coefficient.

A diffractive structure DOE (a second phase structure) for correcting the spherical aberration caused by the difference between the wavelengths λ1 and λ3 is formed on the second surface. The first phase structure HOE is formed on the third surface. The diffractive structure DOE and first phase structure HOE are represented by the optical path difference added to the wave front for transmission. Such an optical path difference is expressed by the optical path function φ(h) (mm) defined by substituting the coefficient of Table 11 into the Numeral 2, where “h” (mm) denotes the height in the direction vertical to the optical axis, “C₂ᵢ” a coefficient for the optical path function, “n” the order of diffraction of the diffracted light flux of the incoming light flux, having the maximum diffraction efficiency, “λ” (nm) the wavelength of the light flux entering the diffractive structure, and “λ_{B}” (nm) the manufacture wavelength (blazed wavelength) of the diffractive structure.

$$Optical path function \\ ϕ ( h ) = λ / λ B \times n \times {\sum }_{i = 1}^{5} {C}_{2 i} {h}^{2 i} \qquad [ Numeral 2 ]$$

where the blazed wavelength λ_{B} of the diffractive structure DOE is 407 mm, and the blazed wavelength λ_{B} of the first phase structure HOE is 785 nm.

### Example 10

Table 12 shows the lens data of the tenth embodiment.

TABLE 12
Example 10: Lens data

| | | | |
|---|---|---|---|
| Focal distance of objective lens | f1 = 2.6 mm | f2 = 2.69 mm | f3 = 2.78 mm |
| Numerical aperture on the image | NA1: 0.65 | NA2: 0.65 | NA3: 0.51 |
| surface side | | | |
| Magnification | m1 = 0 | m2 = 0 | m3 = 0 |

| i-th | | di | ni | di | ni | di | ni |
|---|---|---|---|---|---|---|---|
| surface | Ri | (407 nm) | (407 nm) | (655 nm) | (655 nm) | (785 nm) | (785 nm) |
| 0 | | ∞ | | ∞ | | ∞ | |
| 1 | | 0.0 | | 0.0 | | 0.0 | |
| (aperture | | (φ 3.497 mm) | | (φ 3.497 mm) | | (φ 3.497 mm) | |
| diameter) | | | | | | | |
| 2 | 14.73093 | 0.80 | 1.640199 | 0.80 | 1.593694 | 0.80 | 1.585994 |
| 3 | ∞ | 0.20 | 1.46236 | 0.20 | 1.447749 | 0.20 | 1.444785 |
| 3′ | ∞ | 0.00 | 1.46236 | 0.00 | 1.447749 | 0.00 | 1.444785 |
| 4 | | 0.05 | 1.0 | 0.05 | 1.0 | 0.05 | 1.0 |
| 5 | 1.66216 | 1.50 | 1.46236 | 1.50 | 1.447749 | 1.50 | 1.444785 |
| 6 | −8.54691 | 1.21 | 1.0 | 1.29 | 1.0 | 1.00 | 1.0 |
| 7 | ∞ | 0.6 | 1.61869 | 0.6 | 1.57752 | 1.2 | 1.57063 |
| 8 | ∞ | | | | | | |

2nd surface
Aspherical surface coefficient

| | |
|---|---|
| κ | −2.3492E+01 |
| A4 | −1.4347E−03 |
| A6 | −7.4069E−04 |
| A8 | 6.4363E−04 |
| A10 | 8.9216E−05 |

3rd surface
Optical path function (blazed wavelength: 785 nm)
(0 mm ≦ h < 1.394 mm) Order of diffraction 0/0/1
Diffraction efficiency (scalar calculation)
100/97/84

| | |
|---|---|
| C2 | 5.4206E−03 |
| C4 | −2.8597E−04 |
| C6 | −5.9522E−05 |

3′-th
surface
(1.394 mm ≦ h)
5th surface
Aspherical surface coefficient

| | |
|---|---|
| κ | −7.9878E−01 |
| A4 | 1.9712E−02 |
| A6 | 2.1112E−03 |
| A8 | 2.8106E−03 |
| A10 | −1.6081E−03 |
| A12 | 6.1585E−04 |
| A14 | 8.7826E−05 |

Optical path function (blazed wavelength: 407 nm)
Order of diffraction 10/6/5
Diffraction efficiency (scalar calculation)
100/89/100

| | |
|---|---|
| C2 | −1.9674E−03 |
| C4 | −6.4392E−05 |
| C6 | 5.1834E−06 |
| C8 | 5.1902E−06 |
| C10 | 2.4452E−06 |

6th surface
Aspherical surface coefficient

| | |
|---|---|
| κ | −1.4792E+02 |
| A4 | 1.0721E−02 |
| A6 | 1.2353E−02 |
| A8 | −9.2363E−03 |
| A10 | 1.9756E−03 |
| A12 | −1.5372E−05 |
| A14 | −3.2040E−05 |

| | nd | νd |
|---|---|---|
| Material A | 1.45 | 60 |
| Material B | 1.6 | 27 |
| Second | 1.45 | 60 |
| optical | | |
| element | | |

*3′ denotes the displacement from the 3′-th surface to 3rd surface.

As shown in Table 12, the objective optical system of the present embodiment is HD/DVD/CD compatible objective optical system. The focal distance f1 for wavelength λ1 of 407 nm is set at 2.6 mm, and the magnification m1 at 0; the focal distance f3 for wavelength λ3 of 785 nm is set at 2.78 mm, and the magnification m3 at 0; and the focal distance f2 for wavelength λ2 of 655 nm is set at 2.69 mm, and the magnification m2 at 0.

The refractive index nd on d-line of the material A constituting the first optical element is set at 1.45, and the Abbe's number νd on the d-line at 60; the refractive index nd on the d-line of the material B is set at 1.60, and the Abbe's number νd on d-line at 27; and the refractive index nd on the d-line of the material B constituting the second optical element is set at 1.45, and the Abbe's number νd on the d-line at 60.

The boundary of the material A and the material B of the first optical element is divided into the 3rd surface whose height h having its center on the optical axis is 0 mm≦h≦1.394 mm and the 3′rd surface whose height h is 1.394 mm<h.

Furthermore, each of the emerging surface (the second surface), the 3rd surface and the 3′rd surface of the first optical element is a plane surface which does not have refractive power to the passing light flux therein. Each of the emerging surface (the fifth surface) and entering surface (the sixth surface) of the second optical element) is an aspherical surface which is axisymmetry around the optical axis L and is defined by the expression provided by substituting coefficients in Table 12 for the Numeral 1.

The fifth surface includes a diffractive structure DOE (the third phase structure) for correcting chromatic aberration in the wavelength region of the wavelength λ1. The third surface includes the first phase structure HOE. Structures of the diffractive structure DOE and the first phase structure HOE are represented by optical path difference added to a transmitted wavefront by these structures. The optical path difference is represented by the optical path difference function φ(f) (mm) defined by substituting coefficients in Table 12 for the Numeral 2, where h (mm) is a height along a perpendicular direction to the optical axis, C₂ᵢ is optical path difference function coefficient, n is a diffraction order of the diffracted light flux having the maximum diffraction efficiency among diffracted light fluxes of the emergence light flux, λ (nm) is a wavelength of a light flux entering into the diffractive structure, λB (nm) is a manufacturing wavelength (blaze wavelength) of the diffractive structure.

Here, the blaze wavelength λB of the diffractive structure DOE is 407 nm and the blaze wavelength λB of the first phase structure HOE is 785 nm.

### Example 11

Table 13 shows the lens data of the eleventh example.

In Tables 13 and 14, “ri” denotes a paraxial curvature radius (unit: mm), and “di” (mm) denotes a space between surfaces. “ni” (405 nm), “ni” (655 nm) and “ni” (785 nm) indicate the refractive indexes in the wavelengths λ1, λ2 and λ3, respectively. “νd” indicates the Abbe's number on the line d. “n_{BD}”, “n_{DVD}” and “n_{CD}” resent the order of diffraction of the diffracted light flux of the wavelength λ1 occurring to the diffractive structure, the order of diffraction of the diffracted light flux of the wavelength λ2 and the order of diffraction of the diffracted light flux of the wavelength λ3, respectively. “λ_{B}” shows the manufacture wavelength (blazed wavelength) of the diffractive structure.

TABLE 13-1
[Paraxial data]

| Surface | | | | | | | | |
|---|---|---|---|---|---|---|---|---|
| number | r (mm) | d (mm) | n₄₀₅ | n₆₅₅ | n₇₈₅ | n_{d} | νd | Remarks |
| OBJ | | ∞ | | | | | | Emission |
| | | | | | | | | point |
| 1 | ∞ | 0.90000 | 1.524694 | 1.506513 | 1.503235 | 1.509140 | 56.4 | First |
| 2 | ∞ | 0.10000 | 1.673134 | 1.623379 | 1.615293 | 1.630000 | 27.0 | optical |
| 3 | ∞ | 0.20000 | | | | | | element |
| 4 | 1.50977 | 2.59000 | 1.605256 | 1.586235 | 1.582389 | 1.589130 | 61.3 | Second |
| 5 | −3.98705 | d5 | | | | | | optical |
| | | | | | | | | element |
| 6 | ∞ | d6 | 1.622304 | 1.579954 | 1.573263 | 1.585459 | 30.0 | Protective |
| 7 | ∞ | | | | | | | substrate |

d4_{BD} = 0.7150, d4_{DVD} = 0.4892, d4_{CD} = 0.3004, d5_{BD} = 0.1000, d5_{DVD} = 0.6000, d5_{CD} = 1.2000

[Aspherical surface coefficients]

| | 4th surface | 5th surface |
|---|---|---|
| κ | −0.660911 | −70.338236 |
| A4 | 0.794125E−02 | 0.991271E−01 |
| A6 | 0.864158E−04 | −0.108729E+00 |
| A8 | 0.203333E−02 | 0.805135E−01 |
| A10 | −0.126982E−02 | −0.407820E−01 |
| A12 | 0.285379E−03 | 0.116322E−01 |
| A14 | 0.217201E−03 | −0.139675E−02 |
| A16 | −0.168470E−03 | 0.00000E+00 |
| A18 | 0.450320E−04 | 0.00000E+00 |
| A20 | −0.444325E−05 | 0.00000E+00 |

TABLE 13-2
[Optical path function coefficient]

| | 1st surface | 2nd surface |
|---|---|---|
| n_{BD}/n_{DVD}/n_{CD} | 0/1/0 | 0/0/1 |
| λ_{B} | 655 nm | 785 nm |
| C2 | 4.0000E−03 | 2.0337E−02 |
| C4 | −8.1038E−04 | −1.1543E−03 |
| C6 | −1.5095E−04 | 2.1475E−04 |
| C8 | −1.8979E−06 | −5.2427E−05 |
| C10 | −7.4305E−06 | −1.8138E−05 |

The present embodiment employs the objective optical system shown in FIG. 30. This objective optical system is used for compatibility among the BD, DVD and CD. The focal distance f1 for wavelength λ1 of 407 nm is set at 2.200 mm, and the magnification m1 at 0; the focal distance f3 for wavelength λ3 of 785 nm is set at 2.419 mm, and the magnification m3 at 0, and the focal distance f2 for wavelength λ2 of 655 nm is set at 2.278 mm, and the magnification m2 at 0. The refractive index nd on d-line of the material A constituting the first optical element is set at 1.509140, and the Abbe's number νd on the d-line at 56.4; the refractive index nd on d-line of the material B is set at 1.63000, and the Abbe's number νd on the d-line at 27.0; and the refractive index nd on the d-line of the material B constituting the second optical element is set at 1.58913, and the Abbe's number νd on the d-line at 61.3.

The incoming surface (first surface) of the first optical element, the boundary surface (second surface) between the material A and material B of the first optical element, and the outgoing surface (third surface) of the first optical element are plane surfaces having no refracting power with respect to the light flux. The incoming surface (5th surface) and outgoing surface (6th surface) of the second optical element are formed in an axisymmetric, aspherical surface around the optical axis L, defined by the equation obtained by substituting the coefficient of Table 13 into the aforementioned equation (Numeral. 1).

The first phase structure HOE1 is formed on the second surface, and the second phase structure HOE2 is formed on the first surface. The first phase structure HOE and second phase structure HOE2 are represented by the optical path difference added to the wave front for transmission by this structure. Such an optical path difference is expressed by the optical path function φ(h) (mm) defined by substituting the coefficient of Table 13 into the aforementioned Numeral. 2.

### Example 12

Table 14 shows the lens data of the twelfth example.

TABLE 14-1
[Paraxial data]

| Surface | | | | | | | | |
|---|---|---|---|---|---|---|---|---|
| number | r (mm) | d (mm) | n₄₀₅ | n₆₅₅ | n₇₈₅ | n_{d} | νd | Remarks |
| OBJ | | ∞ | | | | | | Emission point |
| 1 | ∞ | 0.90000 | 1.524694 | 1.506513 | 1.503235 | 1.509140 | 56.4 | First optical |
| 2 | ∞ | 0.10000 | 1.673134 | 1.623379 | 1.615293 | 1.630000 | 27.0 | element |
| 3 | −25.86805 | 0.20000 | | | | | | |
| 4 | 1.50977 | 2.59000 | 1.605256 | 1.586235 | 1.582389 | 1.589130 | 61.3 | Second optical |
| 5 | −3.98705 | d5 | | | | | | element |
| 6 | ∞ | d6 | 1.622304 | 1.579954 | 1.573263 | 1.585459 | 30.0 | Protective |
| 7 | ∞ | | | | | | | substrate |

d4_{BD} = 0.7150, d4_{DVD} = 0.4831, d4_{CD} = 0.3224, d5_{BD} = 0.1000, d5_{DVD} = 0.6000, d5_{CD} = 1.2000

[Aspherical surface coefficients]

| | 3rd surface | 4th surface | 5th surface |
|---|---|---|---|
| κ | 0.236527E+01 | −0.660911 | −70.338236 |
| A4 | 0.162055E−02 | 0.794125E−02 | 0.991271E−01 |
| A6 | 0.111819E−03 | 0.864158E−04 | −0.108729E+00 |
| A8 | 0.151862E−04 | 0.203333E−02 | 0.805135E−01 |
| A10 | 0.187075E−04 | −0.126982E−02 | −0.407820E−01 |
| A12 | 0.000000E+00 | 0.285379E−03 | 0.116322E−01 |
| A14 | 0.000000E+00 | 0.217201E−03 | −0.139675E−02 |
| A16 | 0.000000E+00 | −0.168470E−03 | 0.000000E+00 |
| A18 | 0.000000E+00 | 0.450320E−04 | 0.000000E+00 |
| A20 | 0.000000E+00 | −0.444325E−05 | 0.000000E+00 |

TABLE 14-2
[Optical path function coefficient]

| | 1st surface | 2nd surface | 3rd surface |
|---|---|---|---|
| n_{BD}/n_{DVD}/n_{CD} | 0/1/0 | 0/0/1 | 10/6/5 |
| λ_{B} | 655 nm | 785 nm | 405 nm |
| C2 | −4.0000E−03 | 2.0337E−02 | −1.3000E−03 |
| C4 | −8.1038E−04 | −1.1543E−03 | −1.1308E−04 |
| C6 | −1.5095E−04 | 2.1475E−04 | −5.5669E−06 |
| C8 | −1.8979E−06 | −5.2427E−05 | −1.6989E−06 |
| C10 | −7.4305E−06 | −1.8138E−05 | −1.1766E−06 |

The present embodiment employs the objective optical system shown in FIG. 30. This objective optical system is used for compatibility among the BD, DVD and CD. The focal distance f1 for wavelength λ1 of 405 nm is set at 2.200 mm, and the magnification m1 at 0; the focal distance f3 for wavelength λ3 of 785 nm is set at ;2.434 mm, and the magnification m3 at 0, and the focal distance f2 for wavelength λ2 of 655 nm is set at 2.274 mm, and the magnification m2 at 0.

The refractive index nd on the d-line of the material A constituting the first optical element is set at 1.509140, and the Abbe's number νd on the d-line at 56.4; the refractive index nd on d-line of the material B is set at 1.63000, and the Abbe's number νd on the d-line at 27.0; and the refractive index nd on the d-line of the material B constituting the second optical element is set at 1.58913, and the Abbe's number νd on d-line at 61.3.

The incoming surface (first surface) of the first optical element and the boundary surface (second surface) between the material A and material B of the first optical element are plane surfaces having no refracting power with respect to the light flux. The outgoing surface (3rd surface) of the first optical element, and the incoming surface (4th surface) and outgoing surface (6th surface) of the second optical element are formed in an axisymmetric, aspherical surface around the optical axis L, defined by the equation obtained by substituting the coefficient of Table 14 into the aforementioned equation (Numeral. 1).

The first phase structure HOE1 is formed on the second surface, and the second phase structure HOE2 is formed on the first surface. The third first phase structure HOE3 is formed on the third surface.

The first phase structure HOE, second phase structure HOE2 and third phase structure HOE3 are represented by the optical path difference added to the wave front for transmission by this structure. Such an optical path difference is expressed by the optical path function φ(h) (mm) defined by substituting the coefficient of Table 14 into the aforementioned Numeral. 2.

### Embodiment 7

Referring to the drawing, the following describes the seventh embodiment of the present invention. The same structures as those of the aforementioned first embodiment will not be described to avoid duplication.

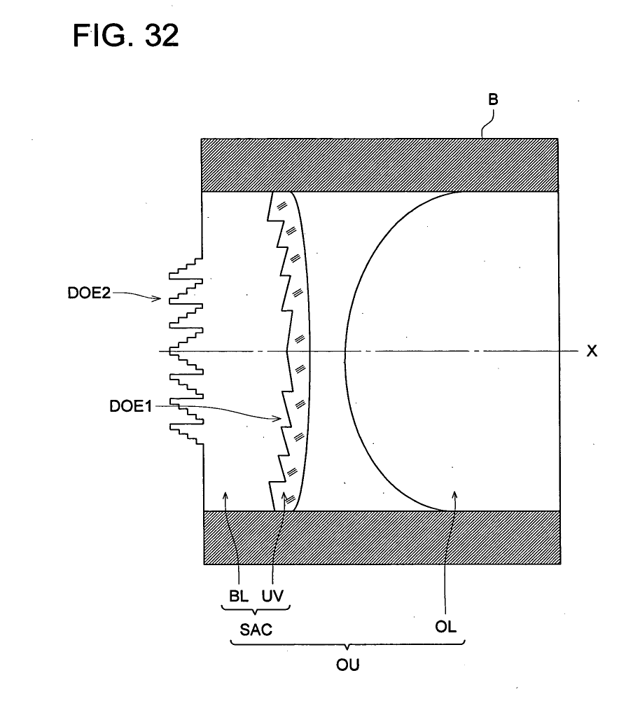

As shown schematically in FIG. 32, the objective lens unit (the objective optical system) OU of the present embodiment is structured so that the diffraction optical device (the first optical element) SAC is integrated coaxially with the objective lens OL through the lens frame B, wherein the aspherical shape of the objective lens OL is designed in such a way that spherical aberration is minimized with respect to the first light flux incoming as parallel light, and the thickness t1 of the HD protective layer PL1. To put it more specifically, the diffraction optical device SAC is fitted into one end of the cylindrical lens frame B and is fixed therein. The objective lens OL is fitted into the other end and is fixed therein. They are integrated into one structure along the optical axis X.

In the present embodiment, the diffraction optical device SAC and objective lens OL are integrated into one structure through the lens frame B. When the diffraction optical device SAC and objective lens OL are integrated into one structure, it is sufficient only if the positional relationship between the diffraction optical device SAC and objective lens OL is kept constant. In addition to the aforementioned method of using the lens frame B as an intermediary, it is also possible to utilize the method of fitting the flange of the diffraction optical device SAC with that of the objective lens OL.

When the positional relationship between the diffraction optical device SAC and objective lens OL is kept constant as described above, it is possible to minimize aberration produced at the time of focusing and tracking. Thus, this arrangement provides excellent focusing or tracking characteristics.

The following describes the structure of the diffraction optical device SAC and the principle of aberration correction: As shown in FIG. 32, the diffraction optical device SAC is provided with a base lens BL (a first part) as a resin lens and a resin layer UV (a second part) as an ultraviolet curing resin, wherein the resin layer UV is laminated on the surface of this base lens. A first diffractive structure DOE1 (a phase structure) having a strap-formed step is formed on the boundary between the base lens BL and resin layer UV. A second diffractive structure DOE2 is formed on the optical surface of the base lens BL on the side opposite to the boundary.

The aforementioned boundary with the first diffractive structure DOE1 formed thereon may hereinafter be referred to as the first diffractive structure, and the boundary may the second diffractive structure DOE2 formed thereon will be referred to as the second diffractive structure.

The diffraction efficiency η(λ) of the diffractive structure DOE1 formed on the boundary between the base lens BL and resin layer UV having different Abbe's numbers (dispersion) is generally expressed by the following equation (61) as a function of:
the wavelength λ1,
the difference Δn(λ) of refractive index between the base lens BL and resin layer UV at this wavelength λ1,
the level difference d of the diffractive structure DOE1, and
the order of diffraction M(λ):
   η(λ)=sin c²[[d·Δn(λ)/λ]−M(λ)] (61)
where sin c (X)=sin (πX)/(πX), and the value of η(λ) is closer to 1 as the value in the square bracket ([ ]) is closer to an integer.

Assume that the difference of the refractive index at the first wavelength λ1 used for the HD is Δn1; the order of diffraction of the diffracted light flux of the first light flux is M1; the difference of the refractive index at the second wavelength λ2 used for the DVD is Δn2; the order of diffraction of the diffracted light flux of the second light flux is M2; the difference of the refractive index at the third wavelength λ3 used for the CD is Δn3; and the order of diffraction of the diffracted light flux of the third light flux is M3. Then the diffraction efficiencies η(λ1), η(λ2), and η(λ3) at each wavelength are expressed by the following equations (62) through (64):
η(λ1)=sin c²[[d·Δn1/λ1]−M1] (62)
η(λ2)=sin c²[[d·Δn2/λ2]−M2] (63)
η(λ3)=sin c²[[d·Δn3/λ3]−M3] (64)

To ensure high diffraction efficiency in each wavelength, it is necessary to select the base lens BL having the difference in refractive index Δni (where “i” denotes 1, 2 or 3) (viz., having the Abbe's number Δν_{d}), resin layer UV, level difference d, and order of diffraction Mi (where “i” denotes 1, 2 or 3) in such a way that the values in the square brackets in Equations (62) through (64) will be close to an integer.

In the diffraction optical device SAC of the present embodiment, the substance for satisfying |Δνd|=26.7, |Δn1|=0.0297, |Δn2|/|Δn1|=1.53, |Δn3|/|Δn1|=1.61, |Δn3|/|Δn2|=1.05 is selected as the material for the base lens BL and resin layer UV, and the step of the diffractive structure DOE1 is set to 15.06 μm. Accordingly, first-order diffracted light flux occurs to the light flux having any wavelength (M1=M2=M3=1). The first diffractive structure DOE1 is set to ensure that the first-order diffracted light flux will occur according to the first and third light fluxes. This arrangement provides a difference between the diffraction angle of the diffracted light flux of the first light flux and the diffraction angle of the diffracted light flux of the third light flux, and therefore corrects the spherical aberration caused by the difference in the thickness of the protective layer between the HD and CD. Further, the base lens BL and resin layer UV are provided with a difference in Abbe's number that satisfies the Eq. (51). This arrangement ensures high diffraction efficiency for the light flux having any wavelength. Thus, this arrangement ensures compatibility between the spherical aberration correction effect and improved transmittance for the blue-violet laser light flux (first light flux) and infrared laser light flux (third light flux). This compatibility has been difficult to achieve in the prior art. The first diffractive structure DOE1 has a negative diffraction power, and the first through third light fluxes having entered the first diffractive structure DOE1 are subjected to divergence by the first diffractive structure DOE1.

As can be seen from the aforementioned descriptions (8) through (10); the diffraction efficiency of the first diffractive structure DOE1 depends on the difference Δni (i=1, 2, 3) in refractive index between the base lens BL and resin layer UV. Thus, if the difference Δni (i=1, 2, 3) in refractive index changes from the design value during the operation of the optical pickup apparatus PU, the intensity of the spot formed by condensation of light on the information recording surface also changes. This will bring about instability in detection of signals by the light detector P_{D}, with the result that recording/reproducing performances will deteriorate.

Generally, the rate of refraction change dn/dT resulting from the temperature change of optical glass is smaller than that of the optical resin by an order of magnitude. Here when the base lens BL is made of lens glass, the rate of refraction change in the resin layer UV resulting from heat generation of the biaxial actuator AC1 and changes in the ambient temperature is greater than that in the base lens BL by an order of magnitude. This results in an increased difference Δni (i=1, 2, 3) in refractive index from the design value, and hence increased changes in the diffraction efficiency of the first diffractive structure DOE1. This problem comes to the fore.

However, the diffraction optical device SAC of the present embodiment uses the base lens BL made of resin. (To put it another way, equation (52) is satisfied by the rate of refraction change (dn/dT)₁ resulting from the temperature change of the base lens BL and the rate of refraction change (dn/dT)₂ resulting from the temperature change of the resin layer UV). Accordingly, the rate of refraction change dn/dT of the base lens BL is greater than that of the glass lens, but the base lens BL exhibits the rate of refraction change having the same symbol and almost the same absolute value as that of the resin layer UV. Accordingly, difference Δni (i=1, 2, 3) in refractive index between the base lens BL and resin layer UV is kept almost constant. Thus, there is a small variation in the diffraction efficiency even in temperature change, and always stable recording and reproducing performances are ensured.

Further, the second diffractive structure DOE2 is intended to correct the spherical aberration resulting from the difference in the thickness between the HD and DVD, and is characterized by wavelength dependency of diffraction wherein only the red laser beam is diffracted on an selective basis, without the blue-violet laser beam or infrared laser beam being diffracted.

The following describes the principle of generation of diffracted light flux and correction of aberration in the second diffractive structure DOE2: The second diffractive structure DOE2 is structured by concentric arrangement of the step-formed patterns having a stepped cross section including the optical axis, and the step is shifted by the height amounting to the number of steps (4 steps in FIG. 32) for each of the predetermined number of levels (5 steps in FIG. 32). Here one step Δ of the stepped structure is set at a height satisfying Δ=2·λ1/(n1_{BL}−1)≈1.2·λ2/(n2_{BL}−1)≈1·λ3/(n3_{BL}−1), where n1_{BL} denotes the refractive index of the base lens BL for the first wavelength λ1; n2_{BL} the refractive index of the base lens BL for the second wavelength λ2 and n3_{BL} the refractive index of the base lens BL for the third wavelength λ3.

The difference in the optical path resulting from the step Δ is twice the first wavelength λ1 and once the third wavelength λ3. Accordingly, the first and third light fluxes pass through directly, without being affected by the second diffractive structure DOE2.

In the meantime, the difference in the optical path resulting from this step Δ is 1.2 times the second wavelength λ2. Accordingly, the second light fluxes passing through the level surface before and after the step are out of phase with each other by 2π/5. Since one sawtooth is divided into five portions, the phase shift of the second light flux is 5×2π/5=2π for one sawtooth, first-order diffracted light flux will be produced. Thus, the spherical aberration resulting from the difference in the thickness of the protective layer between the HD and DVD can be corrected by selective diffraction of the second light flux alone. The diffraction efficiency of the light flux in the second diffractive structure DOE2 is 100% for the first light flux (non-diffracted light flux), 87.5% for the second light flux (diffracted light flux), and 100% for the third light flux. This arrangement ensures high diffraction efficiency for the light flux having any wavelength. Further, the second diffractive structure DOE2

Further, the second diffractive structure DOE2 has a positive diffraction power. The second light flux entering the second diffractive structure DOE2 is condensed by the second diffractive structure DOE2.

Further, the third light flux incident on the diffraction optical device SAC as a parallel light flux directly passes through the second diffractive surfaces, and is subjected to divergence (first-order diffraction) on the first diffractive surface. Since the diffraction angle increases in proportion to the wavelength, divergence applied to the third light flux on the first diffractive surface is greater than the divergence applied to the first light flux. As a result, even after having been converged on the boundary and the optical surface of the resin layer UV on the side opposite to the boundary, the third light flux the objective lens OL as a divergent light flux. If the third light flux enters the objective lens OL having a design magnification of 0 as a divergent light flux, spherical aberration in the direction of insufficient correction occurs. This spherical aberration in the direction of insufficient correction is counteracted by the spherical aberration in the direction of insufficient correction resulting from the difference in the thickness of the protective surface between the HD and CD. The third light flux is condensed on the information recording surface RL3 of the CD where the spherical aberration is corrected.

Further, the second light flux entering the diffraction optical device SAC as a parallel light flux is also condensed by the second diffractive surface (first-order diffraction) and is then diverged by the first diffractive surface (first-order diffraction). Since the diffraction angle increases in proportion to the wavelength, the divergence applied to the second light flux by the first diffractive surface is greater than the divergence of the first divergence, and is smaller than the divergence of the third light flux. As a result, after having been condensed on the boundary and the optical surface of the resin layer UV on the side opposite to the boundary, the second light flux enters the objective lens OL as a divergent light flux less intense than the third light flux. If the second light flux enters the objective lens OL having a design magnification of 0 as a divergent light flux, spherical aberration in the direction of insufficient correction occurs. This spherical aberration in the direction of insufficient correction is counteracted by the spherical aberration in the direction of insufficient correction resulting from the difference in the thickness of the protective surface between the HD and DVD. The second light flux is condensed on the information recording surface RL2 of the DVD where the spherical aberration is corrected.

Further, the first lens EXP1 of the expander lens EXP can be displaced in the direction of optical axis by the uniaxial actuator AC2. The focal distance of the expander lens EXP can be adjusted to ensure that the light flux of each wavelength as a parallel light flux is emitted from the expander lens EXP.

Further, the first lens EXP1 of the expander lens EXP is driven in the direction of optical axis by the uniaxial actuator AC2, thereby changing the magnification of the objective lens unit OU. This arrangement corrects the spherical aberration of the spot formed on the information recording surface RL1 of the HD. The causes for the occurrence of the spherical aberration to be corrected by adjusting the position of the first lens EXP1 includes variations of the wavelength resulting from the production error of the blue-violet semiconductor laser LD1, changes in refractive index of the objective lens OL due to temperature change, distribution of refractive index, a focus jump among information recording layers in a multilayer disc such as a two-layer or four-layer disc, and variations of the thickness or distribution of thickness resulting from the production error of the protective layer of the HD. Instead of the first lens EXP1, it is possible to use the structure wherein the second lens EXP2 is driven in the direction of optical axis. The expander lens EXP is arranged in the optical path common to the first through third light fluxes, this method corrects the spherical aberration formed on the information recording surface using not only the HD but also the DVD and CD.

In the HD having a short light source waveform, the chromatic aberration of the objective lens unit OU may raise a problem. In such a case, the first collimating lens COLL and expander lens EXP is preferred to have a function of correcting the chromatic aberration of the objective lens unit OU. To put it more specifically, the first collimating lens COL1 and expander lens EXP are provided with a diffractive structure. They can be provided with the chromatic aberration correcting function by using a cemented lens provided with a positive lens having a greater Abbe's number and a negative lens having a smaller Abbe's number.

The present embodiment uses the DVD/CD laser light source unit LU wherein the first emission point EP1 and second emission point EP2 are incorporated in one chip. Without being restricted thereto, the present embodiment can use a HD/DVD/CD one-chip laser light source unit LU where the emission point for emitting a HD laser beam having a wavelength of 405 nm is also incorporated in one and the same chip. Alternatively, the present embodiment can also use a HD/DVD/CD one-can laser light source unit, wherein three laser light sources—blue-violet semiconductor laser beam, red semiconductor laser beam and infrared semiconductor laser beam—are incorporated in one and the same enclosure.

In the present embodiment, the light source and light detector P_{D} are arranged separately from each other. Without being restricted to such a structure, it is possible to use a laser light source module packing both the light source and light detector.

Further, by mounting the optical pickup apparatus PU shown in the aforementioned embodiment (not illustrated), a rotary drive apparatus for rotatably holding an optical disc and a control apparatus for controlling the drive of these apparatuses, it is possible to provide an optical disc drive apparatus capable of carrying out at least one of the functions of recording of information on an optical disc and reproducing of information from the optical disc.

Further, the second diffractive structure DOE2 is formed only inside the numerical aperture NA2 of the DVD. Accordingly, the light flux having passed through the area outside the numerical aperture NA2 is turned into a flare component on the information recording surface RL2 of the DVD. This arrangement ensures automatic aperture control of the DVD.

The optical pickup apparatus PU is provided with an aperture restricting filter (not illustrated) for CD, which restricts the apertures corresponding to the numerical aperture NA1 of the CD.

### Example 13

The following shows a specific numerical example (thirteenth embodiment) of the objective lens unit OU provided with a diffraction optical device SAC and an objective lens OL. The diffraction optical device SAC is made up of a lamination of the resin layer provided with an ultraviolet curing resin and the base lens provided with resin. A diffractive structure DOE1 is formed on the boundary between the base lens and resin layer. A diffractive structure DOE2 as a phase structure is formed on the optical surface of the base lens on the light source side. The objective lens OL is a glass lens (BACD5 by HOYA) whose aspherical structure is designed in such a way that spherical aberration will be minimized with respect to the first wavelength λ1 and the thickness t1 of the HD protective layer PL1. However, a plastic lens may be used.

Table 15 shows the lens data in the present embodiment. In this numerical example, the difference of the optical path added to the incoming light flux by the diffractive structures DOE1 and DOE2 is expressed in terms of optical path difference function.

TABLE 15-1
[Paraxial data]

| Surface | | | | | | | | |
|---|---|---|---|---|---|---|---|---|
| number | r (mm) | d (mm) | n₄₀₅ | n₆₅₅ | n₇₈₅ | n_{d} | νd | Remarks |
| OBJ | | ∞ | | | | | | Emission point |
| 1 | ∞ | 1.0000 | 1.56013 | 1.54073 | 1.53724 | 1.54351 | 56.7 | Aberration |
| 2 | −13.55731 | 0.1000 | 1.53044 | 1.49524 | 1.48938 | 1.50000 | 30.0 | correcting |
| 3 | −13.55731 | 0.1000 | | | | | | element |
| 4 | 1.50977 | 2.5900 | 1.60526 | 1.58624 | 1.58239 | 1.58913 | 61.3 | Objective lens |
| 5 | −3.98705 | d4 | | | | | | |
| 6 | ∞ | d5 | 1.62230 | 1.57995 | 1.57326 | 1.58546 | 30.0 | Protective layer |
| 7 | ∞ | | | | | | | |

d4_{HD} = 0.7152, d4_{DVD} = 0.5039, d4_{CD} = 0.3002, d5_{HD} = 0.1000, d5_{DVD} = 0.6000,
d5_{CD} = 1.2000

[Aspherical surface coefficients]

| | 2nd surface | 3rd surface | 4th surface | 5th surface |
|---|---|---|---|---|
| κ | 0.0000E+00 | 0.00000E+00 | −0.660911 | −70.33824 |
| A4 | 0.12192E−02 | 0.12192E−02 | 0.79413E−02 | 0.99127E−01 |
| A6 | 0.61122E−03 | 0.61122E−03 | 0.86416E−04 | −0.10873E+00 |
| A8 | −0.32711E−03 | −0.32711E−03 | 0.20333E−02 | 0.80514E−01 |
| A10 | 0.77728E−04 | 0.77713E−04 | −0.12698E−02 | −0.40782E−01 |
| A12 | 0.00000E+00 | 0.00000E+00 | 0.28538E−03 | 0.11632E−01 |
| A14 | 0.00000E+00 | 0.00000E+00 | 0.21720E−03 | −0.13968E−02 |
| A16 | 0.00000E+00 | 0.00000E+00 | −0.16847E−03 | 0.00000E+00 |
| A18 | 0.00000E+00 | 0.00000E+00 | 0.45032E−04 | 0.00000E+00 |
| A20 | 0.00000E+00 | 0.00000E+00 | −0.44433E−05 | 0.00000E+00 |

TABLE 15-2
[Diffractive surface coefficients]

| | 1st surface | 2nd surface |
|---|---|---|
| M_{HD}/M_{DVD}/M_{CD} | 0/1/0 | 1/1/1 |
| λ_{B} | 655 nm | 700 nm |
| B2 | −0.80000E−02 | 0.35788E−01 |
| B4 | −0.21490E−03 | −0.12331E−02 |
| B6 | 0.20778E−04 | −0.51982E−03 |
| B8 | −0.85988E−04 | 0.29100E−03 |
| B10 | 0.14077E−04 | −0.72300E−04 |

In the present embodiment, the focal distance is 2.2 and the numerical aperture NA1 is 0.85 when the high-density optical disc HD is used. The numerical aperture NA2 is 0.65 when a DVD is used and numerical aperture NA3 is 0.50 when a CD is used. In Table 15, “r” (mm) denotes a curvature radius, and “d” (mm) a lens distance. The n₄₀₅, n₆₅₅ and n₇₈₅ indicate the refractive indexes of the lenses with reference to the first wavelength λ1 (=405 nm), second wavelength λ2 (=655 nm) and third wavelength λ3 (=785 nm), respectively. “νd” indicates the Abbe's number of the lens, and M_{HD}, M_{DVD} and M_{CD} represent the order of diffraction of the diffracted light flux employed in recording/reproducing using HD, the order of diffraction of the diffracted light flux employed in recording/reproducing using DVD, and the order of diffraction of the diffracted light flux employed in recording/reproducing using CD, respectively. Further, E (e.g. 2.5E-3) is used to express the power multiplier of 10 (e.g. 2.5×10⁻³)

The boundary surface (second surface) between the base lens and resin layer, the optical surface (third surface) of the resin layer on the optical disc side, the optical surface (fourth surface) of the objective lens OL on the light source side, and the optical surface (fifth surface) on the optical disc side are each configured in an aspherical shape. The aspherical shape can be expressed by the equation obtained by substituting the coefficient of the Table into the following aspherical shape equation:

[Aspherical Shape Equation]
z=(y²/R)/[1+√{1−(K+1)(y/R)²}]+A₄y⁴+A₆y⁶+A₈y⁸+A₁₀y¹⁰+A₁₂y¹²+A₁₄y¹⁴+A₁₆y¹⁶+A₁₈y¹⁸+A₂₀y²⁰
where reference symbols denote the following:
z: an aspherical shape (distance in the direction along the optical axis from the plane contacting the surface apex of the aspherical surface)
y: distance from the optical axis
R: curvature radius
K: Cornic coefficient
A₄, A₆, A₈, A₁₀, A₁₂, A₁₄, A₁₆, A₁₈ and A₂₀: aspherical surface coefficient

Further, the diffractive structures DOE1 and DOE2 are expressed by the optical path difference added to the incoming light flux by the diffractive structures. Such an optical path difference is expressed by the optical path function φ(mm) obtained by substituting the coefficient of the Table 15 into the equation showing the following optical path difference function:

[Optical Path Difference Function]
φ=M×λ/λ_{B}×(B₂y²+B₄y⁴+B₆y⁶+B₈y⁸+B₁₀y¹⁰)
where the reference symbols denotes the following:
φ: optical path function
λ: wavelength of the light flux incident on the diffractive structure
λ_{B}: manufacture wavelength
M: order of diffraction of the diffracted light flux employed in recording/reproducing using an optical disc
y: distance from optical axis
B₂, B₄, B₆, B₈ and B₁₀: diffractive surface coefficients

The design temperature of the objective lens unit OU in the present embodiment is 25° C. Table 16 shows the diffraction efficiency of the diffractive structure DOE1 at the time of temperature change (ΔT=±30° C.). Table 16 considers only changes in the refractive index of the base lens BL and resin layer UV resulting from the variation in temperature as a calculation parameter. Namely, the change in the refractive index of the base lens BL resulting from the variation in temperature is (dn/dT)₁=−10×10⁻⁵(/° C.), and the change in the refractive index of the resin layer UV resulting from the variation in temperature is (dn/dT)₂=−12×10⁻⁵(/° C.).

Table 17 shows the diffraction efficiency of the diffractive structure DOE1 at the time of temperature change (ΔT=±30° C.). The calculation parameter used in Table 17 is the change in the refractive index of the base lens BL resulting from the variation in temperature, which is smaller than that in the refractive index of the optical resin by an order of magnitude, that is, (dn/dT)₁=−3×10⁻⁵(/° C.). The changes in the refractive index of the resin layer UV caused by temperature variation are the same as those shown in Table 16.

TABLE 16

| temperature/wavelength | 405 nm | 655 nm | 785 nm |
|---|---|---|---|
| 25° C. (design temperature) | 96.5% | 99.3% | 97.8% |
| −5° C. | 97.8% | 99.7% | 97.2% |
| 55° C. | 94.9% | 98.8% | 98.4% |

TABLE 17

| temperature/wavelength | 405 nm | 655 nm | 785 nm |
|---|---|---|---|
| 25° C. (design temperature) | 96.5% | 99.3% | 97.8% |
| −5° C. | 100% | 99.9% | 94.3% |
| 55° C. | 86.7% | 96.2% | 99.7% |

Comparison between Tables 16 and 17 show that, even when a temperature variation of ±30° C. has taken place, changes in the diffraction efficiency are kept within ±2% in the diffraction optical device SAC of the present embodiment satisfying the Eq. (53). This arrangement ensures stable recording/reproducing at all times. In the meantime, when a glass lens is used as a base lens BL, the diffraction efficiency at a wavelength of 405 nm is reduced by about 10% with the rise of temperature by +30° C. This makes it difficult to provide stable recording/reproducing.

### Embodiment 8

The following describes the eighth embodiment of the present invention with reference to drawings:

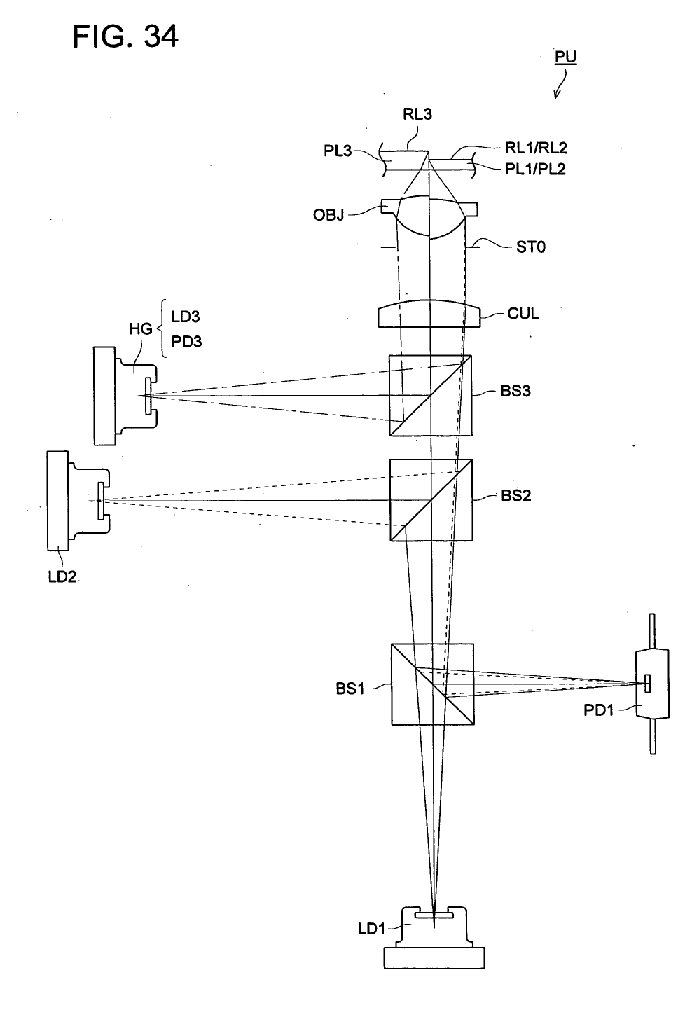

FIG. 34 is a drawing schematically showing the structure of the optical pickup apparatus PU capable of adequately recording/reproducing of information using any of the HD (first optical information recording medium), DVD (second optical information recording medium) and CD (third optical information recording medium). In terms of optical specifications, the HD is characterized by the first wavelength λ1 of 407 nm, the protective layer (protective substrate) PL1 having a thickness t1 of 0.6 mm, and the numerical aperture of NA1 of 0.65. The DVD is characterized by the second wavelength λ2 of 655 nm, the protective layer PL2 having a thickness t2 of 0.6 mm, and the numerical aperture NA2 of 0.65. The CD is characterized by the third wavelength λ3 of 785 nm, the protective layer PL3 having a thickness t3 of 1.2 mm, and the numerical aperture NA3 of 0.51.

The combination of the wavelength, thickness of the protective layer and numerical aperture are not restricted thereto. Further, a BD having a thickness t1 of the protective layer PL1 can be used as the first optical information recording medium.

The objective lens OBJ of the present embodiment is so constructed that the first light flux of wavelength λ1 and the second light flux of wavelength λ2 are emitted as parallel light, and the third light flux are emitted as divergent light.

The optical pickup apparatus PU comprises: a hologram laser HG further comprising an integrated structure of:
a blue-violet semiconductor laser LD1 (first light source), activated when information is recorded and/or reproduced using a high-density optical disc HD, for emitting a laser light flux (first light flux) having a wavelength of 407 nm;
a light detector P_{D}1 for the first light flux;
a red semiconductor laser LD2 (second light source), activated when information is recorded and/or reproduced using a DVD for emitting a laser light flux (second light flux) having a wavelength of 655 nm;
a light detector PD1 for the first and second light fluxes;
an infrared semiconductor laser LD3 (third light source), activated when information is recorded and/or reproduced using a CD, for emitting a laser light flux (third light flux) having a wavelength of 785 nm; and
a light detector PD2 for the third light flux; a coupling lens CUL transmitted by the first and second light fluxes;
an objective lens OBJ, with a diffractive structure formed thereon as a phase structure, having a function of condensing the laser beam on the information recording surfaces RL1, RL2 and RL3;
a biaxial actuator (not illustrated) capable of moving the objective lens OBJ in a predetermined direction;
a first beam splitter BS1, a second beam splitter BS2 and a third beam splitter BS3; and
an aperture STO.

For recording/reproducing of information using the HD in an optical pickup apparatus PU, the blue-violet semiconductor laser LD1 is activated to emit light, as the optical path is indicated by a solid line in FIG. 34. After passing through the first, second and third polarized beam splitters BS1 through B3, the divergent light flux coming from the blue-violet semiconductor laser LD1 reaches the coupling lens CUL. The light is converted into parallel light when it passes through the coupling lens CUL. Having passed through the aperture STO, the light reaches the objective lens OBJ and is converted into a spot formed on the information recording surface RL1 through the first protective layer PL1. The objective lens OBJ allows focusing and tracking to be performed by the biaxial actuator arranged in its periphery.

The reflected light flux modulated by an information pit on the information recording surface RL1 again passes through the objective lens OBJ, coupling lens CUL, third beam splitter BS3 and second beam splitter BS2, and is diverged by the first beam splitter BS1. Then the light is converged on the light receiving surface of the light detector P_{D}1. Then the output signal of the light detector P_{D}1 can be utilized to scan the information recorded on the HD.

For recording/reproducing of information using a DVD, the red ray semiconductor laser LD2 is activated to emit light, as the optical path is indicated by a dotted line in FIG. 34. Reflected by the second beam splitter BS2, the divergent light flux from the infrared semiconductor laser LD2 passes through the third beam splitter BS3 and reaches the coupling lens CUL.

The light is converted into parallel light when it passes through the coupling lens CUL. Passing through the aperture STO, the light reaches the objective lens OBJ. The light is turned into a spot formed on the information recording surface RL2 through the second protective layer PL2, by the objective lens OBJ. The objective lens OBJ allows focusing and tracking to be performed by the biaxial actuator arranged in its periphery.

The reflected light flux modulated by an information pit on the information recording surface RL2 again passes through the objective lens OBJ, coupling lens CUL, third beam splitter BS3 and second beam splitter BS2, and is diverged by the first beam splitter BS1. Then the light is converged on the light receiving surface of the light detector P_{D}1. Then the output signal of the light detector P_{D}1 can be utilized to scan the information recorded on the HD.

For recording/reproducing of information using a CD, the infrared ray semiconductor laser LD3 of the hologram laser HG is activated to emit light, as the optical path is indicated by a one-dot chain line in FIG. 34. The divergent light flux emitted by the infrared semiconductor laser LD3 is reflected by the third beam splitter BS3 and reaches the coupling lens CUL.

The light is converted into divergent light when it passes through the coupling lens CUL. Passing through the aperture STO, the light reaches the objective lens OBJ. The light is turned into a spot formed on the information recording surface RL3 through the third protective layer PL3, by the objective lens OBJ. The objective lens OBJ allows focusing and tracking to be performed by the biaxial actuator arranged in its periphery.

The reflected light flux modulated by an information pit on the information recording surface RL3 again passes through the objective lens OBJ, coupling lens CUL, and is diverged by the third beam splitter BS3. Then the light is converged on the light receiving surface of the light detector P_{D}3 for hologram laser HG. Use of the output of the light detector P_{D}3 enables to scan the information recorded in the CD.

The following describes the structure of the objective optical system OBJ:

The objective optical system OBJ is a single lens provided with lamination of:
a lens (hereinafter referred to as “first part L1”) made of the material having an Abbe's number νd, 40≦νd≦70 (hereinafter also referred to as “material A”) with reference to the line d; and
a lens (hereinafter referred to as “second part L2”) made of the material having an Abbe's number νd, 20≦νd≦40 (hereinafter also referred to as “material B”) with reference to line d, as shown schematically in FIG. 35, wherein these lens are laminated in the direction of optical axis (e.g. corresponding to the fifteenth embodiment to be described later).

A diffractive structure HOE as a phase structure is formed on the boundary surface between the first part L1 and second part L2, wherein this diffractive structure HOE is configured by concentric arrangement of the patterns having a stepped cross section including the optical axis.

In the diffractive structure HOE, the depth d1 of the step S formed inside each pattern P in the direction of optical axis is so set as to meet the equation of 0.8×λ1×K2/(nB1−nA1)≦d1≦1.2×λ1×K2/(nB1−nA1).

In this case, nA1 denotes the refractive index of the material A with respect to the light flux having wavelength λ1, nB1 represents the refractive index of the material B with respect to the light flux of wavelength λ1, and K2 indicates a natural number.

Such arrangement of the depth d1 in the direction of optical axis allows the light flux of wavelength λ1 to pass through, virtually without being provided with phase difference in the diffractive structure HOE. Further, the light flux of wavelength λ3 is provided virtually with phase difference in the diffractive structure HOE, and is subjected to diffraction, since the ratio the difference in the refractive index between the materials A and B is sufficiently increased by different dispersion.

Referring to the lens data of fifteenth embodiment, in the diffractive structure, the depth d1 of the adjacent straps (steps) is set to d1=0.407×2/(1.636473−1.5345)=7.98 μm. Accordingly, if the light of wavelength λ1=0.407 μm has entered this diffractive structure, a phase difference of 2π×2 is produced by the adjacent straps, with the result that a virtual phase difference does not occur. To put it another way, light passes through with high efficiency (100%). When light having a wavelength of λ3 0.785 μm has entered the diffractive structure, a phase difference of d1×(1.584488−1.5036)/0.785=2π×0.823 is produced by the adjacent steps. If a five-step structure within one period is adopted, this difference results in 2π×0.823×5=2π×4.11, which is close to an integer. This arrangement allows the light to be diffracted with high efficiency (84%).

Further, when the light having a wavelength λ2 of 0.655 μm has entered the diffractive structure, a phase difference of 2π×d1×(1.591925−1.5101)/0.655=2π×0.997 is produced by the adjacent steps. The light passes through with high diffraction efficiency (100%) since there is virtually no phase difference.

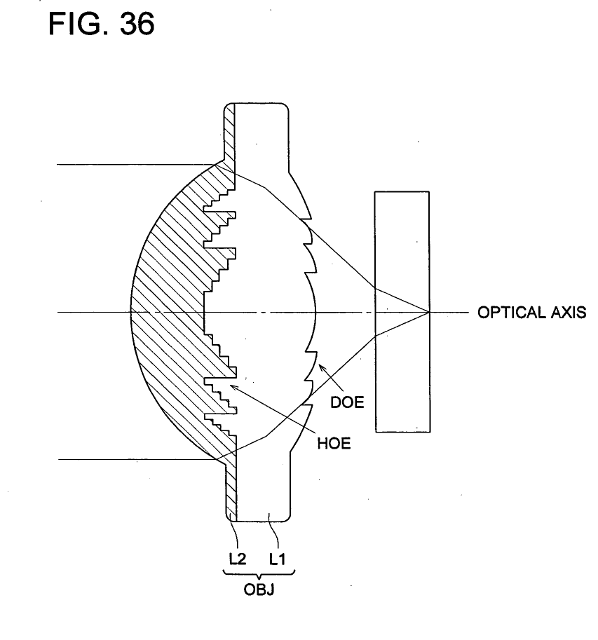

A diffractive structure DOE (FIG. 36) can be formed on the boundary between the first part and air layer, wherein the diffractive structure DOE is provided with a plurality of straps, concentrically arranged about the optical axis, having a serrated cross section including the optical axis. For example, when the thicknesses of the protective substrates of the first and second optical information recording mediums are the same with each other (t1=t2), as in the present embodiment, the chromatic spherical aberration caused by the difference between wavelength λ1 and wavelength λ2 can be corrected by using at least one of the optical surfaces of the objective optical system OBJ as a refraction surface. When the refracting surface is used for correction, at least three aspherical surfaces of the objective optical system OBJ are essential. When correction is made by the diffractive surface with the diffractive structure DOE formed thereon, then the diffractive surface can be provided with the chromatic aberration correcting function conforming to the mode hop of the first optical information recording medium.

As described above, in the optical pickup apparatus PU shown in the present embodiment, the light flux of wavelength λ1 with a waveform ratio corresponding approximately to an integer ratio (e.g. blue-violet laser beam having a wavelength λ1 of about 407 nm) and the light flux of wavelength λ3 (e.g. infrared laser light flux having a wavelength λ3 of about 785 nm) can be emitted at different angles with each other, using the diffractive structure HOE. For example, correction of the spherical aberration and transmittance can be ensured.

The present embodiment uses a light source unit LU comprising a red semiconductor laser LD2 and an infrared semiconductor laser LD3 integrated in one piece. Without being restricted thereto, the present invention allows use of a HD/DVD/CD one-chip laser light source unit LU where the blue-violet semiconductor laser LD1 (first light source) is also incorporated in one and the same enclosure.

One of the ways for laminating an optical resin on optical glass is to use as a mold the optical glass with the phase structure formed on the surface, and to form the optical resin on the optical glass (so-called the insert-molding technique). Another way is to laminate an ultraviolet curing resin on the optical glass with the phase structure formed on the surface thereof and to apply ultraviolet rays for curing purposes. This method is preferred from the viewpoint of production. When this art is used, the other side of the ultraviolet curing resin preferably has a flat plane.

One of the methods of manufacturing the optical glass with a phase structure formed on the surface thereof is to form the phase structure directly on the optical glass substrate by repeating the processes of photolithography and etching. Another way is a so-called molding method, wherein a mold with the phase structure formed thereon is created, and the optical glass with the phase structure formed on the surface thereof is obtained as a replica of this mold. The latter method is preferred from the viewpoint of mass production. A mold with the phase structure formed thereon can be created by the art of repeating the processes of photolithography and etching, thereby forming a phase structure, or by the art of using a precision lathe to produce the phase structure by machining operation.

Preferable ranges of the wavelengths λ1, λ2 and λ3 and protective substrate thicknesses t1, t2 and t3 for the present invention are followings.
350 nm≦λ1≦450 nm
600 nm≦λ2≦700 nm
750 nm≦λ3≦850 nm
0.0 mm≦t1≦0.7 mm
0.4 mm≦t2≦0.7 mm
0.9 mm≦t3≦1.3 mm

More Preferable ranges of the wavelengths λ1, λ2 and λ3 and protective substrate thicknesses t1, t2 and t3 for the present invention are followings.
390 nm≦λ1≦415 nm
635 nm≦λ2≦670 nm
770 nm≦λ3≦810 nm
0.5 mm≦t1≦0.7 mm
0.5 mm≦t2≦0.7 mm
1.1 mm≦t3≦1.3 mm

The following describes the examples of the objective optical system shown in the aforementioned embodiment.

### Example 14

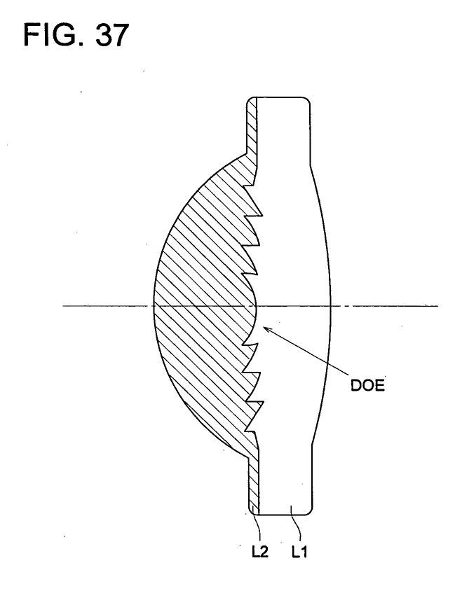

As shown in FIG. 37, the objective optical system of the present embodiment is formed by a lamination of the second part L2 and first part L1 in that order from the side of the light source. A serrated diffractive structure DOE is formed as a phase structure on the boundary between the second part L2 and first part L1.

Table 18 shows the lens data for the fourteenth embodiment.

TABLE 18
Example 14: Lens data

| | | | |
|---|---|---|---|
| Focal distance of objective lens | f1 = 3.00 mm | f2 = 3.11 mm | f3 = 3.13 mm |
| Numerical aperture on the image | NA1: 0.65 | NA2: 0.65 | NA3: 0.51 |
| surface side | | | |
| Magnification | m1 = 0 | m2 = 0 | m3 = −1/19.7 |

| i-th | | di | ni | di | ni | di | ni |
|---|---|---|---|---|---|---|---|
| surface | ri | (407 nm) | (407 nm) | (655 nm) | (655 nm) | (785 nm) | (785 nm) |
| 0 | | ∞ | | ∞ | | 64.05 | |
| 1 | | 0.0 | | 0.0 | | 0.0 | |
| (aperture | | (φ 3.900 mm) | | (φ 4.043 mm) | | (φ 3.323 mm) | |
| diameter) | | | | | | | |
| 2 | 2.0020 | 1.00 | 1.6255 | 1.00 | 1.5934 | 1.00 | 1.5877 |
| 3 | 1.5008 | 1.80 | 1.5345 | 1.80 | 1.5101 | 1.80 | 1.5036 |
| 4 | −3.9962 | 1.11 | 1.0 | 1.19 | 1.0 | 0.99 | 1.0 |
| 5 | ∞ | 0.6 | 1.6187 | 0.6 | 1.5775 | 1.2 | 1.5706 |
| 6 | ∞ | | | | | | |

2nd surface
Aspherical surface coefficient

| | |
|---|---|
| κ | −5.3348E−01 |
| A4 | 2.5578E−04 |
| A6 | −2.6463E−04 |
| A8 | 4.1443E−05 |
| A10 | −3.3703E−05 |
| A12 | 9.1544E−06 |
| A14 | −1.9657E−06 |

3rd surface
Aspherical surface coefficient

| | |
|---|---|
| κ | −1.1223E+00 |
| A4 | 1.7320E−02 |
| A6 | 3.5770E−03 |
| A8 | −2.0559E−03 |
| A10 | −2.0559E−03 |
| A12 | 1.0405E−03 |
| A14 | −3.2525E−06 |

Optical path function (0-th order for HD and DVD; first
order for CD and manufacture wavelength: 470 nm)

| | |
|---|---|
| C2 | −2.6897E−03 |
| C4 | −5.1269E−04 |
| C6 | −2.5699E−06 |
| C8 | −4.0632E−05 |
| C10 | 9.3449E−06 |

4th surface
Aspherical surface coefficient

| | |
|---|---|
| κ | −3.3318E+01 |
| A4 | −5.3666E−03 |
| A6 | 9.0536E−03 |
| A8 | −6.0806E−03 |
| A10 | 1.4406E−03 |
| A12 | −3.2886E−05 |
| A14 | −2.4590E−05 |

| | nd | νd |
|---|---|---|
| Material A | 1.5140 | 42.8 |
| Material B | 1.5980 | 38.0 |

As shown in Table 18, the objective optical system of the present embodiment is an HD/DVD/CD compatible objective optical system. The focal distance f1 for wavelength λ1 of 407 nm is set at 3.00 mm, and the magnification m1 at 0; the focal distance f3 for wavelength λ3 of 785 nm is set at 3.13 mm, and the magnification m3 at −1/19.7 and the focal distance f2 for wavelength λ2 of 655 nm is set at 3.11 mm, and the magnification m2 at 0.

The refractive index nd on d-line of the material A constituting the first part L1 is set at 1.5140, and the Abbe's number νd on the d-line at 42.8; and the refractive index nd on the d-line of the material B constituting the second part L2 is set at 1.5980 and the Abbe's number νd on the d-line at 38.0.

The incoming surface of the second part (second surface), the boundary surface between the second and first part (third surface), and the outgoing surface of the first part (fourth surface) are formed in an axisymmetric, aspherical surface around the optical axis L, defined by the equation obtained by substituting the coefficient of Table 18 into the following equation (Numeral. 3).

$$Aspherical shape \\ x ( h ) = \frac{{h}^{2} / r}{1 + \sqrt{1 - ( 1 + κ ) {( h / r )}^{2}}} + {\sum }_{i = 2} {A}_{2 i} {h}^{2 i} \qquad [ Numeral . 3 ]$$

In the aforementioned equation, “x(h)” denotes the axis in the direction of optical axis (traveling direction of the light is assumed as positive), “κ” the cone coefficient, “A₂ᵢ” the aspherical surface coefficient, “h” the height in the direction perpendicular to the optical axis, and “h (mm)” the curvature radius.

Further, diffractive structure DOE is formed on the third surface. The diffractive structure DOE is expressed by the length of the optical axis added to the wave front for transmission by this structure. Such an optical path difference is expressed by the optical path function φ(h) (mm) defined by substituting the coefficient of Table 18 into the aforementioned Eq. 18, where “C₂ᵢ” denotes the optical path function coefficient; “n” represents the order of diffraction of the diffracted light flux, having the maximum diffraction efficiency, out of the incoming light fluxes having been reflected; “λ (nm)” shows the wavelength of the light flux entering the diffractive structure; and ”λ_{B} (nm)” indicates the manufacture wavelength (blazed wavelength) of the diffractive structure.

$$ϕ ( h ) = λ / {λ}_{B} \times n \times {\sum }_{i = 1} {C}_{2 i} {h}^{2 i} \qquad [ Numeral . 4 ]$$

In this case, the manufacture wavelength (blazed wavelength) of the diffractive structure DOE is 470 nm.

### Example 15

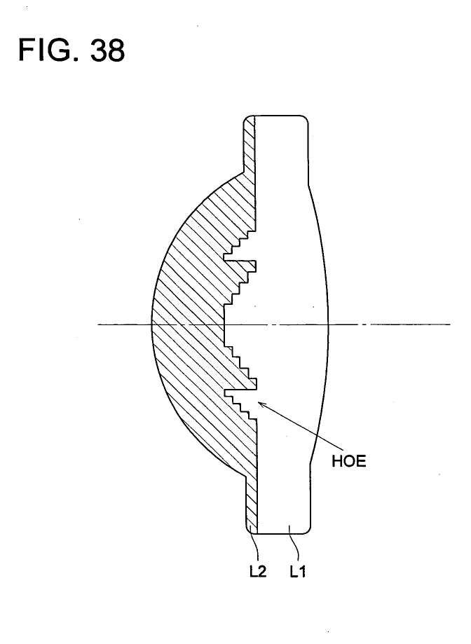

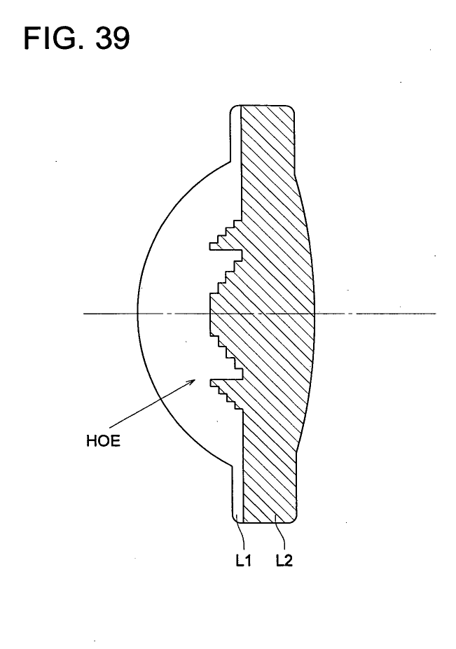

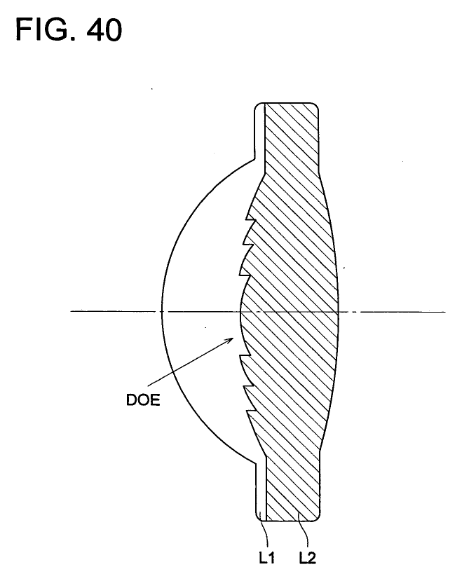

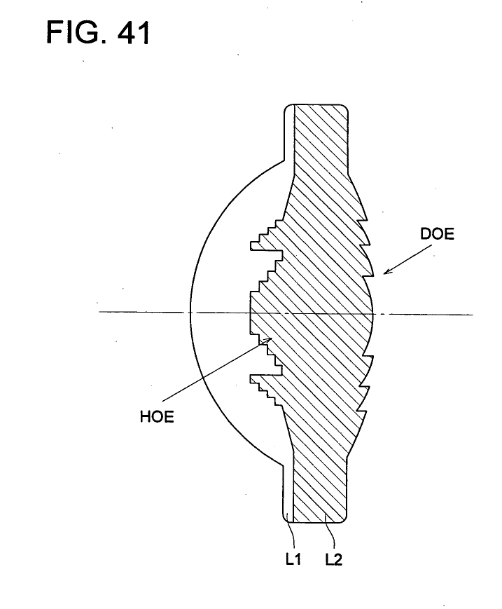

As shown in FIG. 38, the objective optical system of the present embodiment is formed by a lamination of the second part L2 and first part L1 in that order from the side of the light source. A diffractive structure HOE as a phase structure is formed as a phase structure on the boundary between the second part L2 and first part L1.

Table 19 shows the lens data for the third embodiment.

TABLE 19
Example 15: Lens data

| | | | |
|---|---|---|---|
| Focal distance of objective lens | f1 = 3.0 mm | f2 = 3.24 mm | f3 = 3.24 mm |
| Numerical aperture on the image | NA1: 0.65 | NA2: 0.65 | NA3: 0.51 |
| surface side | | | |
| Magnification | m1 = 0 | m3 = 0 | m2 = 0 |

| i-th | | di | ni | di | ni | di | ni |
|---|---|---|---|---|---|---|---|
| surface | ri | (407 nm) | (407 nm) | (655 nm) | (655 nm) | (785 nm) | (785 nm) |
| 0 | | ∞ | | ∞ | | ∞ | |
| 1 | | 0.0 | | 0.0 | | 0.0 | |
| (aperture | | (φ 3.900 mm) | | (φ 3.421 mm) | | (φ 3.421 mm) | |
| diameter) | | | | | | | |
| 2 | 2.3159 | 1.20 | 1.5345 | 1.20 | 1.5101 | 1.20 | 1.5036 |
| 3 | 1.1723 | 2.00 | 1.6365 | 2.00 | 1.5919 | 2.00 | 1.5845 |
| 3′ | 1.1723 | 0.00 | 1.6365 | 0.00 | 1.5919 | 0.00 | 1.5845 |
| 4 | −9.1728 | 0.98 | 1.0 | 1.16 | 1.0 | 0.77 | 1.0 |
| 5 | ∞ | 0.6 | 1.6187 | 0.6 | 1.5775 | 1.2 | 1.5706 |
| 6 | ∞ | | | | | | |

The di′ indicates the distance from the 1′-th surface to the first surface.

2nd surface
Aspherical surface coefficient

| | |
|---|---|
| κ | −4.6638E−01 |
| A4 | 1.1315E−03 |
| A6 | 1.5261E−04 |
| A8 | 8.5635E−05 |
| A10 | −4.5774E−05 |
| A12 | 6.0883E−06 |
| A14 | −2.0412E−07 |

3rd surface (0 mm ≦ h ≦ 1.287 mm)
Aspherical surface coefficient

| | |
|---|---|
| κ | −1.0834E+00 |
| A4 | 4.1005E−02 |
| A6 | 4.6054E−04 |
| A8 | 8.9729E−04 |
| A10 | −3.1315E−03 |
| A12 | 2.8595E−03 |
| A14 | −7.5433E−04 |

Optical path function (0-th order for HD and DVD; first order
for CD and manufacture wavelength: 785 nm)

| | |
|---|---|
| C2 | 2.4223E−03 |
| C4 | −8.6317E−04 |
| C6 | −8.4311E−05 |
| C8 | −1.1295E−04 |
| C10 | 9.8103E−06 |

3′-th surface (1.287 mm ≦ h)
Aspherical surface coefficient

| | |
|---|---|
| κ | −1.0834E+00 |
| A4 | 4.1005E−02 |
| A6 | 4.6054E−04 |
| A8 | 8.9729E−04 |
| A10 | −3.1315E−03 |
| A12 | 2.8595E−03 |
| A14 | −7.5433E−04 |

4th surface
Aspherical surface coefficient

| | |
|---|---|
| κ | −1.9509E+02 |
| A4 | 3.1077E−03 |
| A6 | 6.7363E−03 |
| A8 | −7.9529E−03 |
| A10 | 2.2941E−03 |
| A12 | 2.3194E−04 |
| A14 | −1.7981E−04 |

| | nd | νd |
|---|---|---|
| Material A | 1.5140 | 42.8 |
| Material B | 1.5980 | 28.0 |

As shown in Table 19, the objective optical system of the present embodiment is an HD/DVD/CD compatible objective optical system. The focal distance f1 for wavelength λ1 of 407 nm is set at 3.00 mm, and the magnification m1 at 0; the focal distance f3 for wavelength λ3 of 785 nm is set at 3.24 mm, and the magnification m3 at 0 and the focal distance f2 for wavelength λ2 of 655 nm is set at 3.24 mm, and the magnification m2 at 0.

The refractive index nd on the d-line of the material A constituting the first part L1 is set at 1.5140, and the Abbe's number νd on the d-line at 42.8; and the refractive index nd on d-line of the material B constituting the second part L2 is set at 1.5980, and the Abbe's number νd on the d-line at 28.0.

The boundary surface between the second part and first part is divided into two portions; a 3rd surface where the height h around the optical axis is 0 mm≦h≦1, and a 3′-th surface where 1.287 mm<h.

The incoming surface (second surface) of the second part, third surface, and 3′-th surface and outgoing surface (fourth surface) of the first part are formed in an aspherical surface.

The diffractive structure HOE is formed on the third surface. The manufacture wavelength λ_{B} of the diffractive structure HOE is 785 nm.

### Example 16

As shown in FIG. 13, the objective optical system of the present embodiment is formed by a lamination of the second part L2 and first part L1 in that order from the side of the light source. A diffractive structure HOE as a phase structure is formed as a phase structure on the boundary between the second part L2 and air layer.

Table 20 shows the lens data for the sixteenth example.

TABLE 20
Example 16: Lens data

| | | | |
|---|---|---|---|
| Focal distance of objective lens | f1 = 3.0 mm | f2 = 3.12 mm | f3 = 3.10 mm |
| Numerical aperture on the image | NA1: 0.65 | NA2: 0.51 | NA3: 0.51 |
| surface side | | | |
| Magnification | m1 = 0 | m3 = 0 | m2 = 0 |

| i-th | | di | ni | di | ni | di | ni |
|---|---|---|---|---|---|---|---|
| surface | ri | (407 nm) | (407 nm) | (655 nm) | (655 nm) | (785 nm) | (785 nm) |
| 0 | | ∞ | | ∞ | | ∞ | |
| 1 | | 0.0 | | 0.0 | | 0.0 | |
| (aperture | | (φ 3.900 mm) | | (φ 4.056 mm) | | (φ 4.056 mm) | |
| diameter) | | | | | | | |
| 2 | 2.1131 | 1.10 | 1.6498 | 1.10 | 1.6011 | 1.10 | 1.5947 |
| 2′ | 2.1131 | 0.00 | 1.6498 | 0.00 | 1.6011 | 0.00 | 1.5947 |
| 3 | 2.3241 | 1.40 | 1.6051 | 1.40 | 1.5860 | 1.40 | 1.5819 |
| 4 | −7.9463 | 1.25 | 1.0 | 1.36 | 1.0 | 0.95 | 1.0 |
| 5 | ∞ | 0.6 | 1.6187 | 0.6 | 1.5775 | 1.2 | 1.5706 |
| 6 | ∞ | | | | | | |

The di′ indicates the distance from the 1′-th surface to the first surface.

2nd surface (0 mm ≦ h ≦ 1.581 mm)
Aspherical surface coefficient

| | |
|---|---|
| κ | −5.1962E−01 |
| A4 | 1.1777E−03 |
| A6 | −4.1299E−04 |
| A8 | 2.3850E−04 |
| A10 | −9.2086E−05 |
| A12 | 1.5943E−05 |
| A14 | −1.8029E−06 |

Optical path function (0-th order for HD and DVD; first
order for CD and manufacture wavelength: 785 nm)

| | |
|---|---|
| C2 | −2.4614E−03 |
| C4 | −2.8518E−04 |
| C6 | −8.5393E−05 |
| C8 | 1.3383E−05 |
| C10 | −2.1879E−06 |

2′-nd surface (1.581 mm ≦ h)
Aspherical surface coefficient

| | |
|---|---|
| κ | −5.1962E−01 |
| A4 | 1.1777E−03 |
| A6 | −4.1299E−04 |
| A8 | 2.3850E−04 |
| A10 | −9.2086E−05 |
| A12 | 1.5943E−05 |
| A14 | −1.8029E−06 |

3rd surface
Aspherical surface coefficient

| | |
|---|---|
| κ | −1.7903E+00 |
| A4 | 2.4539E−02 |
| A6 | −6.4924E−03 |
| A8 | 3.1101E−03 |
| A10 | −1.1781E−03 |
| A12 | 2.4835E−04 |
| A14 | −2.4957E−05 |

4th surface
Aspherical surface coefficient

| | |
|---|---|
| κ | −9.8485E+01 |
| A4 | 6.3017E−05 |
| A6 | 5.5784E−03 |
| A8 | −5.5483E−03 |
| A10 | 2.1902E−03 |
| A12 | −4.3963E−04 |
| A14 | 3.6029E−05 |

| | nd | νd |
|---|---|---|
| Material A | 1.5890 | 59.7 |
| Material B | 1.6072 | 27.6 |

As shown in Table 20, the objective optical system of the present embodiment is an HD/DVD/CD compatible objective optical system. The focal distance f1 for wavelength λ1 of 407 nm is set at 3.00 mm, and the magnification m1 at 0; the focal distance f3 for wavelength λ3 of 785 nm is set at 3.10 mm, and the magnification m3 at 0 and the focal distance f2 for wavelength λ2 of 655 nm is set at 3.12 mm, and the magnification m2 at 0.

The refractive index nd on the d-line of the material A constituting the first part L1 is set at 1.5890, and the Abbe's number νd on the d-line at 59.7; and the refractive index nd on the d-line of the material B constituting the second part L2 is set at 1.6072, and the Abbe's number νd on d-line at 27.6.

The incoming surface of the second part is divided into two portions; a 2nd surface where the height h around the optical axis is 0 mm≦h≦1.581 mm, and a 2′-th surface where 1.581 mm<h. The 2nd-surface, 2′-th surface, the boundary surface (third surface) between the second part and first part, and outgoing surface (fourth surface) of the first part are formed in an aspherical surface.

The diffractive structure HOE is formed on the second surface. The manufacture wavelength λ_{B} of the diffractive structure HOE is 785 nm.

### Example 17

As shown in Table 39, the objective optical system of the present embodiment is formed by a lamination of the first part L1 and the second part L2 in that order from the side of the light source. A diffractive structure HOE is formed as a phase structure on the boundary between the first part L1 and second part L2.

Table 21 shows the lens data for the seventeenth Example.

TABLE 21
Example 17: Lens data

| | | | |
|---|---|---|---|
| Focal distance of objective lens | f1 = 2.2 mm | f2 = 2.26 mm | f3 = 2.27 mm |
| Numerical aperture on the image | NA1: 0.85 | NA2: 0.65 | NA3: 0.51 |
| surface side | | | |
| Magnification | m1 = 0 | m2 = −1/17.7 | m3 = 0 |

| i-th | | di | ni | di | ni | di | ni |
|---|---|---|---|---|---|---|---|
| surface | ri | (407 nm) | (407 nm) | (655 nm) | (655 nm) | (785 nm) | (785 nm) |
| 0 | | ∞ | | −39.00 | | ∞ | |
| 1 | | 0.0 | | 0.0 | | 0.0 | |
| (aperture | | (φ 3.74 mm) | | (φ 2.860 mm) | | (φ 3.74 mm) | |
| diameter) | | | | | | | |
| 2 | 1.5542 | 1.70 | 1.5428 | 1.70 | 1.5292 | 1.70 | 1.5254 |
| 3 | −5.0344 | 1.10 | 1.6498 | 1.10 | 1.6011 | 1.10 | 1.5947 |
| 3′ | −2.1462 | 0.00 | 1.6498 | 0.00 | 1.6011 | 0.00 | 1.5947 |
| 4 | −2.1462 | 0.32 | 1.0 | 0.39 | 1.0 | 0.13 | 1.0 |
| 5 | ∞ | 0.0875 | 1.6187 | 0.6 | 1.5775 | 1.2 | 1.5706 |
| 6 | ∞ | | | | | | |

The di′ indicates the distance from the 1′-th surface to the first
surface.

2nd surface
Aspherical surface coefficient

| | |
|---|---|
| κ | −6.8034E−01 |
| A4 | 6.5476E−03 |
| A6 | 2.9046E−03 |
| A8 | −6.4037E−04 |
| A10 | 1.7991E−04 |
| A12 | 4.3404E−05 |
| A14 | −1.3667E−05 |
| A16 | −2.9442E−06 |
| A18 | −1.3039E−06 |
| A20 | 5.0225E−07 |

3rd surface (0 mm ≦ h ≦ 0.462 mm)
Aspherical surface coefficient

| | |
|---|---|
| κ | −8.0064E+00 |
| A4 | 1.1219E−02 |
| A6 | 3.2612E−03 |
| A8 | −9.2701E−04 |
| A10 | 1.2492E−04 |
| A12 | 1.6820E−05 |
| A14 | −1.8650E−05 |
| A16 | −3.4590E−06 |
| A18 | −1.3478E−06 |
| A20 | 6.0951E−07 |

Optical path function (0-th order for HD and DVD; first order
for CD and manufacture wavelength: 785 nm)

| | |
|---|---|
| C2 | −1.4049E−03 |
| C4 | −4.6852E−03 |
| C6 | 7.2316E−03 |
| C8 | −8.5509E−03 |
| C10 | 4.0170E−03 |

3′-th surface (0.462 mm ≦ h)
Aspherical surface coefficient

| | |
|---|---|
| κ | −8.0064E+00 |
| A4 | 1.1219E−02 |
| A6 | 3.2612E−03 |
| A8 | −9.2701E−04 |
| A10 | 1.2492E−04 |
| A12 | 1.6820E−05 |
| A14 | −1.8650E−05 |
| A16 | −3.4590E−06 |
| A18 | −1.3478E−06 |
| A20 | 6.0951E−07 |

4th surface
Aspherical surface coefficient

| | |
|---|---|
| κ | −7.3786E+00 |
| A4 | 1.6342E−01 |
| A6 | −1.7346E−01 |
| A8 | 1.0568E−01 |
| A10 | −3.5872E−02 |
| A12 | 5.1021E−03 |

| | nd | νd |
|---|---|---|
| Material A | 1.5319 | 66.1 |
| Material B | 1.6072 | 27.6 |

### Example 18

As shown in FIG. 40, the objective optical system of the present embodiment is formed by a lamination of the first part L1 and the second part L2 in that order from the side of the light source. A serrated diffractive structure DOE is formed as a phase structure on the boundary between the first part L1 and second part L2.

Table 22 shows the lens data for the eighteenth embodiment.

TABLE 22
Example 18: Lens data

| | | | |
|---|---|---|---|
| Focal distance of objective lens | f1 = 2.2 mm | f2 = 2.23 mm | f3 = 2.23 mm |
| Numerical aperture on the image | NA1: 0.85 | NA2: 0.65 | NA3: 0.51 |
| surface side | | | |
| Magnification | m1 = 0 | m2 = 1/10.9 | m3 = 0 |

| i-th | | di | ni | di | ni | di | ni |
|---|---|---|---|---|---|---|---|
| surface | ri | (407 nm) | (407 nm) | (655 nm) | (655 nm) | (785 nm) | (785 nm) |
| 0 | | ∞ | | −39.00 | | ∞ | |
| 1 | | 0.0 | | 0.0 | | 0.0 | |
| (aperture | | (φ 3.74 mm) | | (φ 2.786 mm) | | (φ 3.74 mm) | |
| diameter) | | | | | | | |
| 2 | 1.5592 | 1.80 | 1.5351 | 1.80 | 1.5104 | 1.80 | 1.5059 |
| 3 | −2.4731 | 1.00 | 1.6255 | 1.00 | 1.5934 | 1.00 | 1.5877 |
| 4 | −2.0830 | 0.32 | 1.0 | 0.31 | 1.0 | 0.13 | 1.0 |
| 5 | ∞ | 0.0875 | 1.6187 | 0.6 | 1.5775 | 1.2 | 1.5706 |
| 6 | ∞ | | | | | | |

The di′ indicates the distance from the 1′-th surface to the first surface.

2nd surface
Aspherical surface coefficient

| | |
|---|---|
| κ | −6.8659E−01 |
| A4 | 6.6827E−03 |
| A6 | 1.8296E−03 |
| A8 | −7.8832E−05 |
| A10 | 9.5357E−05 |
| A12 | 1.6596E−05 |
| A14 | −9.8163E−06 |
| A16 | −2.7000E−07 |
| A18 | −8.3535E−07 |
| A20 | 5.2291E−07 |

3rd surface
Aspherical surface coefficient

| | |
|---|---|
| κ | −1.2017E+00 |
| A4 | 1.7437E−02 |
| A6 | 9.3303E−03 |
| A8 | 7.7167E−04 |
| A10 | 3.8605E−04 |
| A12 | −3.2931E−05 |
| A14 | −6.2313E−05 |
| A16 | −1.5275E−05 |
| A18 | 1.5640E−06 |
| A20 | 1.2002E−06 |

Optical path function (first order for HD and DVD; first
order for CD and manufacture wavelength: 470 nm)

| | |
|---|---|
| C2 | −1.5525E−02 |
| C4 | −6.1300E−04 |
| C6 | 1.3257E−03 |
| C8 | 3.1564E−04 |
| C10 | 2.3795E−05 |

4th surface
Aspherical surface coefficient

| | |
|---|---|
| κ | −6.7764E+00 |
| A4 | 1.6306E−01 |
| A6 | −1.7183E−01 |
| A8 | 1.0524E−01 |
| A10 | −3.7082E−02 |
| A12 | 5.6260E−03 |

| | nd | νd |
|---|---|---|
| Material A | 1.5140 | 42.0 |
| Material B | 1.5980 | 38.0 |

As shown in Table 23, the objective optical system of the present embodiment is a BD/DVD/CD compatible objective optical system. The focal distance f1 for wavelength λ1 of 407 nm is set at 2.20 mm, and the magnification m1 at 0; the focal distance f3 for wavelength λ3 of 785 nm is set at 2.23 mm, and the magnification m3 at 0 and the focal distance f2 for wavelength λ2 of 655 nm is set at 2.23 mm, and the magnification m2 at 1/10.9.

The refractive index nd on d-line of the material A constituting the first part L1 is set at 1.5140, and the Abbe's number νd on the d-line at 42.0; and the refractive index nd on d-line of the material B constituting the second part L2 is set at 1.5980, and the Abbe's number νd on the d-line at 38.0.

The incoming surface (second surface) of the first part, the boundary (third surface) between the first and second part, and the outgoing surface (fourth surface) of the second part are formed in an aspherical surface.

The diffractive structure DOE is formed on the third surface. The manufacture wavelength λ_{B} of the diffractive structure DOE is 470 nm.

### Example 19

As shown in Table 41, the objective optical system of the present embodiment is formed by a lamination of the first part L1 and the second part L2 in that order from the side of the light source. A serrated diffractive structure DOE is formed as a phase structure on the boundary surface between the second part and air layer. A diffractive structure DOE is formed as a phase structure also on the boundary surface between the first part and second part.

Table 24 shows the lens data for the nineteenth embodiment.

TABLE 24
Example 19: Lens data

| | | | |
|---|---|---|---|
| Focal distance of objective lens | f1 = 2.2 mm | f2 = 2.30 mm | f3 = 3.14 mm |
| Numerical aperture on the image | NA1: 0.85 | NA2: 0.65 | NA3: 0.51 |
| Magnification | m1 = 0 | m2 = 0 | m3 = 0 |

| i-th | | di | ni | di | ni | di | ndi |
|---|---|---|---|---|---|---|---|
| surface | ri | (407 nm) | (407 nm) | (655 nm) | (655 nm) | (785 nm) | (785 nm) |
| 0 | | ∞ | | ∞ | | ∞ | |
| 1 | | 0.0 | | 0.0 | | 0.0 | |
| (aperture | | (φ 3.74 mm) | | (φ 2.99 mm) | | (φ 3.203 mm) | |
| diameter) | | | | | | | |
| 2 | 1.5764 | 1.90 | 1.5428 | 1.90 | 1.5292 | 1.90 | 1.5254 |
| 3 | −6.1963 | 0.80 | 1.6498 | 0.80 | 1.6011 | 0.80 | 1.5947 |
| 3′ | −6.1963 | 0.00 | 1.6498 | 0.00 | 1.6011 | 0.00 | 1.5947 |
| 4 | −4.4325 | 0.37 | 1.0 | 0.58 | 1.0 | 0.10 | 1.0 |
| 5 | ∞ | 0.0875 | 1.6187 | 0.6 | 1.5775 | 1.2 | 1.5706 |
| 6 | ∞ | | | | | | |

The di′ indicates the distance from the 1′-th surface to the first 2nd surface

Aspherical surface coefficient

| | |
|---|---|
| κ | −6.6854E−01 |
| A4 | 5.7223E−03 |
| A6 | 2.1228E−03 |
| A8 | 5.7198E−05 |
| A10 | −1.4373E−05 |
| A12 | 4.2164E−05 |
| A14 | 7.9085E−07 |
| A16 | 8.1275E−07 |
| A18 | −1.0384E−06 |
| A20 | 3.2250E−07 |

3rd surface (0 mm ≦ h ≦ 0.708 mm)
Aspherical surface coefficient

| | |
|---|---|
| κ | −1.5848E+02 |
| A4 | 2.7742E−02 |
| A6 | 5.8331E−03 |
| A8 | −1.3553E−04 |
| A10 | 2.4334E−04 |
| A12 | −1.3476E−04 |
| A14 | −1.1797E−05 |
| A16 | 5.0574E−07 |
| A18 | 4.0622E−06 |
| A20 | 2.3413E−06 |

Optical path function (0-th order for HD and DVD; first order
for CD and manufacture wavelength: 785 nm)

| | |
|---|---|
| C2 | −2.5614E−02 |
| C4 | 5.1044E−04 |
| C6 | 2.3337E−03 |
| C8 | −4.8063E−03 |
| C10 | 2.5108E−03 |

3′-th surface (0.708 mm ≦ h)
Aspherical surface coefficient

| | |
|---|---|
| κ | −1.5848E+02 |
| A4 | 2.7742E−02 |
| A6 | 5.8331E−03 |
| A8 | −1.3553E−04 |
| A10 | 2.4334E−04 |
| A12 | −1.3476E−04 |
| A14 | −1.1797E−05 |
| A16 | 5.0574E−07 |
| A18 | 4.0622E−06 |
| A20 | 2.3413E−06 |

4th surface
Aspherical surface coefficient

| | |
|---|---|
| κ | −7.3786E+00 |
| A4 | 1.6342E−01 |
| A6 | −1.7346E−01 |
| A8 | 1.0568E−01 |
| A10 | −3.5872E−02 |
| A12 | 5.1021E−03 |

Optical path function (HD, DVD; second-order DVD: first-order
CD: first-order manufacture wavelength: 407 nm)

| | |
|---|---|
| C2 | −3.6044E−02 |
| C4 | −1.1410E−02 |
| C6 | 6.8212E−03 |
| C8 | 6.9426E−04 |
| C10 | 6.0891E−04 |

| | nd | νd |
|---|---|---|
| Material A | 1.5319 | 66.1 |
| Material B | 1.6072 | 27.6 |

As shown in Table 24, the objective optical system of the present embodiment is a BD/DVD/CD compatible objective optical system. The focal distance f1 for wavelength λ1 of 407 nm is set at 2.20 mm, and the magnification m1 at 0; the focal distance f3 for wavelength λ3 of 785 nm is set at 3.14 mm, and the magnification m3 at 0 and the focal distance f2 for wavelength λ2 of 655 nm is set at 2.30 mm, and the magnification m2 at 0.

The refractive index nd on the d-line of the material A constituting the first part L1 is set at 1.5319, and the Abbe's number νd on the d-line at 66.1; and the refractive index nd on the d-line of the material B constituting the second part L2 is set at 1.6072, and the Abbe's number νd on d-line at 27.6.

The boundary surface between the first part and the second part is divided into two portions; a 3rd surface where the height h around the optical axis is 0 mm≦h≦0.708 mm, and a 3′-th surface where 0.708 mm<h.

The incoming surface (first surface) of the first part, third surface, and 3′-th surface and outgoing surface (fourth surface) of the second part are formed in an aspherical surface.

The diffractive structure HOE is formed on the third surface, and the diffractive structure DOE is formed on the fourth surface. The manufacture wavelength λ_{B} of the diffractive structure HOE on the third surface is 785 nm, and the manufacture wavelength λ_{B} of the diffractive structure DOE on the fourth surface is 407 nm.

Table 25 shows the diffraction efficiency when each of the light fluxes having wavelengths λ1, λ2 and λ3 (indicated as HD, DVD and CD in the drawing) passes through each surface, in the objective optical system shown in the embodiments 14 through 19. FIG. 18 indicates that high diffraction efficiency can be obtained for each of the light fluxes having wavelengths λ1, λ2 and λ3 by the objective optical system shown in each of the aforementioned embodiments.

TABLE 25
Summarized diffraction effects

| | Surface | | | |
|---|---|---|---|---|
| | number | HD | DVD | CD |
| Embodiment 14 | 3rd surface | 87.9 | 70.7 | 52.8 |
| Embodiment 15 | 3rd surface | 100.0 | 99.9 | 84.1 |
| Embodiment 16 | 2nd surface | 100.0 | 64.3 | 65.7 |
| Embodiment 17 | 3rd surface | 100.0 | 80.9 | 68.2 |
| Embodiment 18 | 3rd surface | 87.7 | 71.1 | 50.9 |
| Embodiment 19 | 3rd surface | 100.0 | 80.9 | 68.2 |
| | 4th surface | 100.0 | 92.8 | 99.1 |

According to the present invention, the spherical aberration resulting from only the difference in the thickness of the protective layer among the high-density optical disc, DVD and CD or the spherical aberration resulting from the difference in the wavelength used among the high-density optical disc, DVD and CD can be corrected satisfactorily by the action of the phase structure including the diffractive structure formed on the boundary. At the same time, high efficiency in the use of light can be ensured in the area of blue-violet wavelength in the vicinity of 400 nm, the red wavelength area in the vicinity of 650 nm and the infrared wavelength area in the vicinity of 780 nm. Thus, the present invention provides:
an objective optical system and the aberration correcting element characterized by excellent design performances for the high-density optical disc;
an optical pickup apparatus based on the objective optical system and the aberration correcting element; and
an optical disc drive apparatus equipped with the optical pickup apparatus.

The present invention provides an objective optical system an optical pickup apparatus equipped with the objective optical system, and an optical disc drive apparatus (recording/reproducing drive for optical information recording medium) equipped with the optical pickup apparatus, characterized in that the aforementioned two types of light flux are emitted at mutually different angles using the phase structure for the purpose of achieving compatibility between the high-density optical disc and CD, wherein the wavelength ratio of the light fluxes to be used are almost equal to an integer ratio, and high transmittance can be ensured for a light flux having any wavelength.

According to the present invention, the aberration resulting from the difference in the protective layer among the high-density optical disc, DVD and CD, or the aberration resulting from the difference in the wavelength to be used among the high-density optical disc, DVD and CD can be corrected satisfactorily by the action of the phase structure having a strap-formed step formed on the boundary between the first and second materials. At the same time, high efficiency in the use of diffraction is ensured in the blue-violet wavelength range in the vicinity of 400 nm, the red wavelength range in the vicinity of 650 nm and the infrared wavelength range in the vicinity of 780 nm. Further, the present invention also provides a diffraction optical device characterized by small changes in the transmittance of the phase structure resulting from changes in temperature; an objective optical system having this diffraction optical device; an optical pickup apparatus equipped with this diffraction optical device; and optical drive apparatus equipped with this optical pickup apparatus.

1. An objective optical system for use in an optical pickup apparatus which reproduces and/or records information on an information recording surface of a first optical information medium having a protective substrate with a thickness t1 using a first light flux with a first wavelength λ1 emitted from a first light source, and reproduces and/or records information on an information recording surface of a third optical information medium having a protective substrate with a thickness t3 (t3>t1) using a third light flux with a third wavelength λ3 (λ3>λ1) emitted from a third light source, the objective optical system comprising:
a first optical element;
a first part comprising a material A;
a second part comprising a material B; wherein the first part and the second part are laminated on the first optical element in a direction of an optical axis of the objective optical system, and the material A and the material B have different Abbe constants for d-line each other; and
a first phase structure formed on a boundary between the first part and the second part.

2. The objective optical system of claim 1,
wherein the first phase structure forms a base curve which is a microscopic curve of the first phase structure,
the base curve forms an aspherical surface or a spherical surface,
the objective optical system satisfies following expressions:
20<|Δνd|<40

|Δn1|>0.02.
where Δνd is a difference between an Abbe constant of the material A for d-line and an Abbe constant of the material B for d-line, and
Δn1 is a difference between a refractive index of the first part for the first wavelength λ1 and a refractive index of the second part for the first wavelength λ1.

3. The objective optical system of claim 2,
wherein the optical pickup apparatus further reproduces and/or records information on an information recording surface of a second optical information medium having a protective substrate with a thickness t2 (t1≦t2≦t3) using a second light flux with a second wavelength λ2 (λ1<λ2<λ3) emitted from a second light source.

4. The objective optical system of claim 2,
wherein the objective optical system further comprising an objective lens arranged on an optical-information-recording-medium side of the first optical element.

5. The objective optical system of claim 2,
wherein the first optical element is an objective lens.

6. The objective optical system of claim 2,
wherein the first phase structure is a diffractive structure.

7. The objective optical system of claim 2,
wherein the base curve forms an aspherical surface whose deformation amount becomes larger at a position being farther from an optical axis,
where the deformation amount of the base curve is a distance along an optical axis from a spherical surface represented by a paraxial curvature radius to the base curve.

8. The objective optical system of claim 2,
wherein an optical surface of the second part opposite to the boundary is an aspherical surface having an almost same shape to the base curve.

9. The objective optical system of claim 6,
wherein the objective optical system satisfies following expressions:
P_{D}×P_{RT}<0
0.9<|P_{D}×P_{RT}|<1.1
where P_{D} is a paraxial diffractive power of the first phase structure for the first wavelength λ1, and
P_{RT} is a paraxial refractive power of a total system of the first optical element for the first wavelength λ1.

10. The objective optical system of claim 3,
wherein the objective optical system satisfies following expressions:
0.2<|Δn2|/|Δn1|<2.2
0.4<|Δn3|/|Δn1|<2.4
0.0<|Δn3|/|Δn2|<2.0,
where Δn2 is a difference between a refractive index of the first part for the second wavelength λ2 and a refractive index of the second part for the second wavelength λ2, and
Δn3 is a difference between a refractive index of the first part for the third wavelength λ3 and a refractive index of the second part for the third wavelength λ3.

11. The objective optical system of claim 2,
wherein the first phase structure corrects a spherical aberration caused by a difference between the thickness t1 and the thickness t3.

12. The objective optical system of claim 3,
wherein the first phase structure corrects a spherical aberration caused by a difference between the thickness t1 and the thickness t2 or a spherical aberration caused by a difference between the first wavelength λ1 and the second wavelength λ2.

13. The objective optical system of claim 2, further comprising a second phase structure arranged on an optical surface of the first part opposite to the boundary.

14. The objective optical system of claim 13,
wherein the second phase structure does not diffract the first light flux and the third light flux, and
diffracts the second light flux selectively,
the second phase structure corrects a spherical aberration caused by a difference between the thickness t1 and the thickness t2 or a spherical aberration caused by a difference between the first wavelength λ1 and the second wavelength λ2 and
the first phase structure corrects a spherical aberration caused by a difference between the thickness t1 and the thickness t3.

15. The objective optical system of claim 2, further comprising a second phase structure arranged on a boundary between an air and one of the first part and the second part whose material has larger Abbe constant for d-line.

16. The objective optical system of claim 2, further comprising:
an objective lens arranged on an optical-information-recording-medium side of the first optical element; and
a second phase structure arranged on a surface of the objective lens,
wherein an Abbe constant νd for d-line of the objective lens satisfies 40≦νd≦70.

17. The objective optical system of claim 15,
wherein the second phase structure is a diffractive structure whose cross sectional shape including an optical axis is a stepped shape and
the second phase structure diffracts a light flux corresponding to a wavelength selectively or transmits a light flux corresponding to a wavelength selectively.

18. The objective optical system of claim 16,
wherein the second phase structure is a diffractive structure whose cross sectional shape including an optical axis is a stepped shape and
the second phase structure diffracts a light flux corresponding to a wavelength selectively or transmits a light flux corresponding to a wavelength selectively.

19. The objective optical system of claim 15,
wherein the second phase structure is a blazed diffractive structure.

20. The objective optical system of claim 16,
wherein the second phase structure is a blazed diffractive structure.

21. The objective optical system of claim 3 satisfies
0.9×t1≦t2≦1.1×t1.

22. The objective optical system of claim 2,
wherein the material B is an ultraviolet curing resin.

23. The objective optical system of claim 2,
wherein the first part is formed by molding.

24. The objective optical system of claim 2,
wherein the material A is a resin.

25. The objective optical system of claim 2,
wherein the objective lens is optimized about a spherical aberration correction for a combination of the thickness t1 and the wavelength λ1.

26. The objective optical system of claim 2, satisfies the following expressions:
α×λ1=λ3
K1−0.1≦α≦K1+0.1
where K1 is a natural number.

27. An optical pickup apparatus for reproducing and/or recording information, comprising:
a first light source for emitting a first light flux with a first wavelength λ1;
a third light source for emitting a third light flux with a third wavelength λ3 (λ1<λ3); and
the objective optical system of claim 2,
wherein the optical pickup apparatus reproduces and/or records information on an information recording surface of a first optical information medium having a protective substrate with a thickness t1 using the first light flux, and reproduces and/or records information on an information recording surface of a third optical information medium having a protective substrate with a thickness t3 (t3>t1) using the third light flux.

28. An optical disc drive apparatus, comprising:
the optical pickup apparatus of claim 27; and
a moving unit for moving the optical pickup apparatus in a radius direction of each of the first to third optical information recording media.

29. The objective optical system of claim 1,
wherein the first optical element is arranged on an optical path where the first light flux and the third light flux commonly pass through, and
the first phase structure diffracts the first light flux and does not diffract the third light flux.

30. The objective optical system of claim 29,
wherein the optical pickup apparatus further reproduces and/or records information on an information recording surface of a second optical information medium having a protective substrate with a thickness t2 (t1≦t2<t3) using a second light flux with a second wavelength λ2 (λ1<λ2<λ3) emitted from a second light source.

31. The objective optical system of claim 29,
wherein the first phase structure diffracts the second light flux.

32. The objective optical system of claim 29,
wherein the objective optical system further comprising an objective lens arranged on an optical-information-recording-medium side of the first optical element.

33. The objective optical system of claim 29,
wherein the first optical element is an objective lens.

34. The objective optical system of claim 29,
wherein the objective optical system satisfies following expressions:

|Δn1|<0.01
20<|Δνd|<40
where Δνd is a difference between an Abbe constant of the material A for d-line and an Abbe constant of the material B for d-line, and
Δn1 is a difference between a refractive index of the first part for the first wavelength λ1 and a refractive index of the second part for the first wavelength λ1.

35. The objective optical system of claim 30, satisfying following expressions:
0<|INT(d×Δn2/λ2)−(d×Δn2/λ2)|<0.3
0<|INT(d×Δn3/λ3)−(d×Δn3/λ3)|<0.3
where d is a step depth of the first phase structure,
Δn2 is a difference between a refractive index of the first part for the second wavelength λ2 and a refractive index of the second part for the second wavelength λ2, and
Δn3 is a difference between a refractive index of the first part for the third wavelength λ3 and a refractive index of the second part for the third wavelength λ3.

36. The objective optical system of claim 35, satisfying M2=M3,
where M2=INT(d×Δn2/λ2) and
M3=INT(d×Δn3/λ3).

37. The objective optical system of claim 36, satisfies M2=M3=1.

38. The objective optical system of claim 29, further comprising a second phase structure arranged on a boundary between an air and one of the first part and the second part whose material has larger Abbe constant for d-line.

39. The objective optical system of claim 32, further comprising:
an objective lens arranged on an optical-information-recording-medium side of the first optical element; and
a second phase structure arranged on a surface of the objective lens,
wherein an Abbe constant νd for d-line of the objective lens satisfies 40≦νd≦70.

40. The objective optical system of claim 38,
wherein the second phase structure is a diffractive structure whose cross sectional shape including an optical axis is a stepped shape and
the second phase structure diffracts a light flux corresponding to a wavelength selectively or transmits a light flux corresponding to a wavelength selectively.

41. The objective optical system of claim 39,
wherein the second phase structure is a diffractive structure whose cross sectional shape including an optical axis is a stepped shape and
the second phase structure diffracts a light flux corresponding to a wavelength selectively or transmits a light flux corresponding to a wavelength selectively.

42. The objective optical system of claim 38,
wherein the second phase structure is a blazed diffractive structure.

43. The objective optical system of claim 39,
wherein the second phase structure is a blazed diffractive structure.

44. The objective optical system of claim 30 satisfying
0.9×t1≦t2≦1.1×t1.

45. The objective optical system of claim 29,
wherein one of the material A and the material B is a glass material and another is a resin.

46. The objective optical system of claim 45,
wherein the material A is a glass material and the material B is a resin.

47. The objective optical system of claim 46,
wherein the material B is an ultraviolet curing resin.

48. The objective optical system of claim 46,
wherein the first part is formed by molding.

49. The objective optical system of claim 29,
wherein the first phase structure corrects a spherical aberration caused by a difference between the thickness t1 and the thickness t3.

50. The objective optical system of claim 29, satisfies the following expressions:
α×λ1=λ3
K1−0.1≦α≦K1+0.1
where K1 is a natural number.

51. An optical pickup apparatus for reproducing and/or recording information, comprising:
a first light source for emitting a first light flux with a first wavelength λ1;
a third light source for emitting a third light flux with a third wavelength λ3 (λ1<λ3); and
the objective optical system of claim 32,
wherein the optical pickup apparatus reproduces and/or records information on an information recording surface of a first optical information medium having a protective substrate with a thickness t1 using the first light flux, and reproduces and/or records information on an information recording surface of a third optical information medium having a protective substrate with a thickness t3 (t3>t1) using the third light flux, and
the first optical element is arranged in an optical path between the first light source and the second light source, and the objective lens.

52. An optical pickup apparatus for reproducing and/or recording information, comprising:
a first light source for emitting a first light flux with a first wavelength λ1;
a third light source for emitting a third light flux with a third wavelength λ3 (λ1<λ3); and
the objective optical system of claim 32,
wherein the optical pickup apparatus reproduces and/or records information on an information recording surface of a first optical information medium having a protective substrate with a thickness t1 using the first light flux, and reproduces and/or records information on an information recording surface of a third optical information medium having a protective substrate with a thickness t3 (t3>t1) using the third light flux, and
the first optical element and the objective lens are formed in one body.

53. An optical pickup apparatus of claim 51,
wherein the objective lens is optimized about a spherical aberration correction for a combination of the thickness t1 and the wavelength λ1.

54. An optical pickup apparatus of claim 52,
wherein the objective lens is optimized about a spherical aberration correction for a combination of the thickness t1 and the wavelength λ1.

55. An optical disc drive apparatus, comprising:
the optical pickup apparatus of claim 51; and
a moving unit for moving the optical pickup apparatus in a radius direction of each of the first to third optical information recording media.

56. An optical disc drive apparatus, comprising:
the optical pickup apparatus of claim 52; and
a moving unit for moving the optical pickup apparatus in a radius direction of each of the first to third optical information recording media.

57. An objective optical system of claim 1, comprising two or more optical elements including the first optical element and a second optical element,
wherein the first phase structure is a diffractive structure having a plurality of patterns arranged concentrically,
each of the plurality of patterns has a cross section including an optical axis in a stepped shape with a plurality of levels.

58. The objective optical system of claim 57,
wherein the first phase structure has a structure including a plurality of patterns arranged concentrically,
each of the plurality of patterns has a cross section including an optical axis in a stepped shape with a plurality of levels,
a height of each step is shifted for every predefined number of levels by height of steps corresponding to the predefined number of levels.

59. The objective optical system of claim 57,
wherein the optical pickup apparatus further reproduces and/or records information on an information recording surface of a second optical information medium having a protective substrate with a thickness t2 (t1≦t2<t3) using a second light flux with a second wavelength λ2 (λ1<λ2<λ3) emitted from a second light source.

60. The objective optical system of claim 57,
wherein the objective optical system satisfies
−3.5≦(νdA=νdB)/(100×(ndA−ndB))≦−0.7
where νdA is an Abbe constant of the material A for d-line,
νdB is an Abbe constant of the material B for d-line,
ndA is a refractive index of the material A for d-line,
ndB is a refractive index of the material B for d-line, and
ndA≠ndB.

61. The objective optical system of claim 57,
wherein the material A and the material B satisfies
11≦((νdA−νdB)²+10⁴×(ndA−ndB)²)^{1/2}≦47.5
where νdA is an Abbe constant of the material A for d-line,
νdB is an Abbe constant of the material B for d-line,
ndA is a refractive index of the material A for d-line, and
ndB is a refractive index of the material B for d-line.

62. The objective optical system of claim 60,
wherein the material B satisfies following expressions:
20≦νdB≦40
1.55<ndB≦1.70.

63. The objective optical system of claim 61,
wherein the material B satisfies following expressions:
20<νdB≦40
1.55<ndB≦1.70.

64. The objective optical system of claim 60,
wherein the material A satisfies following expressions:
45≦νdA≦65
1.45<ndA≦1.55.

65. The objective optical system of claim 61,
wherein the material A satisfies following expressions:
45≦νdA≦65
1.45<ndA≦1.55.

66. The objective optical system of claim 57, satisfies following expressions:
α×λ1=λ3
K1−0.1≦α≦K1+0.1
where K1 is a natural number.

67. The objective optical system of claim 66, satisfying K1=2.

68. The objective optical system of claim 66,
wherein the first phase structure does not diffract the first light flux and diffracts the third light flux.

69. The objective optical system of claim 68, satisfies following expressions:
L=d1×(nB1−nA1)/λ1
M=d1×(nB3−nA3)/λ3
L/INT(M)≠Integer
φ(M)=INT(D×M)−(D×M)
−0.4<φ(M)<0.4
where L is 2 or 3,
d1 is a depth along an optical axis of each steps in each of the plurality of patterns of the first phase structure,
nA1 is a refractive index of the material A for the first light flux,
nB1 is a refractive index of the material B for the first light flux,
nA3 is a refractive index of the material A for the third light flux,
nB3 is a refractive index of the material B for the third light flux,
D is the number of levels in each of the plurality of patterns of the first phase structure, and
INT(X) is an integer closest to X.

70. The objective optical system of claim 58, satisfies following expressions:
0.8×λ1×K2/(nB1−nA1)≦d1≦1.2×λ1×K2/(nB1−nA1)
where d1 is a depth along an optical axis of each steps in each of the plurality of patterns of the first phase structure,
nA1 is a refractive index of the material A for the first light flux,
nB1 is a refractive index of the material B for the first light flux,
K2 is a natural number.

71. The objective optical system of claim 70, satisfying K2−2.

72. The objective optical system of claim 71,
wherein a number of levels in each of the plurality of patterns of the first phase structure is 5,
where the number of levels is a number of optical surfaces having ring shapes included in one period of the first phase structure.

73. The objective optical system of claim 57,
wherein the first phase structure corrects a spherical aberration caused by a difference between the thickness t1 and the thickness t3.

74. The objective optical system of claim 57, satisfying m1=m2=0,
where m1 and m2 are magnifications of the objective optical system for the first light flux and the third light flux respectively.

75. The objective optical system of claim 59, satisfies following expressions:
β×λ1=λ2
1.5≦β≦1.7.

76. The objective optical system of claim 59, satisfying the following expressions:
L=d1×(nB1−nA1)/λ1
N=d1×(nB2−nA2)/λ2
L/INT(N)=Integer
φ(N)=INT(D×N)−(D×N)
−0.4<φ(N)<0.4
where L is 2,
d1 is a depth along an optical axis of each steps in each of the plurality of patterns of the first phase structure,
nA1 is a refractive index of the material A for the first light flux,
nB1 is a refractive index of the material B for the first light flux,
nA2 is a refractive index of the material A for the second light flux,
nB2 is a refractive index of the material B for the second light flux,
D is the number of levels included in each of the plurality of patterns of the first phase structure, and
INT(X) is an integer closest to X.

77. The objective optical system of claim 59, further comprising a second phase structure including a plurality of concentric ring shaped zones around an optical axis.

78. The objective optical system of claim 77,
wherein the second phase structure is arranged on an optical surface excluding the boundary between the first part and the second part.

79. The objective optical system of claim 77,
wherein the second phase structure arranged on a boundary between an air and one of the first part and the second part whose material has larger Abbe constant for d-line.

80. The objective optical system of claim 77,
wherein the second phase structure is arranged on an optical surface of the second optical element.

81. The objective optical system of claim 77,
wherein the second phase structure does not diffract the first light flux and the third light flux entering into the second phase structure and diffracts the second light flux.

82. The objective optical system of claim 81,
wherein the second phase structure has a structure including a plurality of patterns arranged concentrically,
each of the plurality of patterns has a cross section including an optical axis in a stepped shape with a plurality of levels,
a height of each step is shifted for every predefined number of levels by height of steps corresponding to the predefined number of levels.

83. The objective optical system of claim 82, satisfies following expressions:
0.8×λ1×K3/(nC1−1)≦d2≦1.2×λ1×K3/(nC1−1)
where d2 is a depth along an optical axis of each steps in each of the plurality of patterns of the second phase structure,
nC1 is a refractive index of one of the first part and second part including the second phase structure,
K3 is an even number.

84. The objective optical system of claim 83, satisfying K3=2.

85. The objective optical system of claim 82,
wherein the number of levels included in each of the plurality of patterns of the second phase structure is 5,
where the number of levels is a number of optical surfaces having ring shapes included in one period of the second phase structure.

86. The objective optical system of claim 77,
wherein a cross section of the second phase structure including an optical axis has a serrated shape.

87. The objective optical system of claim 77,
wherein a cross section of the second phase structure including an optical axis has a stepped structure such that an optical path length becomes larger at a position being farther from an optical axis, or
a stepped structure such that an optical path length becomes smaller at a position being farther from an optical axis.

88. The objective optical system of claim 77,
wherein a cross section of the second phase structure including an optical axis has
a stepped structure such that
an optical path length becomes larger at a position being farther from an optical axis when the position is lower than the predefined height from the optical axis and
an optical path length becomes smaller at a position being farther from an optical axis when the position is higher than the predefined height from the optical axis, or
a stepped structure such that
an optical path length becomes smaller at a position being farther from an optical axis when the position is lower than the predefined height from the optical axis and
an optical path length becomes larger at a position being farther from an optical axis when the position is higher than the predefined height from the optical axis.

89. The objective optical system of claim 77,
wherein the second phase structure provides an optical path length of even number times as large as the first wavelength to the first light flux.

90. The objective optical system of claim 77, satisfying 5≦d3≦10,
where d3 (μm) is a step depth along an optical axis of each of the plurality of ring shaped zones f the second phase structure.

91. The objective optical system of claim 77, satisfying t1=t2,
wherein the second phase structure corrects a chromatic spherical aberration caused by a wavelength difference between the first light flux and the second light flux.

92. The objective optical system of claim 77, satisfying t1<t2,
wherein the second phase structure corrects a chromatic spherical aberration caused by a thickness difference between the thickness t1 and the thickness t2.

93. The objective optical system of claim 59, satisfying m1=m2=m3=0,
where m1 to m3 are magnifications of the objective optical system for the first light flux to the third light flux respectively.

94. The objective optical system of claim 77,
wherein the second phase structure corrects a chromatic aberration for the first light flux.

95. The objective optical system of claim 77,
wherein the second phase structure corrects an increase of a spherical aberration according to a refractive index change of at least one of the first optical element and the second optical element.

96. The objective optical system of claim 57,
the boundary includes a central region and a peripheral region surrounding the central region,
the central region transmits a light flux portion of the first light flux used for reproducing and/or reproducing information on the first optical information recording medium, and a light flux portion of the third light flux used for reproducing and/or reproducing information on the third optical information recording medium, and
the first phase structure is arranged on the central region and is not arranged on the peripheral region.

97. The objective optical system of claim 57,
the boundary includes a central region and a peripheral region surrounding the central region,
the central region transmits a light flux portion of the first light flux used for reproducing and/or reproducing information on the first optical information recording medium, and a light flux portion of the third light flux used for reproducing and/or reproducing information on the third optical information recording medium,
the peripheral region transmits a light flux portion used for reproducing and/or reproducing information on the first optical information recording medium of the first light flux, and a light flux portion not used for reproducing and/or reproducing information on the third optical information recording medium of the third light flux,
the first phase structure is arranged on the central region and the peripheral region.

98. The objective optical system of claim 96,
wherein the objective optical system converges a light flux portion of the third light flux passing through the peripheral region at a more overfocused position than a converged position of the light flux portion passing through the central region.

99. The objective optical system of claim 97,
wherein the objective optical system converges a light flux portion of the third light flux passing through the peripheral region at a more overfocused position than a converged position of the light flux portion passing through the central region.

100. The objective optical system of claim 57,
wherein the boundary forms a plane surface without a refractive power for an incident light flux.

101. The objective optical system of claim 57,
wherein one of the material A and the material B is an ultraviolet curing resin.

102. The objective optical system of claim 57,
wherein each of the material A and the material B is resin.

103. The objective optical system of claim 57,
wherein the first optical element has at least one optical surfaces being an aspherical surface.

104. The objective optical system of claim 77,
wherein the second optical element is arranged at optical-information-recording-medium side of the first optical element.

105. The objective optical system of claim 57,
wherein the first phase structure corrects a spherical aberration caused by a difference between the thickness t1 and the thickness t3.

106. The objective optical system of claim 57,
wherein a material of the second optical element has an Abbe constant for d-line is in a range of 50 to 70.

107. An optical pickup apparatus for reproducing and/or recording information, comprising:
a first light source for emitting a first light flux with a first wavelength λ1;
a third light source for emitting a third light flux with a third wavelength λ3 (λ1<λ3); and
the objective optical system of claim 57,
wherein the optical pickup apparatus reproduces and/or records information using the first light flux on an information recording surface of a first optical information medium having a protective substrate with a thickness t1, and reproduces and/or records information using the third light flux on an information recording surface of a third optical information medium having a protective substrate with a thickness t3 (t3>t1).

108. An optical disc drive apparatus, comprising:
the optical pickup apparatus of claim 107; and
a moving unit for moving the optical pickup apparatus in a radius direction of each of the first to third optical information recording media.

109. The objective optical system of claim 1, further comprising a first phase structure including a plurality of steps in ringed shape,
wherein the objective optical system satisfies following expressions:
20<|Δνd|<40
0.3<(dn/dT)_{A}/(dn/dT)_{B}<3
where Δνd is a difference between an Abbe constant of the material A for d-line and an Abbe constant of the material B for d-line,
(dn/dT)_{A} is a change rate of a refractive index of the material A corresponding to a temperature change, and
(dn/dT)_{B}. is a change rate of a refractive index of the material B corresponding to a temperature change.

110. The objective optical system of claim 109,
wherein the objective optical system satisfies
0.5<(dn/dT)_{A}/(dn/dT)_{B}<2.

111. The objective optical system of claim 109,
wherein the optical pickup apparatus further reproduces and/or records information on an information recording surface of a second optical information medium having a protective substrate with a thickness t2 (t1≦t2≦t3) using a second light flux with a second wavelength λ2 (λ1<λ2<λ3) emitted from a second light source.

112. The objective optical system of claim 109,
wherein each of the material A and the material B is resin.

113. The objective optical system of claim 1, further comprising a first phase structure including a plurality of steps in ringed shape,
wherein the objective optical system satisfies
20<|Δνd|<40,
the material A is a glass material, and
the material B is a material in which a plurality of inorganic particles whose average diameter is 30 nm or less, is dispersed into a base body made of regin,
where Δνd is a difference between an Abbe constant of the material A for d-line and an Abbe constant of the material B for d-line.

114. The objective optical system of claim 113,
wherein a change rate of a refractive index of the base body made of resin corresponding to a temperature change and a change rate of a refractive index of the plurality of inorganic particles has a different sign from each other in the material B.

115. The objective optical system of claim 113,
wherein the material A has a glass transition point of 400° C. or less.

116. The objective optical system of claim 113,
wherein the objective optical system satisfies following expressions:
40<νdA<80
20<νdB<40
where νdA is an Abbe constant of the material A for d-line and
νdB is an Abbe constant of the material B for d-line.

117. The objective optical system of claim 113, satisfying
β−0.1≦α≦β+0.1
where α is λ3/λ1 and β is a natural number.

118. The objective optical system of claim 117, satisfying β=2.

119. The objective optical system of claim 109,
wherein each of the plurality of the steps has a depth of 5 μm or more.

120. The objective optical system of claim 113,
wherein each of the plurality of the steps has a depth of 5 μm or more.

121. The objective optical system of claim 119,
wherein each of the plurality of the steps has a depth of 10 μm or more.

122. The objective optical system of claim 120,
wherein each of the plurality of the steps has a depth of 10 μm or more.

123. The objective optical system of claim 109,
wherein the first phase structure is a diffractive structure.

124. The objective optical system of claim 109, further comprising a second phase structure arranged on a surface excluding the boundary between the first part and the second part.

125. The objective optical system of claim 109,
wherein the first optical element is an objective lens.

126. The objective optical system of claim 109,
wherein the objective optical system includes an objective lens arranged on an optical-information-recording-medium side of the first optical element.

127. The objective optical system of claim 111,
wherein the objective optical system satisfies t2>t1, and
corrects a spherical aberration caused by a difference between the thickness t1 and the thickness t3 and a spherical aberration caused by a difference between the thickness t1 and the thickness t2.

128. The objective optical system of claim 111,
wherein the objective optical system satisfies t2=t1,
the first phase structure corrects a spherical aberration caused by a difference between the thickness t1 and the thickness t3 and a spherical aberration caused by a difference between the first wavelength λ1 and the second wavelength λ2.

129. The objective optical system of claim 126,
wherein the objective lens is optimized about a spherical aberration correction for a combination of the thickness t1 and the first wavelength λ1.

130. The objective optical system of claim 109,
wherein the first phase structure corrects a spherical aberration caused by a difference between the thickness t1 and the thickness t3.

131. The objective optical system of claim 109, satisfies following expressions:
α×λ1=λ3
K1−0.1≦α≦K1+0.1
where K1 is a natural number.

132. An optical pickup apparatus for reproducing and/or recording information, comprising:
a first light source for emitting a first light flux with a first wavelength λ1;
a third light source for emitting a third light flux with a third wavelength λ3 (λ1<λ3); and
the objective optical system of claim 109,
wherein the optical pickup apparatus reproduces and/or records information using the first light flux on an information recording surface of a first optical information medium having a protective substrate with a thickness t1, and reproduces and/or records information using the third light flux on an information recording surface of a third optical information medium having a protective substrate with a thickness t3 (t3>t1).

133. An optical pickup apparatus for reproducing and/or recording information, comprising:
a first light source for emitting a first light flux with a first wavelength λ1;
a third light source for emitting a third light flux with a third wavelength λ3 (λ1<λ3); and
the objective optical system of claim 113,
wherein the optical pickup apparatus reproduces and/or records information using the first light flux on an information recording surface of a first optical information medium having a protective substrate with a thickness t1, and reproduces and/or records information using the third light flux on an information recording surface of a third optical information medium having a protective substrate with a thickness t3 (t3>t1).

134. An optical disc drive apparatus, comprising:
the optical pickup apparatus of claim 132; and
a moving unit for moving the optical pickup apparatus in a radius direction of each of the first to third optical information recording media.

135. An optical disc drive apparatus, comprising:
the optical pickup apparatus of claim 133; and
a moving unit for moving the optical pickup apparatus in a radius direction of each of the first to third optical information recording media.

136. The objective optical system of claim 1, further comprising a second phase structure arranged on a boundary between the first part and air,
wherein the objective optical system satisfies following expressions:
20≦νdA<40
40≦νdB≦70
where νdA is an Abbe constant of the material A for d-line and
νdB is an Abbe constant of the material B for d-line.

137. The objective optical system of claim 136,
wherein at least one of the first phase structure and the second phase structure is a diffractive structure.

138. The objective optical system of claim 137,
wherein the diffractive structure has a structure including a plurality of patterns arranged concentrically,
a shape of a cross section including an optical axis of each of the plurality of patterns has a stepped shape.

139. The objective optical system of claim 137,
wherein the diffractive structure has a structure including a plurality of ring-shaped zones arranged concentrically around an optical axis,
a cross section including an optical axis of the diffractive structure is a serrated shape.

140. The objective optical system of claim 137,
wherein the diffractive structure corrects a chromatic aberration for the first light flux.

141. The objective optical system of claim 136,
wherein the objective optical system consists of the first optical element and
a volume ratio of the first part in a total system of the objective optical system is 20% or below.

142. The objective optical system of claim 136,
wherein the objective optical system consists of the first optical element and
the first part is arranged at a closest position to the first—third light sources in the objective optical system.

143. The objective optical system of claim 136,
wherein at least one of the boundary where the first phase structure arranged and the boundary where the second phase structure arranged forms a plane surface without a refractive power for a passing light flux.

144. The objective optical system of claim 136, satisfying
1.8×t1≦t3≦2.2×t1.

145. The objective optical system of claim 136,
wherein the first phase structure is arranged in a region where a light flux portion used for reproducing and/or reproducing information on the third optical information recording medium of the third light flux.

146. The objective optical system of claim 136,
wherein the optical pickup apparatus further reproduces and/or records information on an information recording surface of a second optical information medium having a protective substrate with a thickness t2 (0.9×t1≦t2≦t3) using a second light flux with a second wavelength λ2 (λ1<λ2<λ3) emitted from a second light source.

147. The objective optical system of claim 146,
wherein at least one of the first phase structure and the second phase structure corrects a chromatic spherical aberration caused by a wavelength difference between the first light flux and the second light flux.

148. The objective optical system of claim 146, satisfies
−1/12≦m2≦1/12
−1/10≦m3≦1/10
where m2 and m3 are magnifications of the objective optical system for the second light flux and the third light flux respectively.

149. The objective optical system of claim 136, further comprising a diffractive structure arranged in a boundary between the second part and air, and
including a plurality of ring-shaped zones arranged concentrically around an optical axis,
a cross section including an optical axis of the diffractive structure is a serrated shape.

150. The objective optical system of claim 136,
wherein the first phase structure corrects a spherical aberration caused by a difference between the thickness t1 and the thickness t3.

151. The objective optical system of claim 136, satisfies following expressions:
α×λ1=λ3
K1−0.1≦α≦K1+0.1
where K1 is a natural number.

152. An optical pickup apparatus for reproducing and/or recording information, comprising:
a first light source for emitting a first light flux with a first wavelength λ1;
a third light source for emitting a third light flux with a third wavelength λ3 (λ1<λ3); and
the objective optical system of claim 136,
wherein the optical pickup apparatus reproduces and/or records information on an information recording surface of a first optical information medium having a protective substrate with a thickness t1 using the first light flux, and reproduces and/or records information on an information recording surface of a third optical information medium having a protective substrate with a thickness t3 (t3>t1) using the third light flux.

153. An optical disc drive apparatus, comprising:
the optical pickup apparatus of claim 152; and
a moving unit for moving the optical pickup apparatus in a radius direction of each of the first to third optical information recording media.
